(19) United States
(12) Patent Application Publication
(10) Pub. No.: US 2023/0276803 A1
(43) Pub. Date: Sep. 7, 2023

(54) A PESTICIDALLY ACTIVE MIXTURE COMPRISING THIETANYLOXY COMPOUND, OXIDES OR SALTS THEREOF

(71) Applicant: PI INDUSTRIES LTD., Udaipur-Rajasthan (IN)

(72) Inventors: Hagalavadi M VENKATESHA, Bengaluru- Karnataka (IN); Ravikumar Suryanarayana SARAGUR, Bengaluru- Karnataka (IN); Ruchi GARG, Varanasi-UP (IN); Jagdish PABBA, Udaipur-Rajasthan (IN); Santosh Shridhar AUTKAR, Akola-Maharashtra (IN)

(73) Assignee: PI INDUSTRIES LTD., Udaipur-Rajasthan (IN)

(21) Appl. No.: 18/014,357

(22) PCT Filed: Jul. 5, 2021
(86) PCT No.: PCT/IB2021/055992

§ 371 Date: Jan. 4, 2023

(30) Foreign Application Priority Data
Jul. 6, 2020 (IN) 202011028575

(51) Int. Cl. A01N 43/56; A01P 3/00

(52) U.S. Cl. CPC A01N 43/56; A01P 3/00

(57) ABSTRACT

The present invention relates to a pesticidal active mixture comprising thietanyloxy compound of formula (I), oxides or a salt thereof,

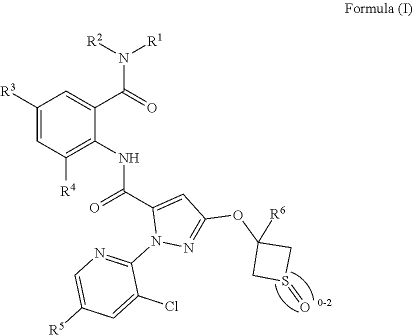

wherein, R¹, R², R³, R⁴, R⁵, and R⁶ are as defined in the description,
and at least one insecticidally active compound (II) or at least one fungicidally active compound (III).

### FIELD OF THE INVENTION

The present invention relates to a pesticidal active mixture which comprises at least one pesticidally active thietanyloxy compound of formula (I), oxides or a salt thereof as a component (1) and at least one insecticidally active compound (II) or at least one fungicidally active compound (III) as a component (2). Further, the present invention relates to a method for controlling invertebrate pests and/or phytopathogenic fungi of plants, to the use of the mixture for seed treatment, to a method for protecting seeds and to the corresponding treated seeds.

### BACKGROUND OF THE INVENTION

One of the problem/needs in controlling pests is to reduce the application rates of the pesticide in order to reduce or avoid environmental or toxicological effects while, at the same time, achieving effective pest control. The need to have pest control agents effective against a broad spectrum of pests is another challenge.

There also exists the need for pest control agents that provide quick action as well as long lasting activity in order to reduce the number of applications.

Another difficulty in relation to the use of solo pesticides is that the repeated and exclusive application in most of the cases leads to natural or adapted resistance against the pesticidally active compound. Therefore, there is a need for pest control means that help prevent or overcome resistance.

Furthermore, there is a desire for pesticidal active mixtures which, when applied, improve plant health, increase vitality of plant propagation or enhance yield.

Therefore, obtaining a pesticidal active mixture that demonstrates a higher controlling effect with reduced environmental or toxicological effects in addition to addressing one or more of the above discussed problems, is highly desirable.

WO2019150220 discloses a compound of the following formula

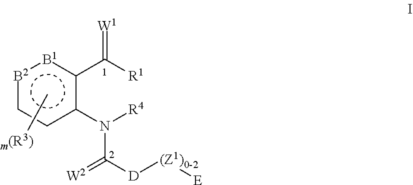

wherein,

W¹ and W² represent O; B¹ and B² represent C;

D is fragment D₄

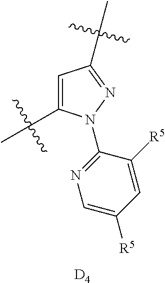

wherein, x is hydrogen, fluorine or chlorine;

Z¹ represents O; E represents thietanyl group;

R¹ represents NR¹⁰R¹¹ wherein R¹⁰ is hydrogen or methyl;

R³ represents cyano, fluorine, chlorine, bromine, methyl and trifluoromethyl;

R⁴ represents hydrogen;

R⁵ represents hydrogen, halogen;

R¹¹ represents C₁-C₆ alkyl, C₃-C₈ cycloalkyl, and C₄-C₈ cycloalkyl-C₁-C₆ alkyl;

and m represents an integer 2.

Surprisingly, it has been found that the pesticidal active mixture according to the present invention not only brings about the additive enhancement of the spectrum of action with respect to the pest/phytopathogen to be controlled, that was in principle to be expected, but also achieves a synergistic effect. The synergistic effect of the pesticidal active mixture of the present invention helps to reduce the application rate of component (1) selected from thietanyloxy compounds of formula (I) and component (2) which is at least one additional insecticidally active compound (II) or at least one fungicidally active compound (III) by maintaining the level of efficacy even if the two individual compounds alone have become less or close to ineffective at such low application rates. Also it allows a substantial broadening of the spectrum of phytopathogens that can be controlled by, at the same time, increasing the safety in use.

### SUMMARY OF THE INVENTION

Accordingly, the present invention provides a pesticidal active mixture comprising a component (1) as thietanyloxy compound of formula (I), oxides or a salt thereof,

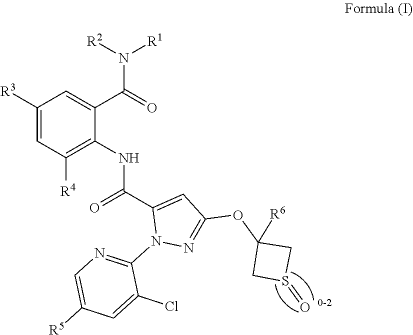

wherein, R¹, R², R³, R⁴, R⁵, and R⁶ are as defined in the description, and a component (2) is at least one insecticidally active compound (II) selected from the group consisting of:
(II-1) Acetylcholinesterase (AChE) inhibitors,
(II-2) GAB A-gated chloride channel blockers,
(II-3) Sodium channel modulators,
(II-4) Nicotinic acetylcholine receptor (nAChR) competitive modulators,
(II-5) Nicotinic acetylcholine receptor (nAChR) allosteric modulators—Site I,
(II-6) Glutamate-gated chloride channel (GluCl) allosteric modulators,
(II-7) Juvenile hormone mimics,
(II-8) Miscellaneous non-specific (multi-site) inhibitors,
(II-9) Chordotonal organ TRPV channel modulators,
(II-10) Mite growth inhibitors affecting CHS1,
(II-11) Microbial disruptors of insect midgut membranes,
(II-12) Inhibitors of mitochondrial ATP synthase,
(II-13) Uncouplers of oxidative phosphorylation via disruption of the proton gradient,
(II-14) Nicotinic acetylcholine receptor (nAChR) channel blockers,
(II-15) Inhibitors of the chitin biosynthesis affecting CHS1,
(II-16) Inhibitors of the chitin biosynthesis type 1,
(II-17) Moulting disruptors,
(II-18) Ecdyson receptor agonists,
(II-19) Octopamin receptor agonists,
(II-20) Mitochondrial complex III electron transport inhibitors,
(II-21) Mitochondrial complex I electron transport inhibitors,
(II-22) Voltage-dependent sodium channel blockers,
(II-23) Inhibitors of the acetyl CoA carboxylase,
(II-24) Mitochondrial complex IV electron transport inhibitors,
(II-25) Mitochondrial complex II electron transport inhibitors,
(II-26) Ryanodine receptor-modulators,
(II-27) Chordotonal organ Modulators—undefined target site,
(II-28) GABA-gated chloride channel allosteric modulators,
(II-29) Baculoviruses,
(II-30) Nicotinic Acetylcholine Receptor (nAChR) Allosteric Modulators—Site II,
(II-31) Insecticidal active compounds of unknown or uncertain mode of action,
(II-32) Biopesticides, and
(II-33) Biochemical pesticides with insecticidal, acaricidal, molluscidal, pheromone and/or nematicidal activity.

Another aspect of the present invention provides a pesticidal active mixture comprising thietanyloxy compound of formula (I), oxides or a salt thereof as a component (1) and a component (2) is at least one fungicidally active compound (III) selected from the group consisting of:
(A) inhibitors of the ergosterol synthesis,
(B) inhibitors of the respiratory chain at complex I or II,
(C) inhibitors of the respiratory chain at complex III,
(D) inhibitors of the mitosis and cell division,
(E) compounds capable of having a multisite action,
(F) compounds capable of inducing a host defense,
(G) inhibitors of the amino acid and/or protein biosynthesis,
(H) inhibitors of the ATP production,
(I) inhibitors of the cell wall synthesis,
(J) inhibitors of the lipid and membrane synthesis,
(K) inhibitors of the melanine biosynthesis,
(L) inhibitors of the nucleic acid synthesis,
(M) inhibitors of the signal transduction,
(N) compounds capable of acting as uncoupler,
(O) other fungicides,
(P) HDAC inhibitors, and
(Q) compounds capable to act as a safener.

In yet another aspect, the present invention provides a method for controlling invertebrate pests and/or phytopathogenic fungi of plants, comprising the step of applying a pesticidal active mixture to the pest and/or microorganisms and/or their habitat including plants, plant parts, seeds, fruits or to the soil.

### DETAILED DESCRIPTION OF THE INVENTION

### Definitions

In the definitions of the symbols given in the above formulae, collective terms were used which are generally representative of the following substituents:

The term “hydrogen” encompasses also isotopes of hydrogen, preferably deuterium and tritium, more preferably deuterium.

The term “halogen” (also in combinations such as haloalkyl, haloalkoxy etc.) encompasses fluorine, chlorine, bromine and iodine, and preferably fluorine, chlorine, bromine.

The term “alkyl” (including in combinations such as alkylthio, alkoxy etc.) encompasses saturated, straight-chain or branched hydrocarbyl radicals having 1 to 6 carbon atoms, for example C1-C6-alkyl, such as methyl, ethyl, propyl, 1-methylethyl, butyl, 1-methylpropyl, 2-methylpropyl, 1,1-dimethylethyl, pentyl, 1-methylbutyl, 2-methylbutyl, 3-methylbutyl, 2,2-dimethylpropyl, 1-ethylpropyl, hexyl, 1,1-dimethylpropyl, 1,2-dimethylpropyl, 1-methylpentyl, 2-methylpentyl, 3-methylpentyl, 4-methylpentyl, 1,1-dimethylbutyl, 1,2-dimethylbutyl, 1,3-dimethylbutyl, 2,2-dimethylbutyl, 2,3-dimethylbutyl, 3,3-dimethylbutyl, 1-ethylbutyl, 2-ethylbutyl, 1,1,2-trimethylpropyl, 1,2,2-trimethylpropyl, 1-ethyl-1-methylpropyl, 1-ethyl-2-methylpropyl, heptyl and octyl. If the alkyl is at the end of a composite substituent, as, for \example, in cycloalkyl-alkyl, the part of the composite substituent at the start, for example the alkyl, may be mono- or polysubstituted identically or differently and independently by cycloalkyl.

The term “cycloalkyl” means alkyl closed to form a ring. Non-limiting examples include but are not limited to cyclopropyl, cyclopentyl and cyclohexyl. This definition also applies to cycloalkyl as a part of a composite substituent, for example cycloalkyl-alkyl etc., unless specifically defined elsewhere.

Depending on the nature of the substituents, the compounds of formula (I) of the present invention or the combining partner forming the part of pesticidal active mixture can be present as mixtures of different possible isomeric forms, in particular of stereoisomers, such as, for example, E and Z, threo and erythro, and also optical isomers, and, if appropriate, also of tautomers. If applicable, compounds of formula (I) or the combining partner forming the part of pesticidal active mixture comprise both the E and the Z isomers, and also the threo and erythro, and the optical isomers, any mixtures of these isomers, and the possible tautomeric forms.

Any of the compounds of formula (I) or the combining partner forming the part of pesticidal active mixture can exist in one or more optical, geometric or chiral isomer forms depending on the number of asymmetric centres in the compound. The compound of formula (I) or the combining partner forming the part of pesticidal active mixture include all the optical isomers and to their racemic or scalemic mixtures (the term “scalemic” denotes a mixture of enantiomers in different proportions), and to the mixtures of all the possible stereoisomers, in all proportions. The diastereomers and/or the optical isomers can be separated according to the methods which are known per se by a person ordinary skilled in the art.

Any of the compounds of formula (I) or the combining partner forming the part of pesticidal active mixture can also exist in one or more geometric isomer forms depending on the number of double bonds in the compound. The compound of formula (I) or the combining partner forming the part of pesticidal active mixture include all geometric isomers and to all possible mixtures, in all proportions. The geometric isomers can be separated according to general methods, which are known per se by a person ordinary skilled in the art.

Depending on the nature of the substituents, the compounds of formula (I) can also exist in one or more geometric isomer forms depending on the relative position (syn/anti or cis/trans) of the substituents of ring B. The invention thus relates equally to all syn/anti (or cis/trans) isomers and to all possible syn/anti (or cis/trans) mixtures, in all proportions. The syn/anti (or cis/trans) isomers can be separated according to general methods, which are known per se by the man ordinary skilled in the art.

The compound of formula (I) can be reacted with acids to give salts.

Examples of inorganic acids are hydrohalic acids, such as hydrogen fluoride, hydrogen chloride, hydrogen bromide and hydrogen iodide, sulfuric acid, phosphoric acid and nitric acid, and acidic salts, such as NaHSO₄ and KHSO₄.

Suitable organic acids are, for example, formic acid, carbonic acid and alkanoic acids, such as acetic acid, trifluoroacetic acid, trichloroacetic acid and propionic acid, and also glycolic acid, thiocyanic acid, lactic acid, succinic acid, citric acid, benzoic acid, cinnamic acid, oxalic acid, alkylsulfonic acids (sulfonic acids having straight-chain or branched alkyl groups having 1 to 20 carbon atoms), arylsulfonic acids or disulfonic acids (aromatic groups, such as phenyl and naphthyl, which carry one or two sulfonic acid groups), alkylphosphonic acids (phosphonic acids having straight-chain or branched alkyl groups having 1 to 20 carbon atoms), arylphosphonic acids or diphosphonic acids (aromatic radicals, such as phenyl and naphthyl, which carry one or two phosphonic acid groups), where the alkyl and aryl groups may carry further substituents, for example p-toluenesulfonic acid, salicylic acid, p-aminosalicylic acid, 2-phenoxybenzoic acid, 2-acetoxybenzoic acid, etc.

In view of the above, the present invention provides a pesticidal mixture comprising a mixture of at least one pesticidally active comprising component (1) as thietanyloxy compound of formula (I),

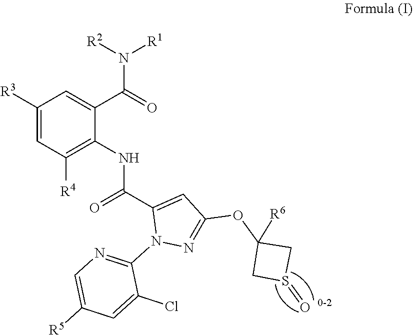

wherein,

R¹ is selected from the group consisting of C₁-C₆ alkyl, C₃-C₅ cycloalkyl, C₃-C₅ cycloalkyl-C₁-C₆ alkyl and C₁-C₆ alkyl-C₃-C₅ cycloalkyl;

R² is selected from the group consisting of hydrogen and methyl;

R³ is selected from the group consisting of halogen and cyano;

R⁴ is selected from the group consisting of methyl, fluorine, chlorine, bromine and trifluoromethyl;

R⁵ is selected from the group consisting of hydrogen, fluorine and chlorine;

R⁶ is selected from the group consisting of hydrogen, methyl and trifluoromethyl;

or agriculturally acceptable salts, isomers/structural isomers, stereo-isomers, diastereomers, enantiomers, tautomers, metal complexes, polymorphs, or N-oxides thereof;

and at least one insecticidally active compound (II) and/or at least one fungicidally active compound (III) as a component (2);

wherein, at least one insecticidally active compound (II) selected from the group consisting of:
(II-1) Acetylcholinesterase (AChE) inhibitors,
(II-2) GAB A-gated chloride channel blockers,
(II-3) Sodium channel modulators,
(II-4) Nicotinic acetylcholine receptor (nAChR) competitive modulators,
(II-5) Nicotinic acetylcholine receptor (nAChR) allosteric modulators—Site I,
(II-6) Glutamate-gated chloride channel (GluCl) allosteric modulators,
(II-7) Juvenile hormone mimics,
(II-8) Miscellaneous non-specific (multi-site) inhibitors,
(II-9) Chordotonal organ TRPV channel modulators,
(II-10) Mite growth inhibitors affecting CHS 1,
(II-11) Microbial disruptors of insect midgut membranes,
(II-12) Inhibitors of mitochondrial ATP synthase,
(II-13) Uncouplers of oxidative phosphorylation via disruption of the proton gradient,
(II-14) Nicotinic acetylcholine receptor (nAChR) channel blockers,
(II-15) Inhibitors of the chitin biosynthesis affecting CHS1,
(II-16) Inhibitors of the chitin biosynthesis type 1,
(II-17) Moulting disruptors,
(II-18) Ecdyson receptor agonists,
(II-19) Octopamin receptor agonists,
(II-20) Mitochondrial complex III electron transport inhibitors,
(II-21) Mitochondrial complex I electron transport inhibitors,
(II-22) Voltage-dependent sodium channel blockers,
(II-23) Inhibitors of the acetyl CoA carboxylase,
(II-24) Mitochondrial complex IV electron transport inhibitors,
(II-25) Mitochondrial complex II electron transport inhibitors,
(II-26) Ryanodine receptor-modulators,
(II-27) Chordotonal organ Modulators—undefined target site,
(II-28) GABA-gated chloride channel allosteric modulators,
(II-29) Baculoviruses,
(II-30) Nicotinic Acetylcholine Receptor (nAChR) Allosteric Modulators—Site II,
(II-31) Insecticidal active compounds of unknown or uncertain mode of action,
(II-32) Biopesticides, and
(II-33) Biochemical pesticides with insecticidal, acaricidal, molluscidal, pheromone and/or nematicidal activity;

and at least one fungicidally active compound (III) selected from the group consisting of:
(A) inhibitors of the ergosterol synthesis,
(B) inhibitors of the respiratory chain at complex I or II,
(C) inhibitors of the respiratory chain at complex III,
(D) inhibitors of the mitosis and cell division,
(E) compounds capable of having a multisite action,
(F) compounds capable of inducing a host defense,
(G) inhibitors of the amino acid and/or protein biosynthesis,
(H) inhibitors of the ATP production,
(I) inhibitors of the cell wall synthesis,
(J) inhibitors of the lipid and membrane synthesis,
(K) inhibitors of the melanine biosynthesis,
(L) inhibitors of the nucleic acid synthesis,
(M) inhibitors of the signal transduction,
(N) compounds capable of acting as uncoupler,
(O) other fungicides,
(P) HDAC inhibitors, and
(Q) compounds capable to act as a safener.

In one embodiment, the present invention provides a pesticidal active mixture comprising component (1) as thietanyloxy compound of formula (I),

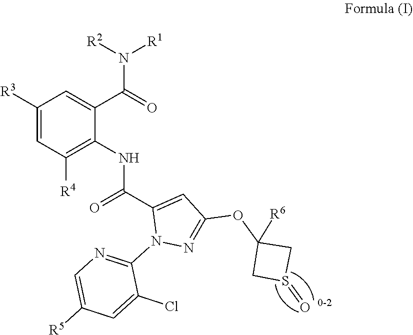

wherein,

R¹ is selected from the group consisting of C₁-C₆ alkyl, C₃-C₅ cycloalkyl, C₃-C₅ cycloalkyl-C₁-C₆ alkyl and C₁-C₆ alkyl-C₃-C₈ cycloalkyl;

R² is selected from the group consisting of hydrogen and methyl;

R³ is selected from the group consisting of halogen and cyano;

R⁴ is selected from the group consisting of methyl, fluorine, chlorine, bromine and trifluoromethyl;

R⁵ is selected from the group consisting of hydrogen, fluorine and chlorine;

R⁶ is selected from the group consisting of hydrogen, methyl and trifluoromethyl;

or agriculturally acceptable salts, isomers/structural isomers, stereo-isomers, diastereomers, enantiomers, tautomers, metal complexes, polymorphs, or N-oxides thereof;

and component (2) is at least one insecticidally active compound (II) selected from the group consisting of:
(II-1) Acetylcholinesterase (AChE) inhibitors selected from the class of
(II-1A) carbamates including alanycarb (Z001), aldicarb (Z002), bendiocarb (Z003), benfuracarb (Z004), butocarboxim (Z005), butoxycarboxim (Z006), carbaryl (Z007), carbofuran (Z008), carbosulfan (Z009), ethiofencarb (Z010), fenobucarb (Z011), formetanate (Z012), furathiocarb (Z013), isoprocarb (Z014), methiocarb (Z015), methomyl (Z016), metolcarb (Z017), oxamyl (Z018), pirimicarb (Z019), propoxur (Z020), thiodicarb (Z021), thiofanox (Z022), triazamate (Z023), trimethacarb (Z024), XMC (Z025), and xylylcarb (Z026); or
(II-1B) organophosphates including acephate (Z027), azamethiphos (Z028), azinphos-ethyl (Z029), azinphosmethyl (Z030), cadusafos (Z031), chlorethoxyfos (Z032), chlorfenvinphos (Z033), chlormephos (Z034), chlorpyrifos (Z035), chlorpyrifos-methyl (Z036), coumaphos (Z037), cyanophos (Z038), demeton-s-methyl (Z039), diazinon (Z040), dichlorvos/ddvp (Z041), dicrotophos (Z042), dimethoate (Z043), dimethylvinphos (Z044), disulfoton (Z045), epn (Z046), ethion (Z047), ethoprophos (Z048), famphur (Z049), fenamiphos (Z050), fenitrothion (Z051), fenthion (Z052), fosthiazate (Z053), heptenophos (Z054), imicyafos (Z055), isofenphos (Z056), isopropyl o-(methoxyaminothio-phosphoryl) salicylate (Z057), isoxathion (Z058), malathion (Z059), mecarbam (Z060), methamidophos (Z061), methidathion (Z062), mevinphos (Z063), monocrotophos (Z064), naled (Z065), omethoate (Z066), oxydemeton-methyl (Z067), parathion (Z068), parathion-methyl (Z069), phenthoate (Z070), phorate (Z071), phosalone (Z072), phosmet (Z073), phosphamidon (Z074), phoxim (Z075), pirimiphos-methyl (Z076), profenofos (Z077), propetamphos (Z078), prothiofos (Z079), pyraclofos (Z080), pyridaphenthion (Z081), quinalphos (Z082), sulfotep (Z083), tebupirimfos (Z084), temephos (Z085), terbufos (Z086), tetrachlorvinphos (Z087), thiometon (Z088), triazophos (Z089), trichlorfon (Z090), and vamidothion (Z091);
(II-2) GABA-gated chloride channel blockers selected from the class of
(II-2A) Cyclodiene Organochlorines including chlordane (Z092) and endosulfan (Z093); or
(II-2B) Phenylpyrazoles (Fiproles) including ethiprole (Z094), fipronil (Z095), flufiprole (Z096), pyrafluprole (Z097) and pyriprole (Z0918;
(II-3) Sodium channel modulators selected from the class of
(II-3A) Pyrethroids/Pyrethrins including acrinathrin (Z099), allethrin (Z100), d-cis-trans allethrin (Z101), d-trans-allethrin (Z102), bifenthrin (Z103), bioallethrin (Z104), bioallethrin s-cyclopentenyl isomer (Z105), bioresmethrin (Z106), cycloprothrin (Z107), cyfluthrin (Z108), beta-cyfluthrin (Z109), cyhalothrin (Z110), lambda-cyhalothrin (Z111), gamma-cyhalothrin (Z112), cypermethrin (Z113), alpha-cypermethrin (Z114), beta-cypermethrin (Z115), theta-cypermethrin (Z116), zeta-cypermethrin (Z117), cyphenothrin [(1r)-trans-isomers (Z118), deltamethrin (Z119), empenthrin [(ez)-(1r)-isomers] (Z120), esfenvalerate (Z121), etofenprox (Z122), fenpropathrin (Z123), fenvalerate (Z124), flucythrinate (Z125), flumethrin (Z126), tau-fluvalinate (Z127), halfenprox (Z128), imiprothrin (Z129), meperfluthrin (Z130), metofluthrin (Z131), momfluorothrin (Z132), kadethrin (Z133), permethrin (Z134), phenothrin [(1r)-trans-isomer] (Z134), prallethrin (Z135), profluthrin (Z136), pyrethrins (pyrethrum) (Z137), resmethrin (Z138), silafluofen (Z139), tefluthrin (Z140), tetramethylfluthrin (Z141), tetramethrin (Z142), tetramethrin [(1r)-isomers] (Z143), tralomethrin (Z144) and transfluthrin (Z145); or
(II-3B) DDT (Z146) or methoxychlor (Z147)
(II-4) Nicotinic acetylcholine receptor (nAChR) competitive modulators selected from the class of (II-4A) Neonicotinoids including acetamiprid (Z148), clothianidin (Z149), dinotefuran (Z150), imidacloprid (Z151), nitenpyram (Z152), thiacloprid (Z153), thiamethoxam (Z154), 1-[(6-chloro-3-pyridinyl)methyl]-2,3,5,6,7,8-hexahydro-9-nitro-(5S,8R)-5,8-epoxy-H-imidazo[1,2-a]azepine (Z155); 1-[(6-chloro-3-pyridyl)methyl]-2-nitro-1-[(E)-pentylidene amino]guanidine (Z156); and 1-[(6-chloro-3-pyridyl)methyl]-7-methyl-8-nitro-5-propoxy-3,5,6,7-tetrahydro-2H-imidazo[1,2-a]pyridine (Z157); or
(II-4B) Nicotine (Z158); or
(II-4C) Sulfoximines including sulfoxaflor (Z159); or
(II-4D) Butenolides including flupyradifurone (Z160); or
(II-4E) Mesoionics including triflumezopyrim (Z161), and dichloromezotiaze (Z162),
(II-4F) Flupyrimin (Z163),
(II-5) Nicotinic acetylcholine receptor (nAChR) allosteric modulators—Site I selected from the class of spinosyns including spinetoram (Z164) and spinosad (Z165),
(II-6) Glutamate-gated chloride channel (GluCl) allosteric modulators selected from the class avermectins/Milbemycins including abamectin (Z166), emamectin benzoate (Z167), lepimectin (Z168) and milbemectin (Z169),
(II-7) Juvenile hormone mimics selected from the class of
(II-7A) Juvenile hormone analogues including hydroprene (Z170), kinoprene (Z171) and methoprene (Z172); or
(II-7B) Fenoxycarb (Z173); or
(II-7C) Pyriproxyfen (Z174),
(II-8) Miscellaneous non-specific (multi-site) inhibitors selected from the class of (II-8A) Alkyl halides including methyl bromide (Z175) and other alkyl halides (Z176); or
(II-8B) Chloropicrin (Z177); or
(II-8C) Fluorides including cryolite (sodium aluminium fluoride) (Z178) and sulfuryl fluoride (Z179); or
(II-8D) Borates including borax (Z180), boric acid (Z181), disodium octaborate (Z182), sodium borate (Z183), and sodium metaborate (Z184); or
(II-8E) Tartar emetic (Z185); or
(II-8F) Methyl isothiocyanate generators including dazomet (Z186) and metam (Z187),
(II-9) Chordotonal organ TRPV channel modulators selected from the class of
(II-9A) Pyridine azomethine derivatives including pymetrozine (Z188), and pyrifluquinazon (Z189); or
(II-9B) Pyropenes including afidopyropen (Z190),
(II-10) Mite growth inhibitors affecting CHS1 selected from the class of
(II-10A) Clofentezine (Z191), Hexythiazox (Z192) and Diflovidazin (Z193); or
(II-10B) Etoxazole (Z194),
(II-11) Microbial disruptors of insect midgut membranes selected from the class of
(II-11A) Bacillus thuringiensis (Z195) and the insecticidal proteins they produce, including Bacillus thuringiensis or Bacillus sphaericus and the insecticidal proteins they produce such as Bacillus thuringiensis subsp. israelensis, Bacillus thuringiensis subsp. aizawai, Bacillus thuringiensis subsp. kurstaki and Bacillus thuringiensis subsp. Tenebrionis, or the B.t crop proteins: Cry1Ab, Cry1Ac, Cry 1Fa, Cry1A.105, Cry2Ab, Vip3A, mCry3A, Cry3Ab, Cry3Bb and Cry34/35Ab1,
(II-12) Inhibitors of mitochondrial ATP synthase selected from the class of
(II-12A) Diafenthiuron (Z197); or
(II-12B) Organotin miticides including azocyclotin (Z198), cyhexatin (Z199) and fenbutatin oxide
(Z200), or
(II-12C) Propargite (Z201), or
(II-12D) Tetradifon (Z202),
(II-13) Uncouplers of oxidative phosphorylation via disruption of the proton gradient selected from the class of
(II-13A) Pyrroles including chlorfenapyr (Z203); or
(II-13B) Dinitrophenols including DNOC (Z204); or
(II-13C) Sulfluramid (Z205),
(II-14) Nicotinic acetylcholine receptor (nAChR) channel blockers selected from the class of nereistoxin analogues including bensultap (Z206), cartap hydrochloride (Z207), thiocyclam (Z208) and thiosultap-sodium (Z209),
(II-15) Inhibitors of the chitin biosynthesis affecting CHS1 selected from the class of bzoylureas including bistrifluron (Z210), chlorfluazuron (Z211), diflubenzuron (Z212), flucycloxuron (Z213), flufenoxuron (Z214), hexaflumuron (Z215), lufenuron (Z216), novaluron (Z217), noviflumuron (Z218), teflubenzuron (Z219) and triflumuron (Z220),
(II-16) Inhibitors of the chitin biosynthesis type 1 including buprofezin (Z221),
(II-17) Moulting disruptors, Dipteran, including cyromazine (Z222), (II-18) Ecdyson receptor agonists selected from the class of diacylhydrazines including methoxyfenozide (Z223), tebufenozide (Z224), halofenozide (Z225), fufenozide (Z226) and chromafenozide (Z227);
(II-19) Octopamin receptor agonists, including amitraz (Z228),
(II-20) Mitochondrial complex III electron transport inhibitors selected from the class of
(II-20A) Hydramethylnon (Z229); or
(II-20B) Acequinocyl (Z230); or
(II-20C) Fluacrypyrim (Z231); or
(II-20D) Bifenazate (Z232),
(II-21) Mitochondrial complex I electron transport inhibitors selected from the class of
(II-21A) METI acaricides and insecticides including fenazaquin (Z233), fenpyroximate (Z234), pyrimidifen (Z235), pyridaben (Z236), tebufenpyrad (Z237) and tolfenpyrad (Z238); or
(II-21B) Rotenone (Z239),
(II-22) Voltage-dependent sodium channel blockers selected from the class of
(II-22A) Oxadiazines including indoxacarb (Z240); or
(II-22B) Semicarbazones including metaflumizone (Z241); or
(II-22C) 1-[(E)-[2-(4-cyanophenyl)-1-[3-(trifluoromethyl)phenyl]ethylidene]amino]-3-[4-(difluoromethoxy)phenyl]urea (Z242),
(II-22D) 2-[3-(ethanesulfonyl)pyridin-2-yl]-5-[trifluoro(methanesulfonyl)]-1,3-benzoxazole (oxazosulfyl) (Z243),
(II-23) Inhibitors of the acetyl CoA carboxylase selected from the class of tetronic and Tetramic acid derivatives including spirodiclofen (Z244), spiromesifen (Z245), spiropidion (Z246), and spirotetramat (Z247),
(II-24) Mitochondrial complex IV electron transport inhibitors selected from the class of
(II-24A) Phosphides including aluminium phosphide (Z248), calcium phosphide (Z249), phosphine
(Z250) and zinc phosphide (Z251); or
(II-24B) Cyanides including calcium cyanide (Z252), potassium cyanide (Z253) and sodium cyanide (Z254),
(II-25) Mitochondrial complex II electron transport inhibitors selected from the class of
(II-25A) Beta-ketonitrile derivatives including cyenopyrafen (Z255) and cyflumetofen (Z256), or
(II-25B) Caboxanilides including pyflubumide (Z257), (II-26) Ryanodine receptor-modulators from the class of diamides including flubendiamide (Z258), chlorantraniliprole (Rynaxypyr®) (Z259), cyantraniliprole (Cyazypyr®) (Z260), cyclaniliprole (Z260), tetraniliprole (Z261), tetra-chlorantraniliprole (Z262), (R)-3-Chlor-N1-{2-methyl-4-[1,2,2,2-tetrafluor-1-(trifluormethyl)ethyl]phenyl}-N2-(1-methyl-2-methylsulfonylethyl)phthalamid (Z263); (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (Z264); methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate (Z265); N-[2-(5-amino-1,3,4-thiadiazol-2-yl)-4-chloro-6-methyl-phenyl]-5-bromo-2-(3-chloro-2-pyridyl)pyrazole-3-carboxamide (Z266); 5-chloro-2-(3-chloro-2-pyridyl)-N-[2,4-dichloro-6-[(1-cyano-1-methyl-ethyl)carbamoyl]phenyl]pyrazole-3-carboxamide (Z267); 5-bromo-N-[2,4-dichloro-6-(methylcarbamoyl)phenyl]-2-(3,5-dichloro-2-pyridyl)pyrazole-3-carboxamide (Z268); N-[2-(tert-butylcarbamoyl)-4-chloro-6-methyl-phenyl]-2-(3-chloro-2-pyridyl)-5-(fluoromethoxy)pyrazole-3-carboxamide (Z269); N2-(1-cyano-1-methyl-ethyl)-N1-(2,4-dimethylphenyl)-3-iodo-phthalamide (Z270); and 3-chloro-N2-(1-cyano-1-methyl-ethyl)-N1-(2,4-dimethylphenyl)phthalamide (Z271),
(II-27) Chordotonal organ Modulators—undefined target site including flonicamid (Z272),
(II-28) GABA-gated chloride channel allosteric modulators selected from the class of
(II-28A) Meta-diamides including broflanilide (Z273); or
(II-28B) Isoxazolines including fluxametamide (Z274); Isocycloseram (Z275),
(II-29) Baculoviruses selected from the class of
(II-29A) Granuloviruses (GVs) including Cydia pomonella GV (Z276) and Thaumatotibia leucotreta GV (Z277); or
(II-29B) Nucleopolyhedroviruses (NPVs) including Anticarsia gemmatalis MNPV (Z278), and Helicoverpa armigera NPV (Z279),
(II-30) Nicotinic Acetylcholine Receptor (nAChR) Allosteric Modulators—Site II including GS omega/kappa HXTX-Hv1a peptide (Z280),
(II-31) Insecticidal active compounds of unknown or uncertain mode of action including
Afidopyropen (Z281), azadirachtin (Z282), amidoflumet (Z283), benzoximate (Z284), benzpyrimoxan (Z285), bifenazate (Z286), bromopropylate (Z287), chinomethionat (Z288), cryolite (Z289), dicofol (Z290), flufenerim (Z291), flometoquin (Z292), fluhexafon (Z293), fluensulfone (Z294), flupyradifurone (Z295), lime sulphur (Z296), mancozeb (Z297), piperonyl butoxide (Z298), pyridalyl (Z299), pyrifluquinazon (Z300), sulfoxaflor (Z301), sulphur (Z302), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (Z303); cyclopropaneacetic acid (Z304); 1,1′-[(3S,4R,4aR,6S,6aS,12R, 12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho [2,1-b]pyrano[3,4-e]pyran-3,6-diyl]ester (Z305); 11-(4-chloro-2,6-dimethylphenyl)-12-hydroxy-1,4-dioxa-9-azadispiro[4.2.4.2]-tetradec-11-en-10-one (Z306); 3-(4′-fluoro-2,4-dimethylbiphenyl-3-yl)-4-hydroxy-8-oxa-1-azaspiro[4.5]dec-3-en-2-one (Z307); 1-[2-fluoro-4-methyl-5-[(2,2,2-trifluoroethyl)sulfinyl]phenyl]-3-(trifluoromethyl)-1H-1,2,4-triazole-5-amine (Z308); or actives on basis of Bacillus firmus (Votivo, II-1582) (Z309); (E/Z)—N-[1-[(6-chloro-3-pyridyl)methyl]-2-pyridylidene]-2,2,2-trifluoro-acetamide (Z310); (E/Z)—N-[1-[(6-chloro-5-fluoro-3-pyridyl)methyl]-2-pyridylidene]-2,2,2-trifluoro-acetamide (Z311); (E/Z)-2,2,2-trifluoro-N-[1-[(6-fluoro-3-pyridyl)methyl]-2-pyridylidene]acetamide (Z312); (E/Z)—N-[1-[(6-bromo-3-pyridyl)methyl]-2-pyridylidene]-2,2,2-trifluoro-acetamide (Z313); (E/Z)—N-[1-[1-(6-chloro-3-pyridyl)ethyl]-2-pyridylidene]-2,2,2-trifluoro-acetamide (Z314); (E/Z)—N-[1-[(6-chloro-3-pyridyl)methyl]-2-pyridylidene]-2,2-difluoro-acetamide (Z315); (E/Z)-2-chloro-N-[1-[(6-chloro-3-pyridyl)methyl]-2-pyridylidene]-2,2-difluoro-acetamide (Z316); (E/Z)—N-[1-[(2-chloropyrimidin-5-yl)methyl]-2-pyridylidene]-2,2,2-trifluoro-acetamide (Z317); (E/Z)—N-[1-[(6-chloro-3-pyridyl)methyl]-2-pyridylidene]-2,2,3,3,3-pentafluoro-propanamide) (Z318); triflumezopyrim (Z319); 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide (Z312); 3-[3-chloro-5-(trifluoromethyl)phenyl]-4-oxo-1-(pyrimidin-5-ylmethyl)pyrido[1,2-a]pyrimidin-1-ium-2-olate (Z313); 8-chloro-N-[2-chloro-5-methoxyphenyl)sulfonyl]-6-trifluoromethyl)-imidazo[1,2-a]pyridine-2-carboxamide (Z314); 4-[5-(3,5-dichlorophenyl)-5-(trifluoromethyl)-4H-isoxazol-3-yl]-2-methyl-N-(1-oxothietan-3-yl)benzamide (Z315); 5-[3-[2,6-dichloro-4-(3,3-dichloroallyloxyl)phenoxy]propoxy]-1H-pyrazole (Z316); Dimpropyridaz (Z317); Tyclopyrazoflor (Z318) and Nicofluprole (Z319), (II-32) Biopesticides selected from the class of Microbial pesticides with insecticidal, acaricidal, molluscidal and/or nematicidal activity including Bacillus firmus (Z320), B.t. ssp. galleriae, B.t. ssp. kurstaki, Beauveria bassiana (Z321), Burkholderia sp. (Z322), Chromobacterium subtsugae (Z323), Isaria fumosorosea (Z324), Lecanicillium longisporum (Z325), L. muscarium (formerly Verticillium lecanii) (Z326), Metarhizium anisopliae (Z327), M. anisopliae var. acridum (Z328), Paecilomyces fumosoroseus Apopka strain 97 (Z329), P. lilacinus (Z330), Paenibacillus poppiliae (Z331), Pasteuria spp. (Z332), P. nishizawae (Z333), P. reneformis (Z334), P. usagae (Z335), Pseudomonas fluorescens (Z336), Steinernema feltiae (Z337), Streptomces galbus (Z338), Wolbachia pipientis (Zap) (Z339), Bacillus amyloliquefaciens (Z373), Bacillus subtilis (Z374), Lecanicillium lecanii (Z375), Purpureocillium lilacinum (Z376) and Burkholderia rinojenses (Z377) and
(II-33) Biochemical pesticides with insecticidal, acaricidal, molluscidal, pheromone and/or nematicidal activity including L-carvone (Z340); citral (Z341); (E,Z)-7,9-dodecadien-1-yl acetate (Z342); ethyl formate (Z343); (E,Z)-2,4-ethyl decadienoate (pear ester) (Z344); (Z,Z,E)-7,11,13-hexadecatrienal (Z345); heptyl butyrate (Z346); isopropyl myristate (Z347); lavanulyl senecioate (Z348); 2-methyl 1-butanol (Z349); methyl eugenol (Z350); methyl jasmonate (Z351); (E,Z)-2,13-octadecadien-1-ol (Z352); (E,Z)-2,13-octadecadien-1-ol acetate (Z353); (E,Z)-3,13-octadecadien-1-ol (Z354), R-1-octen-3-ol (Z355); pentatermanone (Z356); potassium silicate (Z357); sorbitol actanoate (Z358); (E,Z,Z)-3,8,11-tetradecatrienyl acetate (Z359); (Z,E)-9,12-tetradecadien-1-yl acetate (Z360); Z-7-tetradecen-2-one (Z361), Z-9-tetradecen-1-yl acetate (Z362); Z-11-tetradecenal (Z363); Z-11-tetradecen-1-ol (Z364); Acacia negra extract (Z365); extract of grapefruit seeds and pulp (Z366); extract of Chenopodium ambrosiodae (Z367); fatty acid monoester with glycerol or propanediol (Z368), Catnip oil (Z369); Neem oil (Z370); Quillay extract (Z371) and Tagetes oil (Z372).

Particularly, the thietanyloxy compound of formula (I), comprising as component (1) in the pesticidal active mixture is

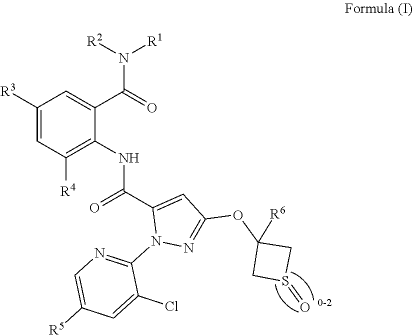

wherein,

R¹ is selected from the group consisting of methyl, ethyl, iso-propyl, tert-butyl, cyclopropyl, methylcyclopropyl, cyclopropylmethyl and cyclopropylethyl;

R² is hydrogen;

R³ is selected from the group consisting of chlorine and cyano;

R⁴ is selected from the group consisting of methyl, chlorine and bromine;

R⁵ is selected from the group consisting of hydrogen, fluorine and chlorine;

R⁶ is selected from the group consisting of hydrogen and methyl;

or agriculturally acceptable salts, isomers/structural isomers, stereo-isomers, diastereomers, enantiomers, tautomers, metal complexes, polymorphs, or N-oxides thereof;

More particularly, the thietanyloxy compound of formula (I) is selected from the group consisting of
(I-1) N-(2-(tert-butylcarbamoyl)-4-chloro-6-methylphenyl)-1-(3-chloropyridin-2-yl)-3-((1,1-dioxidothietan-3-yl)oxy)-1H-pyrazole-5-carboxamide;
(I-2) N-(2-(tert-butylcarbamoyl)-4-chloro-6-methylphenyl)-1-(3-chloropyridin-2-yl)-3-(thietan-3-yloxy)-1H-pyrazole-5-carboxamide;
(I-3) N-(2-(tert-butylcarbamoyl)-4-cyano-6-methylphenyl)-1-(3,5-dichloropyridin-2-yl)-3-(thietan-3-yloxy)-1H-pyrazole-5-carboxamide;
(I-4) N-(4-chloro-2-(isopropylcarbamoyl)-6-methylphenyl)-1-(3-chloropyridin-2-yl)-3-(thietan-3-yloxy)-1H-pyrazole-5-carboxamide;
(I-5) N-(2-(tert-butylcarbamoyl)-4-cyano-6-methylphenyl)-1-(3-chloropyridin-2-yl)-3-((3-methylthietan-3-yl)oxy)-1H-pyrazole-5-carboxamide;
(I-6) N-(2-(tert-butylcarbamoyl)-4-chloro-6-methylphenyl)-1-(3,5-dichloropyridin-2-yl)-3-(thietan-3-yloxy)-1H-pyrazole-5-carboxamide;
(I-7) N-(2-(tert-butylcarbamoyl)-4-cyano-6-methylphenyl)-1-(3-chloropyridin-2-yl)-3-((3-methyl-1,1-dioxidothietan-3-yl)oxy)-1H-pyrazole-5-carboxamide;
(I-8) 1-(3-chloropyridin-2-yl)-N-(2,4-dichloro-6-(isopropylcarbamoyl)phenyl)-3-((1,1-dioxidothietan-3-yl)oxy)-1H-pyrazole-5-carboxamide;
(I-9) N-(2-bromo-4-chloro-6-(isopropylcarbamoyl)phenyl)-1-(3-chloropyridin-2-yl)-3-((1,1-dioxidothietan-3-yl)oxy)-1H-pyrazole-5-carboxamide;
(I-10) N-(4-chloro-2-(cyclopropylcarbamoyl)-6-methylphenyl)-1-(3-chloro-5-fluoropyridin-2-yl)-3-(thietan-3-yloxy)-1H-pyrazole-5-carboxamide; and
(I-11) N-(4-chloro-2-(isopropylcarbamoyl)-6-methylphenyl)-1-(3,5-dichloropyridin-2-yl)-3-((1,1-dioxidothietan-3-yl)oxy)-1H-pyrazole-5-carboxamide.

In a preferred embodiment, the pesticidal active mixture according to the invention comprising component (2) as at least one insecticidally active compound (II) selected from:
(II-2) GAB A-gated chloride channel blockers;
(II-3) Sodium channel modulators (Pyrethroids/Pyrethrins);
(II-4) Nicotinic acetylcholine receptor (nAChR) competitive modulators;
(II-5) Nicotinic acetylcholine receptor (nAChR) allosteric modulators—Site I;
(II-6) Glutamate-gated chloride channel (GluCl) allosteric modulators;
(II-7) Juvenile hormone mimics;
(II-9) Chordotonal organ TRPV channel modulators;
(II-11) Microbial disruptors of insect midgut membranes;
(II-13) Uncouplers of oxidative phosphorylation via disruption of the proton gradient;
(II-22) Voltage-dependent sodium channel blockers;
(II-28) GAB A-gated chloride channel allosteric modulators; and
(II-31) Insecticidal active compounds of unknown or uncertain mode of action

In one embodiment, the pesticidal active mixture according to invention comprise component (2) as insecticidally active compound of formula (II) selected from the group (II-1) acetylcholinesterase (AChE) inhibitors as defined above, in particular (II-1B) organophosphates, especially preferred acephate (Z027).

In one embodiment, the pesticidal active mixture according to invention comprise component (2) as insecticidally active compound of formula (II) selected from the group (II-9B) pyropenes as defined above, especially preferred afidopyropen (Z190).

In one embodiment, the pesticidal active mixture according to invention comprise component (2) as insecticidally active compound of formula (II) selected from the group (II-2) GABA-gated chloride channel blockers as defined above, in particular group (II-2B)—Phenylpyrazoles (Fiproles), especially preferred fipronil (Z095).

In one embodiment, the pesticidal active mixture according to invention comprise component (2) as insecticidally active compound of formula (II) selected from the group (II-3) Sodium channel modulators as defined above, in particular group (II-3A) (Pyrethroids/Pyrethrins), especially preferred bifenthrin (Z103), cypermethrin (Z113).

In one embodiment, the pesticidal active mixture according to invention comprise component (2) as insecticidally active compound of formula (II) selected from the group (II-6) Glutamate-gated chloride channel (GluCl) allosteric modulators as defined above, in particular avermectins/Milbemycins, especially preferred abamectin (Z166) and emamectin benzoate (Z167).

In one embodiment, the pesticidal active mixture according to invention comprise component (2) as insecticidally active compound of formula (II) selected from the group (II-28) GABA-gated chloride channel allosteric modulators as defined above, in particular (II-28A) meta-diamides, especially preferred broflanilide (Z273).

In one embodiment, the pesticidal active mixture according to invention comprise component (2) as insecticidally active compound of formula (II) selected from the group (II-28) GABA-gated chloride channel allosteric modulators as defined above, in particular (II-28B) isoxazolines, especially preferred fluxametamide (Z274).

In one embodiment, the pesticidal active mixture according to invention comprise component (2) as insecticidally active compound of formula (II) selected from the group insecticidal active compounds of unknown or uncertain mode of action as defined above, especially preferred benzpyrimoxan (Z285), flometoquin (Z292), pyridalyl (Z299), dimpropyridaz (Z317), tyclopyrazoflor (Z318), isocycloseram (Z275), fluhexafon (Z293).

In one embodiment, the pesticidal active mixture according to invention comprise component (2) as insecticidally active compound of formula (II) selected from the group (II-13) uncouplers of oxidative phosphorylation via disruption of the proton gradient as defined above, in particular (II-13A) pyrroles, especially preferred chlorfenapyr (Z203).

In one embodiment, the pesticidal active mixture according to invention comprise component (2) as insecticidally active compound of formula (II) selected from the group (II-4) nicotinic acetylcholine receptor (nAChR) competitive modulators as defined above, in particular (II-4A) neonicotinoids, especially preferred clothianidin (Z149), imidacloprid (Z151), thiamethoxam (Z154).

In one embodiment, the pesticidal active mixture according to invention comprise component (2) as insecticidally active compound of formula (II) selected from the group (II-4) nicotinic acetylcholine receptor (nAChR) competitive modulators as defined above, especially preferred (II-4F) flupyrimin (Z163).

In one embodiment, the pesticidal active mixture according to invention comprise component (2) as insecticidally active compound of formula (II) selected from the group (II-4) nicotinic acetylcholine receptor (nAChR) competitive modulators as defined above, in particular (II-4E) mesoionics, especially preferred triflumezopyrim (Z161).

In one embodiment, the pesticidal active mixture according to invention comprise component (2) as insecticidally active compound of formula (II) selected from the group (II-12) inhibitors of mitochondrial ATP synthase as defined above, in particular (II-12A) diafenthiuron (Z197).

In one embodiment, the pesticidal active mixture according to invention comprise component (2) as insecticidally active compound of formula (II) selected from the group (II-22) voltage-dependent sodium channel blockers as defined above, in particular (II-22A) oxadiazines, especially preferred indoxacarb (Z240).

In one embodiment, the pesticidal active mixture according to invention comprise component (2) as insecticidally active compound of formula (II) selected from the group (II-22) voltage-dependent sodium channel blockers as defined above, in particular (II-22B) semicarbazones especially preferred metaflumizone (Z241).

In one embodiment, the pesticidal active mixture according to invention comprise component (2) as insecticidally active compound of formula (II) selected from the group (II-22) voltage-dependent sodium channel blockers as defined above, in particular (II-22D) oxazosulfyl (Z243).

In one embodiment, the pesticidal active mixture according to invention comprise component (2) as insecticidally active compound of formula (II) selected from the group (II-9) chordotonal organ TRPV channel modulators as defined, in particular (II-9A) pyridine azomethine derivatives, especially preferred pymetrozine (Z188).

In one embodiment, the pesticidal active mixture according to invention comprise component (2) as insecticidally active compound of formula (II) selected from the group (II-7) juvenile hormone mimics as defined above, especially preferred (II-7C) pyriproxyfen (Z174).

In one embodiment, the pesticidal active mixture according to invention comprise component (2) as insecticidally active compound of formula (II) selected from the group (II-23) inhibitors of the acetyl CoA carboxylase as defined above, in particular tetronic and tetramic acid derivatives, especially preferred spirodiclofen (Z244) and spiropidion (Z246).

In one embodiment, the pesticidal active mixture according to invention comprise component (2) as insecticidally active compound of formula (II) selected from the group (II-5) nicotinic acetylcholine receptor (nAChR) allosteric modulators—Site I as defined above, in particular spinosyns, especially preferred spinetoram (Z164) and spinosad (Z165).

In one embodiment, the pesticidal active mixture according to invention comprise component (2) as insecticidally active compound of formula (II) selected from the group (II-15) inhibitors of the chitin biosynthesis affecting CHS1 as defined above, in particular bzoylureas especially preferred teflubenzuron (Z219).

In one embodiment, the pesticidal active mixture according to invention comprise component (2) as selected from the group (II-11) microbial disruptors of insect midgut membranes as defined above, especially preferred Bacillus thuringinienses.

In a preferred embodiment, the pesticidal active mixture according to the invention comprise component (2) as at least one insecticidally active compound of formula (II) selected from Abamectin (Z166), Acephate (Z027), acetamiprid (Z148). Afidopyropen (Z190), alpha-cypermethrin (Z114), Bifenthrin (Z103), Broflanilide (Z273), Benzpyrimoxan (Z285), buprofezin (Z221), Chlorfenapyr (Z203), Clothianidin (Z149), cyhalothrin (Z110), Cypermethrin (Z113), Diafenthiuron (Z197), Dimpropyridaz (Z3170, dinotefuran (Z150), Emamectin benzoate (Z167), flonicamid (Z272), Fluxametamide (Z274), Flupyrimin (Z163), Fipronil (Z095), Fluhexafon (Z293), Flometoquin (Z292), Imidacloprid (Z151), Indoxacarb (Z240), Isocycloseram (Z275), Metaflumizone (Z241), Oxazosulfyl (Z243), Pyridalyl (Z299), Pymetrozine (Z188), Pyriproxyfen (Z174), Spirodiclofen (Z244), Spiropidion (Z246), Spinetoram (Z164), Spinosad (Z165), spirotetramat (Z247), Thiamethoxam (Z154), Teflubenzuron (Z219), thiacloprid (Z153), Triflumezopyrim (Z161) and Tyclopyrazoflor (Z318).

In a preferred embodiment, the pesticidal active mixture according to the invention comprise (2) at least one biopesticides selected from Azadirachtin (Z282), Bacillus firmus (Z320), Bacillus thuringinienses (Z195), Bacillus amyloliquefaciens (Z373), Bacillus subtilis (Z374), Beauveria bassiana (Z321), Lecanicillium lecanii (Z375), Metarhizium anisopliae (Z327), Purpureocillium lilacinum (Z376) and Burkholderia rinojenses (Z377).

In another embodiment, the present invention provides a pesticidal active mixture comprising component (1) as thietanyloxy compound of formula (I),

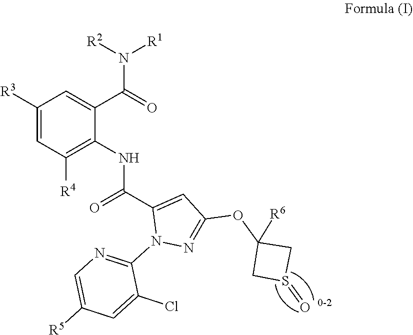

wherein,

R¹ is selected from the group consisting of C₁-C₆ alkyl, C₃-C₅ cycloalkyl, C₃-C₅ cycloalkyl-C₁-C₆ alkyl and C₁-C₆ alkyl-C₃-C₅ cycloalkyl;

R² is selected from the group consisting of hydrogen and methyl;

R³ is selected from the group consisting of fluorine, chlorine, bromine and cyano;

R⁴ is selected from the group consisting of methyl, fluorine, chlorine, bromine and trifluoromethyl;

R⁵ is selected from the group consisting of hydrogen, fluorine and chlorine;

R⁶ is selected from the group consisting of hydrogen, methyl and trifluoromethyl;

or agriculturally acceptable salts, isomers/structural isomers, stereo-isomers, diastereomers, enantiomers, tautomers, metal complexes, polymorphs, or N-oxides thereof;

and a component (2) as a fungicidally active compound (III) selected from the group consisting of:
(A) Inhibitors of the ergosterol biosynthesis including (A001) cyproconazole; (A002) difenoconazole; (A003) epoxiconazole; (A004) fenhexamid; (A005) fenpropidin; (A006) fenpropimorph; (A007) fenpyrazamine; (A008) fluquinconazole; (A009) flutriafol; (A010) imazalil; (A011) imazalil sulfate; (A012) ipconazole; (A013) metconazole; (A014) myclobutanil; (A015) paclobutrazol; (A016) prochloraz; (A017) propiconazole; (A018) prothioconazole; (A019) pyrisoxazole; (A020) spiroxamine; (A021) tebuconazole; (A022) tetraconazole; (A023) triadimenol; (A024) tridemorph; (A025) triticonazole; (A026) (1R,2S,5S)-5-(4-chlorobenzyl)-2-(chloromethyl)-2-methyl-l-(1H-1,2,4-triazol-1-ylmethyl)cyclopentanol; (A027) (1S,2R,5R)-5-(4-chlorobenzyl)-2-(chloromethyl)-2-methyl-1-(1H-1,2,4-triazol-1-ylmethyl)cyclopentanol, (A028) (2R)-2-(1-chlorocyclopropyl)-4-[(1R)-2,2-dichlorocyclopropyl]-1-(1H-1,2,4-triazol-1-yl)butan-2-ol; (A029) (2R)-2-(1-chlorocyclopropyl)-4-[(1S)-2,2-dichlorocyclopropyl]-1-(1H-1,2,4-triazol-1-yl)butan-2-ol; (A030) (2R)-2-[4-(4-chlorophenoxy)-2-(trifluoromethyl)phenyl]-1-(1H-1,2,4-triazol-1-yl)propan-2-ol; (A031) (2S)-2-(1-chlorocyclopropyl)-4-[(1R)-2,2-dichlorocyclopropyl]-1-(1H-1,2,4-triazol-1-yl)butan-2-ol; (A032) (2S)-2-(1-chlorocyclopropyl)-4-[(1S)-2,2-dichlorocyclopropyl]-1-(1H-1,2,4-triazol-1-yl)butan-2-ol; (A033) (2S)-2-[4-(4-chlorophenoxy)-2-(trifluoromethyl)phenyl]-1-(1H-1,2,4-triazol-1-yl)propan-2-ol; (A034) (R)-[3-(4-chloro-2-fluorophenyl)-5-(2,4-difluorophenyl)-1,2-oxazol-4-yl](pyridin-3-yl)methanol; (A035) (S)-[3-(4-chloro-2-fluorophenyl)-5-(2,4-difluorophenyl)-1,2-oxazol-4-yl](pyridin-3-yl)methanol; (A036) [3-(4-chloro-2-fluorophenyl)-5-(2,4-difluorophenyl)-1,2-oxazol-4-yl](pyridin-3-yl)methanol; (A037) 1-({(2R,4S)-2-[2-chloro-4-(4-chlorophenoxy)phenyl]-4-methyl-1,3-dioxolan-2-yl}methyl)-1H-1,2,4-triazole; (A038) 1-({(2S,4S)-2-[2-chloro-4-(4-chlorophenoxy)phenyl]-4-methyl-1,3-dioxolan-2-yl}methyl)-1H-1,2,4-triazole; (A039) 1-{[3-(2-chlorophenyl)-2-(2,4-difluorophenyl)oxiran-2-yl]methyl}-1H-1,2,4-triazol-5-yl thiocyanate; (A040) 1-{[rel(2R,3R)-3-(2-chlorophenyl)-2-(2,4-difluorophenyl)oxiran-2-yl]methyl}-1H-1,2,4-triazol-5-yl thiocyanate; (A041) 1-{[rel(2R,3S)-3-(2-chlorophenyl)-2-(2,4-difluorophenyl)oxiran-2-yl]methyl}-1H-1,2,4-triazol-5-yl thiocyanate; (A042) 2-[(2R,4R,5R)-1-(2,4-dichlorophenyl)-5-hydroxy-2,6,6-trimethylheptan-4-yl]-2,4-dihydro-3H-1,2,4-triazole-3-thione; (A043) 2-[(2R,4R,5S)-1-(2,4-dichlorophenyl)-5-hydroxy-2,6,6-trimethylheptan-4-yl]-2,4-dihydro-3H-1,2,4-triazole-3-thione; (A044) 2-[(2R,4S,5R)-1-(2,4-dichlorophenyl)-5-hydroxy-2,6,6-trimethylheptan-4-yl]-2,4-dihydro-3H-1,2,4-triazole-3-thione; (A045) 2-[(2R,4S,5S)-1-(2,4-dichlorophenyl)-5-hydroxy-2,6,6-trimethylheptan-4-yl]-2,4-dihydro-3H-1,2,4-triazole-3-thione; (A046) 2-[(2S,4R,5R)-1-(2,4-dichlorophenyl)-5-hydroxy-2,6,6-trimethylheptan-4-yl]-2,4-dihydro-3H-1,2,4-triazole-3-thione; (A047) 2-[(2S,4R,5S)-1-(2,4-dichlorophenyl)-5-hydroxy-2,6,6-trimethylheptan-4-yl]-2,4-dihydro-3H-1,2,4-triazole-3-thione; (A048) 2-[(2S,4S,5R)-1-(2,4-dichlorophenyl)-5-hydroxy-2,6,6-trimethylheptan-4-yl]-2,4-dihydro-3H-1,2,4-triazole-3-thione; (A049) 2-[(2S,4S,5S)-1-(2,4-dichlorophenyl)-5-hydroxy-2,6,6-trimethylheptan-4-yl]-2,4-dihydro-3H-1,2,4-triazole-3-thione; (A050) 2-[1-(2,4-dichlorophenyl)-5-hydroxy-2,6,6-trimethylheptan-4-yl]-2,4-dihydro-3H-1,2,4-triazole-3-thione; (A051) 2-[2-chloro-4-(2,4-dichlorophenoxy)phenyl]-1-(1H-1,2,4-triazol-1-yl)propan-2-ol; (A052) 2-[2-chloro-4-(4-chlorophenoxy)phenyl]-1-(1H-1,2,4-triazol-1-yl)butan-2-ol; (A053) 2-[4-(4-chlorophenoxy)-2-(trifluoromethyl)phenyl]-1-(1H-1,2,4-triazol-1-yl)butan-2-ol; (A054) 2-[4-(4-chlorophenoxy)-2-(trifluoromethyl)phenyl]-1-(1H-1,2,4-triazol-1-yl)pentan-2-ol; (A055) 2-[4-(4-chlorophenoxy)-2-(trifluoromethyl)phenyl]-1-(1H-1,2,4-triazol-1-yl)propan-2-ol; (A056) 2-{[3-(2-chlorophenyl)-2-(2,4-difluorophenyl)oxiran-2-yl]methyl}-2,4-dihydro-3H-1,2,4-triazole-3-thione; (A057) 2-{[rel(2R,3R)-3-(2-chlorophenyl)-2-(2,4-difluorophenyl)oxiran-2-yl]methyl}-2,4-dihydro-3H-1,2,4-triazole-3-thione; (A058) 2-{[rel(2R,3S)-3-(2-chlorophenyl)-2-(2,4-difluorophenyl)oxiran-2-yl]methyl}-2,4-dihydro-3H-1,2,4-triazole-3-thione; (A059) 5-(4-chlorobenzyl)-2-(chloromethyl)-2-methyl-1-(1H-1,2,4-triazol-1-ylmethyl)cyclopentanol; (A060) 5-(allylsulfanyl)-1-{[3-(2-chlorophenyl)-2-(2,4-difluorophenyl)oxiran-2-yl]methyl}-1H-1,2,4-triazole; (A061) 5-(allylsulfanyl)-1-{[rel(2R,3R)-3-2-chlorophenyl)-2-(2,4-difluorophenyl)oxiran-2-yl]methyl}-1H-1,2,4-triazole; (A062) 5-(allylsulfanyl)-1-{[rel(2R,3S)-3-(2-chlorophenyl)-2-(2,4-difluorophenyl)oxiran-2-yl]methyl}-1H-1,2,4-triazole; (A063) N′-(2,5-dimethyl-4-{[3-(1,1,2,2-tetrafluoroethoxy)phenyl]sulfanyl}phenyl)-N-ethyl-N-methylimidoformamide; (A064) N′-(2,5-dimethyl-4-{[3-(2,2,2-trifluoroethoxy)phenyl]sulfanyl}phenyl)-N-ethyl-N-methylimidoformamide; (A065) N′-(2,5-dimethyl-4-{[3-(2,2,3,3-tetrafluoropropoxy)phenyl]sulfanyl}phenyl)-N-ethyl-N-methylimidoformamide; (A066) N′-(2,5-dimethyl-4-{[3-(pentafluoroethoxy)phenyl]sulfanyl}phenyl)-N-ethyl-N-methylimidoformamide; (A067) N′-(2,5-dimethyl-4-{3-[(1,1,2,2-tetrafluoroethyl)sulfanyl]phenoxy}phenyl)-N-ethyl-N-methylimidoformamide; (A068) N′-(2,5-dimethyl-4-{3-[(2,2,2-trifluoroethyl)sulfanyl]phenoxy}phenyl)-N-ethyl-N-methylimidoformamide; (A069) N′-(2,5-dimethyl-4-{3-[(2,2,3,3-tetrafluoropropyl)sulfanyl]phenoxy}phenyl)-N-ethyl-N-methylimidoformamide; (A070) N′-(2,5-dimethyl-4-{3-[(pentafluoroethyl)sulfanyl]phenoxy}phenyl)-N-ethyl-N-methylimidoformamide; (A071) N′-(2,5-dimethyl-4-phenoxyphenyl)-N-ethyl-N-methylimidoformamide; (A072) N′-(4-{[3-(difluoromethoxy)phenyl]sulfanyl}-2,5-dimethylphenyl)-N-ethyl-N-methylimidoformamide; (A073) N′-(4-{3-[(difluoromethyl)sulfanyl]phenoxy}-2,5-dimethylphenyl)-N-ethyl-N-methylimidoformamide; (A074) N′-[5-bromo-6-(2,3-dihydro-1H-inden-2-yloxy)-2-methylpyridin-3-yl]-N-ethyl-N-methylimidoformamide; (A075) N′-{4-[(4,5-dichloro-1,3-thiazol-2-yl)oxy]-2,5-dimethylphenyl}-N-ethyl-N-methylimidoformamide; (A076) N′-{5-bromo-6-[(1R)-1-(3,5-difluorophenyl)ethoxy]-2-methylpyridin-3-yl}-N-ethyl-N-methylimidoformamide; (A077) N′-{5-bromo-6-[(1S)-1-(3,5-difluorophenyl)ethoxy]-2-methylpyridin-3-yl}-N-ethyl-N-methylimidoformamide; (A078) N′-{5-bromo-6-[(cis-4-isopropylcyclohexyl)oxy]-2-methylpyridin-3-yl}-N-ethyl-N-methylimidoformamide; (A079) N′-{5-bromo-6-[(trans-4-isopropylcyclohexyl)oxy]-2-methylpyridin-3-yl}-N-ethyl-N-methylimidoformamide; (A080) N′-{5-bromo-6-[1-(3,5-difluorophenyl)ethoxy]-2-methylpyridin-3-yl}-N-ethyl-N-methylimidoformamide; (A081) mefentrifluconazole; (A082) ipfentrifluconazole; (A083) 1-(2,4-difluorophenyl)-2-(1H-1,2,4-triazol-1-yl)-1-[1-(2,6-difluoro-4-chlorophenoxy)cyclopropyl]ethanol; and (A084) 1-[2-(1-chlorocyclopropyl)-3-(2-fluorophenyl)-2-hydroxypropyl]-1H-imidazole-5-carbonitrile,
(B) Inhibitors of the respiratory chain at complex I or II including (B001) benzovindiflupyr; (B002) bixafen; (B003) boscalid; (B004) carboxin; (B005) fluopyram; (B006) flutolanil; (B007) fluxapyroxad; (B008) furametpyr; (B009) isofetamid; (B010) isopyrazam (anti-epimeric enantiomer 1R,4S,9S); (B011) isopyrazam (anti-epimeric enantiomer 1S,4R,9R); (B012) isopyrazam (anti-epimeric racemate 1RS,4SR,9SR); (B013) isopyrazam (mixture of syn-epimeric racemate 1RS,4SR,9RS and anti-epimeric racemate 1RS,4SR,9SR); (B014) isopyrazam (syn-epimeric enantiomer 1R,4S,9R); (B015) isopyrazam (syn-epimeric enantiomer 1S,4R,9S); (B016) isopyrazam (syn-epimeric racemate 1RS,4SR,9RS); (B017) penflufen; (B018) penthiopyrad; (B019) pydiflumetofen; (B020) pyraziflumid; (B021) sedaxane; (B022) 1,3-dimethyl-N-(1,1,3-trimethyl-2,3-dihydro-1H-inden-4-yl)-1H-pyrazole-4-carboxamide; (B023) 1,3-dimethyl-N-[(3R)-1,1,3-trimethyl-2,3-dihydro-1H-inden-4-yl]-1H-pyrazole-4-carboxamide; (B024) 1,3-dimethyl-N-[(3S)-1,1,3-trimethyl-2,3-dihydro-1H-inden-4-yl]-1H-pyrazole-4-carboxamide; (B025) 1-methyl-3-(trifluoromethyl)-N-[2′-(trifluoromethyl)biphenyl-2-yl]-1H-pyrazole-4-carboxamide; (B026) 2-fluoro-6-(trifluoromethyl)-N-(1,1,3-trimethyl-2,3-dihydro-1H-inden-4-yl)benzamide; (B027) 3-(difluoromethyl)-1-methyl-N-(1,1,3-trimethyl-2,3-dihydro-1H-inden-4-yl)-1H-pyrazole-4-carboxamide; (B028) 3-(difluoromethyl)-1-methyl-N-[(3R)-1,1,3-trimethyl-2,3-dihydro-1H-inden-4-yl]-1H-pyrazole-4-carboxamide; (B029) 3-(difluoromethyl)-1-methyl-N-[(3S)-1,1,3-trimethyl-2,3-dihydro-1H-inden-4-yl]-1H-pyrazole-4-carboxamide; (B030) 3-(difluoromethyl)-N-(7-fluoro-1,1,3-trimethyl-2,3-dihydro-1H-inden-4-yl)-1-methyl-1H-pyrazole-4-carboxamide (Fluindapyr); (B031) 3-(difluoromethyl)-N-[(3R)-7-fluoro-1,1,3-trimethyl-2,3-dihydro-1H-inden-4-yl]-1-methyl-1H-pyrazole-4-carboxamide; (B032) 3-(difluoromethyl)-N-[(3S)-7-fluoro-1,1,3-trimethyl-2,3-dihydro-1H-inden-4-yl]-1-methyl-1H-pyrazole-4-carboxamide; (B033) 5,8-difluoro-N-[2-(2-fluoro-4-{[4-(trifluoromethyl)pyridin-2-yl]oxy}phenyl)ethyl]quinazolin-4-amine; (B034) N-(2-cyclopentyl-5-fluorobenzyl)-N-cyclopropyl-3-(difluoromethyl)-5-fluoro-1-methyl-l-H-pyrazole-4-carboxamide; (B035) N-(2-tert-butyl-5-methylbenzyl)-N-cyclopropyl-3-(difluoromethyl)-5-fluoro-1-methyl-1H-pyrazole-4-carboxamide; (B036) N-(2-tert-butylbenzyl)-N-cyclopropyl-3-(difluoromethyl)-5-fluoro-1-methyl-1H-pyrazole-4-carboxamide; (B037) N-(5-chloro-2-ethylbenzyl)-N-cyclopropyl-3-(difluoromethyl)-5-fluoro-1-methyl-1H-pyrazole-4-carboxamide; (B038) N-(5-chloro-2-isopropylbenzyl)-N-cyclopropyl-3-(difluoromethyl)-5-fluoro-1-methyl-1H-pyrazole-4-carboxamide; (B039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide; (B040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide; (B041) N-[1-(2,4-dichlorophenyl)-1-methoxypropan-2-yl]-3-(difluoromethyl)-1-methyl-1H-pyrazole-4-carboxamide; (B042) N-[2-chloro-6-(trifluoromethyl)benzyl]-N-cyclopropyl-3-(difluoromethyl)-5-fluoro-1-methyl-1H-pyrazole-4-carboxamide; (B043) N-[3-chloro-2-fluoro-6-(trifluoromethyl)benzyl]-N-cyclopropyl-3-(difluoromethyl)-5-fluoro-1-methyl-1H-pyrazole-4-carboxamide; (B044) N-[5-chloro-2-(trifluoromethyl)benzyl]-N-cyclopropyl-3-(difluoromethyl)-5-fluoro-1-methyl-1H-pyrazole-4-carboxamide; (B045) N-cyclopropyl-3-(difluoromethyl)-5-fluoro-1-methyl-N-[5-methyl-2-(trifluoromethyl)benzyl]-1H-pyrazole-4-carboxamide; (B046) N-cyclopropyl-3-(difluoromethyl)-5-fluoro-N-(2-fluoro-6-isopropylbenzyl)-1-methyl-1H-pyrazole-4-carboxamide; (B047) N-cyclopropyl-3-(difluoromethyl)-5-fluoro-N-(2-isopropyl-5-methylbenzyl)-1-methyl-1H-pyrazole-4-carboxamide; (B048) N-cyclopropyl-3-(difluoromethyl)-5-fluoro-N-(2-isopropylbenzyl)-1-methyl-1H-pyrazole-4-carbothioamide; (B049) N-cyclopropyl-3-(difluoromethyl)-5-fluoro-N-(2-isopropylbenzyl)-1-methyl-1H-pyrazole-4-carboxamide; (B050) N-cyclopropyl-3-(difluoromethyl)-5-fluoro-N-(5-fluoro-2-isopropylbenzyl)-1-methyl-1H-pyrazole-4-carboxamide; (B051) N-cyclopropyl-3-(difluoromethyl)-N-(2-ethyl-4,5-dimethylbenzyl)-5-fluoro-1-methyl-1H-pyrazole-4-carboxamide; (B052) N-cyclopropyl-3-(difluoromethyl)-N-(2-ethyl-5-fluorobenzyl)-5-fluoro-1-methyl-1H-pyrazole-4-carboxamide; (B053) N-cyclopropyl-3-(difluoromethyl)-N-(2-ethyl-5-methylbenzyl)-5-fluoro-1-methyl-1H-pyrazole-4-carboxamide; (B054) N-cyclopropyl-N-(2-cyclopropyl-5-fluorobenzyl)-3-(difluoromethyl)-5-fluoro-1-methyl-1H-pyrazole-4-carboxamide; (B055) N-cyclopropyl-N-(2-cyclopropyl-5-methylbenzyl)-3-(difluoromethyl)-5-fluoro-1-methyl-1H-pyrazole-4-carboxamide; (B056) N-cyclopropyl-N-(2-cyclopropylbenzyl)-3-(difluoromethyl)-5-fluoro-1-methyl-1H-pyrazole-4-carboxamide; (B057) 2-(difluoromethyl)-N-(1,1-dimethyl-3-propyl-2,3-dihydro-1H-inden-4-yl)nicotinamide; (B058) pyrapropoyne; (B059) inpyrfluxam; and (B060) isoflucypram,
(C) Inhibitors of the respiratory chain at complex III including (C001) ametoctradin; (C002) amisulbrom; (C003) azoxystrobin; (C004) coumethoxystrobin; (C005) coumoxystrobin; (C006) cyazofamid; (C007) dimoxystrobin; (C008) enoxastrobin; (C009) famoxadone; (C010) fenamidone; (C011) flufenoxystrobin; (C012) fluoxastrobin; (C013) kresoxim-methyl; (C014) metominostrobin; (C015) orysastrobin; (C016) picoxystrobin; (C017) pyraclostrobin; (C018) pyrametostrobin; (C019) pyraoxystrobin; (C020) trifloxystrobin; (C021) (2E)-2-{2-[({[(1E)-1-(3-{[(E)-1-fluoro-2 phenylvinyl]oxy}phenyl)ethylidene]amino}oxy)methyl]phenyl}-2-(methoxyimino)-N-methylacetamide; (C022) (2E,3Z)-5-{[1-(4-chlorophenyl)-1H-pyrazol-3-yl]oxy}-2-(methoxyimino)-N,3-dimethylpent-3-enamide; (C023) (2R)-2-{2-[(2,5-dimethylphenoxy)methyl]phenyl}-2-methoxy-N-methylacetamide; (C024) (2S)-2-{2-[(2,5-dimethylphenoxy)methyl]phenyl}-2-methoxy-N-methylacetamide; (C025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl-2-methylpropanoate (Fenpicoxamid); (C026) 2-{2-[(2,5-dimethylphenoxy)methyl]phenyl}-2-methoxy-N-methylacetamide (Mandestrobin); (C027) N-(3-ethyl-3,5,5-trimethylcyclohexyl)-3-formamido-2-hydroxybenzamide; (C028) (2E,3Z)-5-{[l-(4-chloro-2-fluorophenyl)-1H-pyrazol-3-yl]oxy}-2-(methoxyimino)-N,3-dimethylpent-3-enamide; (C029) methyl {5-[3-(2,4-dimethylphenyl)-1H-pyrazol-1-yl]-2-methylbenzyl}carbamate; (C030) 1-(2-{[1-(4-chlorophenyl)pyrazol-3-yl]oxymethyl}-3-methylphenyl)-1,4-dihydro-4-methyl-5H-tetrazol-5-one (Metyltetraprole); and (C031) florylpicoxamid,
(D) Inhibitors of the mitosis and cell division including (D001) carbendazim; (D002) diethofencarb; (D003) ethaboxam; (D004) fluopicolide; (D005) pencycuron; (D006) thiabendazole; (D007) thiophanate-methyl; (D008) zoxamide; (D009) 3-chloro-4-(2,6-difluorophenyl)-6-methyl-5-phenylpyridazine; (D010) 3-chloro-5-(4-chlorophenyl)-4-(2,6-difluorophenyl)-6-methylpylidazine; (D011) 3-chloro-5-(6-chloropyridin-3-yl)-6-methyl-4-(2,4,6-trifluorophenyl)pyridazine; (D012) 4-(2-bromo-4-fluorophenyl)-N-(2,6-difluorophenyl)-1,3-dimethyl-1H-pyrazol-5-amine; (D013) 4-(2-bromo-4-fluorophenyl)-N-(2-bromo-6-fluorophenyl)-1,3-dimethyl-1H-pyrazol-5-amine; (D014) 4-(2-bromo-4-fluorophenyl)-N-(2-bromophenyl)-1,3-dimethyl-1H-pyrazol-5-amine; (D015) 4-(2-bromo-4-fluorophenyl)-N-(2-chloro-6-fluorophenyl)-1,3-dimethyl-1H-pyrazol-5-amine; (D016) 4-(2-bromo-4-fluorophenyl)-N-(2-chlorophenyl)-1,3-dimethyl-1H-pyrazol-5-amine; (D017) 4-(2-bromo-4-fluorophenyl)-N-(2-fluorophenyl)-1,3-dimethyl-1H-pyrazol-5-amine; (D018) 4-(2-chloro-4-fluorophenyl)-N-(2,6-difluorophenyl)-1,3-dimethyl-1H-pyrazol-5-amine; (D019) 4-(2-chloro-4-fluorophenyl)-N-(2-chloro-6-fluorophenyl)-1,3-dimethyl-1H-pyrazol-5-amine; (D020) 4-(2-chloro-4-fluorophenyl)-N-(2-chlorophenyl)-1,3-dimethyl-1H-pyrazol-5-amine; (D021) 4-(2-chloro-4-fluorophenyl)-N-(2-fluorophenyl)-1,3-dimethyl-1H-pyrazol-5-amine; (D022) 4-(4-chlorophenyl)-5-(2,6-difluorophenyl)-3,6-dimethylpyridazine; (D023) N-(2-bromo-6-fluorophenyl)-4-(2-chloro-4-fluorophenyl)-1,3-dimethyl-1H-pyrazol-5-amine; (D024) N-(2-bromophenyl)-4-(2-chloro-4-fluorophenyl)-1,3-dimethyl-1H-pyrazol-5-amine; and (D025) N-(4-chloro-2,6-difluorophenyl)-4-(2-chloro-4-fluorophenyl)-1,3-dimethyl-1H-pyrazol-5-amine,
(E) Compounds capable to have a multisite action including (E001) bordeaux mixture; (E002) captafol; (E003) captan; (E004) chlorothalonil; (E005) copper hydroxide; (E006) copper naphthenate; (E007) copper oxide; (E008) copper oxychloride; (E009) copper(II) sulfate; (E010) dithianon; (E011) dodine; (E012) folpet; (E013) mancozeb; (E014) maneb; (E015) metiram; (E016) metiram zinc; (E017) oxine-copper; (E018) propineb; (E019) sulfur and sulfur preparations including calcium polysulfide; (E020) thiram; (E021) zineb; (E022) ziram; and (E023) 6-ethyl-5,7-dioxo-6,7-dihydro-5H-pynolo[3′,4′:5,6][1,4]dithiino[2,3-c][1,2]thiazole-3-carbonitrile,
(F) Compounds capable to induce a host defence including (F001) acibenzolar-S-methyl; (F002) isotianil; (F003) probenazole; and (F004) tiadinil,
(G) Inhibitors of the amino acid and/or protein biosynthesis including (G001) cyprodinil; (G002) kasugamycin; (G003) kasugamycin hydrochloride hydrate; (G004) oxytetracycline; (G005) pyrimethanil; (G006) 3-(5-fluoro-3,3,4,4-tetramethyl-3,4-dihydroisoquinolin-1-yl)quinoline;
(H) Inhibitors of the ATP production including (H001) silthiofam;
(I) Inhibitors of the cell wall synthesis including (I001) benthiavalicarb; (I002) dimethomorph; (I003) flumorph; (I004) iprovalicarb; (I005) mandipropamid; (I006) pyrimorph; (I007) valifenalate; (I008) (2E)-3-(4-tert-butylphenyl)-3-(2-chloropyridin-4-yl)-1-(morpholin-4-yl)prop-2-en-1-one; and (I009) (2Z)-3-(4-tert-butylphenyl)-3-(2-chloropyridin-4-yl)-1-(morpholin-4-yl)prop-2-en-1-one,
(J) Inhibitors of the lipid and membrane synthesis including (J001) propamocarb; (J002) propamocarb hydrochloride; and (J003) tolclofos-methyl,
(K) Inhibitors of the melanin biosynthesis including (K001) tricyclazole; (K002) 2,2,2-trifluoroethyl {3-methyl-1-[(4-methylbenzoyl)amino]butan-2-yl}carbamate;
(L) Inhibitors of the nucleic acid synthesis including (L001) benalaxyl; (L002) benalaxyl-M (kiralaxyl); (L003) metalaxyl; and (L004) metalaxyl-M (mefenoxam),
(M) Inhibitors of the signal transduction including (M001) fludioxonil; (M002) iprodione; (M003) procymidone; (M004) proquinazid; (M005) quinoxyfen; and (M006) vinclozolin,
(N) Compounds capable to act as an uncoupler including (N001) fluazinam; and (N002) meptyldinocap,
(O) Further compounds including (O001) abscisic acid; (O002) benthiazole; (O003) bethoxazin; (O004) capsimycin; (O005) carvone; (O006) chinomethionat; (O007) cufraneb; (O008) cyflufenamid; (O009) cymoxanil; (O010) cyprosulfamide; (O011) flutianil; (O012) fosetyl-aluminium; (O013) fosetyl-calcium; (O014) fosetyl-sodium; (O015) methyl isothiocyanate; (O016) metrafenone; (O017) mildiomycin; (O018) natamycin; (O019) nickel dimethyldithiocarbamate; (O020) nitrothal-isopropyl; (O021) oxamocarb; (O022) oxathiapiprolin; (O023) oxyfenthiin; (O024) pentachlorophenol and salts; (O025) phosphorous acid and its salts; (O026) propamocarb-fosetylate; (O027) pyriofenone (chlazafenone); (O028) tebufloquin; (O029) tecloftalam; (O030) tolnifanide; (O031) 1-(4-{4-[(5R)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone; (O032) 1-(4-{4-[(5S)-5-(2,6-difluorophenyl)-4,5-dihydro-1,2-oxazol-3-yl]-1,3-thiazol-2-yl}piperidin-1-yl)-2-[5-methyl-3-(trifluoromethyl)-1H-pyrazol-1-yl]ethanone; (O033) 2-(6-benzylpyridin-2-yl)quinazoline; (O034) 2,6-dimethyl-1H,5H-[1,4]dithiino[2,3-c:5,6-c′]dipyrrole-1,3,5,7(2H,6H)-tetrone; (O035) 2-[3,5-bis(difluoromethyl)-1H-pyrazol-1-yl]-1-[4-(4-{5-[2-(prop-2-yn-1-yloxy)phenyl]-4,5-dihydro-1,2-oxazol-3-yl}-1,3-thiazol-2-yl)piperidin-1-yl]ethanone; (O036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone; (O037) 2-[3,5-bis(difluoromethyl)-1H-pyrazol-1-yl]-1-[4-(4-{5-[2-fluoro-6-(prop-2-yn-1-yloxy)phenyl]-4,5-dihydro-1,2-oxazol-3-yl}-1,3-thiazol-2-yl)piperidin-1-yl]ethanone; (O038) 2-[6-(3-fluoro-4-methoxyphenyl)-5-methylpyridin-2-yl]quinazoline; (O039) 2-{(5R)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate; (O040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenylmethanesulfonate; (O041) 2-{2-[(7,8-difluoro-2-methylquinolin-3-yl)oxy]-6-fluorophenyl}propan-2-ol; (O042) 2-{2-fluoro-6-[(8-fluoro-2-methylquinolin-3-yl)oxy]phenyl}propan-2-ol; (O043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenylmethanesulfonate; (O044) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}phenylmethanesulfonate; (O045) 2-phenylphenol and salts; (O046) 3-(4,4,5-trifluoro-3,3-dimethyl-3,4-dihydroisoquinolin-1-yl)quinoline; (O047) 3-(4,4-difluoro-3,3-dimethyl-3,4-dihydroisoquinolin-1-yl)quinoline (Quinofumelin); (O048) 4-amino-5-fluoropyrimidin-2-ol (tautomeric form: 4-amino-5-fluoropyrimidin-2(1H)-one); (O049) 4-oxo-4-[(2-phenylethyl)amino]butanoic acid; (O050) 5-amino-1,3,4-thiadiazole-2-thiol; (O051) 5-chloro-N′-phenyl-N′-(prop-2-yn-1-yl)thiophene-2-sulfonohydrazide; (O052) 5-fluoro-2-[(4-fluorobenzyl)oxy]pyrimidin-4-amine; (O053) 5-fluoro-2-[(4-methylbenzyl)oxy]pyrimidin-4-amine; (O054) 9-fluoro-2,2-dimethyl-5-(quinolin-3-yl)-2,3-dihydro-1,4-benzoxazepine; (O055) but-3-yn-1-yl{6-[({[(Z)-(1-methyl-1H-tetrazol-5-yl)(phenyl)methylene]amino}oxy)methyl]pyridin-2-yl}carbamate; (O056) ethyl (2Z)-3-amino-2-cyano-3-phenylacrylate; (O057) phenazine-1-carboxylic acid; (O058) propyl 3,4,5-trihydroxybenzoate; (O059) quinolin-8-ol; (O060) quinolin-8-ol sulfate (2:1); (O061) tert-butyl {6-[({[(1-methyl-H-tetrazol-5-yl)(phenyl)methylene]amino}oxy)methyl]pyridin-2-yl}carbamate; (O062) 5-fluoro-4-imino-3-methyl-1-[(4-methylphenyl)sulfonyl]-3,4-dihydropyrimidin-2(1H)-one; (O063) fluoxapiprolin; (O064) pyridachlometyl; (O065) ipflufenoquin; and (O066) aminopyrifen, and
(P) Inhibitors of histone deacetylase including (P001) N-(1-ethylcyclopropyl)-4-[5-(trifluoromethyl)-1,2,4-oxadiazol-3-yl]benzamide; (P002) N-(2-isopropylcyclopropyl)-4-[5-(trifluoromethyl)-1,2,4-oxadiazol-3-yl]benzamide; (P003) N-(2-methylcyclopropyl)-4-[5-(trifluoromethyl)-1,2,4-oxadiazol-3-yl]benzamide; (P004) N-(1-methylcyclopropyl)-4-[5-(trifluoromethyl)-1,2,4-oxadiazol-3-yl]benzamide; (P005) N-(2-ethylcyclopropyl)-4-[5-(trifluoromethyl)-1,2,4-oxadiazol-3-yl]benzamide; (P006) N-(2,4-difluorophenyl)-4-[5-(trifluoromethyl)-1,2,4-oxadiazol-3-yl]benzamide; (P007) 5-(trifluoromethyl)-3-[4-[[3-(trifluoromethyl)-1,2,4triazol-1-yl]methyl]phenyl]-1,2,4-oxadiazole; (P008) 2-[[4-[5-(trifluoromethyl)-1,2,4-oxadiazol-3-yl]phenyl]methyl]-1,2,4-triazole-3-carbonitrile; (P009) ethyl 1-[[4-[5-(trifluoromethyl)-1,2,4-oxadiazol-3-yl]phenyl]methyl]pyrazole-4-carboxylate; (P010) N-cyclopropyl-1-[[4-[5-(trifluoromethyl)-1,2,4-oxadiazol-3-yl]phenyl]methyl]pyrazole-4-carboxamide; (P011) N,N-dimethyl-1-[[4-[5-(trifluoromethyl)-1,2,4-oxadiazol-3-yl]phenyl]methyl]pyrazole-4-carboxamide; (P012) N-methyl-1-[[4-[5-(trifluoromethyl)-1,2,4-oxadiazol-3-yl]phenyl]methyl]pyrazole-4-carboxamide; (P013) N,N,-dimethyl-H[4-[5-(trifluoromethyl)-1,2,4-oxadiazol-3-yl]phenyl]methyl]-1,2,4-triazol-3-amine; (P014) 3-[4-[(5-ethylsulfanyl-1,2,4-triazol-1-yl)methyl]phenyl]-5-(trifluoromethyl)-1,2,4-oxadiazole; (P015) 3-[4-(triazolo[4,5-b]pyridin-1-ylmethyl)phenyl]-5-(trifluoromethyl)-1,2,4-oxadiazole; (P016) 3-[4-(triazolo[4,5-b]pyridin-2-ylmethyl)phenyl]-5-(trifluoromethyl)-1,2,4-oxadiazole; (P017) 3-[4-(triazolo[4,5-b]pyridin-3-ylmethyl)phenyl]-5-(trifluoromethyl)-1,2,4-oxadiazole; (P018) methyl 1-[[4-[5-(trifluoromethyl)-1,2,4-oxadiazol-3-yl]phenyl]methyl]pyrazole-4-carboxylate; (P019) ethyl 1-[[3-fluoro-4-[5-(trifluoromethyl)-1,2,4-oxadiazol-3-yl]phenyl]methyl]pyrazole-4-carboxylate; (P020) N,N-diethyl-1-[[4-[5-(trifluoromethyl)-1,2,4-oxadiazol-3-yl]phenyl]methyl]pyrazole-4-carboxamide; (P021) N-methoxy-N-methyl-1-[[4-[5-(trifluoromethyl)-1,2,4-oxadiazol-3-yl]phenyl]methyl]pyrazole-4-carboxamide; (P022) propyl 1-[[4-[5-(trifluoromethyl)-1,2,4-oxadiazol-3-yl]phenyl]methyl]pyrazole-4-carboxylate; (P023) N-methoxy-1-[[4-[5-(trifluoromethyl)-1,2,4-oxadiazol-3-yl]phenyl]methyl]pyrazole-4-carboxamide; (P024) N-ethyl-1-[[4-[5-(trifluoromethyl)-1,2,4-oxadiazol-3-yl]phenyl]methyl]pyrazole-4-carboxamide; (P025) 1-[[4-[5-(trifluoromethyl)-1,2,4-oxadiazol-3-yl]phenyl]methyl]pyrazole-4-carboxamide; (P026) N-methoxy-1-[1-[[4-[5-(trifluoromethyl)-1,2,4-oxadiazol-3-yl]phenyl]methyl]pyrazol-4-yl]methanimine; (P027) ethyl 1-[1-[4-[5-(trifluoromethyl)-1,2,4-oxadiazol-3-yl]phenyl]ethyl]pyrazole-4-carboxylate; (P028) 1-[[4-[5-(trifluoromethyl)-1,2,4-oxadiazol-3-yl]phenyl]methyl]pyrrolidin-2-one; (P029) 1-[[4-[5-(trifluoromethyl)-1,2,4-oxadiazol-3-yl]phenyl]methyl]piperidin-2-one; (P030) 4-[[4-[5-(trifluoromethyl)-1,2,4-oxadiazol-3-yl]phenyl]methyl]morpholin-3-one; (P031) 4,4-dimethyl-2-[[4-[5-(trifluoromethyl)-1,2,4-oxadiazol-3-yl]phenyl]methyl]isoxazolidin-3-one; (P032) 2-[[4-[5-(trifluoromethyl)-1,2,4-oxadiazol-3-yl]phenyl]methyl]isoxazolidin-3-one; (P033) 5,5-dimethyl-2-[[4-[5-(trifluoromethyl)-1,2,4-oxadiazol-3-yl]phenyl]methyl]isoxazolidin-3-one; (P034) 3,3-dimethyl-1 [4-[5-(trifluoromethyl)-1,2,4-oxadiazol-3-yl]phenyl]methyl]piperidin-2-one; (P035) 1-[[2-fluoro-4-[5-(trifluoromethyl)-1,2,4-oxadiazol-3-yl]phenyl]methyl]pyrrolidin-2-one; (P036) 1-[[2-fluoro-4-[5-(trifluoromethyl)-1,2,4-oxadiazol-3-yl]phenyl]methyl]piperidin-2-one; (P037) 2-[[4-[5-(trifluoromethyl)-1,2,4-oxadiazol-3-yl]phenyl]methyl]oxazinan-3-one; (P038) 1-[[3-fluoro-4-[5-(trifluoromethyl)-1,2,4-oxadiazol-3-yl]phenyl]methyl]piperidin-2-one; (P039) 3-[[4-[5-(trifluoromethyl)-1,2,4-oxadiazol-3-yl]phenyl]methyl]oxazolidin-2-one; (P040) 1-methyl-3-[[4-[5-(trifluoromethyl)-1,2,4-oxadiazol-3-yl]phenyl]methyl]imidazolidin-2-one; (P041) 1-[[3-fluoro-4-[5-(trifluoromethyl)-1,2,4-oxadiazol-3-yl]phenyl]methyl]-3,3-dimethyl-piperidin-2-one; (P042) 1-[[3-fluoro-4-[5-(trifluoromethyl)-1,2,4-oxadiazol-3-yl]phenyl]methyl]pyrrolidin-2-one; (P043) 2-[[3-fluoro-4-[5-(trifluoromethyl)-1,2,4-oxadiazol-3-yl]phenyl]methyl]-4,4-dimethyl-isoxazolidin-3-one; (P044) 2-[[2,3-difluoro-4-[5-(trifluoromethyl)-1,2,4-oxadiazol-3-yl]phenyl]methyl]isoxazolidin-3-one; (P045) 2-[[3-fluoro-4-[5-(trifluoromethyl)-1,2,4-oxadiazol-3-yl]phenyl]methyl]isoxazolidin-3-one; (P046) 1-[[3-fluoro-4-[5-(trifluoromethyl)-1,2,4-oxadiazol-3-yl]phenyl]methyl]azepan-2-one; (P047) N-[[4-[5-(trifluoromethyl)-1,2,4-oxadiazol-3-yl]phenyl]methyl]propanamide; (P048) 2,2-dimethyl-N-[[4-[5-(trifluoromethyl)-1,2,4-oxadiazol-3-yl]phenyl]methyl]but-3-ynamide; (P049) N-[[4-[5-(trifluoromethyl)-1,2,4-oxadiazol-3-yl]phenyl]methyl]butanamide; (P050) 3-methyl-N-[[4-[5-(trifluoromethyl)-1,2,4-oxadiazol-3-yl]phenyl]methyl]butanamide; (P051) 2-methyl-N-[[4-[5-(trifluoromethyl)-1,2,4-oxadiazol-3-yl]phenyl]methyl]prop-2-enamide; (P052) 2-methyl-N-[[4-[5-(trifluoromethyl)-1,2,4-oxadiazol-3-yl]phenyl]methyl]butanamide; (P053) 2-methoxy-N-[[4-[5-(trifluoromethyl)-1,2,4-oxadiazol-3-yl]phenyl]methyl]; (P054) 3,3,3-trifluoro-N-[[3-fluoro-4-[5-(trifluoromethyl)-1,2,4-oxadiazol-3-yl]phenyl]methyl]propanamide; (P055) 3,3,3-trifluoro-N-[[2-fluoro-4-[5-(trifluoromethyl)-1,2,4-oxadiazol-3-yl]phenyl]methyl]propanamide; (P056) N-[[2,3-difluoro-4-[5-(trifluoromethyl)-1,2,4-oxadiazol-3-yl]phenyl]methyl]butanamide; (P057) N-[[2,3-difluoro-4-[5-(trifluoromethyl)-1,2,4-oxadiazol-3-yl]phenyl]methyl]-3,3,3-trifluoro-propanamide; (P058) 2-(difluoromethoxy)-N-[[4-[5-(trifluoromethyl)-1,2,4-oxadiazol-3-yl]phenyl]methyl]acetamide; (P059) 2-methoxy-2-methyl-N-[[4-[5-(trifluoromethyl)-1,2,4-oxadiazol-3-yl]phenyl]methyl]propanamide; (P060) 1-methyl-3-[[4-[5-(trifluoromethyl)-1,2,4-oxadiazol-3-yl]phenyl]methyl]urea; (P061) 1-ethyl-1-methyl-3-[[4-[5-(trifluoromethyl)-1,2,4-oxadiazol-3-yl]phenyl]methyl]urea; (P062) 1-ethoxy-3-[[4-[5-(trifluoromethyl)-1,2,4-oxadiazol-3-yl]phenyl]methyl]urea; (P063) 1-methoxy-1-methyl-3-[[4-[5-(trifluoromethyl)-1,2,4-oxadiazol-3-yl]phenyl]methyl]; (P064) 1,1-diethyl-3-[[4-[5-(trifluoromethyl)-1,2,4-oxadiazol-3-yl]phenyl]methyl]urea; (P065) N-methoxy-N-[[4-[5-(trifluoromethyl)-1,2,4-oxadiazol-3-yl]phenyl]methyl]cyclopropanecarboxamide; (P066) N-methoxy-N-[[4-[5-(trifluoromethyl)-1,2,4-oxadiazol-3-yl]phenyl]methyl]pent-4-ynamide; (P067) N-methoxy-2-methyl-N-[[4-[5-(trifluoromethyl)-1,2,4-oxadiazol-3-yl]phenyl]methyl]prop-2-enamide; (P068) N,2-dimethoxy-N-[[4-[5-(trifluoromethyl)-1,2,4-oxadiazol-3-yl]phenyl]methyl]propanamide; (P069) N-cyclopropyl-3,3,3-trifluoro-N-[[4-[5-(trifluoromethyl)-1,2,4-oxadiazol-3-yl]phenyl]methyl]propanamide; (P070) 2,2-difluoro-N-(2-methoxyethyl)-N-[[4-[5-(trifluoromethyl)-1,2,4-oxadiazol-3-yl]phenyl]methyl]cyclo propanecarboxamide; (P071) N-ethyl-2-methyl-N-[[4-[5-(trifluoromethyl)-1,2,4-oxadiazol-3-yl]phenyl]methyl]propanamide; (P072) N-[[3-fluoro-4-[5-(trifluoromethyl)-1,2,4-oxadiazol-3-yl]phenyl]methyl]-N-methoxy-propanamide; (P073) 2-methoxy-N-(2,2,2-trifluoroethyl)-N-[[4-[5-(trifluoromethyl)-1,2,4-oxadiazol-3-yl]phenyl]methyl] acetamide; (P074) N-[[2,3-difluoro-4-[5-(trifluoromethyl)-1,2,4-oxadiazol-3-yl]phenyl]methyl]-N-methoxy-cyclopropane carboxamide; (P075) 2-(difluoromethoxy)-N-methyl-N-[[4-[5-(trifluoromethyl)-1,2,4-oxadiazol-3-yl]phenyl]methyl]acetamide; (P076) N-ethoxy-2-methoxy-N-[[4-[5-(trifluoromethyl)-1,2,4-oxadiazol-3-yl]phenyl]methyl]propanamide; (P077) N-isopropyl-N-[[4-[5-(trifluoromethyl)-1,2,4-oxadiazol-3-yl]phenyl]methyl]tetrahydrofuran-2-carboxamide; (P078) 1-methoxy-3-methyl-1-[[4-[5-(trifluoromethyl)-1,2,4-oxadiazol-3-yl]phenyl]methyl]urea; (P079) 3-cyclopropyl-1-methoxy-1-[[4-[5-(trifluoromethyl)-1,2,4-oxadiazol-3-yl]phenyl]methyl]urea; (P080) 3-ethoxy-1-methoxy-1-[[4-[5-(trifluoromethyl)-1,2,4-oxadiazol-3-yl]phenyl]methyl]urea; (P081) 3-allyl-1-methoxy-1-[[4-[5-(trifluoromethyl)-1,2,4-oxadiazol-3-yl]phenyl]methyl]urea; (P082) 1-cyclopropyl-3-methoxy-3-methyl-1-[[4-[5-(trifluoromethyl)-1,2,4-oxadiazol-3-yl]phenyl]methyl]urea; (P083) 3-isopropyl-1-methoxy-1-[[4-[5-(trifluoromethyl)-1,2,4-oxadiazol-3-yl]phenyl]methyl]urea; (P084) 1-methoxy-3-prop-2-ynyl-1-[[4-[5-(trifluoromethyl)-1,2,4-oxadiazol-3-yl]phenyl]methyl]urea; (P085) 1-[[3-fluoro-4-[5-(trifluoromethyl)-1,2,4-oxadiazol-3-yl]phenyl]methyl]-1-methoxy-3-methyl-urea; (P086) 3-(cyclopropylmethyl)-1-methyl-1-[[4-[5-(trifluoromethyl)-1,2,4-oxadiazol-3-yl]phenyl]methyl]urea; (P087) 1-ethyl-3-(2,2,2-trifluoroethyl)-1-[[4-[5-(trifluoromethyl)-1,2,4-oxadiazol-3-yl]phenyl]methyl]urea; (P088) 1,3-dimethoxy-1-[[4-[5-(trifluoromethyl)-1,2,4-oxadiazol-3-yl]phenyl]methyl]urea; (P089) 3-ethyl-1-methoxy-1-[[4-[5-(trifluoromethyl)-1,2,4-oxadiazol-3-yl]phenyl]methyl]urea; (P090) N-methyl-4-[5-(trifluoromethyl)-1,2,4-oxadiazol-3-yl]benzamide; (P091) N-[(E)-methoxyiminomethyl]-4-[5-(trifluoromethyl)-1,2,4-oxadiazol-3-yl]benzamide; (P092) N—[(Z)-methoxyiminomethyl]-4-[5-(trifluoromethyl)-1,2,4-oxadiazol-3-yl]benzamide; (P093) N-[4-[5-(trifluoromethyl)-1,2,4-oxadiazol-3-yl]phenyl]cyclopropanecarboxamide; (P094) N-(2-fluorophenyl)-4-[5-(trifluoromethyl)-1,2,4-oxadiazol-3-yl]benzamide; (P095) 2,2-difluoro-N-methyl-2-[4-[5-(trifluoromethyl)-1,2,4-oxadiazol-3-yl]phenyl]acetamide; (P096) N-allyl-N-[[4-[5-(trifluoromethyl)-1,2,4-oxadiazol-3-yl]phenyl]methyl]acetamide; (P097) N-[(E)-N-methoxy-C-methyl-carbonimidoyl]-4-[5-(trifluoromethyl)-1,2,4-oxadiazol-3-yl]benzamide; (P098) N—[(Z)—N-methoxy-C-methyl-carbonimidoyl]-4-[5-(trifluoromethyl)-1,2,4-oxadiazol-3-yl]benzamide; (P100) N-allyl-N-[[4-[5-(trifluoromethyl)-1,2,4-oxadiazol-3-yl]phenyl]methyl]propanamide; (P101) 4,4-dimethyl-1-[[4-[5-(trifluoromethyl)-1,2,4-oxadiazol-3-yl]phenyl]methyl]pyrrolidin-2-one; (P102) N-methyl-4-[5-(trifluoromethyl)-1,2,4-oxadiazol-3-yl]benzenecarbothioamide; and (P103) 5-methyl-1-[[4-[5-(trifluoromethyl)-1,2,4-oxadiazol-3-yl]phenyl]methyl]pyrrolidin-2-one.

In a preferred embodiment, the pesticidal active mixture according to the invention comprise component (2) as at least one fungicidally active compound (III) selected from:
(A) Inhibitors of the ergosterol synthesis;
(B) Inhibitors of the respiratory chain at complex I or II;
(C) Inhibitors of the respiratory chain at complex III;
(D) Inhibitors of the mitosis and cell division;
(E) Compounds capable to have a multisite action;
(L) Inhibitors of the nucleic acid synthesis;
(M) Inhibitors of the signal transduction;
(N) Compounds capable to act as an uncoupler; and
(P) Inhibitors of histone deacetylase.

In another preferred embodiment, the pesticidal active mixture according to the invention comprises compound (II) as at least one fungicidally active compound selected from (A001) cyproconazole, (A002) difenoconazole, (A003) epoxiconazole, (A006) fenpropimorph, (A009) flutriafol, (A013) metconazole, (A017) propiconazole, (A018) prothioconazole, (A021) tebuconazole, (A022) tetraconazol, (A081) mefentrifluconazole, (B001) benzovindiflupyr, (B002) bixafen, (B005) fluopyram, (B007) fluxapyroxad, (B019) pydiflumetofen, (B30) fluindapyr, (B059) inpyrfluxam, (C003) azoxystrobin, (C012) fluoxastrobin (C014) metominostrobin, (C017) pyraclostrobin, (C016) picoxystrobin, (C020) trifloxystrobin, (C025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl-2-methylpropanoate (Fenpicoxamid), (C030) 1-(2-{[1-(4-chlorophenyl)pyrazol-3-yl]oxymethyl}-3-methylphenyl)-1,4-dihydro-4-methyl-5H-tetrazol-5-one (Metyltetraprole), (D001) carbendazim, (D007) thiophanate-methyl, (E004) chlorothalonil, (E010) dithianon, (E013) mancozeb, (E020) thiram, (F002) Isotianil, (F003) Probenazole, (L003) metalaxyl, (M001) fludioxonil, (N001) fluazinam, (O022) Oxathiapiprolin, (O043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate (fluoxapiprolin), (O046) 3-(4,4,5-trifluoro-3,3-dimethyl-3,4-dihydroisoquinolin-1-yl)quinoline, (O047) 3-(4,4-difluoro-3,3-dimethyl-3,4-dihydroisoquinolin-1-yl)quinoline (Quinofumelin), (O065) ipflufenoquin and (P094) N-(2-fluorophenyl)-4-[5-(trifluoromethyl)-1,2,4-oxadiazol-3-yl]benzamide.

In a more preferred embodiment, the pesticidal active mixture according to the invention comprise component (2) as at least one fungicidally active compound (III) 1 selected from (C003) Azoxystrobin, (C017) Pyraclostrobin, (L003) Metalaxyl, (D007) Thiophanate-methyl, (B007) Fluxapyroxad, (M001) Fludioxonil, (F003) Probenazole, (F002) Isotianil and (B005) Fluopyram.

The following combinations exemplify specific embodiments of the agrochemical composition according to the present invention.

Following combinations listed in Table-1, wherein component (1) (compound of formula (I), a group represented by the expression “(I)” comprising of compounds I-1, I-2, I-3, I-4, I-5, I-6, I-7, I-8, I-9, I-10 and I-11) and component (2) is selected from the groups II-1) to II-33) as defined herein

TABLE 1
(I) + (II-1A), (I) + (II-1B), (I) + (II-2A), (I) + (II-2B), (I) + (II-3A), (I) + (II-3B), (I) + (II-4A), (I) + (II-4B),
(I) + ( II-4C), (I) + (II-4D), (I) + (II-4E), (I) + (II-5), (I) + ( II-6), (I) + (II-7A), (I) + (II-7B), (I) + (II-7C),
(I) + (II-8A), (I) + (II-8B), (I) + (II-8C), (I) + (II-8D), (I) + (II-8E), (I) + (II-8F), (I) + (II-9A), (I) + (II-9B),
(I) + (II-10A), (I) + (II-10B), (I) + (II-11A), (I) + (II-12A), (I) + (II-12B), (I) + (II-12C), (I) + (II-12D), (I) + (II-
13A), (I) + (II-13B), (I) + ( II-13C), (I) + (II-14), (I) + (II-15), (I) + (II-16), (I) + (II-17), (I) + (II-18), (I) + (II-
19), (I) + (II-20A), (I) + (II-20B), (I) + (II-20C), (I) + (II-20D), (I) + ( II-21A), (I) + (II-21B), (I) + (II-22A),
(I) + (II-22B), (I) + (II-22C), (I) + (II-23), (I) + (II-24A), (I) + (II-24B), (I) + (II-25A), (I) + (II-25B), (I) + (II-
26), (I) + (II-27), (I) + (II-28A), (I) + (II-28B), (I) + (II-29A), (I) + (II-29B), (I) + (II-30), (I) + (II-31), (I) + ( II-
32), (I) + (II-33).

In particular, combinations listed in Table-1A, wherein component (1) (compound of formula (I), a group represented by the expression “(I)” comprising of compounds I-1, I-2, I-3, I-4, I-5, I-6, I-7, I-8, I-9, I-10 and I-11) and component (2) is selected from the compounds Z001) to Z377) as defined herein

TABLE-1A
(I) + (Z001), (I) + (Z002), (I) + (Z003), (I) + (Z004), (I) + (Z005), (I) + (Z006), (I) + (Z007), (I) + (Z008),
(I) + (Z009), (I) + (Z010), (I) + (Z011), (I) + (Z012), (I) + (Z013), (I) + (Z014), (I) + (Z015), (I) + (Z016),
(I) + (Z017), (I) + (Z018), (I) + (Z019), (I) + (Z020), (I) + (Z021), (I) + (Z022), (I) + (Z023), (I) + (Z024),
(I) + (Z025), (I) + (Z026), (I) + (Z027), (I) + (Z028), (I) + (Z029), (I) + (Z030), (I) + (Z031), (I) + (Z032),
(I) + (Z033), (I) + (Z034), (I) + (Z035), (I) + (Z036), (I) + (Z037), (I) + (Z038), (I) + (Z039), (I) + (Z040),
(I) + (Z041), (I) + (Z042), (I) + (Z043), (I) + (Z044), (I) + (Z045), (I) + (Z046), (I) + (Z047), (I) + (Z048),
(I) + (Z049), (I) + (Z050), (I) + (Z051), (I) + (Z052), (I) + (Z053), (I) + (Z054), (I) + (Z055), (I) + (Z056),
(I) + (Z057), (I) + (Z058), (I) + (Z059), (I) + (Z060), (I) + (Z061), (I) + (Z062), (I) + (Z063), (I) + (Z064),
(I) + (Z065), (I) + (Z066), (I) + (Z067), (I) + (Z068), (I) + (Z069), (I) + (Z070), (I) + (Z071), (I) + (Z072),
(I) + (Z073), (I) + (Z074), (I) + (Z075), (I) + (Z076), (I) + (Z077), (I) + (Z078), (I) + (Z079), (I) + (Z080),
(I) + (Z081), (I) + (Z082), (I) + (Z083), (I) + (Z084), (I) + (Z085), (I) + (Z086), (I) + (Z087), (I) + (Z088),
(I) + (Z089), (I) + (Z090), (I) + (Z091), (I) + (Z092), (I) + (Z093), (I) + (Z094), (I) + (Z095), (I) + (Z096),
(I) + (Z097), (I) + (Z098), (I) + (Z099), (I) + (Z100), (I) + (Z101), (I) + (Z102), (I) + (Z103), (I) + (Z104),
(I) + (Z105), (I) + (Z106), (I) + (Z107), (I) + (Z108), (I) + (Z109), (I) + (Z110), (I) + (Z111), (I) + (Z112),
(I) + (Z113), (I) + (Z114), (I) + (Z115), (I) + (Z116), (I) + (Z117), (I) + (Z118), (I) + (Z119), (I) + (Z120),
(I) + (Z121), (I) + (Z122), (I) + (Z123), (I) + (Z124), (I) + (Z125), (I) + (Z126), (I) + (Z127), (I) + (Z128),
(I) + (Z129), (I) + (Z130), (I) + (Z131), (I) + (Z132), (I) + (Z133), (I) + (Z134), (I) + (Z135), (I) + (Z136),
(I) + (Z137), (I) + (Z138), (I) + (Z139), (I) + (Z140), (I) + (Z141), (I) + (Z142), (I) + (Z143), (I) + (Z144),
(I) + (Z145), (I) + (Z146), (I) + (Z147), (I) + (Z148), (I) + (Z149), (I) + (Z150), (I) + (Z151), (I) + (Z152),
(I) + (Z153), (I) + (Z154), (I) + (Z155), (I) + (Z156), (I) + (Z157), (I) + (Z158), (I) + (Z159), (I) + (Z160),
(I) + (Z161), (I) + (Z162), (I) + (Z163), (I) + (Z164), (I) + (Z165), (I) + (Z166), (I) + (Z167), (I) + (Z168),
(I) + (Z169), (I) + (Z170), (I) + (Z171), (I) + (Z172), (I) + (Z173), (I) + (Z174), (I) + (Z175), (I) + (Z176),
(I) + (Z177), (I) + (Z178), (I) + (Z179), (I) + (Z180), (I) + (Z181), (I) + (Z182), (I) + (Z183), (I) + (Z184),
(I) + (Z185), (I) + (Z186), (I) + (Z187), (I) + (Z188), (I) + (Z189), (I) + (Z190), (I) + (Z191), (I) + (Z192),
(I) + (Z193), (I) + (Z194), (I) + (Z195), (I) + (Z196), (I) + (Z197), (I) + (Z198), (I) + (Z199), (I) + (Z200),
(I) + (Z201), (I) + (Z202), (I) + (Z203), (I) + (Z204), (I) + (Z205), (I) + (Z206), (I) + (Z207), (I) + (Z208),
(I) + (Z209), (I) + (Z210), (I) + (Z211), (I) + (Z212), (I) + (Z213), (I) + (Z214), (I) + (Z215), (I) + (Z216),
(I) + (Z217), (I) + (Z218), (I) + (Z219), (I) + (Z220), (I) + (Z221), (I) + (Z222), (I) + (Z223), (I) + (Z224),
(I) + (Z225), (I) + (Z226), (I) + (Z227), (I) + (Z228), (I) + (Z229), (I) + (Z230), (I) + (Z231), (I) + (Z232),
(I) + (Z233), (I) + (Z234), (I) + (Z235), (I) + (Z236), (I) + (Z237), (I) + (Z238), (I) + (Z239), (I) + (Z240),
(I) + (Z241), (I) + (Z242), (I) + (Z243), (I) + (Z244), (I) + (Z245), (I) + (Z246), (I) + (Z247), (I) + (Z248),
(I) + (Z249), (I) + (Z250), (I) + (Z251), (I) + (Z252), (I) + (Z253), (I) + (Z254), (I) + (Z255), (I) + (Z256),
(I) + (Z257), (I) + (Z258), (I) + (Z259), (I) + (Z260), (I) + (Z261), (I) + (Z262), (I) + (Z263), (I) + (Z264),
(I) + (Z265), (I) + (Z266), (I) + (Z267), (I) + (Z268), (I) + (Z269), (I) + (Z270), (I) + (Z271), (I) + (Z272),
(I) + (Z273), (I) + (Z274), (I) + (Z275), (I) + (Z276), (I) + (Z277), (I) + (Z278), (I) + (Z279), (I) + (Z280),
(I) + (Z281), (I) + (Z282), (I) + (Z283), (I) + (Z284), (I) + (Z285), (I) + (Z286), (I) + (Z287), (I) + (Z288),
(I) + (Z289), (I) + (Z290), (I) + (Z291), (I) + (Z292), (I) + (Z293), (I) + (Z294), (I) + (Z295), (I) + (Z296),
(I) + (Z297), (I) + (Z298), (I) + (Z299), (I) + (Z300), (I) + (Z301), (I) + (Z302), (I) + (Z303), (I) + (Z304),
(I) + (Z305), (I) + (Z306), (I) + (Z307), (I) + (Z308), (I) + (Z309), (I) + (Z310), (I) + (Z311), (I) + (Z312),
(I) + (Z313), (I) + (Z314), (I) + (Z315), (I) + (Z316), (I) + (Z317), (I) + (Z318), (I) + (Z319), (I) + (Z320),
(I) + (Z321), (I) + (Z322), (I) + (Z323), (I) + (Z324), (I) + (Z325), (I) + (Z326), (I) + (Z327), (I) + (Z328),
(I) + (Z329), (I) + (Z330), (I) + (Z331), (I) + (Z332), (I) + (Z333), (I) + (Z334), (I) + (Z335), (I) + (Z336),
(I) + (Z337), (I) + (Z338), (I) + (Z339), (I) + (Z340), (I) + (Z341), (I) + (Z342), (I) + (Z343), (I) + (Z344),
(I) + (Z345), (I) + (Z346), (I) + (Z347), (I) + (Z348), (I) + (Z349), (I) + (Z350), (I) + (Z351), (I) + (Z352),
(I) + (Z353), (I) + (Z354), (I) + (Z355), (I) + (Z356), (I) + (Z357), (I) + (Z358), (I) + (Z359), (I) + (Z360),
(I) + (Z361), (I) + (Z362), (I) + (Z363), (I) + (Z364), (I) + (Z365), (I) + (Z366), (I) + (Z367), (I) + (Z368),
(I) + (Z369), (I) + (Z370), (I) + (Z371), (I) + (Z372), (I) + (Z373), (I) + (Z374), (I) + (Z375), (I) + (Z376) and
(I) + (Z377).

(In one embodiment, the weight ratio of component (1) to component (2) is between 500:1 and 1:500 in combinations [(I)+(II-1A] to [(I)+(II-33)] or [(I)+(Z001)] to [(I)+(Z377)] of Table: 1.

In one embodiment, the weight ratio of component (1) to component (2) is between 100:1 and 1:100 in combinations [(I)+(II-1A] to [(I)+(II-33)] or [(I)+(Z001)] to [(I)+(Z377)] of Table: 1.

In one embodiment, the weight ratio of component (1) to component (2) is between 50:1 and 1:50 in combinations [(I)+(II-1A] to [(I)+(II-33)] or [(I)+(Z001)] to [(I)+(Z377)] of Table: 1.

In one embodiment, the weight ratio of component (1) to component (2) is between 20:1 and 1:20 in combinations [(I)+(II-1A] to [(I)+(II-33)] or [(I)+(Z001)] to [(I)+(Z377)] of Table: 1.

In one embodiment, the weight ratio of component (1) to component (2) is between 5:1 and 1:5 in combinations [(I)+(II-1A] to [(I)+(II-33)] or [(I)+(Z001)] to [(I)+(Z377)] of Table: 1.

In one embodiment, the weight ratio of component (1) to component (2) is between 3:1 and 1:3 in combinations [(I)+(II-1A] to [(I)+(II-33)] or [(I)+(Z001)] to [(I)+(Z377)] of Table: 1.

In one embodiment, the weight ratio of component (1) to component (2) is between 2:1 and 1:2 in combinations [(I)+(II-1A] to [(I)+(II-33)] or [(I)+(Z001)] to [(I)+(Z377)] of Table: 1.

In one embodiment, the weight ratio of component (1) to component (2) is 1:1 in combinations [(I)+(II-1A] to [(I)+(II-33)] or [(I)+(Z001)] to [(I)+(Z377)] of Table: 1.

Following combinations listed in Table-2, wherein component (1) is compound (I-1) and component (2) selected from the groups II-1) to II-33) as defined herein

TABLE-2
(I-1) + (II-1A), (I-1) + (II-1B), (I-1) + (II-2A), (I-1) + (II-2B), (I-1) + (II-3A), (I-1) + (II-3B), (I-1) + (II-4A),
(I-1) + (II-4B), (I-1) + (II-4C), (I-1) + (II-4D), (I-1) + (II-4E), (I-1) + (II-5), (I-1) + (II-6), (I-1) + (II-7A), (I-
1) + (II-7B), (I-1) + (II-7C), (I-1) + (II-8A), (I-1) + (II-8B), (I-1) + (II-8C), (I-1) + (II-8D), (I-1) + (II-8E), (I-
1) + (II-8F), (I-1) + (II-9A), (I-1) + (II-9B), (I-1) + (II-10A), (I-1) + (II-10B), (I-1) + (II-11A), (I-1) + (II-12A),
(I-1) + (II-12B), (I-1) + (II-12C), (I-1) + (II-12D), (I-1) + (II-13A), (I-1) + (II-13B), (I-1) + (II-13C), (I-
1) + (II-14), (I-1) + (II-15), (I-1) + (II-16), (I-1) + (II-17), (I-1) + (II-18), (I-1) + (II-19), (I-1) + (II-20A), (I-
1) + (II-20B), (I-1) + (II-20C), (I-1) + (II-20D), (I-1) + (II-21A), (I-1) + (II-21B), (I-1) + (II-22A), (I-1) + (II-
22B), (I-1) + (II-22C), (I-1) + (II-23), (I-1) + (II-24A), (I-1) + (II-24B), (I-1) + (II-25A), (I-1) + (II-25B), (I-
1) + (II-26), (I-1) + (II-27), (I-1) + (II-28A), (I-1) + (II-28B), (I-1) + (II-29A), (I-1) + (II-29B), (I-1) + (II-30),
(I-1) + (II-31), (I-1) + (II-32), (I-1) + (II-33).

In particular, combinations listed in Table-2A, wherein component (1) is compound (I-1) and component (2) selected from the compounds (Z001) to (Z377)] as defined herein

TABLE-2A
(I-1) + (Z001), (I-1) + (Z002), (I-1) + (Z003), (I-1) + (Z004), (I-1) + (Z005), (I-1) + (Z006), (I-1) + (Z007), (I-
1) + (Z008), (I-1) + (Z009), (I-1) + (Z010), (I-1) + (Z011), (I-1) + (Z012), (I-1) + (Z013), (I-1) + (Z014), (I-
1) + (Z015), (I-1) + (Z016), (I-1) + (Z017), (I-1) + (Z018), (I-1) + (Z019), (I-1) + (Z020), (I-1) + (Z021), (I-
1) + (Z022), (I-1) + (Z023), I-1) + (Z024), (I-1) + (Z025), (I-1) + (Z026), (I-1) + (Z027), (I-1) + (Z028), (I-
1) + (Z029), (I-1) + (Z030), (I-1) + (Z031), (I-1) + (Z032), (I-1) + (Z033), (I-1) + (Z034), (I-1) + (Z035), (I-
1) + (Z036), (I-1) + (Z037), (I-1) + (Z038), (I-1) + (Z039), (I-1) + (Z040), (I-1) + (Z041), (I-1) + (Z042), (I-
1) + (Z043), (I-1) + (Z044), (I-1) + (Z045), (I-1) + (Z046), (I-1) + (Z047), (I-1) + (Z048), (I-1) + (Z049), (I-
1) + (Z050), (I-1) + (Z051), (I-1) + (Z052), (I-1) + (Z053), (I-1) + (Z054), (I-1) + (Z055), (I-1) + (Z056), (I-
1) + (Z057), (I-1) + (Z058), (I-1) + (Z059), (I-1) + (Z060), (I-1) + (Z061), (I-1) + (Z062), (I-1) + (Z063), (I-
1) + (Z064), (I-1) + (Z065), (I-1) + (Z066), (I-1) + (Z067), (I-1) + (Z068), (I-1) + (Z069), (I-1) + (Z070), (I-
1) + (Z071), (I-1) + (Z072), (I-1) + (Z073), (I-1) + (Z074), (I-1) + (Z075), (I-1) + (Z076), (I-1) + (Z077), (I-
1) + (Z078), (I-1) + (Z079), (I-1) + (Z080), (I-1) + (Z081), (I-1) + (Z082), (I-1) + (Z083), (I-1) + (Z084), (I-
1) + (Z085), (I-1) + (Z086), (I-1) + (Z087), (I-1) + (Z088), (I-1) + (Z089), (I-1) + (Z090), (I-1) + (Z091), (I-
1) + (Z092), (I-1) + (Z093), (I-1) + (Z094), (I-1) + (Z095), (I-1) + (Z096), (I-1) + (Z097), (I-1) + (Z098), (I-
1) + (Z099), (I-1) + (Z100), (I-1) + (Z101), (I-1) + (Z102), (I-1) + (Z103), (I-1) + (Z104), (I-1) + (Z105), (I-
1) + (Z106), (I-1) + (Z107), (I-1) + (Z108), (I-1) + (Z109), (I-1) + (Z110), (I-1) + (Z111), (I-1) + (Z112), (I-
1) + (Z113), (I-1) + (Z114), (I-1) + (Z115), (I-1) + (Z116), (I-1) + (Z117), (I-1) + (Z118), (I-1) + (Z119), (I-
1) + (Z120), (I-1) + (Z121), (I-1) + (Z122), (I-1) + (Z123), (I-1) + (Z124), (I-1) + (Z125), (I-1) + (Z126), (I-
1) + (Z127), (I-1) + (Z128), (I-1) + (Z129), (I-1) + (Z130), (I-1) + (Z131), (I-1) + (Z132), (I-1) + (Z133), (I-
1) + (Z134), (I-1) + (Z135), (I-1) + (Z136), (I-1) + (Z137), (I-1) + (Z138), (I-1) + (Z139), (I-1) + (Z140), (I-
1) + (Z141), (I-1) + (Z142), (I-1) + (Z143), (I-1) + (Z144), (I-1) + (Z145), (I-1) + (Z146), (I-1) + (Z147), (I-
1) + (Z148), (I-1-1) + (Z149), (I-1-1) + (Z150), (I-1-1) + (Z151), (I-1-1) + (Z152), (I-1-1) + (Z153), (I-
1) + (Z154), (I-1) + (Z155), (I-1) + (Z156), (I-1) + (Z157), (I-1) + (Z158), (I-1) + (Z159), (I-1) + (Z160), (I-
1) + (Z161), (I-1) + (Z162), (I-1) + (Z163), (I-1) + (Z164), (I-1) + (Z165), (I-1) + (Z166), (I-1) + (Z167), (I-
1) + (Z168), (I-1) + (Z169), (I-1) + (Z170), (I-1) + (Z171), (I-1) + (Z172), (I-1) + (Z173), (I-1) + (Z174), (I-
1) + (Z175), (I-1) + (Z176), (I-1) + (Z177), (I-1) + (Z178), (I-1) + (Z179), (I-1) + (Z180), (I-1) + (Z181), (I-
1) + (Z182), (I-1) + (Z183), (I-1) + (Z184), (I-1) + (Z185), (I-1) + (Z186), (I-1) + (Z187), (I-1) + (Z188), (I-
1) + (Z189), (I-1) + (Z190), (I-1) + (Z191), (I-1) + (Z192), (I-1) + (Z193), (I-1) + (Z194), (I-1) + (Z195), (I-
1) + (Z196), (I-1) + (Z197), (I-1) + (Z198), (I-1) + (Z199), (I-1) + (Z200), (I-1) + (Z201), (I-1) + (Z202), (I-
1) + (Z203), (I-1) + (Z204), (I-1) + (Z205), (I-1) + (Z206), (I-1) + (Z207), (I-1) + (Z208), (I-1) + (Z209), (I-
1) + (Z210), (I-1) + (Z211), (I-1) + (Z212), (I-1) + (Z213), (I-1) + (Z214), (I-1) + (Z215), (I-1) + (Z216), (I-
1) + (Z217), (I-1) + (Z218), (I-1) + (Z219), (I-1) + (Z220), (I-1) + (Z221), (I-1) + (Z222), (I-1) + (Z223), (I-
1) + (Z224), (I-1) + (Z225), (I-1) + (Z226), (I-1) + (Z227), (I-1) + (Z228), (I-1) + (Z229), (I-1) + (Z230), (I-
1) + (Z231), (I-1) + (Z232), (I-1) + (Z233), (I-1) + (Z234), (I-1) + (Z235), (I-1) + (Z236), (I-1) + (Z237), (I-
1) + (Z238), (I-1) + (Z239), (I-1) + (Z240), (I-1) + (Z241), (I-1) + (Z242), (I-1) + (Z243), (I-1) + (Z244), (I-
1) + (Z245), (I-1) + (Z246), (I-1) + (Z247), (I-1) + (Z248), (I-1) + (Z249), (I-1) + (Z250), (I-1) + (Z251), (I-
1) + (Z252), (I-1) + (Z253), (I-1) + (Z254), (I-1) + (Z255), (I-1) + (Z256), (I-1) + (Z257), (I-1) + (Z258), (I-
1) + (Z259), (I-1) + (Z260), (I-1) + (Z261), (I-1) + (Z262), (I-1) + (Z263), (I-1) + (Z264), (I-1) + (Z265), (I-
1) + (Z266), (I-1) + (Z267), (I-1) + (Z268), (I-1) + (Z269), (I-1) + (Z270), (I-1) + (Z271), (I-1) + (Z272), (I-
1) + (Z273), (I-1) + (Z274), (I-1) + (Z275), (I-1) + (Z276), (I-1) + (Z277), (I-1) + (Z278), (I-1) + (Z279), (I-
1) + (Z280), (I-1) + (Z281), (I-1) + (Z282), (I-1) + (Z283), (I-1) + (Z284), (I-1) + (Z285), (I-1) + (Z286), (I-
1) + (Z287), (I-1) + (Z288), (I-1) + (Z289), (I-1) + (Z290), (I-1) + (Z291), (I-1) + (Z292), (I-1) + (Z293), (I-
1) + (Z294), (I-1) + (Z295), (I-1) + (Z296), (I-1) + (Z297), (I-1) + (Z298), (I-1) + (Z299), (I-1) + (Z300), (I-
1) + (Z301), (I-1) + (Z302), (I-1) + (Z303), (I-1) + (Z304), (I-1) + (Z305), (I-1) + (Z306), (I-1) + (Z307), (I-
1) + (Z308), (I-1) + (Z309), (I-1) + (Z310), (I-1) + (Z311), (I-1) + (Z312), (I-1) + (Z313), (I-1) + (Z314), (I-
1) + (Z315), (I-1) + (Z316), (I-1) + (Z317), (I-1) + (Z318), (I-1) + (Z319), (I-1) + (Z320), (I-1) + (Z321), (I-
1) + (Z322), (I-1) + (Z323), (I-1) + (Z324), (I-1) + (Z325), (I-1) + (Z326), (I-1) + (Z327), (I-1) + (Z328), (I-
1) + (Z329), (I-1) + (Z330), (I-1) + (Z331), (I-1) + (Z332), (I-1) + (Z333), (I-1) + (Z334), (I-1) + (Z335), (I-
1) + (Z336), (I-1) + (Z337), (I-1) + (Z338), (I-1) + (Z339), (I-1) + (Z340), (I-1) + (Z341), (I-1) + (Z342), (I-
1) + (Z343), (I-1) + (Z344), (I-1) + (Z345), (I-1) + (Z346), (I-1) + (Z347), (I-1) + (Z348), (I-1) + (Z349), (I-
1) + (Z350), (I-1) + (Z351), (I-1) + (Z352), (I-1) + (Z353), (I-1) + (Z354), (I-1) + (Z355), (I-1) + (Z356), (I-
1) + (Z357), (I-1) + (Z358), (I-1) + (Z359), (I-1) + (Z360), (I-1) + (Z361), (I-1) + (Z362), (I-1) + (Z363), (I-
1) + (Z364), (I-1) + (Z365), (I-1) + (Z366), (I-1) + (Z367), (I-1) + (Z368), (I-1) + (Z369), (I-1) + (Z370), (I-
1) + (Z371), (I-1) + (Z372), (I-1) + (Z373), (I-1) + (Z374), (I-1) + (Z375), (I-1) + (Z376) and (I-1) + (Z377).

TABLE 3
Combination [(I-2) + (II-1A) to [(I-2) + (II-33)] or [(I-2) + (Z001)] to [(I-2) + (Z377)] are defined as
combination [(I-1) + (II-1A) to [(I-1) + (II-33)] or [(I-1) + (Z001)] to [(I-1) + (Z386)] of Table 2,
wherein compound (I-1) in each mixture is replaced with compound (I-2).

TABLE 4
Combination [(I-3) + (II-1A) to [(I-3) + (II-33)] or [(I-3) + (Z001)] to [(I-3) + (Z377)] are defined as
combination [(I-1) + (II-1A) to [(I-1) + (II-33)] or [(I-1) + (Z001)] to [(I-1) + (Z377)] of Table 2,
wherein compound (I-1) in each mixture is replaced with compound (I-3).

TABLE 5
Combination [(I-4) + (II-1A) to [(I-4) + (II-33)] or [(I-4) + (Z001)] to [(I-4) + (Z377)] are defined as
combination [(I-1) + (II-1A) to [(I-1) + (II-33)] or [(I-1) + (Z001)] to [(I-1) + (Z377)] of Table 2,
wherein compound (I-1) in each mixture is replaced with compound (I-4).

TABLE 6
Combination [(I-5) + (II-1A) to [(I-5) + (II-33)] or [(I-5) + (Z001)] to [(I-5) + (Z377)] are defined as
combination [(I-1) + (II-1A) to [(I-1) + (II-33)] or [(I-1) + (Z001)] to [(I-1) + (Z377)] of Table 2,
wherein compound (I-1) in each mixture is replaced with compound (I-5).

TABLE 7
Combination [(I-6) + (II-1A) to [(I-6) + (II-33)] or [(I-6) + (Z001)] to [(I-6) + (Z377)] are defined as
combination [(I-1) + (II-1A) to [(I-1) + (II-33)] or [(I-1) + (Z001)] to [(I-1) + (Z377)] of Table 2,
wherein compound (I-1) in each mixture is replaced with compound (I-6).

TABLE 8
Combination [(I-7) + (II-1A) to [(I-7) + (II-33)] or [(I-7) + (Z001)]
to [(I-7) + (Z377)] are defined as combination [(I-1) + (II-1A) to
[(I-1) + (II-33)] or [(I-1) + (Z001)] to [(I-1) + (Z377)] of Table 2,
wherein compound (I-1) in each mixture is replaced with compound (I-7).

TABLE 9
Combination [(I-8) + (II-1A) to [(I-8) + (II-33)] or [(I-8) + (Z001)] to
[(I-8) + (Z377)] are defined as combination [(I-1) + (II-1A) to
[(I-1) + (II-33)] or [(I-1) + (Z001)] to [(I-1) + (Z377)] of Table 2,
wherein compound (I-1) in each mixture is replaced with compound (I-8).

TABLE 10
Combination [(I-9) + (II-1A) to [(I-9) + (II-33)] or [(I-9) + (Z001)] to
[(I-9) + (Z377)] are defined as combination [(I-1) + (II-1A) to
[(I-1) + (II-33)] or [(I-1) + (Z001)] to [(I-1) + (Z377)] of Table 2,
wherein compound (I-1) in each mixture is replaced with compound (I-9).

TABLE 11
Combination [(I-10) + (II-1A) to [(I-10) + (II-33)] or [(I-10) + (Z001)] to
[(I-10) + (Z377)] are defined as combination [(I-1) + (II-1A) to
[(I-1) + (II-33)] or [(I-1) + (Z001)] to [(I-1) + (Z377)] of Table 2,
wherein compound (I-1) in each mixture is replaced with compound (I-10).

TABLE 12
Combination [(I-11) + (II-1A) to [(I-11) + (II-33)] or [(I-11) + (Z001)] to
[(I-11) + (Z377)] are defined as combination [(I-1) + (II-1A) to [(I-1) +
(II-33)] or [(I-1) + (Z001)] to [(I-1) + (Z377)] of Table 2, wherein
compound (I-1) in each mixture is replaced with compound (I-11).

Preferably, following combinations listed in Table-2, wherein, component (1) is compound (I-1) and component (2) selected from compounds (Z001) to (Z377) as defined herein.

(I-1)+Broflanilide (Z273), (I-1)+Bifenthrin (Z103), (I-1)+Emamectin benzoate (Z167), (I-1)+Indoxacarb (Z240), (I-1)+Fluxametamide (Z274), (I-1)+Spinosad (Z165), (I-1)+Spinetoram (Z164), (I-1)+Imidacloprid (Z151), (I-1)+Thiamethoxam (Z154), (I-1)+Clothianidin (Z149), (I-1)+Afidopyropen (Z190), (I-1)+Triflumezopyrim (Z161), (I-1)+Bacillus thuringiensis (Z195), (I-1)+Dimpropyridaz (Z317), (I-1)+Tyclopyrazoflor (Z318), (I-1)+Isocycloseram (Z275), (I-1)+Flometoquin (Z292), (I-1)+Fipronil (Z095), (I-1)+Pyridalyl (Z299), (I-1)+oxazosulfyl (Z243), (I-1)+Chlorfenapyr (Z203), (I-1)+Metaflumizone (Z241), (I-1)+Pyriproxyfen (Z174), (I-1)+Abamectin (Z166), (I-1)+Pymetrozine (Z188).

Following combinations listed in Table-13, wherein component (1) (compound of formula (I), a group represented by the expression “(I)” comprising of compounds I-1, I-2, I-3, I-4, I-5, I-6, I-7, I-8, I-9, I-10 and I-11) and component (2) is selected from the groups A) to P) as defined herein.

TABLE-13
(I) + (A001), (I) + (A002), (I) + (A003), (I) + (A004), (I) + (A005), (I) + (A006), (I) + (A007), (I) + (A008),
(I) + (A009), (I) + (A010), (I) + (A011), (I) + (A012), (I) + (A013), (I) + (A014), (I) + (A015), (I) + (A016),
(I) + (A017), (I) + (A018), (I) + (A019), (I) + (A020), (I) + (A021), (I) + (A022), (I) + (A023), (I) + (A024),
(I) + (A025), (I) + (A026), (I) + (A027), (I) + (A028), (I) + (A029), (I) + (A030), (I) + (A031), (I) + (A032),
(I) + (A033), (I) + (A034), (I) + (A035), (I) + (A036), (I) + (A037), (I) + (A038), (I) + (A039), (I) + (A040),
(I) + (A041), (I) + (A042), (I) + (A043), (I) + (A044), (I) + (A045), (I) + (A046), (I) + (A047), (I) + (A048),
(I) + (A049), (I) + (A050), (I) + (A051), (I) + (A052), (I) + (A053), (I) + (A054), (I) + (A055), (I) + (A056),
(I) + (A057), (I) + (A058), (I) + (A059), (I) + (A060), (I) + (A061), (I) + (A062), (I) + (A063), (I) + (A064),
(I) + (A065), (I) + (A066), (I) + (A067), (I) + (A068), (I) + (A069), (I) + (A070), (I) + (A071), (I) + (A072),
(I) + (A073), (I) + (A074), (I) + (A075), (I) + (A076), (I) + (A077), (I) + (A078), (I) + (A079), (I) + (A080),
(I) + (A081), (I) + (A082), (I) + (A083), (I) + (A084), (I) + (B001), (I) + (B002), (I) + (B003), (I) + (B004),
(I) + (B005), (I) + (B006), (I) + (B007), (I) + (B008), (I) + (B009), (I) + (B010), (I) + (B011), (I) + (B012),
(I) + (B013), (I) + (B014), (I) + (B015), (I) + (B016), (I) + (B017), (I) + (B018), (I) + (B019), (I) + (B020),
(I) + (B021), (I) + (B022), (I) + (B023), (I) + (B024), (I) + (B025), (I) + (B026), (I) + (B027), (I) + (B028),
(I) + (B029), (I) + (B030), (I) + (B031), (I) + (B032), (I) + (B033), (I) + (B034), (I) + (B035), (I) + (B036),
(I) + (B037), (I) + (B038), (I) + (B039), (I) + (B040), (I) + (B041), (I) + (B042), (I) + (B043), (I) + (B044),
(I) + (B045), (I) + (B046), (I) + (B047), (I) + (B048), (I) + (B049), (I) + (B050), (I) + (B051), (I) + (B052),
(I) + (B053), (I) + (B054), (I) + (B055), (I) + (B056), (I) + (B057), (I) + (B058), (I) + (B059), (I) + (B060),
(I) + (C001), (I) + (C002), (I) + (C003), (I) + (C004), (I) + (C005), (I) + (C006), (I) + (C007), (I) + (C008),
(I) + (C009), (I) + (C010), (I) + (C011), (I) + (C012), (I) + (C013), (I) + (C014), (I) + (C015), (I) + (C016),
(I) + (C017), (I) + (C018), (I) + (C019), (I) + (C020), (I) + (C021), (I) + (C022), (I) + (C023), (I) + (C024),
(I) + (C025), (I) + (C026), (I) + (C027), (I) + (C028), (I) + (C029), (I) + (C030), (I) + (D001), (I) + (D002),
(I) + (D003), (I) + (D004), (I) + (D005), (I) + (D006), (I) + (D007), (I) + (D008), (I) + (D009), (I) + (D010),
(I) + (D011), (I) + (D012), (I) + (D013), (I) + (D014), (I) + (D015), (I) + (D016), (I) + (D017), (I) + (D018),
(I) + (D019), (I) + (D020), (I) + (D021), (I) + (D022), (I) + (D023), (I) + (D024), (I) + (D025), (I) + (E001),
(I) + (E002), (I) + (E003), (I) + (E004), (I) + (E005), (I) + (E006), (I) + (E007), (I) + (E008), (I) + (E009),
(I) + (E010), (I) + (E011), (I) + (E012), (I) + (E013), (I) + (E014), (I) + (E015), (I) + (E016), (I) + (E017),
(I) + (E018), (I) + (E019), (I) + (E020), (I) + (E021), (I) + (E022), (I) + (E023), (I) + (F001), (I) + (F002),
(I) + (F003), (I) + (F004), (I) + (G001), (I) + (G002), (I) + (G003), (I) + (G004), (I) + (G005), (I) + (G006),
(I) + (H001), (I) + (I001), (I) + (I002), (I) + (I003), (I) + (I004), (I) + (I005), (I) + (I006), (I) + (I007),
(I) + (I008), (I) + (I009), (I) + (J001), (I) + (J002), (I) + (J003), (I) + (K001), (I) + (K002), (I) + (L001),
(I) + (L002), (I) + (L003), (I) + (L004), (I) + (M001), (I) + (M002), (I) + (M003), (I) + (M004), (I) + (M005),
(I) + (M006), (I) + (N001), (I) + (N002), (I) + (O001), (I) + (O002), (I) + (O003), (I) + (O004), (I) + (O005),
(I) + (O006), (I) + (O007), (I) + (O008), (I) + (O009), (I) + (O010), (I) + (O011), (I) + (O012), (I) + (O013),
(I) + (O014), (I) + (O015), (I) + (O016), (I) + (O017), (I) + (O018), (I) + (O019), (I) + (O020), (I) + (O021),
(I) + (O022), (I) + (O023), (I) + (O024), (I) + (O025), (I) + (O026), (I) + (O027), (I) + (O028), (I) + (O029),
(I) + (O030), (I) + (O031), (I) + (O032), (I) + (O033), (I) + (O034), (I) + (O035), (I) + (O036), (I) + (O037),
(I) + (O038), (I) + (O039), (I) + (O040), (I) + (O041), (I) + (O042), (I) + (O043), (I) + (O044), (I) + (O045),
(I) + (O046), (I) + (O047), (I) + (O048), (I) + (O049), (I) + (O050), (I) + (O051), (I) + (O052), (I) + (O053),
(I) + (O054), (I) + (O055), (I) + (O056), (I) + (O057), (I) + (O058), (I) + (O059), (I) + (O060), (I) + (O061),
(I) + (O062), (I) + (O063), (I) + (O064), (I) + (O065), (I) + (O066) (I) + (P001), (I) + (P002), (I) + (P003),
(I) + (P004), (I) + (P005), (I) + (P006), (I) + (P007), (I) + (P008), (I) + (P009), (I) + (P010), (I) + (P011),
(I) + (P012), (I) + (P013), (I) + (P014), (I) + (P015), (I) + (P016), (I) + (P017), (I) + (P018), (I) + (P019),
(I) + (P020), (I) + (P021), (I) + (P022), (I) + (P023), (I) + (P024), (I) + (P025), (I) + (P026), (I) + (P027),
(I) + (P028), (I) + (P029), (I) + (P030), (I) + (P031), (I) + (P032), (I) + (P033), (I) + (P034), (I) + (P035),
(I) + (P036), (I) + (P037), (I) + (P038), (I) + (P039), (I) + (P040), (I) + (P041), (I) + (P042), (I) + (P043),
(I) + (P044), (I) + (P045), (I) + (P046), (I) + (P047), (I) + (P048), (I) + (P049), (I) + (P050), (I) + (P051),
(I) + (P052), (I) + (P053), (I) + (P054), (I) + (P055), (I) + (P056), (I) + (P057), (I) + (P058), (I) + (P059),
(I) + (P060), (I) + (P061), (I) + (P062), (I) + (P063), (I) + (P064), (I) + (P065), (I) + (P066), (I) + (P067),
(I) + (P068), (I) + (P069), (I) + (P070), (I) + (P071), (I) + (P072), (I) + (P073), (I) + (P074), (I) + (P075),
(I) + (P076), (I) + (P077), (I) + (P078), (I) + (P079), (I) + (P080), (I) + (P081), (I) + (P082), (I) + (P083),
(I) + (P084), (I) + (P085), (I) + (P086), (I) + (P087), (I) + (P088), (I) + (P089), (I) + (P090), (I) + (P091),
(I) + (P092), (I) + (P093), (I) + (P094), (I) + (P095), (I) + (P096), (I) + (P097), (I) + (P098), (I) + (P099),
(I) + (P100), (I) + (P101), (I) + (P102), (I) + (P103).

In one embodiment the weight ratio of component (1) to component (2) is between 500:1 and 1:500 in combinations [(I)+(A001] to [(I)+(P103)] of Table: 13.

In one embodiment the weight ratio of component (1) to component (2) is between 100:1 and 1:100 in combinations [(I)+(A001] to [(I)+(P103)] of Table: 13.

In one embodiment the weight ratio of component (1) to component (2) is between 50:1 and 1:50 in combinations [(I)+(A001] to [(I)+(P103)] of Table: 13.

In one embodiment the weight ratio of component (1) to component (2) is between 20:1 and 1:20 in combinations [(I)+(A001] to [(I)+(P103)] of Table: 13.

In one embodiment the weight ratio of component (1) to component (2) is between 5:1 and 1:5 in combinations [(I)+(A001] to [(I)+(P103)] of Table: 13.

In one embodiment the weight ratio of component (1) to component (2) is between 3:1 and 1:3 in combinations [(I)+(A001] to [(I)+(P103)] of Table: 13.

In one embodiment the weight ratio of component (1) to component (2) is between 2:1 and 1:2 in combinations [(I)+(A001] to [(I)+(P103)] of Table: 13.

In one embodiment the weight ratio of component (1) to component (2) is 1:1 in combinations [(I)+(A001] to [(I)+(P103)] of Table: 13.

Following combinations listed in Table-14, wherein, component (1) is compound (I-1) and component (2) selected from the groups A) to P) as defined herein.

TABLE 14
(I-1) + (A001), (I-1) + (A002), (I-1) + (A003), (I-1) + (A004), (I-1) + (A005), (I-1) + (A006), (I-1) + (A007),
(I-1) + (A008), (I-1) + (A009), (I-1) + (A010), (I-1) + (A011), (I-1) + (A012), (I-1) + (A013), (I-1) + (A014),
(I-1) + (A015), (I-1) + (A016), (I-1) + (A017), (I-1) + (A018), (I-1) + (A019), (I-1) + (A020), (I-1) + (A021),
(I-1) + (A022), (I-1) + (A023), (I-1) + (A024), (I-1) + (A025), (I-1) + (A026), (I-1) + (A027), (I-1) + (A028),
(I-1) + (A029), (I-1) + (A030), (I-1) + (A031), (I-1) + (A032), (I-1) + (A033), (I-1) + (A034), (I-1) + (A035),
(I-1) + (A036), (I-1) + (A037), (I-1) + (A038), (I-1) + (A039), (I-1) + (A040), (I-1) + (A041), (I-1) + (A042),
(I-1) + (A043), (I-1) + (A044), (I-1) + (A045), (I-1) + (A046), (I-1) + (A047), (I-1) + (A048), (I-1) + (A049),
(I-1) + (A050), (I-1) + (A051), (I-1) + (A052), (I-1) + (A053), (I-1) + (A054), (I-1) + (A055), (I-1) + (A056),
(I-1) + (A057), (I-1) + (A058), (I-1) + (A059), (I-1) + (A060), (I-1) + (A061), (I-1) + (A062), (I-1) + (A063),
(I-1) + (A064), (I-1) + (A065), (I-1) + (A066), (I-1) + (A067), (I-1) + (A068), (I-1) + (A069), (I-1) + (A070),
(I-1) + (A071), (I-1) + (A072), (I-1) + (A073), (I-1) + (A074), (I-1) + (A075), (I-1) + (A076), (I-1) + (A077),
(I-1) + (A078), (I-1) + (A079), (I-1) + (A080), (I-1) + (A081), (I-1) + (A082), (I-1) + (A083), (I-1) + (A084),
(I-1) + (B001), (I-1) + (B002), (I-1) + (B003), (I-1) + (B004), (I-1) + (B005), (I-1) + (B006), (I-1) + (B007),
(I-1) + (B008), (I-1) + (B009), (I-1) + (B010), (I-1) + (B011), (I-1) + (B012), (I-1) + (B013), (I-1) + (B014),
(I-1) + (B015), (I-1) + (B016), (I-1) + (B017), (I-1) + (B018), (I-1) + (B019), (I-1) + (B020), (I-1) + (B021),
(I-1) + (B022), (I-1) + (B023), (I-1) + (B024), (I-1) + (B025), (I-1) + (B026), (I-1) + (B027), (I-1) + (B028),
(I-1) + (B029), (I-1) + (B030), (I-1) + (B031), (I-1) + (B032), (I-1) + (B033), (I-1) + (B034), (I-1) + (B035),
(I-1) + (B036), (I-1) + (B037), (I-1) + (B038), (I-1) + (B039), (I-1) + (B040), (I-1) + (B041), (I-1) + (B042),
(I-1) + (B043), (I-1) + (B044), (I-1) + (B045), (I-1) + (B046), (I-1) + (B047), (I-1) + (B048), (I-1) + (B049),
(I-1) + (B050), (I-1) + (B051), (I-1) + (B052), (I-1) + (B053), (I-1) + (B054), (I-1) + (B055), (I-1) + (B056),
(I-1) + (B057), (I-1) + (B058), (I-1) + (B059), (I-1) + (B060), (I-1) + (C001), (I-1) + (C002), (I-1) + (C003),
(I-1) + (C004), (I-1) + (C005), (I-1) + (C006), (I-1) + (C007), (I-1) + (C008), (I-1) + (C009), (I-1) + (C010),
(I-1) + (C011), (I-1) + (C012), (I-1) + (C013), (I-1) + (C014), (I-1) + (C015), (I-1) + (C016), (I-1) + (C017),
(I-1) + (C018), (I-1) + (C019), (I-1) + (C020), (I-1) + (C021), (I-1) + (C022), (I-1) + (C023), (I-1) + (C024),
(I-1) + (C025), (I-1) + (C026), (I-1) + (C027), (I-1) + (C028), (I-1) + (C029), (I-1) + (C030), (I-1) + (D001),
(I-1) + (D002), (I-1) + (D003), (I-1) + (D004), (I-1) + (D005), (I-1) + (D006), (I-1) + (D007), (I-1) + (D008),
(I-1) + (D009), (I-1) + (D010), (I-1) + (D011), (I-1) + (D012), (I-1) + (D013), (I-1) + (D014), (I-1) + (D015),
(I-1) + (D016), (I-1) + (D017), (I-1) + (D018), (I-1) + (D019), (I-1) + (D020), (I-1) + (D021), (I-1) + (D022),
(I-1) + (D023), (I-1) + (D024), (I-1) + (D025), (I-1) + (E001), (I-1) + (E002), (I-1) + (E003), (I-1) + (E004),
(I-1) + (E005), (I-1) + (E006), (I-1) + (E007), (I-1) + (E008), (I-1) + (E009), (I-1) + (E010), (I-1) + (E011), (I-
1) + (E012), (I-1) + (E013), (I-1) + (E014), (I-1) + (E015), (I-1) + (E016), (I-1) + (E017), (I-1) + (E018), (I-
1) + (E019), (I-1) + (E020), (I-1) + (E021), (I-1) + (E022), (I-1) + (E023), (I-1) + (F001), (I-1) + (F002), (I-
1) + (F003), (I-1) + (F004), (I-1) + (G001), (I-1) + (G002), (I-1) + (G003), (I-1) + (G004), (I-1) + (G005), (I-
1) + (G006), (I-1) + (H001), (I-1) + (I001), (I-1) + (I002), (I-1) + (I003), (I-1) + (I004), (I-1) + (I005), (I-
1) + (I006), (I-1) + (I007), (I-1) + (I008), (I-1) + (I009), (I-1) + (J001), (I-1) + (J002), (I-1) + (J003), (I-
1) + (K001), (I-1) + (K002), (I-1) + (L001), (I-1) + (L002), (I-1) + (L003), (I-1) + (L004), (I-1) + (M001), (I-
1) + (M002), (I-1) + (M003), (I-1) + (M004), (I-1) + (M005), (I-1) + (M006), (I-1) + (N001), (I-1) + (N002),
(I-1) + (O001), (I-1) + (O002), (I-1) + (O003), (I-1) + (O004), (I-1) + (O005), (I-1) + (O006), (I-1) + (O007),
(I-1) + (O008), (I-1) + (O009), (I-1) + (O010), (I-1) + (O011), (I-1) + (O012), (I-1) + (O013), (I-1) + (O014),
(I-1) + (O015), (I-1) + (O016), (I-1) + (O017), (I-1) + (O018), (I-1) + (O019), (I-1) + (O020), (I-1) + (O021),
(I-1) + (O022), (I-1) + (O023), (I-1) + (O024), (I-1) + (O025), (I-1) + (O026), (I-1) + (O027), (I-1) + (O028),
(I-1) + (O029), (I-1) + (O030), (I-1) + (O031), (I-1) + (O032), (I-1) + (O033), (I-1) + (O034), (I-1) + (O035),
(I-1) + (O036), (I-1) + (O037), (I-1) + (O038), (I-1) + (O039), (I-1) + (O040), (I-1) + (O041), (I-1) + (O042),
(I-1) + (O043), (I-1) + (O044), (I-1) + (O045), (I-1) + (O046), (I-1) + (O047), (I-1) + (O048), (I-1) + (O049),
(I-1) + (O050), (I-1) + (O051), (I-1) + (O052), (I-1) + (O053), (I-1) + (O054), (I-1) + (O055), (I-1) + (O056),
(I-1) + (O057), (I-1) + (O058), (I-1) + (O059), (I-1) + (O060), (I-1) + (O061), (I-1) + (O062), (I-1) + (O063),
(I-1) + (O064), (I-1) + (O065), (I-1) + (O066) (I-1) + (P001), (I-1) + (P002), (I-1) + (P003), (I-1) + (P004), (I-
1) + (P005), (I-1) + (P006), (I-1) + (P007), (I-1) + (P008), (I-1) + (P009), (I-1) + (P010), (I-1) + (P011), (I-
1) + (P012), (I-1) + (P013), (I-1) + (P014), (I-1) + (P015), (I-1) + (P016), (I-1) + (P017), (I-1) + (P018), (I-
1) + (P019), (I-1) + (P020), (I-1) + (P021), (I-1) + (P022), (I-1) + (P023), (I-1) + (P024), (I-1) + (P025), (I-
1) + (P026), (I-1) + (P027), (I-1) + (P028), (I-1) + (P029), (I-1) + (P030), (I-1) + (P031), (I-1) + (P032), (I-
1) + (P033), (I-1) + (P034), (I-1) + (P035), (I-1) + (P036), (I-1) + (P037), (I-1) + (P038), (I-1) + (P039), (I-
1) + (P040), (I-1) + (P041), (I-1) + (P042), (I-1) + (P043), (I-1) + (P044), (I-1) + (P045), (I-1) + (P046), (I-
1) + (P047), (I-1) + (P048), (I-1) + (P049), (I-1) + (P050), (I-1) + (P051), (I-1) + (P052), (I-1) + (P053), (I-
1) + (P054), (I-1) + (P055), (I-1) + (P056), (I-1) + (P057), (I-1) + (P058), (I-1) + (P059), (I-1) + (P060), (I-
1) + (P061), (I-1) + (P062), (I-1) + (P063), (I-1) + (P064), (I-1) + (P065), (I-1) + (P066), (I-1) + (P067), (I-
1) + (P068), (I-1) + (P069), (I-1) + (P070), (I-1) + (P071), (I-1) + (P072), (I-1) + (P073), (I-1) + (P074), (I-
1) + (P075), (I-1) + (P076), (I-1) + (P077), (I-1) + (P078), (I-1) + (P079), (I-1) + (P080), (I-1) + (P081), (I-
1) + (P082), (I-1) + (P083), (I-1) + (P084), (I-1) + (P085), (I-1) + (P086), (I-1) + (P087), (I-1) + (P088), (I-
1) + (P089), (I-1) + (P090), (I-1) + (P091), (I-1) + (P092), (I-1) + (P093), (I-1) + (P094), (I-1) + (P095), (I-
1) + (P096), (I-1) + (P097), (I-1) + (P098), (I-1) + (P099), (I-1) + (P100), (I-1) + (P101), (I-1) + (P102), (I-
1) + (P103).

TABLE 15
Combination [(I-2) + (A001] to [(I-2) + (P103)] are defined as
combination [(I-1) + (A001] to [(I-1) + (P103)] of Table 14, wherein
compound (I-1) in each mixture is replaced with compound (I-2).

TABLE 16
Combination [(I-3) + (A001] to [(I-3) + (P103)] are defined as
combination [(I-1) + (A001] to [(I-1) + (P103)] of Table 14, wherein
compound (I-1) in each mixture is replaced with compound (I-3).

TABLE 17
Combination [(I-4) + (A001] to [(I-4) + (P103)] are defined as
combination [(I-1) + (A001] to [(I-1) + (P103)] of Table 14, wherein
compound (I-1) in each mixture is replaced with compound (I-4).

TABLE 18
Combination [(I-5) + (A001] to [(I-5) + (P103)] are defined as
combination [(I-1) + (A001] to [(I-1) + (P103)] of Table 14, wherein
compound (I-1) in each mixture is replaced with compound (I-5).

TABLE 19
Combination [(I-6) + (A001] to [(I-6) + (P103)] are defined as
combination [(I-1) + (A001] to [(I-1) + (P103)] of Table 14, wherein
compound (I-1) in each mixture is replaced with compound (I-6).

TABLE 20
Combination [(I-7) + (A001] to [(I-7) + (P103)] are defined as
combination [(I-1) + (A001] to [(I-1) + (P103)] of Table 14, wherein
compound (I-1) in each mixture is replaced with compound (I-7).

TABLE 21
Combination [(I-8) + (A001] to [(I-7) + (P103)] are defined as
combination [(I-1) + (A001] to [(I-1) + (P103)] of Table 14, wherein
compound (I-1) in each mixture is replaced with compound (I-8).

TABLE 22
Combination [(I-9) + (A001] to [(I-9) + (P103)] are defined as
combination [(I-1) + (A001] to [(I-1) + (P103)] of Table 14, wherein
compound (I-1) in each mixture is replaced with compound (I-9).

TABLE 23
Combination [(I-10) + (A001] to [(I-10) + (P103)] are defined as
combination [(I-1) + (A001] to [(I-1) + (P103)] of Table 14, wherein
compound (I-1) in each mixture is replaced with compound (I-10).

TABLE 24
Combination [(I-11) + (A001] to [(I-11) + (P103)] are defined as
combination [(I-1) + (A001] to [(I-1) + (P103)] of Table 14, wherein
compound (I-1) in each mixture is replaced with compound (I-11).

Following combinations listed in Table-14, wherein, component (1) is compound (I-1) and component (2) selected from the groups A) to P) as defined herein.

(I-1)+(A001) cyproconazole, (I-1)+(A002) difenoconazole, (I-1)+(A004) tetraconazol, (I-1)+(A006) fenpropimorph, (I-1)+(A009) flutriafol, (I-1)+(A013) metconazole, (I-1)+(A017) propiconazole, (I-1)+(A018) prothioconazole, (I-1)+(A021) tebuconazole, (I-1)+(A022) epoxiconazole, (I-1)+(A081) mefentrifluconazole, (I-1)+(B001) benzovindiflupyr, (I-1)+(B002) bixafen, (I-1)+(B005) fluopyram, (I-1)+(B007) fluxapyroxad, (I-1)+(B019) pydiflumetofen, (I-1)+(B30) fluindapyr, (I-1)+(B038) isoflucypram, (I-1)+(B059) inpyrfluxam, (I-1)+(C003) azoxystrobin, (I-1)+(C012) fluoxastrobin (I-1)+(C014) metominostrobin, (I-1)+(C017) pyraclostrobin, (I-1)+(C016) picoxystrobin, (I-1)+(C020) trifloxystrobin, (I-1)+(C025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl-2-methylpropanoate (Fenpicoxamid), (I-1)+(C030) 1-(2-{[1-(4-chlorophenyl)pyrazol-3-yl]oxymethyl}-3-methylphenyl)-1,4-dihydro-4-methyl-5H-tetrazol-5-one (Metyltetraprole), (I-1)+(D001) carbendazim, (I-1)+(D007) thiophanate-methyl, (I-1)+(E004) chlorothalonil, (I-1)+(E010) dithianon, (I-1)+(E013) mancozeb, (I-1)+(E020) thiram, (I-1)+(F002) Isotianil, (I-1)+(F003) Probenazole (L003) metalaxyl, (I-1)+(M001) fludioxonil, (I-1)+(N001) fluazinam, (I-1)+(O022) Oxathiapiprolin, (I-1)+(O043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate (fluoxapiprolin), (I-1)+(O046) 3-(4,4,5-trifluoro-3,3-dimethyl-3,4-dihydroisoquinolin-1-yl)quinoline, (I-1)+(O047) 3-(4,4-difluoro-3,3-dimethyl-3,4-dihydroisoquinolin-1-yl)quinoline (Quinofumelin), (I-1)+(O065) ipflufenoquin, and (I-1)+(P094) N-(2-fluorophenyl)-4-[5-(trifluoromethyl)-1,2,4-oxadiazol-3-yl]benzamide.

Preferably, following combinations listed in Table-14, wherein, component (1) is compound (I-1) and component (2) selected from the groups A) to P) as defined herein.

(I-1)+(C003), (I-1)+(C017), (I-1)+(L003), (I-1)+(D007), (I-1)+(B007), (I-1)+(M001), (I-1)+(F003), (I-1)+(F002), (I-1)+(B005).

In another embodiment, the mixture according to the invention is a mixture of one active compound of formula (I) with at least one active component (2).

In another embodiment, the mixture according to the invention is a mixture of one active compound of formula (I) with two active components (2) as compound (II) or with two active components (2) as compound (III), or with one active component (2) as compound (II) and a further active component (2), e.g. selected from compound (III), as described herein (ternary mixture).

In another embodiment, the mixture according to the invention is a mixture of one active compound of formula (I) with three active components (2), or with three active compounds selected from group compound (II) and compound (III), wherein at least one compound is selected from Compound (II) (4-way mixture).

The compounds of formula (I) can be obtained by various routes in analogy to processes and examples disclosed in WO2019150220.

The mixtures according to the present invention are in particular suitable for efficiently controlling arthropodal pests such as arachnids, myriapedes, insects and nematodes.

Insects, Arachnids and Nematodes

The mixtures according to the present invention are especially suitable for efficiently combating the following pests:

Insects from the order of the lepidopterans (Lepidoptera), for example Acronicta major, Adoxophyes orana, Aedia leucomelas, Agrotis spp. such as Agrotis fucosa, Agrotis segetum, Agrotis ipsilon; Alabama argillacea, Anticarsia gemmatalis, Anticarsia spp., Argyresthia conjugella, Autographa gamma, Barathra brassicae, Bucculatrix thurberiella, Bupalus piniarius, Cacoecia murinana, Cacoecia podana, Capua reticulana, Carpocapsa pomonella, Cheimatobia brumata, Chilo spp. such as Chilo suppressalis; Choristoneura fumiferana, Choristoneura occidentalis, Cirphis unipuncta, Clysia ambiguella, Cnaphalocerus spp., Cydia pomonella, Dendrolimus pini, Diaphania nitidalis, Diatraea grandiosella, Earias insulana, Elasmopalpus lignosellus, Ephestia cautella, Ephestia kuehniella, Eupoecilia ambiguella, Euproctis chrysorrhoea, Euxoa spp., Evetria bouliana, Feltia spp. such as Feltia subterranean; Galleria mellonella, Grapholitha funebrana, Grapholitha molesta, Helicoverpa spp. such as Helicoverpa armigera, Helicoverpa zea; Heliothis spp. such as Heliothis armigera, Heliothis virescens, Heliothis zea; Hellula undalis, Hibernia defoliaria, Hofinannophila pseudospretella, Homona magnanima, Hyphantria cunea, Hyponomeuta padella, Hyponomeuta malinellus, Keiferia lycopersicella, Lambdina fiscellaria, Laphygma spp. such as Laphygma exigua; Leucoptera coffeella, Leucoptera scitella, Lithocolletis blancardella, Lithophane antennata, Lobesia botrana, Loxagrotis albicosta, Loxostege sticticalis, Lymantria spp. such as Lymantria dispar, Lymantria monacha; Lyonetia clerkella, Malacosoma neustria, Mamestra spp. such as Mamestra brassicae; Mocis repanda, Mythimna separata, Orgyia pseudotsugata, Oria spp., Ostrinia spp. such as Ostrinia nubilalis; Oulema oryzae, Panolis flammea, Pectinophora spp. such as Pectinophora gossypiella; Peridroma saucia, Phalera bucephala, Phthorimaea spp. such as Phthorimaea operculella; Phyllocnistis citrella, Pieris spp. such as Pieris brassicae, Pieris rapae; Plathypena scabra, Plutella maculipennis, Plutella xylostella, Prodenia spp., Pseudaletia spp., Pseudoplusia includens, Pyrausta nubilalis, Rhyacionia frustrana, Scrobipalpula absoluta, Sitotroga cerealella, Sparganothis pilleriana, Spodoptera spp. such as Spodoptera frugiperda, Spodoptera littoralis, Spodoptera litura; Thaumatopoea pityocampa, Thermesia gemmatalis, Tinea pellionella, Tineola bisselliella, Tortrix viridana, Trichoplusia spp. such as Trichoplusia ni; Tuta absoluta, and Zeiraphera canadensis, beetles (Coleoptera), for example Acanthoscehdes obtectus, Adoretus spp., Agelastica alni, Agrilus sinuatus, Agriotes spp. such as Agriotes fuscicollis, Agriotes lineatus, Agriotes obscurus; Amphimallus solstitialis, Anisandrus dispar, Anobium punctatum, Anomala rufocuprea, Anoplophora spp. such as Anoplophora glabripennis; Anthonomus spp. such as Anthonomus grandis, Anthonomus pomorum; Anthrenus spp., Aphthona euphoridae, Apogonia spp., Athous haemorrhoidalis, Atomaria spp. such as Atomaria linearis; Attagenus spp., Aulacophora femoralis, Blastophagus piniperda, Blitophaga undata, Bruchidius obtectus, Bruchus spp. such as Bruchus lentis, Bruchus pisorum, Bruchus rufimanus; Byctiscus betulae, Callosobruchus chinensis, Cassida nebulosa, Cerotoma trifurcata, Cetonia aurata, Ceuthorhynchus spp. such as Ceuthorrhynchus assimilis, Ceuthorrhynchus napi; Chaetocnema tibialis, Cleonus mendicus, Conoderus spp. such as Conoderus vespertinus; Cosmopolites spp., Costelytra zealandica, Crioceris asparagi, Cryptorhynchus lapathi, Ctenicera ssp. such as Ctenicera destructor; Curculio spp., Dectes texanus, Dermestes spp., Diabrotica spp. such as Diabrotica 12-punctata Diabrotica speciosa, Diabrotica Iongicornis, Diabrotica semipunctata, Diabrotica virgifera; Epilachna spp. such as Epilachna varivestis, Epilachna vigintioctomaculata; Epitrix spp. such as Epitrix hirtipennis; Eutinobothrus brasiliensis, Faustinus cubae, Gibbium psylloides, Heteronychus arator, Hylamorpha elegans, Hylobius abietis, Hylotrupes bajulus, Hypera brunneipennis, Hypera postica, Hypothenemus spp., Ips typographus, Lachnosterna consanguinea, Lema bilineata, Lema melanopus, Leptinotarsa spp. such as Leptinotarsa decemlineata; Limonius californicus, Lissorhoptrus oryzophilus, Lissorhoptrus oryzophilus, Lixus spp., Lyctus spp. such as Lyctus bruneus; Melanotus communis, Meligethes spp. such as Meligethes aeneus; Melolontha hippocastani, Melolontha melolontha, Migdolus spp., Monochamus spp. such as Monochamus alternatus; Naupactus xanthographus, Niptus hololeucus, Oryctes rhinoceros, Oryzaephilus surinamensis, Otiorrhynchus sulcatus, Otiorrhynchus ovatus, Otiorrhynchus sulcatus, Oulema oryzae, Oxycetonia jucunda, Phaedon cochleariae, Phyllobius pyri, Phyllopertha horticola, Phyllophaga spp., Phyllotreta spp. such as Phyllotreta chrysocephala, Phyllotreta nemorum, Phyllotreta striolata; Phyllophaga spp., Phyllopertha horticola, Popillia japonica, Premnotrypes spp., Psylliodes chrysocephala, Ptinus spp., Rhizobius ventralis, Rhizopertha dominica, Sitona lineatus, Sitophilus spp. such as Sitophilus granaria, Sitophilus zeamais; Sphenophorus spp. such as Sphenophorus levis; Stemechus spp. such as Stemechus subsignatus; Symphyletes spp., Tenebrio molitor, Tribolium spp. such as Tribolium castaneum; Trogoderma spp., Tychius spp., Xylotrechus spp., and Zabrus spp. such as Zabrus tenebrioides, flies, mosquitoes (Diptera), e.g. Aedes spp. such as Aedes aegypti, Aedes albopictus, Aedes vexans; Anastrepha ludens, Anopheles spp. such as Anopheles albimanus, Anopheles crucians, Anopheles freeborni, Anopheles gambiae, Anopheles leucosphyrus, Anopheles maculipennis, Anopheles minimus, Anopheles quadrimaculatus, Anopheles sinensis; Bibio hortulanus, Calliphora erythrocephala, Calliphora vicina, Cerafitis capitata, Ceratitis capitata, Chrysomyia spp. such as Chrysomya bezziana, Chrysomya hominivorax, Chrysomya macellaria; Chrysops atlanticus, Chrysops discalis, Chrysops silacea, Cochliomyia spp. such as Cochliomyia hominivorax; Contarinia spp. such as Contarinia sorghicola; Cordylobia anthropophaga, Culex spp. such as Culex nigripalpus, Culex pipiens, Culex quinquefasciatus, Culex tarsalis, Culex tritaeniorhynchus; Culicoides furens, Culiseta inornata, Culiseta melanura, Cuterebra spp., Dacus cucurbitae, Dacus oleae, Dasineura brassicae, Delia spp. such as Delia antique, Delia coarctata, Delia platura, Delia radicum; Dermatobia hominis, Drosophila spp., Fannia spp. such as Fannia canicularis; Gastraphilus spp. such as Gasterophilus intestinalis; Geomyza Tripunctata, Glossina fuscipes, Glossina morsitans, Glossina palpalis, Glossina tachinoides, Haematobia irritans, Haplodiplosis equestris, Hippelates spp., Hylemyia spp. such as Hylemyia platura; Hypoderma spp. such as Hypoderma lineata; Hyppobosca spp., Leptoconops torrens, Liriomyza spp. such as Liriomyza sativae, Liriomyza trifolii; Lucilia spp. such as Lucilia caprina, Lucilia cuprina, Lucilia sericata; Lycoria pectoralis, Mansonia titillanus, Mayetiola spp. such as Mayetiola destructor; Musca spp. such as Musca autumnalis, Musca domestica; Muscina stabulans, Oestrus spp. such as Oestrus ovis; Opomyza florum, Oscinella spp. such as Oscinella frit; Pegomya hysocyami, Phlebotomus argentipes, Phorbia spp. such as Phorbia antiqua, Phorbia brassicae, Phorbia coarctata; Prosimulium mixtum, Psila rosae, Psorophora columbiae, Psorophora discolor, Rhagoletis cerasi, Rhagoletis pomonella, Sarcophaga spp. such as Sarcophaga haemorrhoidalis; Simulium vittatum, Stomoxys spp. such as Stomoxys calcitrans; Tabanus spp. such as Tabanus atratus, Tabanus bovinus, Tabanus lineola, Tabanus similis; Tannia spp., Tipula oleracea, Tipula paludosa, and Wohlfahrtia spp., thrips (Thysanoptera), e.g. Baliothrips biformis, Dichromothrips corbetti, Dichromothrips ssp., Enneothrips flavens, Frankliniella spp. such as Frankliniella fusca, Frankliniella occidentalis, Frankliniella tritici; Heliothrips spp., Hercinothrips femoralis, Kakothrips spp., Rhipiphorothrips cruentatus, Scirtothrips spp. such as Scirtothrips citri; Taeniothrips cardamoni, Thrips spp. such as Thrips olyzae, Thrips palmi, Thrips tabaci; termites (Isoptera), e.g. Calotermes flavicollis, Coptotermes formosanus, Heterotermes aureus, Heterotermes Iongiceps, Heterotermes tenuis, Leucotermes flavipes, Odontotermes spp., Reticulitermes spp. such as Reticulitermes speratus, Reticulitermes flavipes, Reticulitermes grassei, Reticulitermes lucifugus, Reticulitermes santonensis, Reticulitermes virginicus; Termes natalensis, cockroaches (Blattaria-Blattodea), e.g. Acheta domesticus, Blatta orientalis, Blattella asahinae, Blattella germanica, Gryllotalpa spp., Leucophaea maderae, Locusta spp., Melanoplus spp., Periplaneta americana, Periplaneta australasiae, Periplaneta brunnea, Periplaneta fuligginosa, Periplaneta japonica, bugs, aphids, leafhoppers, whiteflies, scale insects, cicadas (Hemiptera), e.g. Acrosternum spp. such as Acrosternum hilare; Acyrthosiphon spp. such as Acyrthosiphon onobrychis, Acyrthosiphon pisum; Adelges laricis, Aeneolamia spp., Agonoscena spp., Aleurodes spp., Aleurolobus barodensis, Aleurothrixus spp., Amrasca spp., Anasa tristis, Antestiopsis spp., Anuraphis cardui, Aonidiella spp., Aphanostigma piri, Aphidula nasturtii, Aphis spp. such as Aphis fabae, Aphis forbesi, Aphis gossypii, Aphis grossulariae, Aphis pomi, Aphis sambuci, Aphis schneideri, Aphis spiraecola; Arboridia apicalis, Arilus critatus, Aspidiella spp., Aspidiotus spp., Atanus spp., Aulacorthum solani, Bemisia spp. such as Bemisia argentifolii, Bemisia tabaci; Blissus spp. such as Blissus leucopterus; Brachycaudus cardui, Brachycaudus helichrysi, Brachycaudus persicae, Brachycaudus prunicola, Brachycolus spp., Brevicoryne brassicae, Calligypona marginata, Calocoris spp., Campylomma livida, Capitophorus horni, Carneocephala fulgida, Cavelerius spp., Ceraplastes spp., Ceratovacuna lanigera, Cercopidae, Cerosipha gossypii, Chaetosiphon fragaefolii, Chionaspis tegalensis, Chlorita onukii, Chromaphis juglandicola, Chrysomphalus ficus, Cicadulina mbila, Cimex spp. such as Cimex hemipterus, Cimex lectularius; Coccomytilus halli, Coccus spp., Creontiades dilutus, Cryptomyzus ribis, Cryptomyzus ribis, Cyrtopeltis notatus, Dalbulus spp., Dasynus piperis, Dialeurades spp., Diaphorina spp., Diaspis spp., Dichelops furcatus, Diconocoris hewetti, Doralis spp., Dreyfusia nordmannianae, Dreyfusia piceae, Drosicha spp., Dysaphis spp. such as Dysaphis plantaginea, Dysaphis pyri, Dysaphis radicola; Dysaulacorthum pseudosolani, Dysdercus spp. such as Dysdercus cingulatus, Dysdercus intermedius; Dysmicoccus spp., Empoasca spp. such as Empoasca fabae, Empoasca solana; Eriosoma spp., Eiythroneura spp., Einygaster spp. such as Einygaster integriceps; Euscelis bilobatus, Euschistus spp. such as Euschistuos heros, Euschistus impictiventris, Euschistus servus; Geococcus coffeae, Halyomorpha spp. such as Halyomorpha halys; Heliopeltis spp., Homalodisca coagulata, Horcias nobilellus, Hyalopterus pruni, Hyperomyzus lactucae, Iceiya spp., Idiocerus spp., Idioscopus spp., Laodelphax striatellus, Lecanium spp., Lepidosaphes spp., Leptocorisa spp., Leptoglossus phyllopus, Lipaphis eiysimi, Lygus spp. such as Lygus hesperus, Lygus lineolaris, Lygus pratensis; Macropes excavatus, Macrosiphum spp. such as Macrosiphum rosae, Macrosiphum avenae, Macrosiphum euphorbiae; Mahanarva fimbriolata, Megacopta cribraria, Megoura viciae, Melanaphis pyrarius, Melanaphis sacchari, Metcafiella spp., Metopolophium dirhodum, Miridae spp., Monellia costalis, Monelliopsis pecanis, Myzus spp. such as Myzus ascalonicus, Myzus cerasi, Myzus persicae, Myzus varians; Nasonovia ribis-nigri, Nephotettix spp. such as Nephotettix malayanus, Nephotettix nigropictus, Nephotettix parvus, Nephotettix virescens; Nezara spp. such as Nezara viridula; Nilaparvata lugens, Oebalus spp., Oncometopia spp., Orthezia praelonga, Parabemisia myricae, Paratrioza spp., Parlatoria spp., Pemphigus spp. such as Pemphigus bursarius; Pentomidae, Peregrinus maidis, Perkinsiella saccharicida, Phenacoccus spp., Phloeomyzus passerinii, Phorodon humuli, Phylloxera spp., Piesma quadrata, Piezodorus spp. such as Piezodorus guildinii, Pinnaspis aspidistrae, Planococcus spp., Protopulvinaria pyriformis, Psallus seriatus, Pseudacysta persea, Pseudaulacaspis pentagona, Pseudococcus spp. such as Pseudococcus comstocki; Psylla spp. such as Psylla mali, Psylla piri; Pteromalus spp., Pyrilla spp., Quadraspidiotus spp., Quesada gigas, Rastrococcus spp., Reduvius senilis, Rhodnius spp., Rhopalomyzus ascalonicus, Rhopalosiphum spp. such as Rhopalosiphum pseudobrassicas, Rhopalosiphum insertum, Rhopalosiphum maidis, Rhopalosiphum padi; Sagatodes spp., Sahlbergella singularis, Saissetia spp., Sappaphis mala, Sappaphis mali, Scaphoides titanus, Schizaphis graminum, Schizoneura lanuginosa, Scotinophora spp., Selenaspidus articulatus, Sitobion avenae, Sogata spp., Sogatella furcifera, Solubea insularis, Stephanitis nashi, Stictocephala festina, Tenalaphara malayensis, Thyanta spp. such as Thyanta perditor; Tibraca spp., Tinocallis caryaefoliae, Tomaspis spp., Toxoptera spp. such as Toxoptera aurantii; Trialeurodes spp. such as Trialeurodes vaporariorum; Triatoma spp., Trioza spp., Typhlocyba spp., Unaspis spp. such as Unaspis yanonensis; and Viteus vitifolii, ants, bees, wasps, sawflies (Hymenoptera), e.g. Athalia rosae, Atta capiguara, Atta cephalotes, Atta cephalotes, Atta laevigata, Atta robusta, Atta sexdens, Atta texana, Bombus spp., Camponotus floridanus, Crematogaster spp., Dasymutilla occidentalis, Diprion spp., Dolichovespula maculata, Hoplocampa spp. such as Hoplocampa minuta, Hoplocampa testudinea; Lasius spp. such as Lasius niger, Linepithema humile, Monomorium pharaonic, Paravespula germanica, Paravespula pennsylvanica, Paravespula vulgaris, Pheidole megacephala, Pogonomyrmex barbatus, Pogonomyrmex californicus, Polistes rubiginosa, Solenopsis geminata, Solenopsis invicta, Solenopsis richteri, Solenopsis xyloni, Vespa spp. such as Vespa crabro, and Vespula squamosa, crickets, grasshoppers, locusts (Orthoptera), e.g. Acheta domestica, Calliptamus italicus, Chortoicetes terminifera, Dociostaurus maroccanus, Gryllotalpa africana, Gryllotalpa gryllotalpa, Hieroglyphus daganensis, Kraussaria angulifera, Locusta migratoria, Locustana pardalina, Melanoplus bivittatus, Melanoplus femurrubrum, Melanoplus mexicanus, Melanoplus sanguinipes, Melanoplus spretus, Nomadacris septemfasciata, Oedaleus senegalensis, Schistocerca americana, Schistocerca gregaria, Tachycines asynamorus, and Zonozerus variegatus, Arachnids (Arachnida), such as acari, e.g. of the families Argasidae, Ixodidae and Sarcoptidae, such as Amblyomma spp. (e.g. Amblyomma americanum, Amblyomma variegatum, Amblyomma maculatum), Argas spp. (e.g. Argas persicus), Boophilus spp. (e.g. Boophilus annulatus, Boophilus decoloratus, Boophilus microplus), Dermacentor silvarum, Dermacentor andersoni, Dermacentor variabilis, Hyalomma spp. (e.g. Hyalomma truncatum), Ixodes spp. (e.g. Ixodes ricinus, Ixodes rubicundus, Ixodes scapularis, Ixodes holocyclus, Ixodes pacificus), Ornithodorus spp. (e.g. Ornithodorus moubata, Ornithodorus hermsi, Ornithodorus turicata), Ornithonyssus bacoti, Otobius megnini, Dermanyssus gallinae, Psoroptes spp. (e.g. Psoroptes ovis), Rhipicephalus spp. (e.g. Rhipicephalus sanguineus, Rhipicephalus appendiculatus, Rhipicephalus evertsi), Rhizoglyphus spp., Sarcoptes spp. (e.g. Sarcoptes scabiei), and Eriophyidae spp. such as Acaria sheldoni, Aculops spp. (e.g. Aculops pelekassi) Aculus spp. (e.g. Aculus schlechtendali), Epitrimerus pyri, Phyllocoptruta oleivora and Eriophyes spp. (e.g. Eriophyes sheldoni); Tarsonemidae spp. such as Hemitarsonemus spp., Phytonemus pallidus and Polyphagotarsonemus latus, Stenotarsonemus spp.; Tenuipalpidae spp. such as Brevipalpus spp. (e.g. Brevipalpus phoenicis); Tetranychidae spp. Such as Eotetranychus spp., Eutetranychus spp., Oligonychus spp., Tetranychus cinnabarinus, Tetranychus kanzawai, Tetranychus pacificus, Tetranychus telarius and Tetranychus urticae; Bryobia praetiosa, Panonychus spp. (e.g. Panonychus ulmi, Panonychus citri), Metatetranychus spp. and Oligonychus spp. (e.g. Oligonychus pratensis), Vasates lycopersici; Araneida, e.g. Latrodectus mactans, and Loxosceles reclusa. And Acarus siro, Chorioptes spp., Scorpio maurus fleas (Siphonaptera), e.g. Ceratophyllus spp., Ctenocephalides felis, Ctenocephalides canis, Xenopsylla cheopis, Pulex irritans, Tunga penetrans, and Nosopsyllus fasciatus, silverfish, firebrat (Thysanura), e.g. Lepisma saccharina and Thermobia domestica, centipedes (Chilopoda), e.g. Geophilus spp., Scutigera spp. such as Scutigera coleoptrata; millipedes (Diplopoda), e.g. Blaniulus guttulatus, Narceus spp., Earwigs (Dermaptera), e.g. Forficula auricularia, lice (Phthiraptera), e.g. Damalinia spp., Pediculus spp. such as Pediculus humanus capitis, Pediculus humanus corporis; Pthirus pubis, Haematopinus spp. such as Haematopinus eurysternus, Haematopinus suis; Linognathus spp. such as Linognathus vituli; Bovicola bovis, Menopon gallinae, Menacanthus stramineus and Solenopotes capillatus, Trichodectes spp., springtails (Collembola), e.g. Onychiurus ssp. such as Onychiurus armatus.

The mixtures according to the present invention are also suitable for efficiently controlling nematodes: Plant parasitic nematodes such as root knot nematodes, Meloidogyne hapla, Meloidogyne incognita, Meloidogyne javanica, and other Meloidogyne species; cyst-forming nematodes, Globodera rostochiensis and other Globodera species; Heterodera avenae, Heterodera glycines, Heterodera schachtii, Heterodera trifolii, and other Heterodera species; Seed gall nematodes, Anguina species; Stem and foliar nematodes, Aphelenchoides species such as Aphelenchoides besseyi; Sting nematodes, Belonolaimus longicaudatus and other Belonolaimus species; Pine nematodes, Bursaphelenchus lignicolus Mamiya et Kiyohara, Bursaphelenchus xylophilus and other Bursaphelenchus species; Ring ematodes, Criconema species, Criconemella species, Criconemoides species, Mesocriconema species; Stem and bulb nematodes, Ditylenchus destructor, Ditylenchus dipsaci and other Ditylenchus species; Awl nematodes, Dolichodorus species; Spiral nematodes, Heliocotylenchus multicinctus and other Helicotylenchus species; Sheath and sheathoid nematodes, Hemicycliophora species and Hemicriconemoides species; Hirshmanniella species; Lance nematodes, Hoploaimus species; false rootknot nematodes, Nacobbus species; Needle nematodes, Longidorus elongatus and other Longidorus species; Lesion nematodes, Pratylenchus brachyurus, Pratylenchus neglectus, Pratylenchus penetrans, Pratylenchus curvitatus, Pratylenchus goodeyi and other Pratylenchus species; Burrowing nematodes, Radopholus similis and other Radopholus species; Reniform nematodes, Rotylenchus robustus, Rotylenchus reniformis and other Rotylenchus species; Scutellonema species; Stubby root nematodes, Trichodorus primitivus and other Trichodorus species, Paratrichodorus species; Stunt nematodes, Tylenchorhynchus claytoni, Tylenchorhynchus dubius and other Tylenchorhynchus species; Citrus nematodes, Tylenchulus species such as Tylenchulus semipenetrans; Dagger nematodes, Xiphinema species; and other plant parasitic nematode species.

Examples of further pests which may be controlled by the pesticidal mixture of the present invention include: from the class of the Bivalva, for example, Dreissena spp.; from the class of the Gastropoda, for example, Anon spp., Biomphalaria spp., Bulinus spp., Deroceras spp., Galba spp., Lymnaea spp., On comelania spp., Succinea spp.; from the class of the helminths, for example, Ancylostoma duodenale, Ancylostoma ceylanicum, Acylostoma braziliensis, Ancylostoma spp., Ascaris lumbricoides, Ascaris spp., Brugia malayi, Brugia timori, unostomum spp., Chabertia spp., Clonorchis spp., Cooperia spp., Dicrocoelium spp., Dictyocaulus filaria, Diphyllobothrium latum, Dracunculus medinensis, Echinococcus granulosus, Echinococcus multilocularis, Enterobius vermicularis, Faciola spp., Haemonchus spp. such as Haemonchus contortus; Heterakis spp., Hymenolepis nana, Hyostrongulus spp., Loa Loa, Nematodirus spp., Oesophagostomum spp., Opisthorchis spp., Onchocerca volvulus, Ostertagia spp., Paragonimus spp., Schistosomen spp., Strongyloides fuelleborni, Strongyloides stercora lis, Stronyloides spp., Taenia saginata, Taenia solium, Trichinella spiralis, Trichinella nativa, Trichinella britovi, Trichinella nelsoni, Trichinella pseudopsiralis, Trichostrongulus spp., Trichuris trichiura, Wuchereria bancrofti; from the order of the Isopoda, for example, Armadillidium vulgare, Oniscus asellus, Porcellio scaber; and from the order of the Symphyla, for example, Scutigerella immaculata.

Further examples of pest species which may be controlled by the pesticidal mixture of the present invention include: Anisoplia austriaca, Apamea spp., Austroasca viridigrisea, Baliothrips biformis, Caenorhabditis elegans, Cephus spp., Ceutorhynchus napi, Chaetocnema aridula, Chilo auricilius, Chilo indicus, Chilo polychlysus, Chortiocetes terminifera, Cnaphalocroci medinalis, Cnaphalocrosis spp., Colias etytheme, Collops spp., Comitermes cumulans, Creontiades spp., Cyclocephala spp., Dalbulus maidis, Deraceras reticulatum, Diatrea saccharalis, Dichelops furcatus, Dicladispa annigera, Diloboderus spp. such as Diloboderus abderus; Edessa spp., Epinotia spp., Formicidae, Geocoris spp., Globitermes sulfureus, Giyllotalpidae, Halotydeus destructor, Hipnodes bicolor, Hydrellia philippina, fulus spp., Laodelphax spp., Leptocorsia acuta, Leptocorsia oratorius, Liogenys fuscus, Lucillia spp., Lyogenys fuscus, Mahanarva spp., Maladera matrida, Marasmia spp., Mastotermes spp., Mealybugs, Megascelis ssp, Metamasius hemipterus, Microtheca spp., Mocis latipes, Murgantia spp., Mythemina separata, Neocapritermes opacus, Neocapritermes parvus, Neomegalotomus spp., Neotermes spp., Nymphula depunctalis, Oebalus pugnax, Orseolia spp. such as Orseolia oryzae; Oxycaraenus hyalinipennis, Plusia spp., Pomacea canaliculata, Procornitermes ssp., Procornitermes triacifer, Psylloides spp., Rachiplusia spp., Rhodopholus spp., Scaptocoris castanea, Scaptocoris spp., Scirpophaga spp. such as Scirpophaga incertulas, Scirpophaga innotata; Scotinophara spp. such as Scotinophara coarctata; Sesamia spp. such as Sesamia inferens, Sogaella frucifera, Solenapsis geminata, Spissistilus spp., Stalk borer, Stenchaetothrips biformis, Steneotarsonemus spinki, Sylepta derogata, Telehin licus, and Trichostrongylus spp.

The mixtures of the present invention are particularly useful for controlling insects, preferably sucking or piercing insects such as insects from the genera Thysanoptera, Diptera and Hemiptera, and chewing-biting pests such as insects from the genera of Lepidoptera and Coleoptera, in particular the following species: Thysauoptera: Frankliniella fusca, Frankliniella occidentalis, Frankliniella tritici, Scirtothrips citri, Thrips oryzae, Thrips palmi and Thrips tabaci, Diptera, e.g. Aedes aegypti, Aedes albopictus, Aedes vexans, Anastrepha ludens, Anopheles maculipennis, Anopheles crucians, Anopheles albimanus, Anopheles gambiae, Anopheles freeborni, Anopheles leucosphyrus, Anopheles minimus, Anopheles quadrimaculatus, Calliphora vicina, Ceratitis capitata, Chrysomya bezziana, Chrysomya hominivorax, Chrysomya macellaria, Chrysops discalis, Chrysops silacea, Chrysops atlanticus, Cochliomyia hominivorax, Contarinia sorghicola Cordylobia anthropophaga, Culicoides furens, Culex pipiens, Culex nigripalpus, Culex quinquefasciatus, Culex tarsalis, Culiseta inornata, Culiseta melanura, Dacus cucurbitae, Dacus oleae, Dasineura brassicae, Delia antique, Delia coarctata, Delia platura, Delia radicum, Dermatobia hominis, Fannia canicularis, Geomyza Tripunctata, Gasterophilus intestinalis, Glossina morsitans, Glossina palpalis, Glossina fuscipes, Glossina tachinoides, Haematobia irritans, Haplodiplosis equestris, Hippelates spp., Hylemyia platura, Hypoderma lineata, Leptoconops torrens, Liriomyza sativae, Liriomyza trifolii, Lucilia caprina, Lucilia cuprina, Lucilia sericata, Lycoria pectoralis, Mansonia titillanus, Mayetiola destructor, Musca autumnalis, Musca domestica, Muscina stabulans, Oestrus ovis, Opomyza forum, Oscinella frit, Pegomya hysocyami, Phorbia antiqua, Phorbia brassicae, Phorbia coarctata, Phlebotomus argentipes, Psorophora columbiae, Psila rosae, Psorophora discolor, Prosimulium mixtum, Rhagoletis cerasi, Rhagoletis pomonella, Sarcophaga haemorrhoidalis, Sarcophaga spp., Simulium vittatum, Stomoxys calcitrans, Tabanus bovinus, Tabanus atratus, Tabanus lineola, and Tabanus similis, Tipula oleracea, and Tipula paludosa; Hemiptera, in particular aphids: Acyrthosiphon onobrychis, Adelges laricis, Aphidula nasturtii, Aphis fabae, Aphis forbesi, Aphis pomi, Aphis gossypii, Aphis grossulariae, Aphis schneideri, Aphis spiraecola, Aphis sambuci, Acyrthosiphon pisum, Aulacorthum solani, Brachycaudus cardui, Brachycaudus helichrysi, Brachycaudus persicae, Brachycaudus prunicola, Brevicoryne brassicae, Capitophorus horni, Cerosipha gossypii, Chaetosiphon fragaefolii, Cryptomyzus ribis, Dreyfusia nordmannianae, Dreyfusia piceae, Dysaphis radicola, Dysaulacorthum pseudosolani, Dysaphis plantaginea, Dysaphis pyri, Empoasca fabae, Hyalopterus pruni, Hyperomyzus lactucae, Macrosiphum avenae, Macrosiphum euphorbiae, Macrosiphon rosae, Megoura viciae, Melanaphis pyrarius, Metopolophium dirhodum, Myzodes persicae, Myzus ascalonicus, Myzus cerasi, Myzus varians, Nasonovia ribis-nigri, Nilaparvata lugens, Pemphigus bursarius, Perkinsiella saccharicida, Phorodon humuli, Psylla mali, Psylla piri, Rhopalomyzus ascalonicus, Rhopalosiphum maidis, Rhopalosiphum padi, Rhopalosiphum insertum, Sappaphis mala, Sappaphis mali, Schizaphis graminum, Schizoneura lanuginosa, Sitobion avenae, Trialeurodes vaporariorum, Toxoptera aurantiiand, and Viteus vitifolii.

Lepidoptera, in particular: Agrotis ipsilon, Agrotis segetum, Alabama argillacea, Anticarsia gemmatalis, Argyresthia conjugella, Autographa gamma, Bupalus piniarius, Cacoecia murinana, Capua reticulana, Cheimatobia brumata, Choristoneura fumiferana, Choristoneura occidentalis, Cirphis unipuncta, Cydia pomonella, Dendrolimus pini, Diaphania nitidalis, Diatraea grandiosella, Earias insulana, Elasmopalpus lignosellus, Eupoecilia ambiguella, Evetria bouliana, Feltia subterranea, Galleria mellonella, Grapholitha funebrana, Grapholitha molesta, Heliothis armigera, Heliothis virescens, Heliothis zea, Hellula undalis, Hibernia defoliaria, Hyphantria cunea, Hyponomeuta malinellus, Keiferia lycopersicella, Lambdina fiscellaria, Laphygma exigua, Leucoptera coffeella, Leucoptera scitella, Lithocolletis blancardella, Lobesia botrana, Loxostege sticticalis, Lymantria dispar, Lymantria monacha, Lyonetia clerkella, Malacosoma neustria, Mamestra brassicae, Orgyia pseudotsugata, Ostrinia nubilalis, Panolis flammea, Pectinophora gossypiella, Peridroma saucia, Phalera bucephala, Phthorimaea operculella, Phyllocnistis citrella, Pieris brassicae, Plathypena scabra, Plutella xylostella, Pseudoplusia includens, Rhyacionia frustrana, Scrobipalpula absoluta, Sitotroga cerealella, Sparganothis pilleriana, Spodoptera frugiperda, Spodoptera littoralis, Spodoptera litura, Thaumatopoea pityocampa, Tortrix viridana, Trichoplusia ni and Zeiraphera canadensis.

The mixtures of the present invention are particularly useful for controlling insects from the order of Coleoptera, in particular Agrilus sinuatus, Agriotes lineatus, Agriotes obscurus, Amphimallus solstitialis, Anisandrus dispar, Anthonomus grandis, Anthonomus pomorum, Aphthona euphoridae, Athous haemorrhoidalis, Atomaria linearis, Blastophagus piniperda, Blitophaga undata, Bruchus rufimanus, Bruchus pisorum, Bruchus lentis, Byctiscus betulae, Cassida nebulosa, Cerotoma trifurcata, Cetonia aurata, Ceuthorrhynchus assimilis, Ceuthorrhynchus caapi, Chaetocnema tibialis, Conoderus vespertinus, Crioceris asparagi, Ctenicera ssp., Diabrotica longicomis, Diabrotica semipunctata, Diabrotica 12-punctata Diabrotica speciosa, Diabrotica virgifera, Epilachna varivestis, Epitrix hirtipennis, Eutinobothrus brasiliensis, Hylobius abietis, Hypera brunneipennis, Hypera postica, Ips typographus, Lema bilineata, Lema melanopus, Leptinotarsa decemlineata, Limonius califomicus, Lissorhoptrus oryzophilus, Melanotus communis, Meligethes aeneus, Melolontha hippocastani, Melolontha melolontha, Oulema oryzae, Otiorrhynchus sulcatus, Otiorrhynchus ovatus, Phaedon cochleariae, Phyllobius pyri, Phyllotreta chrysocephala, Phyllophaga sp., Phyllopertha horticola, Phyllotreta nemorum, Phyllotreta striolata, Popillia japonica, Sitona lineatus and Sitophilus granaria.

The mixtures of the present invention are particularly useful for controlling insects of the orders Lepidoptera, Coleoptera, Hemiptera and Thysanoptera.

The mixtures of the present invention are especially suitable for efficiently combating pests like insects from the order of the lepidopterans (Lepidoptera), beetles (Coleoptera), flies and mosquitoes (Diptera), thrips (Thysanoptera), termites (Isoptera), bugs, aphids, leafhoppers, whiteflies, scale insects, cicadas (Hemiptera), ants, bees, wasps, sawflies (Hymenoptera), crickets, grasshoppers, locusts (Orthoptera), and also Arachnoidea, such as arachnids (Acarina).

The term “mixture” as used herein includes combinations.

The present invention also provides methods for controlling insects, acarids, nematodes or phytopathogenic fungi comprising contacting the insect, acarid, nematode or phytopathogenic fungi or their food supply, habitat, breeding grounds or their locus with a pesticidally effective amount of the mixture of the present invention.

Moreover, the present invention also relates to a method of protecting plants from the attack or infestation by insects, acarids, nematodes or phytopathogenic fungi comprising contacting the plant, or the soil or water in which the plant is growing, with a pesticidally effective amount of a mixture of the present invention.

The invention also provides a method for the protection of plant propagation material, preferably seeds, from soil insects and seedlings, roots and shoots from soil and foliar insects or fungi, which comprises contacting the plant propagation material as e.g. the seeds before sowing and/or after pregermination with a pesticidally effective amount of a mixture of the present invention.

The invention also provides seeds comprising the mixture of the present invention.

The invention also provides pesticidal compositions, comprising a liquid or solid carrier and the pesticidal active mixture of the present invention.

The invention also relates to the use of the pesticidal active mixture for combating insects, acarids, nematodes or phytopathogenic fungi.

The mixture(s) of the compound of formula (I) with at least one active compound (II) or at least one active compound (III) are herein referred to as “mixture(s) according to the invention”.

In a specific embodiment, the mixture according to the invention is a mixture of one active compound of formula (I) with another active compound (II) (binary mixture).

In a specific embodiment, the mixture according to the invention is a mixture of one active compound of formula (I) with another active compound (III) (binary mixture).

Phytopathogenic Fungi

Non-limiting examples of pathogens of fungal diseases which can be treated in accordance with the present invention include:

Diseases caused by powdery mildew pathogens, for example Blumeria species, for example Blumeria graminis; Podosphaera species, for example Podosphaera leucotricha; Sphaerotheca species, for example Sphaerotheca fuliginea; Uncinula species, for example Uncinula necator; Erysiphe species, for example Erysiphe cichoracearu;

diseases caused by rust disease pathogens, for example Gymnosporangium species, for example Gymnosporangium sabinae; Hemileia species, for example Hemileia vastatrix; Phakopsora species, for example Phakopsora pachyrhizi or Phakopsora meibomiae; Puccinia species, for example Puccinia recondita, Puccinia graminis or Puccinia striiformis, and Puccinia melanocephala; Uromyces species, for example Uromyces appendiculatus;

In particular, Cronartium ribicola (White pine blister rust); Gymnosporangium juniperi-virginianae (Cedar-apple rust); Hemileia vastatrix (Coffee rust); Phakopsora meibomiae and P. pachyrhizi (Soybean rust); Puccinia coronata (Crown Rust of Oats and Ryegrass); Puccinia graminis (Stem rust of wheat and Kentucky bluegrass, or black rust of cereals); Puccinia hemerocallidis (Daylily rust); Puccinia persistens subsp. triticina (wheat rust or ‘brown or red rust’); Puccinia sorghi (rust in corn); Puccinia striiformis (‘Yellow rust’ in cereals); Puccinia melanocephala; Uromyces appendiculatus (rust of beans); Uromyces phaseoli (Bean rust); Puccinia melanocephala (‘Brown rust’ in sugarcane); Puccinia kuehnii (‘Orange rust’ in sugarcane).

diseases caused by pathogens from the group of the Oomycetes, for example Albugo species, for example Albugo candida; Bremia species, for example Bremia lactucae; Peronospora species, for example Peronospora pisi or P. brassicae; Phytophthora species, for example Phytophthora infestans; Plasmopara species, for example Plasmopara viticola; Pseudoperonospora species, for example Pseudoperonospora humuli or Pseudoperonospora cubensis; Pythium species, for example Pythium ultimum;

leaf blotch diseases and leaf wilt diseases caused, for example, by Alternaria species, for example Alternaria solani; Cercospora species, for example Cercospora beticola; Cladiosporium species, for example Cladiosporium cucumerinum; Cochliobolus species, for example Cochliobolus sativus (conidial form: Drechslera, syn: Helminthosporium) or Cochliobolus miyabeanus; Colletotrichum species, for example Colletotrichum lindemuthanium; Cycloconium species, for example Cycloconium oleaginum; Diaporthe species, for example Diaporthe citri; Elsinoe species, for example Elsinoe fawcettii; Gloeosporium species, for example Gloeosporium laeticolor; Glomerella species, for example Glomerella cingulata; Guignardia species, for example Guignardia bidwelli; Leptosphaeria species, for example Leptosphaeria macularis; Magnaporthe species, for example Magnaporthe grisea; Microdochium species, for example Microdochium nivale; Mycosphaerella species, for example Mycosphaerella graminicola, Mycosphaerella arachidicola or Mycosphaerella fijiensis; Phaeosphaeria species, for example Phaeosphaeria nodorum; Pyrenophora species, for example Pyrenophora teres or Pyrenophora tritici repentis; Ramularia species, for example Ramularia collo-cygni or Ramularia areola; Rhynchosporium species, for example Rhynchosporium secalis; Septoria species, for example Septoria apii or Septoria lycopersici; Stagonospora species, for example Stagonospora nodorum; Typhula species, for example Typhula incamata; Venturia species, for example Venturia inaequalis;

root and stem diseases caused, for example, by Corticium species, for example Corticium graminearum; Fusarium species, for example Fusarium oxysporum; Gaeumannomyces species, for example Gaeumannomyces graminis; Plasmodiophora species, for example Plasmodiophora brassicae; Rhizoctonia species, for example Rhizoctonia solani; Sarocladium species, for example Sarocladium oryzae; Sclerotium species, for example Sclerotium oryzae; Tapesia species, for example Tapesia acuformis; Thielaviopsis species, for example Thielaviopsis basicola; Ganoderma species, for example Ganoderma lucidum;

ear and panicle diseases (including corn cobs) caused, for example, by Alternaria species, for example Alternaria spp.; Aspergillus species, for example Aspergillus flavus; Cladosporium species, for example Cladosporium cladosporioides; Claviceps species, for example Claviceps purpurea; Fusarium species, for example Fusarium culmorum; Gibberella species, for example Gibberella zeae; Monographella species, for example Monographella nivalis; Stagnospora species, for example Stagnospora nodorum;

diseases caused by smut fungi, for example Sphacelotheca species, for example Sphacelotheca reiliana; Tilletia species, for example Tilletia caries or Tilletia controversa; Urocystis species, for example Urocystis occulta; Ustilago species, for example Ustilago cauda;

fruit rot caused, for example, by Aspergillus species, for example Aspergillus flavus; Botrytis species, for example Botrytis cinerea; Penicillium species, for example Penicillium expansum or Penicillium purpurogenum; Rhizopus species, for example Rhizopus stolonifer; Sclerotinia species, for example Sclerotinia sclerotiorum; Verticilium species, for example Verticilium alboatrum;

seed- and soil-borne rot and wilt diseases, and also diseases of seedlings, caused, for example, by Alternaria species, for example Alternaria brassicicola; Aphanomyces species, for example Aphanomyces euteiches; Ascochyta species, for example Ascochyta lentis; Aspergillus species, for example Aspergillus flavus; Cladosporium species, for example Cladosporium herbarum; Cochliobolus species, for example Cochliobolus sativus (conidial form: Drechslera, Bipolaris Syn: Helminthosporium); Colletotrichum species, for example Colletotrichum coccodes; Fusarium species, for example Fusarium culmorum; Gibberella species, for example Gibberella zeae; Macrophomina species, for example Macrophomina phaseolina; Microdochium species, for example Microdochium nivale; Monographella species, for example Monographella nivalis; Penicillium species, for example Penicillium expansum; Phoma species, for example Phoma lingam; Phomopsis species, for example Phomopsis sojae; Phytophthora species, for example Phytophthora cactorum; Pyrenophora species, for example Pyrenophora graminea; Pyricularia species, for example Pyricularia oryzae; Pythium species, for example Pythium ultimum; Rhizoctonia species, for example Rhizoctonia solani; Rhizopus species, for example Rhizopus oryzae; Sclerotium species, for example Sclerotium rolfsii; Septoria species, for example Septoria nodorum; Typhula species, for example Typhula incarnata; Verticillium species, for example Verticillium dahliae;

cancers, galls and witches' broom caused, for example, by Nectria species, for example Nectria galligena;

wilt diseases caused, for example, by Monilinia species, for example Monilinia laxa;

deformations of leaves, flowers and fruits caused, for example, by Exobasidium species, for example Exobasidium vexans; Taphrina species, for example Taphrina deformans;

degenerative diseases in woody plants, caused, for example, by Esca species, for example Phaeomoniella chlamydospora, Phaeoacremonium aleophilum or Fomitiporia mediterranea; Ganoderma species, for example Ganoderma boninense;

diseases of flowers and seeds caused, for example, by Botrytis species, for example Botrytis cinerea;

diseases of plant tubers caused, for example, by Rhizoctonia species, for example Rhizoctonia solani; Helminthosporium species, for example Helminthosporium solani;

diseases caused by bacterial pathogens, for example Xanthomonas species, for example Xanthomonas campestris pv. oryzae; Pseudomonas species, for example Pseudomonas syringae pv. lachrymans; Erwinia species, for example Erwinia amylovora; Ralstonia species, for example Ralstonia solanacearum;

Fungal diseases on roots and the stem base caused, for example, by black root rot (Calonectria crotalariae), charcoal rot (Macrophomina phaseolina), fusarium blight or wilt, root rot, and pod and collar rot (Fusarium oxysporum, Fusarium orthoceras, Fusarium semitectum, Fusarium equiseti), mycoleptodiscus root rot (Mycoleptodiscus terrestris), neocosmospora (Neocosmospora vasinfecta), pod and stem blight (Diaporthe phaseolorum), stem canker (Diaporthe phaseolorum var. caulivora), phytophthora rot (Phytophthora megaspenna), brown stem rot (Phialophora gregata), pythium rot (Pythium aphanidennatum, Pythium irregulare, Pythium debaryanum, Pythium myriotylum, Pythium ultimum), rhizoctonia root rot, stem decay, and damping-off (Rhizoctonia solani), sclerotinia stem decay (Sclerotinia sclerotiorum), sclerotinia southern blight (Sclerotinia rolfsii), thielaviopsis root rot (Thielaviopsis basicola).

Plants which can be treated in accordance with the invention include the following: Rosaceae sp (for example pome fruits such as apples, pears, apricots, cherries, almonds and peaches), Ribesioidae sp., Juglandaceae sp., Betulaceae sp., Anacardiaceae sp., Fagaceae sp., Moraceae sp., Oleaceae sp., Actinidaceae sp., Lauraceae sp., Musaceae sp. (for example banana trees and plantations), Rubiaceae sp. (for example coffee), Theaceae sp., Sterculiceae sp., Rutaceae sp. (for example lemons, oranges and grapefruit); Vitaceae sp. (for example grapes); Solanaceae sp. (for example tomatoes, peppers), Liliaceae sp., Asteraceae sp. (for example lettuce), Umbelliferae sp., Cruciferae sp., Chenopodiaceae sp., Cucurbitaceae sp. (for example cucumber), Alliaceae sp. (for example leek, onion), Papilionaceae sp. (for example peas); major crop plants, such as Poaceae/Gramineae sp. (for example maize, turf, cereals such as wheat, rye, rice, barley, oats, millet and triticale), Asteraceae sp. (for example sunflower), Brassicaceae sp. (for example white cabbage, red cabbage, broccoli, cauliflower, Brussels sprouts, pak choi, kohlrabi, radishes, and oilseed rape, mustard, horseradish and cress), Fabacae sp. (for example bean, peanuts), Papilionaceae sp. (for example soya bean), Solanaceae sp. (for example potatoes), Chenopodiaceae sp. (for example sugar beet, fodder beet, swiss chard, beetroot); Malvaceae (for example cotton); useful plants and ornamental plants for gardens and wooded areas; and genetically modified varieties of each of these plants.

The pesticidal active mixture of the present invention or the composition comprising them can be used for curative or protective/preventive control of phytopathogenic fungi. The present invention therefore also relates to curative and protective methods for controlling phytopathogenic fungi by the use of the pesticidal active mixture of the present invention or the composition comprising them, which are applied to the seed, the plant or plant parts, the fruit or the soil in which the plants grow.

The fact that the pesticidal active mixture of the present invention or the composition comprising them are well tolerated by plants at the concentrations required for controlling plant diseases allows the treatment of above-ground parts of plants, of propagation stock and seeds, and of the soil.

According to the invention, all plants and plant parts can be treated. By plants is meant all plants and plant populations such as desirable and undesirable wild plants, cultivars and plant varieties (whether or not protectable by plant variety or plant breeder's rights). Cultivars and plant varieties can be plants obtained by conventional propagation and breeding methods which can be assisted or supplemented by one or more biotechnological methods such as by use of double haploids, protoplast fusion, random and directed mutagenesis, molecular or genetic markers or by bioengineering and genetic engineering methods. By plant parts is meant all above ground and below ground parts and organs of plants such as shoot, leaf, blossom and root, whereby for example leaves, needles, stems, branches, blossoms, fruiting bodies, fruits and seed as well as roots, conns and rhizomes are listed. Crops and vegetative and generative propagating material, for example cuttings, conns, rhizomes, runners and seeds also belong to plant parts.

The pesticidal active mixture of the present invention or the composition comprising them, when they are well tolerated by plants, have favorable homeotherm toxicity and are well tolerated by the environment, are suitable for protecting plants and plant organs, for enhancing harvest yields, for improving the quality of the harvested material. They can preferably be used as crop protection compositions. They are active against normally sensitive and resistant species and against all or some stages of development.

Plants which can be treated in accordance with the present invention include the following main crop plants: maize, soya bean, alfalfa, cotton, sunflower, Brassica oil seeds such as Brassica napus (e.g. canola, rapeseed), Brassica rapa, B. juncea (e.g. (field) mustard) and Brassica carinata, Arecaceae sp. (e.g. oilpalm, coconut), rice, wheat, sugar beet, sugar cane, oats, rye, barley, millet and sorghum, triticale, flax, nuts, grapes and vine and various fruit and vegetables from various botanic taxa, e.g. Rosaceae sp. (e.g. pome fruits such as apples and pears, but also stone fruits such as apricots, cherries, almonds, plums and peaches, and berry fruits such as strawberries, raspberries, red and black currant and gooseberry), Ribesioidae sp., Juglandaceae sp., Betulaceae sp., Anacardiaceae sp., Fagaceae sp., Aforaceae sp., Oleaceae sp. (e.g. olive tree), Actinidaceae sp., Lauraceae sp. (e.g. avocado, cinnamon, camphor), Afusaceae sp. (e.g. banana trees and plantations), Rubiaceae sp. (e.g. coffee), Theaceae sp. (e.g. tea), Sterculiceae sp., Rutaceae sp. (e.g. lemons, oranges, mandarins and grapefruit); Solanaceae sp. (e.g. tomatoes, potatoes, peppers, capsicum, aubergines, tobacco), Liliaceae sp., Compositae sp. (e.g. lettuce, artichokes and chicory—including root chicmy, endive or common chicory), Umbelliferae sp. (e.g. carrots, parsley, celery and celeriac), Cucurbitaceae sp. (e.g. cucumbers—including gherkins, pumpkins, watermelons, calabashes and melons), Alliaceae sp. (e.g. leeks and onions), Cruciferae sp. (e.g. white cabbage, red cabbage, broccoli, cauliflower, Brussels sprouts, pak choi, kohlrabi, radishes, horseradish, cress and chinese cabbage), Leguminosae sp. (e.g. peanuts, peas, lentils and beans—e.g. common beans and broad beans), Chenopodiaceae sp. (e.g. Swiss chard, fodder beet, spinach, beetroot), Linaceae sp. (e.g. hemp), Cannabeacea sp. (e.g. cannabis), Malvaceae sp. (e.g. okra, cocoa), Papaveraceae (e.g. poppy), Asparagaceae (e.g. asparagus); useful plants and ornamental plants in the garden and woods including turf, lawn, grass and Stevia rebaudiana; and in each case genetically modified types of these plants.

In particular, the pesticidal active mixture of the present invention or the composition comprising them, are suitable for controlling the following plant diseases:

Albugo spp. (white rust) on ornamentals, vegetables (e. g. A. candida) and sunflowers (e. g. A tragopogonis); Alternaria spp. (Alternaria leaf spot) on vegetables, rape (A brassicola or brassicae), sugar beets (A tenuis), fruits, rice, soybeans, potatoes (e. g. A solani or A alternata), tomatoes (e. g. A solani or A alternata) and wheat; Aphanomyces spp. on sugar beets and vegetables; Ascochyta spp. on cereals and vegetables, e. g. A tritici (anthracnose) on wheat and A hordei on barley; Bipolaris and Drechslera spp. (teleomorph: Cochliobolus spp.), e.g. Southern leaf blight (D. maydis) or Northern leaf blight (B. zeicola) on corn, e. g. spot blotch (B. sorokiniana) on cereals and e. g. B. oryzae on rice and turfs; Blumeria (formerly Erysiphe) graminis (powdery mildew) on cereals (e.g. on wheat or barley); Botrytis cinerea (teleomorph: Botryotinia fuckeliana: grey mold) on fruits and berries (e.g. strawberries), vegetables (e.g. lettuce, carrots, celery and cabbages), rape, flowers, vines, forestry plants and wheat; Bremia lactucae (downy mildew) on lettuce; Ceratocystis (syn. Ophiostoma) spp. (rot or wilt) on broad leaved trees and evergreens, e.g. C. ulmi (Dutch elm disease) on elms; Cercospora spp. (Cercospora leaf spots) on corn (e.g. Gray leaf spot: C. zeaemaydis), rice, sugar beets (e.g. C. beticola), sugar cane, vegetables, coffee, soybeans (e.g. C. sojina or C. kikuchil) and rice; Cladosporium spp. on tomatoes (e.g. C. fulvum: leaf mold) and cereals, e.g. C. herbarum (black ear) on wheat; Claviceps purpurea (ergot) on cereals; Cochliobolus (anamorph: Helmin thosporium of Bipolaris) spp. (leaf spots) on corn (C. carbonum), cereals (e.g. C. sativus, anamorph: B. sorokiniana) and rice (e.g. C. miyabeanus, anamorph: H. oryzae); Colletotrichum (teleomorph: Glomerella) spp. (anthracnose) on cotton (e. g. C. gossypit), corn (e.g. C. graminicola: Anthracnose stalk rot), fruits, potatoes (e.g. C. coccodes: black dot), vegetables like beans (e.g. C. lindemuthianum) and soybeans (e.g. C. truncatum or C. gloeosporioides); Corticium spp., e.g. C. sasakii (sheath blight) on rice; Corynespora cassiicola (leaf spots) on soybeans and ornamentals; Cycloconium spp., e.g. C. oleaginum on olive trees; Cylindrocarpon spp. (e.g. fruit tree canker or young vine decline, teleomorph: Nectria or Neonectria spp.) on fruit trees, vines (e. g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e.g. D. phaseolorum (damping off) on soybeans; Drechslera (syn. Helminthosporium, teleomorph: Pyrenophora) spp. on corn, cereals, such as barley (e.g. D. teres, net blotch) and wheat (e.g. D. tritici-repentis: tan spot), rice and turf; Esca (dieback, apoplexy) on vines, caused by Formitiporia (syn. Phellinus) punctata, F. mediterranea, Phaeomoniella chlamydospora (earlier Phaeoacremonium chlamydosporum), Phaeoacremonium aleophilum and/or Botryosphaeria obtusa; Elsinoe spp. on pome fruits (E. pyn), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e. g. E. pist), such as cucurbits (e.g. E. cichoracearum), cabbages, rape (e.g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e.g. E. turcicum); Fusarium (teleomorph: Gibberella) spp. (wilt, root or stem rot) on various plants, such as F. graminearum or F. culmorum (root rot, scab or head blight) on cereals (e.g. wheat or barley), F. oxysporum on tomatoes, F. solani (f. sp. glycines now syn. F. virguliforme) and F. tucumaniae and F. brasiliense each causing sudden death syndrome on soybeans, and F. verticillioides on corn; Gaeumannomyces graminis (take-all) on cereals (e.g. wheat or barley) and corn; Gibberella spp. on cereals (e. g. G. zeae) and rice (e.g. G. fujikuroi: Bakanae disease); Glomerella cingulata on vines, pome fruits and other plants and G. gossypii on cotton; Grainstaining complex on rice; Guignardia bidwellii (black rot) on vines; Gymnosporangium spp. on rosaceous plants and junipers, e. g. G. sabinae (rust) on pears; Helminthosporium spp. (syn. Drechslera, teleomorph: Cochliobolus) on corn, cereals and rice; Hemileia spp., e.g. H. vastatrix (coffee leaf rust) on coffee; Isariopsis clavispora (syn. Cladosporium vitis) on vines; Macrophomina phaseolina (syn. phaseoft) (root and stem rot) on soybeans and cotton; Microdochium (syn. Fusarium) nivale (pink snow mold) on cereals (e. g. wheat or barley); Microsphaera diffusa (powdery mildew) on soybeans; Monilinia spp., e.g. M. laxa, M. fructicola and M. fructigena (bloom and twig blight, brown rot) on stone fruits and other rosaceous plants; Mycosphaerella spp. on cereals, bananas, soft fruits and ground nuts, such as e. g. M. graminicola (anamorph: Septoria tritici, Septoria blotch) on wheat or M. fijiensis (black Sigatoka disease) on bananas; Peronospora spp. (downy mildew) on cabbage (e.g. P. brassicae), rape (e.g. P. parasitica), onions (e.g. P. destructor), tobacco (P. tabacina) and soybeans (e.g. P. manshurica); Phakopsora pachyrhizi and P. meibomiae (soybean rust) on soybeans; Phialophora spp. e.g. on vines (e.g. P. tracheiphila and P. tetraspora) and soybeans (e.g. P. gregata: stem rot); Phoma lingam (root and stem rot) on rape and cabbage and P. betae (root rot, leaf spot and damping-off) on sugar beets; Phomopsis spp. on sunflowers, vines (e. g. P. viticola: can and leaf spot) and soybeans (e.g. stem rot: P. phaseoli, teleomorph: Diaporthe phaseolorum); Phy soderma maydis (brown spots) on corn; Phytophthora spp. (wilt, root, leaf, fruit and stem root) on various plants, such as paprika and cucurbits (e.g. P. capsicl), soybeans (e. g. P. megasperma, syn. P. sojae), potatoes and tomatoes (e. g. P. infestans: late blight) and broad leaved trees (e.g. P. ramorum: sudden oak death); Plasmodiophora brassicae (club root) on cabbage, rape, radish and other plants; Plasmopara spp., e.g. P. viticola (grapevine downy mildew) on vines and P. halstedii on sunflowers; Podosphaera spp. (powdery mildew) on rosa ceous plants, hop, pome and soft fruits, e.g. P. leucotricha on apples; Polymyxa spp., e.g. on cereals, such as barley and wheat (P. graminis) and sugar beets (P. betae) and thereby trans mitted viral diseases; Pseudocercosporella herpotrichoides (eyespot, teleomorph: Tapesia yallundae) on cereals, e.g. wheat or barley; Pseudoperonospora (downy mildew) on various plants, e.g. P. cubensis on cucurbits or P. humili on hop; Pseudopezicula tracheiphila (red fire disease or, rotbrenner’, anamorph: Phialophora) on vines; Puccinia spp. (rusts) on various plants, e.g. P. triticina (brown or leaf rust), P. striiformis (stripe or yellow rust), P. hordei (dwarf rust), P. graminis (stem or black rust) or P. recondita (brown or leaf rust) on cereals, such as e.g. wheat, barley or rye, P. kuehnii (orange rust) on sugar cane and P. asparagi on asparagus; Pyrenophora (anamorph: Drechslera) tritici-repentis (tan spot) on wheat or P. teres (net blotch) on barley; Pyricularia spp., e.g. P. oryzae (teleomorph: Magnaporthe grisea, rice blast) on rice and P. grisea on turf and cereals; Pythium spp. (damping-off) on turf, rice, corn, wheat, cotton, rape, sunflowers, soybeans, sugar beets, vegetables and various other plants (e. g. P. ultimum or P. aphanidermatum); Ramularia spp., e. g. R. collo-cygni (Ramularia leaf spots, Physiological leaf spots) on barley and R. beticola on sugar beets; Rhizoctonia spp. on cotton, rice, potatoes, turf, corn, rape, potatoes, sugar beets, vegetables and various other plants, e. g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis (scald) on barley, rye and triticale; Sarocladium oryzae and S. attenuatum (sheath rot) on rice; Sclerotinia spp. (stem rot or white mold) on vegetables and field crops, such as rape, sunflowers (e. g. S. sclerotiorum) and soy beans (e.g. S. rolfsii or S. sclerotiorum); Septoria spp. on various plants, e. g. S. glycines (brown spot) on soybeans, S. tritici (Septoria blotch) on wheat and S. (syn. Stagonospora) no dorum (Stagonospora blotch) on cereals; Uncinula (syn. Erysiphe) necator (powdery mildew, anamorph: Oidium tucken) on vines; Setospaeria spp. (leaf blight) on corn (e.g. S. turcicum, syn. Helminthosporium turcicum) and turf; Sphacelotheca spp. (smut) on corn, (e.g. S. reiliana: head smut), sorghum and sugar cane; Sphaerotheca fuliginea (powdery mildew) on cucurbits; Spongospora subterranea (powdery scab) on potatoes and thereby transmitted viral diseases; Stagonospora spp. on cereals, e. g. S. nodorum (Stagonospora blotch, teleomorph: Lepto sphaeria [syn. Phaeosphaeria] nodorum) on wheat; Synchytrium endobioticum on potatoes (potato wart disease); Taphrina spp., e.g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e. g. T. tritici (syn. T. caries, wheat bunt) and T. controversa (dwarf bunt) on wheat; Typhula incamata (grey snow mold) on barley or wheat; Urocystis spp., e.g. U. occulta (stem smut) on rye; Uromyces spp. (rust) on vegetables, such as beans (e.g. U. appendiculatus, syn. U. phaseoft) and sugar beets (e.g. U. betae); Ustilago spp. (loose smut) on cereals (e. g. U. nuda and U. avaenae), corn (e. g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. dahliae on strawberries, rape, potatoes and tomatoes.

Formulations

The pesticidal active mixture of the present invention can be converted into the customary formulations, for example solutions, emulsions, suspensions, dusts, powders, pastes and granules. The use form depends on the particular intended purpose; in each case, it should ensure a fine and even distribution of the compounds of the mixture.

Therefore, the present invention also relates to pesticidal active mixtures comprising an auxiliary and the pesticidal active mixture of the present invention.

An agrochemical composition comprises a pesticidally effective amount of the pesticidally active mixture of the present invention. The term “effective amount” denotes an amount of the composition or of the mixture, which is sufficient for controlling harmful pests on cultivated plants or in the protection of materials and which does not result in a substantial damage to the treated plants. Such an amount can vary in a broad range and is dependent on various factors, such as the animal pest species to be controlled, the treated cultivated plant or material, the climatic conditions and the specific mixture used.

The pesticidal active mixture of the present invention can be converted into customary types of agrochemical compositions, e. g. solutions, emulsions, suspensions, dusts, powders, pastes, granules, pressings, capsules, and mixtures thereof. Examples for composition types are suspension concentrates (SC), Oil Dispersions (OD), emulsifiable concentrates (e.g. EC & EW), Microemulsions (ME), capsules (e.g. CS), pastes, pastilles, wettable powders or dusts (e.g. WP, SP, WS, DP, DS), pressings (e.g. BR, TB, DT), granules (e.g. WG, SG, GR, FG, GG, MG), gels. Other formulations delivering mixed actives are ZC, ZE and ZW. Delivery of ingredients solo or mixes for seed treatment may be formulated through FS formats. These and further compositions types are defined in the “Catalogue of pesticide formulation types and international coding system”, Technical Monograph No. 2, 6th Ed. May 2008, CropLife International.

The compositions are prepared in a known manner, such as described by Mollet and Grubemann, formulation technology, Wiley VCH, Weinheim, 2001; or Knowles, New developments in crop protection product formulation, Agrow Reports DS243, T&F Informa, London, 2005.

Examples for suitable auxiliaries or agriculturally acceptable auxiliaries are solvents, liquid carriers, solid carriers or fillers, surfactants, dispersants, emulsifiers, wetters, spreaders, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

Suitable solvents and liquid carriers are water and organic solvents, such as low molecular weight mineral oil fractions of medium to high boiling point, e.g.; paraffins, oils of vegetable or animal origin; aliphatic, cyclic and aromatic hydrocarbons, e. g. toluene, paraffin, tetrahydronaphthalene, alkylated naphthalenes; alcohols, e.g. ethanol, propanol, butanol, benzylalcohol, cyclohexanol; glycols; DMSO; ketones, e.g. cyclohexanone; esters, e.g. lactates, carbonates, fatty acid esters, gamma-butyrolactone; fatty acids; phosphonates; amines; amides, e.g. N-methylpyrrolidone, fatty acid dimethylamides, dimethyl formamide (DMF), and mixtures thereof.

Suitable solid carriers or fillers are mineral earths, e.g. silicates, silica gels, talc, kaolins, limestone, lime, chalk, clays, dolomite, diatomaceous earth, bentonite, calcium sulfate, magnesium sulfate, magnesium oxide; polysaccharides, e.g. cellulose, starch; fertilizers, e g ammonium sulfate, ammonium phosphate, ammonium nitrate, ureas; products of vegetable origin, e.g. cereal meal, tree bark meal, wood meal, nutshell meal, and mixtures thereof.

Suitable surfactants are surface-active compounds, such as anionic, cationic, nonionic and amphoteric surfactants, ethoxylated fatty alcohols or their esters, ethoxylated-propoxylated fatty alcohols and their esters, fatty alcohol methyl esters, fatty alcohol methylester ethoxylates, EO-PO block copolymers, alkylpolyglucosides, polyelectrolytes, and their mixtures thereof. Such surfactants can be used as emusifiers, adjuvants, dispersant, solubilizer, wetter, penetration enhancer, protective colloid Examples of surfactants are listed in McCutcheon's, Vol. 1: Emulsifiers & Detergents, McCutcheon's Directories, Glen Rock, USA, 2008 (International Ed. or North American Ed.).

Suitable anionic surfactants are alkali, alkaline earth or ammonium salts of sulfonates, sulfates, phosphates, carboxylates, and mixtures thereof. Examples of sulfonates are alkylarylsulfonates, diphenylsulfonates, alpha-olefin sulfonates, ligno-sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and alkyl naphthalenes, sulfosuccinates or sulfosuccinamates.

Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides.

Examples of esters are fatty acid esters, glycerol esters or monoglycerides. Examples of sugar-based surfactants are sorbitans, ethoxylated sorbitans, sucrose and glucose esters or alkyl-polyglucosides. Examples of polymeric surfactants are home- or copolymers of vinylpyrrolidone, vinylalcohols, or vinylacetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide and polypropylene oxide.

Suitable polyelectrolytes are polyacids or polybases. Examples of polyacids are alkali salts of polyacrylic acid or polyacid comb polymers. Examples of polybases are polyvinylamines or polyethyleneamines. Suitable adjuvants are compounds, which have a neglectable or even no pesticidal activity themselves, and which improve the biological performance of the compound I or the mixture according to the invention on the target. Examples are surfactants, mineral or vegetable oils, and other auxiliaries. Further examples are listed by Knowles, Adjuvants and additives, Agrow Reports DS256, T&F Informa UK, 2006, chapter 5.

Suitable thickeners are polysaccharides (e.g. xanthan gum, carboxymethylcellulose), as clays, kaolines, (organically modified or unmodified), polycarboxylates, and silicates.

Suitable bactericides isothiazolinone derivatives such as alkylisothiazolinones and benzisothiazolinones are included to prevent the growth of bateria and fungi.

Suitable anti-freezing agents are ethylene glycol, propylene glycol, and glycerin.

Suitable anti-foaming agents are silicones, long chain alcohols, and salts of fatty acids.

Suitable colorants, namely dyes and pigments of low water solubility and water-soluble dyes, are used for identification and consumer cues. Examples are inorganic colorants (e.g. iron oxide, titan oxide, iron hexacyanoferrate) and organic colorants (e.g. alizarin-, azo- and phthalocyanine colorants).

Thickeners and rheology modifiers often used for acceptable consumer preferred properties are polyvinylpyrrolidones, polyvinylacetates, polyvinyl alcohols, polyacrylates, biological or synthetic waxes, carboxymethyl celluloses and cellulose ethers or guar gum or its derivatives are used as thickeners and rheology modifiers.

Examples for composition types and their preparation are:
i) Water-Soluble Concentrates (SL, LS)

10-60 wt % of the pesticidal active mixture of the present invention and 5-15 wt % wetting agent (e.g. alcohol alkoxylates) are dissolved in water and/or in a water-soluble solvent up to 100 wt %. The active substance dissolves upon dilution with water.
ii) Emulsifiable Concentrates (EC)

15-70 wt % of the pesticidal active mixture of the present invention and 5-10 wt % emulsifiers (e.g.

calcium dodecylbenzenesulfonate and castor oil ethoxylate) are dissolved in up to 100 wt % water-insoluble organic solvent (e.g. aromatic hydrocarbon). Dilution with water gives an emulsion.
iii) Emulsions (EW)

5-40 wt % of the pesticidal active mixture of the present invention and 1-10 wt % emulsifiers EO-PO copolymers of MW 5000-1000 are mixed with an organic solvent (5-75%) (e.g light paraffin) and water (10-80%) to yield a translucent or opaque mixture which may be added to water to yield an emulsion of the active in water, are dissolved in 20-40 wt water-insoluble organic solvent (e.g. aromatic hydrocarbon). This mixture is introduced into up to 100 wt % water by means of an emulsifying machine and made into a homogeneous emulsion. Dilution with water gives an emulsion.
iv) Suspensions (SC)

In an agitated ball mill, 20-60 wt % of the pesticidal active mixture of the present invention is comminuted with addition of 2-10 wt % dispersants and wetting agents (e.g. sodium lignosulfonate and alcohol ethoxylate), 0.1-2 wt % thickener (e.g. xanthan gum) and up to 100 wt % water to give a fine active substance suspension. Dilution with water gives a stable suspension of the active substance. For FS type composition up to 40 wt % binder (e.g. polyvinylalcohol) is added.
v) Water-Dispersible Granules and Water-Soluble Granules (WG, SG)

50-80 wt % of the pesticidal active mixture of the present invention is ground finely with addition of up to 100 wt % dispersants and wetting agents (e.g. sodium lignosulfonate and alcohol ethoxylate) and prepared as water-dispersible or water-soluble granules by means of technical appliances (e. g. extrusion, spray tower, fluidized bed). Dilution with water gives a stable dispersion or solution of the active substance.
vi) Water-Dispersible Powders and Water-Soluble Powders (WP, SP, WS)

50-80 wt % of the pesticidal active mixture of the present invention is ground in a rotor-stator mill with addition of 1-5 wt % dispersants (e.g. sodium lignosulfonate), 1-3 wt % wetting agents (e.g. alcohol ethoxylate) and up to 100 wt % solid carrier, e.g. silica gel. Dilution with water gives a stable dispersion or solution of the active substance.
vii) Gel (GW, GF)

In an agitated ball mill, 5-25 wt % of the pesticidal active mixture of the present invention is comminuted with addition of 3-10 wt % dispersants (e.g. sodium lignosulfonate), 1-5 wt % thickener (e.g. carboxymethylcellulose) and up to 100 wt % water to give a fine suspension of the active substance. Dilution with water gives a stable suspension of the active substance.
viii) Microemulsion (ME)

5-20 wt % of the pesticidal active mixture of the present invention is added to 5-30 wt % organic solvent blend (e.g. fatty acid dimethylamide and cyclohexanone), 10-25 wt % surfactant blend (e.g. alkohol ethoxylate and arylphenol ethoxylate), and a cosurfactant (1-10%) (e.g fatty alcohol or a long chain alkyl ester) and water up to 100%. This mixture is stirred for 1 h to produce spontaneously a thermodynamically stable microemulsion.
ix) Microcapsules (CS)

An oil phase comprising 5-50 wt % of the pesticidal active mixture of the present invention, 0-40 wt % water insoluble organic solvent (e.g. aromatic hydrocarbon), 2-15 wt % acrylic monomers (e.g. methylmethacrylate, methacrylic acid and a di- or triacrylate) are dispersed into an aqueous solution of a protective colloid (e.g. polyvinyl alcohol). Radical polymerization initiated by a radical initiator results in the formation of poly(meth)acrylate microcapsules. Alternatively, an oil phase comprising 5-50 wt % of a compound I according to the invention, 0-40 wt % water insoluble organic solvent (e.g. aromatic hydrocarbon), and an isocyanate monomer (e.g. diphenylmethene-4,4′-diisocyanatae) are dispersed into an aqueous solution of a protective colloid (e.g. polyvinyl alcohol). The addition of a polyamine (e.g. hexamethylenediamine) results in the formation of a polyurea microcapsules. The monomers amount to 1-10 wt %. The wt % relate to the total CS composition.
x) Dustable Powders (DP, DS)

1-10 wt % of the pesticidal active mixture of the present invention is ground finely and mixed intimately with up to 100 wt % solid carrier, e.g. finely divided kaolin.
xi) Granules (GR, FG)

0.5-30 wt % of the pesticidal active mixture of the present invention is ground finely and associated with up to 100 wt % solid carrier (e.g. silicate). Granulation is achieved by extrusion, spray-drying or the fluidized bed.
xii) Ultra-Low Volume Liquids (UL)

1-50 wt % of the pesticidal active mixture of the present invention is dissolved in up to 100 wt % organic solvent, e.g. aromatic hydrocarbon.

The pesticidal active compositions generally comprise between 0.01 and 95%, preferably between 0.1 and 90%, and in particular between 0.5 and 75%, by weight of active substance. The active substances are employed in a purity of from 90% to 100%, preferably from 95% to 100% (according to NMR spectrum).

In one embodiment, a suspoconcentration (SC) is preferred for the application in crop protection. In one sub-embodiment thereof, the SC agrochemical composition comprises between 50 to 500 g/L (grams per Litre), or between 100 and 250 g/L, or 100 g/L or 150 g/L or 200 g/L or 250 g/L.

Water-soluble concentrates (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of plant propagation materials, particularly seeds. The compositions in question give, after two-to-tenfold dilution, active substance concentrations of from 0.01 to 60% by weight, preferably from 0.1 to 40% by weight, in the ready-to-use preparations.

Application can be carried out before or during sowing. Methods for applying the pesticidal active mixture of the present invention and compositions thereof, respectively, on to plant propagation material, especially seeds include dressing, coating, pelleting, dusting, soaking and in-furrow application methods of the propagation material. Preferably, the pesticidal active mixture of the present invention or the compositions thereof, respectively, are applied on to the plant propagation material by a method such that germination is not induced, e. g. by seed dressing, pelleting, coating and dusting.

When employed in plant protection, the amounts of active substances applied are, depending on the kind of effect desired, from 0.001 to 5 kg per ha, preferably from 0.001 to 2 kg per ha, more preferably from 0.005 to 1 kg per ha, in particular from 0.005 to 0.5 kg per ha.

In treatment of plant propagation materials such as seeds, e. g. by dusting, coating or drenching seed, amounts of active substance of 0.1 to 1000 g, preferably from 0.1 to 300 g, more preferably from 0.1 to 100 g and most preferably from 0.25 to 100 g, per 100 kilogram of plant propagation material (preferably seed) are generally required.

When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

Various types of oils, wetters, adjuvants, fertilizer, or micronutrients, and other pesticides (e.g. herbicides, insecticides, fungicides, growth regulators, safeners, biopesticides) may be added to the active substances or the compositions comprising them as premix or, if appropriate not until immediately prior to use (tank mix). These agents can be admixed with the compositions according to the invention in a weight ratio of 1:100 to 100:1, preferably 1:10 to 10:1.

Biopesticides are typically created by growing and concentrating naturally occurring organisms and/or their metabolites including bacteria and other microbes, fungi, viruses, nematodes, proteins, etc. They are often considered to be important components of integrated pest management (IPM) programmes and have received much practical attention as substitutes to synthetic chemical plant protection products (PPPs).

Another aspect of the present invention is when preparing the mixtures, it is preferred to employ the mixture according to the invention to which further active compounds, e.g. against harmful fungi or having herbicidal activity, or growth-regulating agents or fertilizers can be added.

Compositions of this invention may further contain other active ingredients than those listed above. For example, fungicides, herbicides, fertilizers such as ammonium nitrate, urea, potash, and superphosphate, phytotoxicants and plant growth regulators and safeners. These additional ingredients may be used sequentially or in combination with the above-described compositions, if appropriate also added only immediately prior to use (tank mix). For example, the plant(s) may be sprayed with a composition of this invention either before or after being treated with other active ingredients.

Applications

Due to their excellent activity, the pesticidal active mixture according to the present invention or the composition comprising the mixture may be used for controlling invertebrate pests and or phytopathogenic fungi.

The pesticidal mixture according to the present invention comprising the compound of formula (I) and insecticidally active compound (II) or fungicidally active compound (III) can be applied simultaneously, that is jointly or separately, or in succession, that is immediately one after another and thereby creating the mixture “in-situ” on the desired location, as e.g. the plant, the sequence, in the case of separate application, generally not having any effect on the result of the control measures.

In a binary mixtures the pesticidal active mixture and composition according to the present invention comprising the compound of formula (I) and insecticidally active compound (II) or fungicidally active compound (III) are usually applied in a weight ratio of from 5000:1 to 1:5000, preferably from 1000:1 to 1:1000, more preferably from 500:1 to 1:500 and 125:1 to 1:125, particularly preferably from 25:1 to 1:25 and specifically preferable from 10:1 to 1:10, 5:1 to 1:5, 3:1 to 1:3 or 2:1 to 1:2. In such binary mixtures, compound (I) and (II) or (III) maybe used in equal amounts, or an excess of compound (I), or an excess of compound (II) or (III) may be used.

Depending on the desired effect, the application rates of the mixture according to the invention are from 5 g/ha to 5000 g/ha, preferably from 0.5 g/ha to 1000 g/ha, more preferably from 1 g/ha to 750 g/ha, in particular from 5 g/ha to 500 g/ha and 5 g/ha to 200 g/ha.

The pesticidal active mixture according to the present invention or the composition comprising the mixture is effective through both contact and ingestion.

The pesticidal active mixture according to the present invention or the composition comprising the mixture can be applied to any and all developmental stages, such as egg, larva, pupa, and adult. The pests may be controlled by contacting the target pest, its food supply, habitat, breeding ground or its locus with a pesticidally effective amount of the inventive pesticidally active mixture or of compositions comprising the mixture.

According to a preferred embodiment, the pesticidal active mixture according to the present invention or the composition comprising the mixture is used in crop protection, especially for the protection of living plants.

According to another specific embodiment of the invention, the pesticidal active mixture according to the present invention is employed via soil application. Soil application is especially favorable for use against ants, termites, crickets, or cockroaches.

According to another embodiment of the invention, for use against non crop pests such as ants, termites, wasps, flies, mosquitoes, crickets, locusts, or cockroaches, the pesticidal active mixture according to the present invention is prepared into a bait preparation.

The bait can be a liquid, a solid or a semisolid preparation (e.g. a gel).

The animal pest (also referred to as “invertebrate pest”), i.e. the insects, arachnids and nematodes, the plant, soil or water in which the plant is growing can be contacted with the pesticidal active mixture according to the invention or composition(s) comprising the mixture by any application method known in the art. As such, “contacting” includes both direct contact (applying the compounds/compositions directly on the animal pest or plant—typically to the foliage, stem or roots of the plant) and indirect contact (applying the compounds/mixtures/compositions to the locus of the animal pest or plant).

The pesticidal active mixture according to the present invention or the pesticidal composition comprising the mixture may be used to protect growing plants and crops from attack or infestation by animal pests, especially insects, acaridae or arachnids by contacting the plant/crop with a pesticidal effective amount of the mixture according to the invention. The term “crop” refers both to growing and harvested crops.

The pesticidal active mixture according to the present invention and the compositions comprising the mixture are particularly important in the control of a multitude of insects on various cultivated plants, such as cereal, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

The pesticidal active mixture according to the present invention is employed as such or in form of compositions by treating the insects or the plants, plant propagation materials, such as seeds, soil, surfaces, materials or rooms to be protected from insecticidal attack with an insecticidally effective amount of the active compounds. The application can be carried out both before and after the infection of the plants, plant propagation materials, such as seeds, soil, surfaces, materials or rooms by the insects.

The present invention also includes a method of combating animal pests which comprises contacting the animal pests, their habitat, breeding ground, food supply, cultivated plants, seed, soil, area, material or environment in which the animal pests are growing or may grow, or the materials, plants, seeds, soils, surfaces or spaces to be protected from animal attack or infestation with a pesticidally effective amount of a mixture of at least one active compound I and at least one active compound II.

Moreover, animal pests may be controlled by contacting the target pest, its food supply, habitat, breeding ground or its locus with a pesticidal effective amount of a mixture according to the invention. As such, the application may be carried out before or after the infection of the locus, growing crops, or harvested crops by the pest.

The pesticidal active mixture according to the present invention or the composition comprising the mixture can also be applied preventively to places at which occurrence of the pests is expected.

The pesticidal active mixture according to the present invention or the composition comprising the mixture may be also used to protect growing plants from attack or infestation by pests by contacting the plant with a pesticidally effective amount of mixture according to the invention. As such, “contacting” includes both direct contact (applying the compounds/compositions directly on the pest and/or plant—typically to the foliage, stem or roots of the plant) and indirect contact (applying the mixtures according to the invention/compositions to the locus of the pest and/or plant).

“Locus” means a habitat, breeding ground, plant, seed, soil, area, material or environment in which a pest or parasite is growing or may grow.

The term “plant propagation material” is to be understood to denote all the generative parts of the plant such as seeds and vegetative plant material such as cuttings and tubers (e. g. potatoes), which can be used for the multiplication of the plant. This includes seeds, roots, fruits, tubers, bulbs, rhizomes, shoots, sprouts and other parts of plants. Seedlings and young plants, which are to be transplanted after germination or after emergence from soil, may also be included. These plant propagation materials may be treated prophylactically with a plant protection compound either at or before planting or transplanting.

The term “cultivated plants” is to be understood as including plants which have been modified by breeding, mutagenesis or genetic engineering. Genetically modified plants are plants, the genetic material of which has been so modified by the use of recombinant DNA techniques that under natural circumstances cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-transitional modification of protein(s) (oligo- or polypeptides) for example by glycosylation or polymer additions such as prenylated, acetylated or farnesylated moieties or PEG moieties (e.g. as disclosed in Biotechnol Prog. 2001 July-August; 17(4):720-8., Protein Eng Des Sel. 2004 January; 17(1):57-66, Nat Protoc. 2007; 2(5): 1225-35., Curr Opin Chem Biol. 2006 October; 10(5):487-91. Epub 2006 Aug. 28., Biomaterials. 2001 March; 22(5):405-17, Bioconjug Chem. 2005 January-February; 16(1):113-21).

The term “cultivated plants” is to be understood also including plants that have been rendered tolerant to applications of specific classes of herbicides, such as hydroxy-phenylpyruvate dioxygenase (HPPD) inhibitors; acetolactate synthase (ALS) inhibitors, such as sulfonyl ureas (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e. g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073); enolpyruvylshikimate-3-phosphate synthase (EPSPS) inhibitors, such as glyphosate (see e. g. WO 92/00377); glutamine synthetase (GS) inhibitors, such as glufosinate (see e. g. EP-A-0242236, EP-A-242246) or oxynil herbicides (see e. g. U.S. Pat. No. 5,559,024) as a result of conventional methods of breeding or genetic engineering. Several cultivated plants have been rendered tolerant to herbicides by conventional methods of breeding (mutagenesis), for example Clearfield® summer rape (Canola) being tolerant to imidazolinones, e. g. imazamox. Genetic engineering methods have been used to render cultivated plants, such as soybean, cotton, corn, beets and rape, tolerant to herbicides, such as glyphosate and glufosinate, some of which are commercially available under the trade names RoundupReady® (glyphosate) and LibertyLink® (glufosinate).

The term “cultivated plants” is to be understood also including plants that are by the use of recombinant DNA techniques capable to synthesize one or more insecticidal proteins, especially those known from the bacterial genus Bacillus, particularly from Bacillus thuringiensis, such as a-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, for example Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, for example WO 02/015701). Further examples of such toxins or genetically modified plants capable of synthesizing such toxins are dis-closed, for example, in EP-A 374 753, WO 93/007278, WO 95/34656, EP-A 427 529, EP-A 451 878, WO 03/018810 and WO 03/052073.

The methods for producing such genetically modified plants are generally known to the person skilled in the art and are described, for example, in the publications mentioned above. These insecticidal proteins, contained in the genetically modified plants, impart to the plants producing these proteins protection from harmful pests from certain taxonomic groups of arthropods, particularly to beetles (Coleoptera), flies (Diptera), and butterflies and moths (Lepidoptera) and to plant parasitic nematodes (Nematoda).

The term “cultivated plants” is to be understood also including plants that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, for example EP-A 0 392 225), plant disease resistance genes (for example potato cultivars, which express resistance genes acting against Phytophthora infestans derived from the mexican wild potato Solanum bulbocastanum) or T4-lyso-zym (e. g. potato cultivars capable of synthesizing these proteins with increased resistance against bacteria such as Erwinia amylvora). The methods for producing such genetically modified plants are generally known to the person skilled in the art and are described, for example, in the publications mentioned above.

The term “cultivated plants” is to be understood also including plants that are by the use of recombinant DNA techniques capable to synthesize one or more proteins to increase the productivity (e. g. bio mass production, grain yield, starch content, oil content or protein content), tolerance to drought, salinity or other growth-limiting environ-mental factors or tolerance to pests and fungal, bacterial or viral pathogens of those plants.

The term “cultivated plants” is to be understood also including plants that contain by the use of recombinant DNA techniques a modified amount of substances of content or new substances of content, specifically to improve human or animal nutrition, for example oil crops that produce health-promoting long-chain omega-3 fatty acids or unsaturated omega-9 fatty acids (e. g. Nexera® rape).

The term “cultivated plants” is to be understood also including plants that contain by the use of recombinant DNA techniques a modified amount of substances of content or new substances of content, specifically to improve raw material production, for example potatoes that produce increased amounts of amylopectin (e. g. Amflora® potato).

In general, “pesticidally effective amount” means the amount of active ingredients or mixture according to the invention needed to achieve an observable effect on growth, including the effects of necrosis, death, retardation, prevention, and removal, destruction, or otherwise diminishing the occurrence and activity of the target organism. The pesticidally effective amount can vary for the various mixtures/compositions used in the invention. A pesticidally effective amount of the compositions will also vary according to the prevailing conditions such as desired pesticidal effect and duration, weather, target species, locus, mode of application, and the like.

In the case of foliar treatment, the quantity of active ingredient ranges from 0.01 to 5000 g per hectare, e.g. from 0.1 g to 2000 g per hectare or from 1 g to 500 g per ha, desirably from 10 g to 200 g per hectare, preferably from 15 to 100 g per hectare, or from 20 to 80 g per hectare, or from 10 to 60 g per hectare, or from 20 to 50 g per hectare, or from 30 to 50 g per hectare, or from 40 to 50 g per hectare.

In the case of soil treatment or of application to the pests dwelling place or nest, the quantity of active ingredient ranges from 0.0001 to 500 g per 100 m², preferably from 0.001 to 20 g per 100 m².

Customary application rates in the protection of materials are, for example, from 0.01 g to 1000 g of active compounds per m² treated material, desirably from 0.1 g to 50 g per m².

Insecticidal compositions for use in the impregnation of materials typically contain from 0.001 to 95 weight %, preferably from 0.1 to 45 weight %, and more preferably from 1 to 25 weight % of at least one repellent and/or insecticide.

The pesticidal active mixture according to the invention or the composition comprising the mixture is effective through both contact (via soil, glass, wall, bed net, carpet, plant parts or animal parts), and ingestion (bait, or plant part).

The pesticidal active mixture according to the invention or the composition comprising the mixture may also be applied against non-crop insect pests, such as ants, termites, wasps, flies, mosquitos, crickets, or cockroaches. For use against said non-crop pests, the pesticidal active mixture according to the invention or the composition comprising the mixture is preferably used in a bait composition.

The bait employed in the composition is a product, which is sufficiently attractive to incite insects such as ants, termites, wasps, flies, mosquitos, crickets etc. or cockroaches to eat it.

The attractiveness can be manipulated by using feeding stimulants or sex pheromones. Food stimulants are chosen, for example, but not exclusively, from animal and/or plant proteins (meat-, fish- or blood meal, insect parts, egg yolk), from fats and oils of animal and/or plant origin, or mono-, oligo- or polyorganosaccharides, especially from sucrose, lactose, fructose, dextrose, glucose, starch, pectin or even molasses or honey. Fresh or decaying parts of fruits, crops, plants, animals, insects or specific parts thereof can also serve as a feeding stimulant.

Sex pheromones are known to be more insect specific. Specific pheromones are described in the literature and are known to those skilled in the art.

For use in bait compositions, the typical content of active ingredients is from 0.001 weight % to 15 weight %, desirably from 0.001 weight % to 5% weight % of active compounds.

Formulations of the pesticidal active mixture according to the invention as aerosols (e.g in spray cans), oil sprays or pump sprays are highly suitable for the non-professional user for controlling pests such as flies, fleas, ticks, mosquitos or cockroaches. Aerosol recipes are preferably composed of the active compound(s), solvents such as lower alcohols (e.g. methanol, ethanol, propanol, butanol), ketones (e.g. acetone, methyl ethyl ketone), paraffin hydrocarbons (e.g. kerosenes) having boiling ranges of approximately 50 to 250° C., dimethylformamide, N-methylpyrrolidone, dimethyl sulfoxide, aromatic hydrocarbons such as toluene, xylene, water, furthermore auxiliaries such as emulsifiers such as sorbitol monooleate, oleyl ethoxylate having 3-7 mol of ethylene oxide, fatty alcohol ethoxylate, perfume oils such as ethereal oils, esters of medium fatty acids with lower alcohols, aromatic carbonyl compounds, if appropriate stabilizers such as sodium benzoate, amphoteric surfactants, lower epoxides, triethyl orthoformate and, if required, propellants such as propane, butane, nitrogen, compressed air, dimethyl ether, carbon dioxide, nitrous oxide, or mixtures of these gases.

The oil spray formulations differ from the aerosol recipes in that no propellants are used.

For use in spray compositions, the content of active ingredient is from 0.001 to 80 weights %, preferably from 0.01 to 50 weight % and most preferably from 0.01 to 15 weight %.

The pesticidally active mixture according to the invention and composition comprising the mixture can also be used in mosquito and fumigating coils, smoke cartridges, vaporizer plates or long-term vaporizers and also in moth papers, moth pads or other heat-independent vaporizer systems.

Methods to control insects causing infectious diseases (e.g. malaria, dengue and yellow fever, lymphatic filariasis, and leishmaniasis) with pesticidally active mixture according to the invention and their respective compositions also comprise treating surfaces of huts and houses, air spraying and impregnation of curtains, tents, clothing items, bed nets, tsetse-fly trap or the like. Insecticidal compositions for application to fibers, fabric, knitgoods, nonwovens, netting material or foils and tarpaulins preferably comprise a mixture including the insecticide, optionally a repellent and at least one binder. Suitable repellents for example are N,N-Diethyl-meta-toluamide (DEET), N,N-diethylphenylacetamide (DEPA), 1-(3-cyclohexan-1-yl-carbonyl)-2-methylpiperine, (2-hydroxymethylcyclohexyl) acetic acid lactone, 2-ethyl-1,3-hexandiol, indalone, Methylneodecanamide (MNDA), a pyrethroid not used for insect control such as {(+/−)-3-allyl-2-methyl-4-oxocyclopent-2-(+)-enyl-(+)-trans-chrysantemate (Esbiothrin), a repellent derived from or identical with plant extracts like limonene, eugenol, (+)-Eucamalol (1), (−)-1-epi-eucamalol or crude plant extracts from plants like Eucalyptus maculata, Vitex rotundifolia, Cymbopogan martinii, Cymbopogan citratus (lemon grass), Cymopogan nartdus (citronella).

Suitable binders are selected for example from polymers and copolymers of vinyl esters of aliphatic acids (such as such as vinyl acetate and vinyl versatate), acrylic and methacrylic esters of alcohols, such as butyl acrylate, 2-ethylhexylacrylate, and methyl acrylate, mono- and di-ethylenically unsaturated hydrocarbons, such as styrene, and aliphatic diens, such as butadiene.

The pesticidal active mixture according to the present invention and the composition comprising the same can be used for protecting wooden materials such as trees, board fences, sleepers, etc. and buildings such as houses, outhouses, factories, but also construction materials, furniture, leathers, fibers, vinyl articles, electric wires and cables etc. from ants and/or termites, and for controlling ants and termites from doing harm to crops or human being (e.g. when the pests invade into houses and public facilities). The pesticidal active mixture according to the invention or the composition comprising the mixture is applied not only to the surrounding soil surface or into the under-floor soil in order to protect wooden materials but it can also be applied to lumbered articles such as surfaces of the under-floor concrete, alcove posts, beams, plywoods, furniture, etc., wooden articles such as particle boards, half boards, etc. and vinyl articles such as coated electric wires, vinyl sheets, heat insulating material such as styrene foams, etc. In case of application against ants doing harm to crops or human beings, the ant controller of the present invention is applied to the crops or the surrounding soil or is directly applied to the nest of ants or the like.

Seed Treatment

The pesticidal active mixture according to the present invention or the composition comprising the mixture is also suitable for the treatment of seeds in order to protect the seed from insect pests, in particular from soil-living insect pests and the resulting plant's roots and shoots against soil pests and foliar insects.

The pesticidal active mixture according to the present invention or the composition comprising the mixture is particularly useful for the protection of the seed from soil pests and the resulting plant's roots and shoots against soil pests and foliar insects.

The protection of the resulting plant's roots and shoots is preferred. More preferred is the protection of resulting plant's shoots from piercing and sucking insects.

The present invention therefore comprises a method for the protection of seeds from insects, in particular from soil insects and of the seedlings' roots and shoots from insects, in particular from soil and foliar insects, said method comprising contacting the seeds before sowing and/or after pregermination with a mixture according to the invention. Particularly preferred is a method, wherein the plant's roots and shoots are protected, more preferably a method, wherein the plants shoots are protected from piercing and sucking insects, most preferably a method, wherein the plants shoots are protected from aphids. Also preferred is a method, wherein the plant's roots and shoots are protected from chewing and biting insects, most preferably a method, wherein the plants shoots and roots are protected from Lepidoptera and/or Coleoptera, most preferably wherein the plant shoots and roots are protected from rice leaf beetles.

The term seed embraces seeds and plant propagules of all kinds including but not limited to true seeds, seed pieces, suckers, corms, bulbs, fruit, tubers, grains, cuttings, cut shoots and the like and means in a preferred embodiment true seeds.

The term seed treatment comprises all suitable seed treatment techniques known in the art, such as seed dressing, seed coating, seed dusting, seed soaking and seed pelleting.

The present invention also comprises seeds coated with or containing the pesticidal active mixture according to the invention.

The term “coated with and/or containing” generally signifies that the active ingredient is for the most part on the surface of the propagation product at the time of application, although a greater or lesser part of the ingredient may penetrate into the propagation product, depending on the method of application. When the said propagation product is (re)planted, it may absorb the active ingredient.

Suitable seed is seed of cereals, root crops, oil crops, vegetables, spices, ornamentals, for example seed of durum and other wheat, barley, oats, rye, maize (fodder maize and sugar maize/sweet and field corn), soybeans, oil crops, crucifers, cotton, sunflowers, bananas, rice, oilseed rape, turnip rape, sugarbeet, fodder beet, eggplants, potatoes, grass, lawn, turf, fodder grass, tomatoes, leeks, pumpkin/squash, cabbage, iceberg lettuce, pepper, cucumbers, melons, Brassica species, melons, beans, peas, garlic, onions, carrots, tuberous plants such as potatoes, sugar cane, tobacco, grapes, petunias, geranium/pelargoniums, pansies and impatiens.

In addition, the pesticidal active mixture according to the present invention or the composition comprising the mixture may also be used for the treatment of seeds from plants, which tolerate the action of herbicides or fungicides or insecticides owing to breeding, including genetic engineering methods.

For example, the pesticidal active mixture according to the invention or the composition comprising the mixture can be employed in treatment of seeds from plants, which are resistant to herbicides from the group consisting of the sulfonylureas, imidazolinones, glufosinate-ammonium or glyphosate-isopropylammonium and analogous active substances (see for example, EP-A 242 236, EP-A 242 246) (WO 92/00377) (EP-A 257 993, U.S. Pat. No. 5,013,659) or in transgenic crop plants, for example cotton, with the capability of producing Bacillus thuringiensis toxins (Bt toxins) which make the plants resistant to certain pests (EP-A 142 924, EP-A 193 259),

Furthermore, the pesticidal active mixture according to the present invention or the composition comprising the mixture can also be used for the treatment of seeds from plants, which have modified characteristics in comparison with existing plants, which can be generated for example by traditional breeding methods and/or the generation of mutants, or by recombinant procedures. For example, a number of cases have been described of recombinant modifications of crop plants for the purpose of modifying the starch synthesized in the plants (e.g. WO 92/11376, WO 92/14827, WO 91/19806) or of transgenic crop plants having a modified fatty acid composition (WO 91/13972).

The seed treatment application of the active compounds is carried out by spraying or by dusting the seeds before sowing of the plants and before emergence of the plants.

Compositions which are especially useful for seed treatment are e.g.:
Soluble concentrates (SL, LS)
Emulsions (EW, EO, ES)
E Suspensions (SC, OD, FS)
Water-dispersible granules and water-soluble granules (WG, SG)
Water-dispersible powders and water-soluble powders (WP, SP, WS)
Gel-formulations (GF)
Dustable powders (DP, DS)

Conventional seed treatment formulations include for example flowable concentrates FS, solutions LS, powders for dry treatment DS, water dispersible powders for slurry treatment WS, water-soluble powders SS and emulsion ES and EC and gel formulation GF. These formulations can be applied to the seed diluted or undiluted. Application to the seeds is carried out before sowing, either directly on the seeds or after having pregerminated the latter

In a preferred embodiment a FS formulation is used for seed treatment. Typically, a FS formulation may comprise 1-800 g/l of active ingredient, 1-200 g/I Surfactant, 0 to 200 g/I antifreezing agent, 0 to 400 g/l of binder, 0 to 200 g/l of a pigment and up to 1 liter of a solvent, preferably water.

Especially preferred FS formulations comprising compounds of formula (I), compounds (II) or the pesticidal active mixture according to the invention, for seed treatment usually comprise from 0.1 to 80% by weight (1 to 800 g/l) of the active ingredient, from 0.1 to 20% by weight (1 to 200 g/l) of at least one surfactant, e.g. 0.05 to 5% by weight of a wetter and from 0.5 to 15% by weight of a dispersing agent, up to 20% by weight, e.g. from 5 to 20% of an anti-freeze agent, from 0 to 15% by weight, e.g. 1 to 15% by weight of a pigment and/or a dye, from 0 to 40% by weight, e.g. 1 to 40% by weight of a binder (sticker/adhesion agent), optionally up to 5% by weight, e.g. from 0.1 to 5% by weight of a thickener, optionally from 0.1 to 2% of an anti-foam agent, and optionally a preservative such as a biocide, antioxidant or the like, e.g. in an amount from 0.01 to 1% by weight and a filler/vehicle up to 100% by weight.

Seed Treatment formulations may additionally also comprise binders and optionally colorants. Binders can be added to improve the adhesion of the active materials on the seeds after treatment. Suitable binders are homo- and copolymers from alkylene oxides like ethylene oxide or propylene oxide, polyvinylacetate, polyvinylalcohols, polyvinylpyrrolidones, and copolymers thereof, ethylene-vinyl acetate copolymers, acrylic homo- and copolymers, polyethyleneamines, polyethyleneamides and polyethyleneimines, polysaccharides like celluloses, tylose and starch, polyolefin homo- and copolymers like olefin/maleic anhydride copolymers, polyurethanes, polyesters, polystyrene homo and copolymers

Optionally, also colorants can be included in the formulation. Suitable colorants or dyes for seed treatment formulations are Rhodamin B, C.I. Pigment Red 112, C.I. Solvent Red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of a gelling agent is carrageen (Satiagel®)

In the treatment of seed, the application rates of the compounds I are generally from 0.1 g to 10 kg per 100 kg of seed, preferably from 1 g to 5 kg per 100 kg of seed, more preferably from 1 g to 1000 g per 100 kg of seed and in particular from 1 g to 200 g per 100 kg of seed.

The present invention therefore also relates to seed comprising a compound of the formula (I), or an agriculturally useful salt of compound of formula (I), as defined herein.

The amount of the compound of formula (I) or the agriculturally useful salt thereof will in general vary from 0.1 g to 10 kg per 100 kg of seed, preferably from 1 g to 5 kg per 100 kg of seed, in particular from 1 g to 1000 g per 100 kg of seed. For specific crops such as lettuce the rate can be higher.

Without further elaboration, it is reasonable to believe that any person skilled in the art who is using the preceding description can utilize the present invention to its fullest extent. The following examples are therefore to be interpreted as merely illustrative and not limiting of the disclosure in any way whatever.

### CHEMISTRY EXAMPLES

### Preparation of Thietan-3-ol

A solution of potassium hydroxide (42.8 g, 648 mmol) in water (200 mL) was saturated with freshly prepared hydrogen sulphide gas. Hydrogen sulphide gas was prepared by adding hydrochloric acid (56.3 mL, 648 mmol) to a solution of sodium sulphide 9-hydrate (156 g, 648 mmol). 2-(chloromethyl)oxirane (25.4 mL, 324 mmol) was added dropwise during 2 h under stirring and simultaneous purging of hydrogen sulphide. The temperature gradually rised to 60° C., the reaction mixture was stirred for 16 h. After completion of the reaction, the reaction mixture was extracted three times with 200 mL of ethyl acetate. The ethyl acetate layer was concentrated under reduced pressure. The crude product was distilled under high vacuum to obtain thietan-3-ol (15 g, 166 mmol, 51% yield) confirmed by GCMS and NMR. ¹H NMR (400 MHz, CDCl₃) δ 4.87 (td, J=15.3, 7.6 Hz, 1H), 3.33-3.37 (m, 2H), 3.24-3.29 (m, 2H), 2.64-2.67 (m, 1H). GC-MS− 90(M).

### Step 1: Preparation of ethyl 3-bromo-1-(3-chloropyridin-2-yl)-4,5-dihydro-1H-pyrazole-5-carboxylate

To a solution of acetonitrile (250 mL) and ethyl 2-(3-chloropyridin-2-yl)-5-oxopyrazolidine-3-carboxylate (25 g, 93 mmol) was added phosphoryl tribromide (31.9 g, 111 mmol) at RT. The reaction mixture was refluxed for 5 h. After completion of the reaction, it was cooled to 25° C. and then the solvent was removed under reduced pressure. The reaction mixture was diluted with water (400 mL) and quenched by saturated sodium bicarbonate solution. The reaction mixture was extracted twice with dichloromethane (700 mL). The combined dichloromethane layers were washed with brine and dried over anhydrous sodium sulphate. Dichloromethane was removed to obtain the crude product, which was purified by combi flash chromatography by using 15% ethyl acetate in hexane. Ethyl 3-bromo-1-(3-chloropyridin-2-yl)-4,5-dihydro-1H-pyrazole-5-carboxylate was obtain in good yield (29 g, 87 mmol, 94% yield).

¹-NMR (400 MHz, DMSO-d₆) δ 8.13 (dd, J=4.6, 1.5 Hz, 1H), 7.79-7.90 (m, 1H), 7.00 (dd, J=7.8, 4.6 Hz, 1H), 5.20 (dd, J=12.0, 8.8 Hz, 1H), 4.30 (d, J=6.8 Hz, 0H), 4.12 (q, J=7.1 Hz, 2H), 3.60 (dd, J=17.6, 12.0 Hz, 1H), 3.26-3.38 (m, 1H), 0.85-1.34 (m, 3H).

### Step 2: Preparation of ethyl 1-(3-chloropyridin-2-yl)-3-(thietan-3-yloxy)-4,5-dihydro-1H-pyrazole-5-carboxylate

To a stirred solution of ethyl 3-bromo-1-(3-chloropyridin-2-yl)-4,5-dihydro-1H-pyrazole-5-carboxylate (32 g, 96 mmol) in toluene (320 mL) was added Cuprous Iodide (9.16 g, 48.1 mmol) 1,10-phenanthroline (12.14 g, 67.4 mmol), potassium carbonate (39.9 g, 289 mmol) and thietan-3-ol (13.01 g, 144 mmol). The reaction was heated to reflux temperature for 16 h. After completion of the reaction, the resultant mixture was filtered. The obtained filtrate was diluted with water, extracted with ethyl acetate (250 ml). The organic layer was dried over sodium sulphate, evaporated. The obtained crude was purified by column chromatography and afforded ethyl 1-(3-chloropyridin-2-yl)-3-(thietan-3-yloxy)-4,5-dihydro-1H-pyrazole-5-carboxylate (18 g, 52.7 mmol, 54.7% yield) confirmed by LCMS.

LC-MS: m/z=342.1 [M+H].

### Step 3: Preparation of ethyl 1-(3-chloropyridin-2-yl)-3-(thietan-3-yloxy)-1H-pyrazole-5-carboxylate

To a stirred solution of ethyl 1-(3-chloropyridin-2-yl)-3-(thietan-3-yloxy)-4,5-dihydro-1H-pyrazole-5-carboxylate (16 g, 46.8 mmol) in dioxane (160 mL) was added DDQ (12.75 g, 56.2 mmol). The reaction was heated to reflux temperature for 16 h. After completion of the reaction, the resultant mixture was filtered. The obtained filtrate was diluted with water and extracted with ethyl acetate (150 mL). The ethyl acetate layer was dried over sodium sulphate, evaporated. The obtained crude was purified by column chromatography to obtain ethyl 1-(3-chloropyridin-2-yl)-3-(thietan-3-yloxy)-1H-pyrazole-5-carboxylate (9 g, 26.5 mmol, 56.6% yield).

¹H NMR (400 MHz, DMSO-d₆) δ 8.51-8.53 (m, 1H), 8.21 (td, J=4.1, 1.5 Hz, 1H), 7.63 (dd, J=8.1, 4.7 Hz, 1H), 6.65 (t, J=2.5 Hz, 1H), 5.42-5.50 (m, 1H), 4.09-4.14 (m, 2H), 3.48 (td, J=8.0, 1.7 Hz, 2H), 3.39 (td, J=7.6, 1.9 Hz, 2H), 1.03-1.07 (m, 3H). LCMS: m/z=340 [M+H].

### Step 4: Preparation of 1-(3-chloropyridin-2-yl)-3-(thietan-3-yloxy)-1H-pyrazole-5-carboxylic acid

To a stirred solution of ethyl 1-(3-chloropyridin-2-yl)-3-(thietan-3-yloxy)-1H-pyrazole-5-carboxylate (1.5 g, 4.4 mmol) in tetrahydrofuran (7 mL), methanol (1 mL) and water (4 mL), lithium hydroxide hydrate (0.4 g, 8.8 mmol) was added and stirred at 25° C. for 2 h. After completion of the reaction, the reaction mixture was concentrated under reduced pressure. The reaction mixture was diluted with water (5 mL) and acidified using 10% hydrochloric acid at 0° C. The precipitated solid was filtered off and solids were washed with pentane, dried under vacuum to obtain 1-(3-chloropyridin-2-yl)-3-(thietan-3-yloxy)-1H-pyrazole-5-carboxylic acid (1 g, 3.2 mmol, 74% yield).

¹H-NMR (400 MHz, DMSO-d₆) δ 13.88-13.24 (1H), 8.50 (d, J=3.7 Hz, 1H), 8.17 (d, J=7.9 Hz, 1H), 7.60 (dd, J=7.7, 4.7 Hz, 1H), 6.56 (d, J=14.1 Hz, 1H), 5.41-5.48 (m, 1H), 3.48 (t, J=8.5 Hz, 2H), 3.36-3.40 (m, 2H).

### Step 5: Preparation of 6-chloro-2-(1-(3-chloropyridin-2-yl)-3-(thietan-3-yloxy)-1H-pyrazol-5-yl)-8-methyl-4H-benzo[d][1,3]oxazin-4-one

Ms-Cl (4.87 mL, 62.6 mmol) was dissolved in acetonitrile (50 mL) and the resultant mixture was cooled to 0° C. A solution of 1-(3-chloropyridin-2-yl)-3-(thietan-3-yloxy)-1H-pyrazole-5-carboxylic acid (15 g, 48.1 mmol) and pyridine (6.62 ml, 82 mmol) in acetonitrile (75 mL) was added dropwise over five minutes at the same temperature. A slurry was formed during the addition. The mixture was stirred for ten minutes at this temperature. Then 2-amino-5-chloro-3-methylbenzoic acid (8.93 g, 48.1 mmol), pyridine (6.62 ml, 82 mmol) in acetonitrile (75 mL) was added to the reaction mixture. The reaction mixture was stirred 15 minutes at the same temperature and Ms-Cl (4.87 mL, 62.6 mmol) in acetonitrile (50 ml) was added dropwise over five minutes at the same temperature. Then reaction mixture was stirred at same temperature for 15 min and at 25° C. for 16 h. After completion of the reaction, the reaction mixture was diluted with water and precipitated solid was filtered, washed with water, dried under vacuum to obtain 6-chloro-2-(1-(3-chloropyridin-2-yl)-3-(thietan-3-yloxy)-1H-pyrazol-5-yl)-8-methyl-4H-benzo[d][1,3]oxazin-4-one (17 g, 36.9 mmol, 77% yield)

¹H-NMR (400 MHz, DMSO-d₆) δ 8.57 (dd, J=4.7, 1.4 Hz, 1H), 8.27 (dd, J=8.1, 1.5 Hz, 1H), 7.88 (d, J=2.3 Hz, 1H), 7.76 (d, J=1.7 Hz, 1H), 7.69 (dd, J=8.1, 4.7 Hz, 1H), 6.84 (s, 1H), 5.48-5.56 (m, 1H), 3.52 (dd, J=9.8, 7.9 Hz, 2H), 3.40-3.45 (m, 2H), 1.71 (s, 3H). LCMS: m/z=460.90 [M+H]

### Step 6: Preparation of N-(2-(tert-butylcarbamoyl)-4-chloro-6-methylphenyl)-1-(3-chloropyridin-2-yl)-3-(thietan-3-yloxy)-1H-pyrazole-5-carboxamide

A stirred solution of 6-chloro-2-(1-(3-chloropyridin-2-yl)-3-(thietan-3-yloxy)-1H-pyrazol-5-yl)-8-methyl-4H-benzo[d][1,3]oxazin-4-one (22 g, 47.7 mmol) in tetrahydrofuran (220 mL) was cooled to 0° C., and 2-methylpropan-2-amine (15.03 ml, 143 mmol) was added dropwise to it. The resulting reaction mixture was stirred at 0° C. for 2 h. After completion of the reaction, the reaction mixture was concentrated. The crude product was purified by column chromatography using 4-5% methanol/dichloromethane and afforded N-(2-(tert-butylcarbamoyl)-4-chloro-6-methylphenyl)-1-(3-chloropyridin-2-yl)-3-(thietan-3-yloxy)-1H-pyrazole-5-carboxamide (17 g, 31.8 mmol, 66.7% yield).

¹H-NMR (400 MHz, DMSO-d₆) δ 10.05 (s, 1H), 8.44 (dd, J=4.6, 1.5 Hz, 1H), 8.11 (dd, J=8.1, 1.5 Hz, 1H), 7.61 (s, 1H), 7.54 (dd, J=8.1, 4.6 Hz, 1H), 7.43 (d, J=2.0 Hz, 1H), 7.26 (d, J=2.0 Hz, 1H), 6.72 (s, 1H), 5.44-5.51 (m, 1H), 3.51-3.55 (m, 2H), 3.38-3.43 (m, 2H), 2.15 (s, 3H), 1.23-1.26 (m, 9H). LCMS: m/z=534 [M+H].

### Step 7: N-(2-(tert-butylcarbamoyl)-4-chloro-6-methylphenyl)-1-(3-chloropyridin-2-yl)-3-((1,1-dioxidothietan-3-yl)oxy)-1H-pyrazole-5-carboxamide

To a stirred solution of N-(2-(tert-butylcarbamoyl)-4-chloro-6-methylphenyl)-1-(3-chloropyridin-2-yl)-3-(thietan-3-yloxy)-1H-pyrazole-5-carboxamide (35 g, 65.5 mmol) in acetic acid (300 mL), hydrogenperoxide (H₂O₂) (20.07 mL, 196 mmol) was added slowly to the reaction mixture. The reaction mixture was heated to 100° C., stirred for 3 h. After completion of the reaction, the reaction mixture was alkalised with 15% NaOH aqueous solution. The reaction mixture was diluted with 150 ml water and extracted with dichloromethane (2×250 mL) and dried with sodium sulphate. The dichloromethane layer was concentrated under reduced pressure, the crude was purified with a combiflash chromatography to obtain N-(2-(tert-butylcarbamoyl)-4-chloro-6-methylphenyl)-1-(3-chloropyridin-2-yl)-3-((1,1-dioxidothietan-3-yl)oxy)-1H-pyrazole-5-carboxamide (23.05 g, 40.7 mmol, 62.1% yield).

¹H-NMR (400 MHz, DMSO-d6) δ 10.11 (s, 1H), 8.45 (dd, J=4.6, 1.5 Hz, 1H), 8.12 (dd, J=7.9, 1.6 Hz, 1H), 7.62 (s, 1H), 7.56 (dd, J=7.9, 4.8 Hz, 1H), 7.43-7.44 (m, 1H), 7.27 (d, J=2.0 Hz, 1H), 6.80 (s, 1H), 5.29-5.34 (m, 1H), 4.71-4.77 (m, 2H), 4.29 (dd, J=15.9, 2.4 Hz, 2H), 2.16-2.34 (m, 3H), 1.25 (s, 9H). LCMS: m/z=566 [M+H].

Biology

As described herein, the compounds of formula (I) and the compositions thereof show synergistic insecticidal/fungicidal activities which are exerted with respect to numerous pest/phytopathogenic fungi which attacks on important agricultural crops.

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 20-22):

Colby's Formulas:

The expected activity for a given combination of two active compounds (binary composition) can be calculated as follows:

E=X+Y−(XY/100)

In which E represents the expected percentage of inhibition of the pests for the combination of two insecticides or one insecticide and one fungicide at defined doses (for example equal to x and y respectively), x is the percentage of inhibition observed for the pest/disease by the compound (1) at a given dose (equal to x), y is the percentage of inhibition observed for the pest/disease by the compound (2) or (3) at a defined dose (equal to y). When the percentage of inhibition observed for the combination is greater than E, there is a synergistic effect.

The expected activity for a given combination of three active compounds (ternary composition) can be calculated as follows:

E=X+Y+Z−(XY+XZ+YZ)/100+(XYZ)/10000
X: efficacy, expressed in % of the untreated control, when using the active compound (1) at the concentration a,
Y: efficacy, expressed in % of the untreated control, when using the active compound (2) at the concentration b
Z: efficacy, expressed in % of the untreated control, when using the active compound (3) at the concentration c.
E is the efficacy when the active compounds (1), (2) and (3) are applied at application rates of a, b and c.

The following biological tests demonstrate the pesticidal efficacy of compounds, mixtures or compositions of this invention on important pests. However, the pest control protection afforded by the compounds, mixtures or compositions is not limited to these species. In certain instances, combinations of a compound of this invention with other invertebrate pest control compounds or agents are found to exhibit similar synergistic effects against further invertebrate pests.

### BIOLOGY EXAMPLES

The compounds of formula (I-1) in a binary mixture with different other insecticides or fungicides of the present invention were assessed for their insecticidal activity as described in the following tests:

### Example A: Compound of (I-1) and Mixtures Thereof Against Helicoverpa armigera

The diet incorporation method was used, in which semi-synthetic diet was incorporated into the test solutions consisting either of the single compounds or respective compound combinations, when the temperature was approximately 50° C. in the bio-assay containers, then stirred thoroughly for proper mixing and allowed to cool for 30 min. The solidified diet was cut into equal pieces, and then each piece was transferred into one cell of a bio-assay tray. A single starved third instar larva was released into each of these cells of the bio-assay trays and the tray was covered with a lid. The bio-assay trays were kept under laboratory conditions at a temperature of 25° C. and relative humidity of 70%. Observations on dead, moribund and live larvae were recorded 96 h after the release of the larvae. Percent mortality was calculated by combining dead and moribund larvae and comparing the result to the one of the untreated control. The results are shown for the compound of formula (I-1) in Table A.

Surprisingly, the following combinations, indicated in the table below, have revealed unexpected synergistic effects:

TABLE A
Evaluation of Compound (I-1), insecticides selected from [(II-1A]
to (II-33)] or [(Z001) to (Z377)] or fungicides selected
from groups A) to P) and mixtures thereof against Helicoverpa armigera

| | | | | Expected | |
|---|---|---|---|---|---|
| | | | Observed | Efficacy | |
| | Conc. | | Efficacy | (%) | Synergy |
| Compounds | (ppm) | Ratio | (%) | (Colby's) | (%) |
| Compound (I-1) | 0.41 | | 50 | | |
| Broflanilide | 0.12 | | 0 | | |
| Compound (I-1) + | 0.41 + 0.12 | 3.4:1 | 62.5 | 50 | 13 |
| Broflanilide | | | | | |
| Compound (I-1) | 0.1 | | 12.5 | | |
| Broflanilide | 0.05 | | 12.5 | | |
| Compound (I-1) + | 0.1 + 0.05 | 2:1 | 50 | 23 | 27 |
| Broflanilide | | | | | |
| Compound (I-1) | 0.1 | | 25 | | |
| Broflanilide | 0.15 | | 12.5 | | |
| Compound (I-1) + | 0.1 + 0.15 | 1:1.5 | 50 | 34 | 16 |
| Broflanilide | | | | | |
| Compound (I-1) | 0.1 | | 12.5 | | |
| Bifenthrin | 20 | | 75 | | |
| Compound (I-1) + | 0.1 + 20 | 1:200 | 100 | 78 | 22 |
| Bifenthrin | | | | | |
| Compound (I-1) | 0.1 | | 25 | | |
| Emamectin benzoate | 0.05 | | 0 | | |
| Compound (I-1) + | 0.1 + 0.05 | 2:1 | 37.5 | 25 | 13 |
| Emamectin benzoate | | | | | |
| Compound (I-1) | 0.1 | | 12.5 | | |
| Indoxacarb | 0.2 | | 0 | | |
| Compound (I-1) + | 0.1 + 0.2 | 1:2 | 37.5 | 13 | 25 |
| Indoxacarb | | | | | |
| Compound (I-1) | 0.41 | | 50 | | |
| Fluxametamide | 0.28 | | 12.5 | | |
| Compound (I-1) + | 0.41 + 0.28 | 1.5:1 | 100 | 56 | 44 |
| Fluxametamide | | | | | |
| Compound (I-1) | 0.1 | | 12.5 | | |
| Fluxametamide | 0.13 | | 12.5 | | |
| Compound (I-1) + | 0.1 + 0.13 | 1:1.3 | 100 | 23 | 77 |
| Fluxametamide | | | | | |
| Compound (I-1) | 0.1 | | 25 | | |
| Spinosad | 0.2 | | 0 | | |
| Compound (I-1) + | 0.1 + 0.2 | 1:2 | 50 | 25 | 25 |
| Spinosad | | | | | |
| Compound (I-1) | 0.1 | | 12.5 | | |
| Spinetoram | 2.5 | | 87.5 | | |
| Compound (I-1) + | 0.1 + 2.5 | 1:25 | 100 | 89 | 11 |
| Spinoteram | | | | | |
| Compound (I-1) | 1 | | 25 | | |
| Imidacloprid | 50 | | 0 | | |
| Compound (I-1) + | 1 + 50 | 1:50 | 37.5 | 25 | 13 |
| Imidacloprid | | | | | |
| Compound (I-1) | 1 | | 25 | | |
| Thiamethoxam | 100 | | 25 | | |
| Compound (I-1) + | 1 + 100 | 1:100 | 87.5 | 44 | 44 |
| Thiamethoxam | | | | | |
| Compound (I-1) | 1 | | 25 | | |
| Afidopyropen | 100 | | 0 | | |
| Compound (I-1) + | 1 + 100 | 1:100 | 75 | 25 | 50 |
| Afidopyropen | | | | | |
| Compound (I-1) | 1 | | 25 | | |
| Fluopyram | 50 | | 0 | | |
| Compound (I-1) + | 1 + 50 | 1:50 | 100 | 25 | 75 |
| Fluopyram | | | | | |
| Compound (I-1) | 1 | | 25 | | |
| Fluopyram | 100 | | 0 | | |
| Compound (I-1) + | 1 + 100 | 1:100 | 75 | 25 | 50 |
| Fluopyram | | | | | |
| Compound (I-1) | 1 | | 25 | | |
| Triflumezopyrim | 50 | | 12.5 | | |
| Compound (I-1) + | 1 + 50 | 1:50 | 87.5 | 34 | 53 |
| Triflumezopyrim | | | | | |
| Compound (I-1) | 1 | | 25 | | |
| Triflumezopyrim | 100 | | 0 | | |
| Compound (I-1) + | 1 + 100 | 1:100 | 75 | 25 | 50 |
| Triflumezopyrim | | | | | |
| Compound (I-1) | 1 | | 25 | | |
| Dimpropyridaz | 100 | | 0 | | |
| Compound (I-1) + | 1 + 100 | 1:100 | 100 | 25 | 75 |
| Dimpropyridaz | | | | | |
| Compound (I-1) | 1 | | 25 | | |
| Tyclopyrazoflor | 100 | | 12.5 | | |
| Compound (I-1) + | 1 + 100 | 1:100 | 100 | 34 | 66 |
| Tyclopyrazoflor | | | | | |
| Compound (I-1) | 1 | | 25 | | |
| Pyraclostrobin | 100 | | 0 | | |
| Compound (I-1) + | 1 + 100 | 1:100 | 50 | 25 | 25 |
| Pyraclostrobin | | | | | |
| Compound (I-1) | 1 | | 25 | | |
| Pyraclostrobin | 200 | | 0 | | |
| Compound (I-1) + | 1 + 200 | 1:200 | 50 | 25 | 25 |
| Pyraclostrobin | | | | | |
| Compound (I-1) | 1 | | 25 | | |
| Pyraclostrobin | 500 | | 0 | | |
| Compound (I-1) + | 1 + 500 | 1:500 | 50 | 25 | 25 |
| Pyraclostrobin | | | | | |
| Compound (I-1) | 1 | | 25 | | |
| Thiophanate-methyl | 100 | | 0 | | |
| Compound (I-1) + | 1 + 100 | 1:100 | 62.5 | 25 | 38 |
| Thiophanate-methyl | | | | | |
| Compound (I-1) | 1 | | 25 | | |
| Thiophanate-methyl | 200 | | 0 | | |
| Compound (I-1) + | 1 + 200 | 1:200 | 62.5 | 25 | 38 |
| Thiophanate-methyl | | | | | |
| Compound (I-1) | 1 | | 25 | | |
| Thiophanate-methyl | 500 | | 0 | | |
| Compound (I-1) + | 1 + 500 | 1:500 | 62.5 | 25 | 38 |
| Thiophanate-methyl | | | | | |
| Compound (I-1) | 1 | | 25 | | |
| Fluxapyroxad | 100 | | 0 | | |
| Compound (I-1) + | 1 + 100 | 1:100 | 75 | 25 | 50 |
| Fluxapyroxad | | | | | |
| Compound (I-1) | 1 | | 25 | | |
| Azoxystrobin | 100 | | 0 | | |
| Compound (I-1) + | 1 + 100 | 1:100 | 62.5 | 25 | 38 |
| Azoxystrobin | | | | | |
| Compound (I-1) | 1 | | 25 | | |
| Azoxystrobin | 200 | | 0 | | |
| Compound (I-1) + | 1 + 200 | 1:200 | 62.5 | 25 | 38 |
| Azoxystrobin | | | | | |
| Compound (I-1) | 1 | | 25 | | |
| Azoxystrobin | 500 | | 0 | | |
| Compound (I-1) + | 1 + 500 | 1:500 | 50 | 25 | 25 |
| Azoxystrobin | | | | | |
| Compound (I-1) | 1 | | 25 | | |
| Fludioxonil | 100 | | 0 | | |
| Compound (I-1) + | 1 + 100 | 1:100 | 75 | 25 | 50 |
| Fludioxonil | | | | | |
| Compound (I-1) | 1 | | 25 | | |
| Probenazole | 200 | | 12.5 | | |
| Compound (I-1) + | 1 + 200 | 1:200 | 87.5 | 34 | 53 |
| Probenazole | | | | | |
| Compound (I-1) | 1 | | 25 | | |
| Isotianil | 100 | | 0 | | |
| Compound (I-1) + | 1 + 100 | 1:100 | 75 | 25 | 50 |
| Isotianil | | | | | |

### Example B: Evaluation of Compound (I-1), Insecticides Selected from [(II-1A] to (II-33)] or [(Z001) to (Z377)] or Fungicides Selected from Groups A) to P) and Mixtures Thereof Against Spodoptera litura

The diet incorporation method was used, in which semi-synthetic diet was incorporated into the test solution consisting either of the single compound or respective compound combinations, when the temperature was approximately 50° C. in the bioassay containers, then stirred thoroughly for proper mixing and allowed to cool for 30 min. The solidified diet was cut into equal pieces, and then each piece was transferred into one cell of the bio-assay trays. A single starved third instar larva was released into each of these cells of the bio-assay trays and the tray was covered with a lid. The bio-assay trays were kept under laboratory conditions at a temperature of 25° C. and relative humidity of 70%. Observations on dead, moribund and live larvae were recorded 96 h after the release. Percent mortality was calculated by combining dead and moribund larvae and comparing the result with the one of the untreated control. The results are shown for the compound of formula (I-1) in Table B.

Surprisingly, the following combinations indicated in the table below, have revealed unexpected synergistic effects:

TABLE B
Evaluation of Compound (I-1) and (insecticides [(II-1A]
to (II-33)] or [(Z001) to (Z37)] or fungicides selected
from groups A) to P)) mixtures thereof against Spodoptera litura

| | | | | Expected | |
|---|---|---|---|---|---|
| | | | Observed | Efficacy | |
| | Conc. | | Efficacy | (%) | Synergy |
| Compounds | (ppm) | Ratio | (%) | (Colby's) | (%) |
| Compound (I-1) | 0.32 | | 37.5 | | |
| Broflanilide | 0.07 | | 0 | | |
| Compound (I-1) + | 0.32 + 0.07 | 4.6:1 | 50 | 38 | 13 |
| Broflanilide | | | | | |
| Compound (I-1) | 0.1 | | 0 | | |
| Bifenthrin | 10 | | 12.5 | | |
| Compound (I-1) + | 0.1 + 10 | 1:100 | 37.5 | 13 | 25 |
| Bifenthrin | | | | | |
| Compound (I-1) | 0.1 | | 0 | | |
| Emamectin benzoate | 0.1 | | 25 | | |
| Compound (I-1) + | 0.1 + 0.1 | 1:1 | 37.5 | 25 | 13 |
| Emamectin benzoate | | | | | |
| Compound (I-1) | 0.1 | | 0 | | |
| Indoxacarb | 0.1 | | 0 | | |
| Compound (I-1) + | 0.1 + 0.1 | 1:1 | 12.5 | 0 | 13 |
| Indoxacarb | | | | | |
| Compound (I-1) | 0.32 | | 37.5 | | |
| Spinosad | 11.88 | | 0 | | |
| Compound (I-1) + | 0.32 + 11.88 | 1:40 | 50 | 38 | 13 |
| Spinosad | | | | | |
| Compound (I-1) | 0.1 | | 0 | | |
| Spinosad | 0.2 | | 0 | | |
| Compound (I-1) + | 0.1 + 0.2 | 1:2 | 25 | 0 | 25 |
| Spinosad | | | | | |
| Compound (I-1) | 1 | | 12.5 | | |
| Imidacloprid | 50 | | 25 | | |
| Compound (I-1) + | 1 + 50 | 1:50 | 50 | 34 | 16 |
| Imidacloprid | | | | | |
| Compound (I-1) | 1 | | 25 | | |
| Imidacloprid | 100 | | 0 | | |
| Compound (I-1) + | 1 + 100 | 1:100 | 50 | 25 | 25 |
| Imidacloprid | | | | | |
| Compound (I-1) | 1 | | 12.5 | | |
| Thiamethoxam | 50 | | 0 | | |
| Compound (I-1) + | 1 + 50 | 1:50 | 50 | 13 | 38 |
| Thiamethoxam | | | | | |
| Compound (I-1) | 1 | | 12.5 | | |
| Clothianidin | 10 | | 0 | | |
| Compound (I-1) + | 1 + 10 | 1:10 | 25 | 13 | 13 |
| Clothianidin | | | | | |
| Compound (I-1) | 1 | | 25 | | |
| Clothianidin | 20 | | 0 | | |
| Compound (I-1) + | 1 + 20 | 1:20 | 87.5 | 25 | 63 |
| Clothianidin | | | | | |
| Compound (I-1) | 1 | | 12.5 | | |
| Afidopyropen | 50 | | 0 | | |
| Compound (I-1) + | 1 + 50 | 1:50 | 50 | 13 | 38 |
| Afidopyropen | | | | | |
| Compound (I-1) | 1 | | 25 | | |
| Afidopyropen | 100 | | 0 | | |
| Compound (I-1) + | 1 + 100 | 1:100 | 87.5 | 25 | 63 |
| Afidopyropen | | | | | |
| Compound (I-1) | 1 | | 25 | | |
| Fluopyram | 100 | | 0 | | |
| Compound (I-1) + | 1 + 100 | 1:100 | 75 | 25 | 50 |
| Fluopyram | | | | | |
| Compound (I-1) | 1 | | 25 | | |
| Dimpropyridaz | 100 | | 0 | | |
| Compound (I-1) + | 1 + 100 | 1:100 | 87.5 | 25 | 63 |
| Dimpropyridaz | | | | | |
| Compound (I-1) | 1 | | 25 | | |
| Oxazosulfyl | 100 | | 0 | | |
| Compound (I-1) + | 1 + 100 | 1:100 | 87.5 | 25 | 63 |
| Oxazosulfyl | | | | | |
| Compound (I-1) | 1 | | 25 | | |
| Tyclopyrazoflor | 100 | | 0 | | |
| Compound (I-1) + | 1 + 100 | 1:100 | 87.5 | 25 | 63 |
| Tyclopyrazoflor | | | | | |
| Compound (I-1) | 0.1 | | 12.5 | | |
| Isocycloseram | 10 | | 12.5 | | |
| Compound (I-1) + | 0.1 + 10 | 1:100 | 50 | 23 | 27 |
| Isocycloseram | | | | | |
| Compound (I-1) | 1 | | 25 | | |
| Pyraclostrobin | 100 | | 0 | | |
| Compound (I-1) + | 1 + 100 | 1:100 | 50 | 25 | 25 |
| Pyraclostrobin | | | | | |
| Compound (I-1) | 1 | | 25 | | |
| Pyraclostrobin | 200 | | 0 | | |
| Compound (I-1) + | 1 + 200 | 1:200 | 50 | 25 | 25 |
| Pyraclostrobin | | | | | |
| Compound (I-1) | 1 | | 25 | | |
| Pyraclostrobin | 500 | | 0 | | |
| Compound (I-1) + | 1 + 500 | 1:500 | 50 | 25 | 25 |
| Pyraclostrobin | | | | | |
| Compound (I-1) | 1 | | 25 | | |
| Thiophanate-methyl | 100 | | 0 | | |
| Compound (I-1) + | 1 + 100 | 1:100 | 50 | 25 | 25 |
| Thiophanate-methyl | | | | | |
| Compound (I-1) | 1 | | 25 | | |
| Thiophanate-methyl | 200 | | 0 | | |
| Compound (I-1) + | 1 + 200 | 1:200 | 62.5 | 25 | 38 |
| Thiophanate-methyl | | | | | |
| Compound (I-1) | 1 | | 25 | | |
| Thiophanate-methyl | 500 | | 0 | | |
| Compound (I-1) + | 1 + 500 | 1:500 | 62.5 | 25 | 38 |
| Thiophanate-methyl | | | | | |
| Compound (I-1) | 1 | | 25 | | |
| Fluxapyroxad | 100 | | 0 | | |
| Compound (I-1) + | 1 + 100 | 1:100 | 75 | 25 | 50 |
| Fluxapyroxad | | | | | |
| Compound (I-1) | 1 | | 25 | | |
| Fluxapyroxad | 200 | | 0 | | |
| Compound (I-1) + | 1 + 200 | 1:200 | 75 | 25 | 50 |
| Fluxapyroxad | | | | | |
| Compound (I-1) | 1 | | 25 | | |
| Fluxapyroxad | 500 | | 0 | | |
| Compound (I-1) + | 1 + 500 | 1:500 | 75 | 25 | 50 |
| Fluxapyroxad | | | | | |
| Compound (I-1) | 1 | | 25 | | |
| Azoxystrobin | 100 | | 0 | | |
| Compound (I-1) + | 1 + 100 | 1:100 | 50 | 25 | 25 |
| Azoxystrobin | | | | | |
| Compound (I-1) | 1 | | 25 | | |
| Metalaxyl | 100 | | 0 | | |
| Compound (I-1) + | 1 + 100 | 1:100 | 100 | 25 | 75 |
| Metalaxyl | | | | | |
| Compound (I-1) | 1 | | 25 | | |
| Metalaxyl | 200 | | 0 | | |
| Compound (I-1) + | 1 + 200 | 1:200 | 100 | 25 | 75 |
| Metalaxyl | | | | | |
| Compound (I-1) | 1 | | 25 | | |
| Metalaxyl | 500 | | 0 | | |
| Compound (I-1) + | 1 + 500 | 1:500 | 100 | 25 | 75 |
| Metalaxyl | | | | | |
| Compound (I-1) | 1 | | 25 | | |
| Fludioxonil | 200 | | 25 | | |
| Compound (I-1) + | 1 + 200 | 1:200 | 100 | 44 | 56 |
| Fludioxonil | | | | | |
| Compound (I-1) | 1 | | 25 | | |
| Probenazole | 100 | | 12.5 | | |
| Compound (I-1) + | 1 + 100 | 1:100 | 100 | 34 | 66 |
| Probenazole | | | | | |
| Compound (I-1) | 1 | | 25 | | |
| Probenazole | 200 | | 0 | | |
| Compound (I-1) + | 1 + 200 | 1:200 | 87.5 | 25 | 63 |
| Probenazole | | | | | |
| Compound (I-1) | 1 | | 25 | | |
| Isotianil | 100 | | 0 | | |
| Compound (I-1) + | 1 + 100 | 1:100 | 100 | 25 | 75 |
| Isotianil | | | | | |
| Compound (I-1) | 1 | | 25 | | |
| Isotianil | 200 | | 0 | | |
| Compound (I-1) + | 1 + 200 | 1:200 | 100 | 25 | 75 |
| Isotianil | | | | | |

### Example C: Compound of Formula (I-1) and (Insecticides [(II-1A] to (II-33)] or [(Z001) to (Z377)] or Fungicides Selected from Groups A) to P)) Mixtures Thereof Plutella xylostella

The leaf dip method was used, wherein the required quantity of the compound or respective compound combinations were weighed and dissolved in a test solution prepared in tubes. The tubes were put on a vortex at 2000 rpm for 90 min for proper mixing and then diluted with a 0.01% Triton-X solution to the desired test concentration. Cabbage leaves were dipped into the solution for 10 seconds, shade dried for 20 min and then transferred to single cells of bioassay trays. A single second instar larva was released into each cell and the tray was covered with a lid. The bio-assay trays were kept under laboratory conditions at a temperature of 25° C. and relative humidity of 70%. Observations on dead, moribund and live larvae were recorded 72 h after the release. Percent mortality was calculated by combining dead and moribund larvae and comparing the result with the one of the untreated control. The results are shown for compound of formula (I-1) in Table C.

Surprisingly, the following combinations indicated in the table below, have revealed unexpected synergistic effects:

TABLE C
Evaluation of Compound (I-1), insecticides selected from [(II-1A]
to (II-33)] or [(Z001) to (Z377)] or fungicides selected
from groups A) to P) and mixtures thereof against Plutella xylostella

| | | | | Expected | |
|---|---|---|---|---|---|
| | | | Observed | Efficacy | |
| | Conc. | | Efficacy | (%) | Synergy |
| Compounds | (ppm) | Ratio | (%) | (Colby's) | (%) |
| Compound (I-1) | 0.1 | | 12.5 | | |
| Bifenthrin | 1 | | 25 | | |
| Compound (I-1) + | 0.1 + 1 | 1:10 | 50 | 34 | 16 |
| Bifenthrin | | | | | |
| Compound (I-1) | 0.1 | | 12.5 | | |
| Fluxametamide | 0.1 | | 0 | | |
| Compound (I-1) + | 0.1 + 0.1 | 1:1 | 62.5 | 13 | 50 |
| Fluxametamide | | | | | |
| Compound (I-1) | 0.1 | | 12.5 | | |
| Spinoteram | 0.05 | | 62.5 | | |
| Compound (I-1) + | 0.1 + 0.05 | 2:1 | 87.5 | 67 | 20 |
| Spinoteram | | | | | |
| Compound (I-1) | 0.1 | | 12.5 | | |
| Imidacloprid | 0.1 | | 0 | | |
| Compound (I-1) + | 0.1 + 0.1 | 1:1 | 100 | 13 | 88 |
| Imidacloprid | | | | | |
| Compound (I-1) | 0.1 | | 12.5 | | |
| Thiamethoxam | 1 | | 12.5 | | |
| Compound (I-1) + | 0.1 + 1 | 1:10 | 100 | 23 | 77 |
| Thiamethoxam | | | | | |
| Compound (I-1) | 0.05 | | 12.5 | | |
| Clothianidin | 0.1 | | 0 | | |
| Compound (I-1) + | 0.05 + 0.1 | 1:2 | 25 | 13 | 13 |
| Clothianidin | | | | | |
| Compound (I-1) | 0.1 | | 12.5 | | |
| Afidopyropen | 0.1 | | 0 | | |
| Compound (I-1) + | 0.1 + 0.1 | 1:1 | 37.5 | 13 | 25 |
| Afidopyropen | | | | | |
| Compound (I-1) | 0.1 | | 12.5 | | |
| Oxazosulfyl | 0.1 | | 0 | | |
| Compound (I-1) + | 0.1 + 0.1 | 1:1 | 25 | 13 | 13 |
| Oxazosulfyl | | | | | |
| Compound (I-1) | 0.1 | | 12.5 | | |
| Tyclopyrazoflor | 0.1 | | 0 | | |
| Compound (I-1) + | 0.1 + 0.1 | 1:1 | 25 | 13 | 13 |
| Tyclopyrazoflor | | | | | |
| Compound (I-1) | 0.1 | | 12.5 | | |
| Isocycloseram | 0.1 | | 87.5 | | |
| Compound (I-1) + | 0.1 + 0.1 | 1:1 | 100 | 89 | 11 |
| Isocycloseram | | | | | |
| Compound (I-1) | 0.005 | | 0 | | |
| Flometoquin | 0.005 | | 62.5 | | |
| Compound (I-1) + | 0.005 + 0.005 | 1:1 | 75 | 63 | 13 |
| Flometoquin | | | | | |
| Compound (I-1) | 0.005 | | 0 | | |
| Flometoquin | 0.001 | | 0 | | |
| Compound (I-1) + | 0.005 + 0.001 | 5:1 | 50 | 0 | 50 |
| Flometoquin | | | | | |
| Compound (I-1) | 0.005 | | 0 | | |
| Fipronil | 0.005 | | 50 | | |
| Compound (I-1) + | 0.005 + 0.005 | 1:1 | 100 | 50 | 50 |
| Fipronil | | | | | |
| Compound (I-1) | 0.0025 | | 0 | | |
| Fipronil | 0.005 | | 50 | | |
| Compound (I-1) + | 0.0025 + 0.005 | 1:2 | 62.5 | 50 | 13 |
| Fipronil | | | | | |
| Compound (I-1) | 0.004 | | 0 | | |
| Pyridalyl | 0.002 | | 50 | | |
| Compound (I-1) + | 0.004 + 0.002 | 2:1 | 87.5 | 50 | 38 |
| Pyridalyl | | | | | |
| Compound (I-1) | 0.02 | | 12.5 | | |
| Chlorfenapyr | 0.2 | | 75 | | |
| Compound (I-1) + | 0.02 + 0.2 | 1:10 | 100 | 78 | 22 |
| Chlorfenapyr | | | | | |
| Compound (I-1) | 0.03 | | 12.5 | | |
| Chlorfenapyr | 0.15 | | 62.5 | | |
| Compound (I-1) + | 0.03 + 0.15 | 1:5 | 100 | 67 | 33 |
| Chlorfenapyr | | | | | |
| Compound (I-1) | 0.1 | | 12.5 | | |
| Metaflumizone | 0.001 | | 12.5 | | |
| Compound (I-1) + | 0.1 + 0.001 | 1:100 | 37.5 | 23 | 14 |
| Metaflumizone | | | | | |
| Compound (I-1) | 0.1 | | 12.5 | | |
| Metaflumizone | 0.01 | | 25 | | |
| Compound (I-1) + | 0.1 + 0.01 | 1:10 | 50 | 34 | 16 |
| Metaflumizone | | | | | |
| Compound (I-1) | 0.1 | | 12.5 | | |
| Pyriproxyfen | 0.05 | | 12.5 | | |
| Compound (I-1) + | 0.1 + 0.05 | 2:1 | 50 | 23 | 27 |
| Pyriproxyfen | | | | | |
| Compound (I-1) | 0.1 | | 12.5 | | |
| Abamectin | 0.001 | | 12.5 | | |
| Compound (I-1) + | 0.1 + 0.001 | 100:1 | 50 | 23 | 27 |
| Abamectin | | | | | |
| Compound (I-1) | 0.1 | | 12.5 | | |
| Abamectin | 0.005 | | 25 | | |
| Compound (I-1) + | 0.1 + 0.005 | 500:1 | 50 | 34 | 16 |
| Abamectin | | | | | |
| Compound (I-1) | 0.5 | | 25 | | |
| Pymetrozine | 0.05 | | 0 | | |
| Compound (I-1) + | 0.5 + 0.05 | 10:1 | 75 | 25 | 50 |
| Pymetrozine | | | | | |
| Compound (I-1) | 0.5 | | 25 | | |
| Pymetrozine | 0.01 | | 0 | | |
| Compound (I-1) + | 0.1 + 0.01 | 5:1 | 37.5 | 25 | 13 |
| Pymetrozine | | | | | |

The compound of formula (I-1), mixed with a biological active compound (Bacillus thuringiensis, as an example for biologicals) were also assessed for their activity as described in the following tests:

### Example D: Biological Testing Method for the Evaluation of Bacillus thuringiensis Against Helicoverpa armigera

The leaf dip method was used, wherein the required quantity of the compounds were weighed and dissolved in a test solution prepared in tubes. The tubes were put on a vortex at 2000 rpm for 90 min for proper mixing and then, for the single compounds, diluted with a 0.01% Triton-X solution, for the combinations, diluted with a 0.01% Triton-X solution containing formulated Bt, to get the desired test concentrations. Tomato leaves were dipped in the solution for 10 seconds, shade dried for 20 min and then transferred to single cells of the bioassay trays. A single third instar larva was released into each cell and the tray was covered with a lid. The bio-assay trays were kept under laboratory conditions at a temperature of 25° C. and relative humidity of 70%. Observations on dead, moribund and live larvae were recorded at 72 h after the release. Percent mortality was calculated by combining dead and moribund larvae and comparing the result to the one of the untreated control. The results have been described for compound of formula (I-1) in Table D.

TABLE D
Evaluation of Compound (I-1) and (Bacillus thuringiensis)
mixture thereof against Helicoverpa armigera

| | | | | Expected | |
|---|---|---|---|---|---|
| | | | Observed | Efficacy | |
| | Conc. | | Efficacy | (%) | Synergy |
| Compounds | (ppm) | Ratio | (%) | (Colby's) | (%) |
| Compound (I-1) | 0.1 | | 12.5 | | |
| Bt | 0.2 | | 0 | | |
| Compound (I-1) + | 0.1 + 0.2 | 1:2 | 25 | 13 | 13 |
| Bt | | | | | |

### Example E: Biological Testing Method for the Evaluation of Bacillus thuringiensis Against Spodoptera litura

The leaf dip method was used, wherein the required quantity of the compounds were weighed and dissolved in a test solution prepared in tubes. The tubes were put on a vortex at 2000 rpm for 90 min for proper mixing and then, for the single compounds, diluted with a 0.01% Triton-X solution, for the combinations, diluted with a 0.01% Triton-X solution containing formulated Bt, to get the desired test concentration. Tomato leaves were dipped in the solution for 10 seconds, shade dried for 20 min and then transferred to single cells of the bioassay trays. A single third instar larva was released into each cell and the tray was covered with a lid. The bio-assay trays were kept under laboratory conditions at a temperature of 25° C. and relative humidity of 70%. Observations on dead, moribund and live larvae were recorded at 72 h after the release. Percent mortality was calculated by combining dead and moribund larvae and comparing the results to the one of the untreated control. The results have been described for compound of formula (I-1) in Table E.

TABLE E
Evaluation of Compound (I-1) and (Bacillus thuringiensis)
mixture thereof against Spodoptera litura

| | | | | Expected | |
|---|---|---|---|---|---|
| | | | Observed | Efficacy | |
| | Conc. | | Efficacy | (%) | Synergy |
| Compounds | (ppm) | Ratio | (%) | (Colby's) | (%) |
| Compound (I-1) | 0.1 | | 0 | | |
| Bt | 1 | | 12.5 | | |
| Compound (I-1) + | 0.1 + 1 | 1:10 | 25 | 13 | 13 |
| Bt | | | | | |

### Example F: Biological Testing Method for the Evaluation of Bacillus thuringiensis Against Plutella xylostella

The leaf dip method was used, wherein the required quantity of the compounds were weighed and dissolved in a test solution prepared in tubes. The tubes were put on a vortex at 2000 rpm for 90 min for proper mixing and then, for the single compounds, diluted with a 0.01% Triton-X solution, for the combinations, diluted with a 0.01% Triton-X solution containing formulated Bt, to get the desired test concentration. Cabbage leaves were dipped in the solution for 10 seconds, shade dried for 20 min and then transferred to single cells of bioassay trays. A single second instar larva was released into each cell and the tray was covered with a lid. The bio-assay trays were kept under laboratory conditions at a temperature of 25° C. and relative humidity of 70%. Observations on dead, moribund and live larvae were recorded 72 h after the release. Percent mortality was calculated by combining dead and moribund larvae and comparing the results to the one of the untreated control. The results have been described for compound of formula (I-1) in Table F.

TABLE F
Evaluation of Compound (I-1) and (Bacillus thuringiensis)
mixture threof against Plutella xylostella

| | | | | Expected | |
|---|---|---|---|---|---|
| | | | Observed | Efficacy | |
| | Conc. | | Efficacy | (%) | Synergy |
| Compounds | (ppm) | Ratio | (%) | (Colby's) | (%) |
| Compound (I-1) | 0.1 | | 0 | | |
| Bt | 0.2 | | 0 | | |
| Compound (I-1) A + | 0.1 + 0.2 | 1:2 | 25 | 0 | 25 |
| Bt | | | | | |
| Compound (I-1) | 0.1 | | 0 | | |
| Bt | 1 | | 0 | | |
| Compound (I-1) + | 0.1 + 1 | 1:10 | 12.5 | 0 | 13 |
| Bt | | | | | |

As demonstrated in the tables above, the mixture with a compound of formula (I-1) with Bacillus thuringiensis, as an example for biologicals, indicated a stable and unexpected synergistic insecticidal effect against the most important Lepidopteran pests.

The compound of formula (I-1) in mixture with fungicides was assessed for their fungicidal activity as described in the following tests:

### Biological Test Examples In Vivo on Plants (Preventive)

The compounds were selected for glasshouse testing to assess the fungicidal activity of the combinations under preventive conditions against the following pathogens:

### Example G: Compound of Formula (I-1) and Mixtures Thereof Against Alternaria solani in Tomato

The single compounds or respective compound combinations were dissolved in 2% dimethyl sulfoxide/acetone and then mixed with water containing emulsifier to a calibrated spray volume of 50 mL. The test solutions were poured into spray bottles for further applications.

To test the preventive activity, healthy young tomato plants, raised in the greenhouse, were sprayed with the active compound preparation at the stated application rates inside the spray cabinets using hollow cone nozzles. One day after treatment, the plants were inoculated with a spore suspension containing 0.24×10⁶ Alternaria solani inoculum and 2% Malt. The inoculated plants were then kept in a greenhouse chamber at a temperature of 22-24° C. and 90-95% relative humidity for disease expression.

A visual assessment of the performance of the single compounds or compound combinations was carried out by rating the disease severity (0-100% scale) on treated plants 3, 7, 10 and 15 days after application. Efficacy (% control) of the single compounds and mixtures was calculated by comparing the disease rating in the treatment with the one of the untreated control. The compounds were also assessed for their plant compatibility by recording symptoms like necrosis, chlorosis and stunting. The results have been described for the compound of formula (I-1) in Table G.

TABLE-G
Evaluation of Compound (I-1), fungicides selected from groups A) to P)and mixtures
thereof against Alternaria solani

| | | | | | Expected | |
|---|---|---|---|---|---|---|
| | | | | Observed | Efficacy | |
| Sr. | | Conc. | | Efficacy | (%) | Synergy |
| No. | Compound | (ppm) | Ratio | (%) | (Colby's) | (%) |
| 1 | Compound (I-1) | 100 | | 14 | | |
| 2 | Fluopyram | 10 | | 67 | | |
| 3 | Compound (I-1) + | 100 + 10 | 10:1 | 100 | 72 | 28 |
| | Fluopyram | | | | | |
| 4 | Compound (I-1) | 500 | | 16 | | |
| 5 | Fluopyram | 10 | | 67 | | |
| 6 | Compound (I-1) + | 500 + 10 | 50:1 | 100 | 72 | 28 |
| | Fluopyram | | | | | |
| 7 | Compound (I-1) | 500 | | 16 | | |
| 8 | Azoxystrobin | 0.1 | | 40 | | |
| 9 | Compound (I-1) + | 500 + 0.1 | 5000:1 | 73 | 50 | 24 |
| | Azoxystrobin | | | | | |
| 10 | Compound (I-1) | 500 | | 16 | | |
| 11 | Fluxapyroxad | 0.05 | | 14 | | |
| 12 | Compound (I-1) + | 500 + 0.05 | 10000:1 | 57 | 28 | 29 |
| | Fluxapyroxad | | | | | |
| 13 | Compound (I-1) | 100 | | 14 | | |
| 14 | Metalaxyl | 100 | | 17 | | |
| 15 | Compound (I-1) + Metalaxyl | 100 + 100 | 1:1 | 78 | 29 | 50 |
| 16 | Compound (I-1) | 100 | | 14 | | |
| 17 | Metalaxyl | 50 | | 22 | | |
| 18 | Compound (I-1) + Metalaxyl | 100 + 50 | 2:1 | 70 | 33 | 37 |
| 19 | Compound (I-1) | 500 | | 16 | | |
| 20 | Metalaxyl | 50 | | 22 | | |
| 21 | Compound (I-1) + Metalaxyl | 500 + 50 | 10:1 | 86 | 34 | 52 |
| 22 | Compound (I-1) | 500 | | 16 | | |
| 23 | Metalaxyl | 100 | | 17 | | |
| 24 | Compound (I-1) + Metalaxyl | 500 + 100 | 5:1 | 92 | 30 | 62 |

### Example H: Compound of Formula (I-1), Fungicides Selected from Groups A) to P) and Mixtures Thereof Against Phakopsora pachyrhizi in Soybean

The single compounds or the respective compound combinations were dissolved in 2% dimethyl sulfoxide/acetone and then mixed with water containing an emulsifier to a calibrated spray volume of 50 ml. The test solutions were poured into spray bottles for further applications.

To test the preventive activity of compounds, healthy young Soybean plants, raised in the greenhouse, were sprayed with the active compound preparation at the stated application rates inside the spray cabinets using hollow cone nozzles. One day after treatment, the plants were inoculated with a suspension containing 2×10⁵ Phakopsora pachyrhizi conidia. The inoculated plants were then kept in a greenhouse chamber at a temperature of 22-24° C. and 80-90% relative humidity for disease expression.

A visual assessment of the performance of the single compounds and respective compound combinations was carried out by rating the disease severity (0-100% scale) on treated plants 3, 7, 10 and 15 days after application. Efficacy (% control) of the compounds was calculated by comparing the disease rating in the treatment with the one of the untreated control. The compounds were also assessed for their plant compatibility by recording symptoms like necrosis, chlorosis and stunting. The results have been described for the compound of formula (I-1) in Table H.

TABLE-H
Evaluation of Compound (I-1), fungicides selected from groups A) to P) mixtures
against Phakopsora pachyrhizi

| | | | | | Expected | |
|---|---|---|---|---|---|---|
| | | | | Observed | Efficacy | |
| Sr. | | Conc. | | Efficacy | (%) | Synergy |
| No. | Compound | (ppm) | Ratio | (%) | (Colby's) | (%) |
| 1 | Compound (I-1) | 500 | | 47 | | |
| 2 | Azoxystrobin | 0.1 | | 39 | | |
| 3 | Compound (I-1) + | 500 + 0.1 | 5000:1 | 88 | 68 | 21 |
| | Azoxystrobin | | | | | |
| 4 | Compound (I-1) | 500 | | 47 | | |
| 5 | Fluxapyroxad | 0.05 | | 41 | | |
| 6 | Compound (I-1) + | 500 + 0.05 | 10000:1 | 88 | 69 | 20 |
| | Fluxapyroxad | | | | | |
| 7 | Compound (I-1) | 100 | | 44 | | |
| 8 | Isotianil | 10.0 | | 31 | | |
| 9 | Compound (I-1) + Isotianil | 100 + 10 | 10:1 | 100 | 62 | 39 |
| 10 | Compound (I-1) | 500 | | 47 | | |
| 11 | Isotianil | 50.0 | | 41 | | |
| 12 | Compound (I-1) + Isotianil | 500 + 50 | 10:1 | 100 | 69 | 31 |
| 13 | Compound (I-1) | 100 | | 44 | | |
| 14 | Isotianil | 50.0 | | 41 | | |
| 15 | Compound (I-1) + Isotianil | 100 + 50 | 2:1 | 100 | 67 | 33 |
| 16 | Compound (I-1) | 500 | | 47 | | |
| 17 | Isotianil | 10.0 | | 31 | | |
| 18 | Compound (I-1) + Isotianil | 500 + 10 | 50:1 | 100 | 64 | 36 |
| 19 | Compound (I-1) | 100 | | 44 | | |
| 20 | Probenazole | 10.00 | | 28 | | |
| 21 | Compound (I-1) + | 100 + 10 | 10:1 | 100 | 60 | 40 |
| | Probenazole | | | | | |
| 22 | Compound (I-1) | 500 | | 47 | | |
| 23 | Probenazole | 2 | | 22 | | |
| 24 | Compound (I-1) + | 500 + 2 | 250:1 | 100 | 59 | 41 |
| | Probenazole | | | | | |
| 25 | Compound (I-1) | 500 | | 47 | | |
| 26 | Probenazole | 10.00 | | 28 | | |
| 27 | Compound (I-1) + | 500 + 10 | 50:1 | 100 | 62 | 38 |
| | Probenazole | | | | | |
| 28 | Compound (I-1) | 500 | | 47 | | |
| 29 | Pyraclostrobin | 0.05 | | 39 | | |
| 30 | Compound (I-1) + | 500 + 0.05 | 10000:1 | 85 | 68 | 18 |
| | Pyraclostrobin | | | | | |

### Example I: Compound of Formula (I-1) and Mixtures Thereof Against Pyricularia oryzae in Rice

The single compounds or respective compound combinations were dissolved in 2% dimethyl sulfoxide/acetone and then mixed with water containing emulsifier to a calibrated spray volume of 50 mL. The test solutions were poured into spray bottles for further applications.

To test the preventive activity of compounds, healthy young tomato plants, raised in the greenhouse, were sprayed with the active compound preparation at the stated application rates inside the spray cabinets using hollow cone nozzles. One day after treatment, the plants were inoculated with a spore suspension containing 1.4×10⁶ Pyricularia oryzae inoculum (in sterile water). The inoculated plants were then kept in a greenhouse chamber at a temperature of 22-24° C. and 90-95% relative humidity for disease expression.

A visual assessment of the performance of the compounds or compound combinations was carried out by rating the disease severity (0-100% scale) on treated plants 3, 7, 10 and 15 days after application. Efficacy (% control) of the single compounds and mixtures was calculated by comparing the disease rating in the treatment with the one of the untreated control. The compounds were also assessed for their plant compatibility by recording symptoms like necrosis, chlorosis and stunting. The results have been described for the compound of formula (I-1) in Table I.

TABLE-I
Evaluation of Compound (I-1), fungicides selected from groups A) to P)
and mixtures thereof against Pyricularia oryzae

| | | | | | Expected | |
|---|---|---|---|---|---|---|
| | | | | Observed | Efficacy | |
| Sr. | | Conc. | | Efficacy | (%) | Synergy |
| No. | Compound | (ppm) | Ratio | (%) | (Colby's) | (%) |
| 1 | Compound (I-1) | 500 | | 38 | | |
| 2 | Fludioxonil | 2 | | 19 | | |
| 3 | Compound (I-1) + Fludioxonil | 500 + 2 | 250:1 | 60 | 50 | 10 |

### Example J: Compound of Formula (I-1) and Mixtures Thereof Against Parastagonospora nodorum/Septoria nodorum/Stagnospora nodorum in Wheat

The single compounds or respective compound combinations were dissolved in 2% dimethyl sulfoxide/acetone and then mixed with water containing emulsifier to a calibrated spray volume of 50 mL. The test solutions were poured into spray bottles for further applications.

To test the preventive activity of compounds, healthy young tomato plants, raised in the greenhouse, were sprayed with the active compound preparation at the stated application rates inside the spray cabinets using hollow cone nozzles. One day after treatment, the plants were inoculated with a spore suspension containing 2.8×10⁶ Stagnospora nodorum inoculum.

The inoculated plants were then kept in a greenhouse chamber at 22-25° C. temperature and 90-100% relative humidity for disease expression.

A visual assessment of the performance of the single compounds or compound combinations was carried out by rating the disease severity (0-100% scale) on treated plants 3, 7, 10 and 15 days after application. Efficacy (% control) of the single compounds and mixtures was calculated by comparing the disease rating in the treatment with the one of the untreated control. The compounds were also assessed for their plant compatibility by recording symptoms like necrosis, chlorosis and stunting. The results have been described for the compound of formula (I-1) in Table J.

TABLE-J
Evaluation of Compound (I-1), fungicides selected from groups A) to P) and mixtures
thereofagainst Septoria nodorum

| | | | | | Expected | |
|---|---|---|---|---|---|---|
| | | | | Observed | Efficacy | |
| Sr. | | Conc. | | Efficacy | (%) | Synergy |
| No. | Compound | (ppm) | Ratio | (%) | (Colby's) | (%) |
| 1 | Compound (I-1) | 500 | | 37 | | |
| 2 | Azoxystrobin | 0.05 | | 12 | | |
| 3 | Compound (I-1) + Azoxystrobin | 500 + 0.05 | 10000:1 | 69 | 45 | 25 |
| 4 | Compound (I-1) | 500 | | 37 | | |
| 5 | Azoxystrobin | 0.1 | | 24 | | |
| 6 | Compound (I-1) + Azoxystrobin | 500 + 0.1 | 5000:1 | 72 | 52 | 20 |
| 10 | Compound (I-1) | 500 | | 37 | | |
| 11 | Fluxapyroxad | 0.1 | | 29 | | |
| 12 | Compound (I-1) + Fluxapyroxad | 500 + 0.1 | 5000:1 | 81 | 55 | 25 |

### Example K: Compound of Formula (I-1) and Mixtures Thereof Against Erysiphe cichoracearum in Cucumber

The single compounds or the respective compound combinations were dissolved in 2% dimethyl sulfoxide/acetone and then mixed with water containing emulsifier to a calibrated spray volume of 50 mL. The test solutions were poured into spray bottles for further applications.

To test the preventive activity of compounds, healthy young cucumber plants, raised in the greenhouse, were sprayed with the active compound preparation at the stated application rates inside the spray cabinets using hollow cone nozzles. One day after treatment, the plants were inoculated with a conidial suspension containing 2×10⁵ Erysiphe cichoracearum inoculum. The inoculated plants were then kept in a greenhouse chamber at a temperature of 22-24° C. and 50-60% relative humidity for disease expression.

A visual assessment of the performance of the compounds and the respective compound combinations was carried out by rating the disease severity (0-100% scale) on treated plants 3, 7, 10 and 15 days after application. Efficacy (% control) of the single compounds or compound combinations was calculated by comparing the disease rating in the treatment with the one of the untreated control. The compounds were also assessed for their plant compatibility by recording symptoms like necrosis, chlorosis and stunting. The results have been described for the compound of formula (I-1) in Table K.

TABLE-K
Evaluation of Compound (I-1), fungicides selected from groups A) to P) and mixtures thereof
against Erysiphe cichoracearum

| | | | | | Expected | |
|---|---|---|---|---|---|---|
| | | | | Observed | Efficacy | |
| Sr. | | Conc. | | Efficacy | (%) | Synergy |
| No. | Compound | (ppm) | Ratio | (%) | (Colby's) | (%) |
| 1 | Compound (I-1) | 500 | | 28 | | |
| 2 | Azoxystrobin | 0.05 | | 26 | | |
| 3 | Compound (I-1) + | 500 + 0.05 | 10000:1 | 82 | 47 | 36 |
| | Azoxystrobin | | | | | |
| 4 | Compound (I-1) | 500 | | 28 | | |
| 5 | Pyraclostrobin | 0.05 | | 29 | | |
| 6 | Compound (I-1) + | 500 + 0.05 | 10000:1 | 76 | 49 | 28 |
| | Pyraclostrobin | | | | | |
| 7 | Compound (I-1) | 500 | | 28 | | |
| 8 | Pyraclostrobin | 0.1 | | 29 | | |
| 9 | Compound (I-1) + | 500 + 0.1 | 5000:1 | 76 | 49 | 28 |
| | Pyraclostrobin | | | | | |
| 10 | Compound (I-1) | 500 | | 28 | | |
| 11 | Thiophenyte | 50 | | 29 | | |
| 12 | Compound (I-1) + | 500 + 50 | 10:1 | 64 | 49 | 15 |
| | Thiophenyte | | | | | |

As demonstrated in the tables above, the mixture with a compound of formula I-1 with different insecticides and fungicides did not only indicate a surprising and unexpected synergistic insecticidal effect but also a fungicidal one against a range of different important diseases.

Having described the invention with reference to certain preferred embodiments, other embodiments will become apparent to one skilled in the art from the consideration of the specification. It will be apparent to those skilled in the art that many modifications, both to materials and methods, may be practiced without departing from the scope of the invention.

1. A pesticidal mixture comprising a mixture of at least one pesticidally active compound of formula (I), as a component (1); 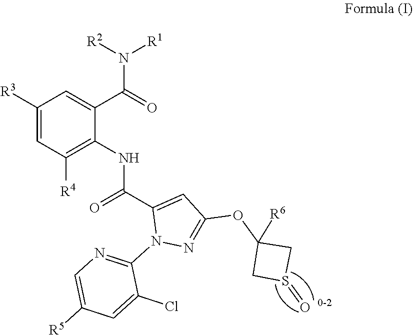
wherein,
R¹ is selected from the group consisting of C₁-C₆ alkyl, C₃-C₅ cycloalkyl, C₃-C₅ cycloalkyl-C₁-C₆ alkyl and C₁-C₆ alkyl-C₃-C₅ cycloalkyl;
R² is selected from the group consisting of hydrogen and methyl;
R³ is selected from the group consisting of halogen and cyano;
R⁴ is selected from the group consisting of methyl, fluorine, chlorine, bromine and trifluoromethyl;
R⁵ is selected from the group consisting of hydrogen, fluorine and chlorine;
R⁶ is selected from the group consisting of hydrogen, methyl and trifluoromethyl;
or agriculturally acceptable salts, isomers/structural isomers, stereo-isomers, diastereomers, enantiomers, tautomers, metal complexes, polymorphs, or N-oxides thereof;
and at least one insecticidally active compound (II) and/or at least one fungicidally active compound (III) as a component (2);
wherein at least one insecticidally active compound (II) selected from the group consisting of:
(II-1) Acetylcholinesterase (AChE) inhibitors,
(II-2) GABA-gated chloride channel blockers,
(II-3) Sodium channel modulators,
(II-4) Nicotinic acetylcholine receptor (nAChR) competitive modulators,
(II-5) Nicotinic acetylcholine receptor (nAChR) allosteric modulators—Site I,
(II-6) Glutamate-gated chloride channel (GluCl) allosteric modulators,
(II-7) Juvenile hormone mimics,
(II-8) Miscellaneous non-specific (multi-site) inhibitors,
(II-9) Chordotonal organ TRPV channel modulators,
(II-10) Mite growth inhibitors affecting CHS1,
(II-11) Microbial disruptors of insect midgut membranes,
(II-12) Inhibitors of mitochondrial ATP synthase,
(II-13) Uncouplers of oxidative phosphorylation via disruption of the proton gradient,
(II-14) Nicotinic acetylcholine receptor (nAChR) channel blockers,
(II-15) Inhibitors of the chitin biosynthesis affecting CHS1,
(II-16) Inhibitors of the chitin biosynthesis type 1,
(II-17) Moulting disruptors,
(II-18) Ecdyson receptor agonists,
(II-19) Octopamin receptor agonists,
(II-20) Mitochondrial complex III electron transport inhibitors,
(II-21) Mitochondrial complex I electron transport inhibitors,
(II-22) Voltage-dependent sodium channel blockers,
(II-23) Inhibitors of the acetyl CoA carboxylase,
(II-24) Mitochondrial complex IV electron transport inhibitors,
(II-25) Mitochondrial complex II electron transport inhibitors,
(II-26) Ryanodine receptor-modulators,
(II-27) Chordotonal organ Modulators—undefined target site,
(II-28) GABA-gated chloride channel allosteric modulators,
(II-29) Baculoviruses,
(II-30) Nicotinic Acetylcholine Receptor (nAChR) Allosteric Modulators—Site II,
(II-31) Insecticidal active compounds of unknown or uncertain mode of action,
(II-32) Biopesticides, and
(II-33) Biochemical pesticides with insecticidal, acaricidal, molluscidal, pheromone and/or nematicidal activity;
and at least one fungicidally active compound (III) selected from the group consisting of:
(A) inhibitors of the ergosterol synthesis,
(B) inhibitors of the respiratory chain at complex I or II,
(C) inhibitors of the respiratory chain at complex III,
(D) inhibitors of the mitosis and cell division,
(E) compounds capable of having a multisite action,
(F) compounds capable of inducing a host defense,
(G) inhibitors of the amino acid and/or protein biosynthesis,
(H) inhibitors of the ATP production,
(I) inhibitors of the cell wall synthesis,
(J) inhibitors of the lipid and membrane synthesis,
(K) inhibitors of the melanine biosynthesis,
(L) inhibitors of the nucleic acid synthesis,
(M) inhibitors of the signal transduction,
(N) compounds capable of acting as uncoupler,
(O) other fungicides,
(P) HDAC inhibitors, and
(Q) compounds capable to act as a safener.

2. The pesticidal mixture according to claim 1, wherein the compound of formula (I) or oxides or salts thereof as a component (1) is selected from (I-1) N-(2-(tert-butylcarbamoyl)-4-chloro-6-methylphenyl)-1-(3-chloropyridin-2-yl)-3-((1,1-dioxidothietan-3-yl)oxy)-1H-pyrazole-5-carboxamide; (I-2) N-(2-(tert-butylcarbamoyl)-4-chloro-6-methylphenyl)-1-(3-chloropyridin-2-yl)-3-(thietan-3-yloxy)-1H-pyrazole-5-carboxamide; (I-3) N-(2-(tert-butylcarbamoyl)-4-cyano-6-methylphenyl)-1-(3,5-dichloropyridin-2-yl)-3-(thietan-3-yloxy)-1H-pyrazole-5-carboxamide; (I-4) N-(4-chloro-2-(isopropylcarbamoyl)-6-methylphenyl)-1-(3-chloropyridin-2-yl)-3-(thietan-3-yloxy)-1H-pyrazole-5-carboxamide; (I-5) N-(2-(tert-butylcarbamoyl)-4-cyano-6-methylphenyl)-1-(3-chloropyridin-2-yl)-3-((3-methylthietan-3-yl)oxy)-1H-pyrazole-5-carboxamide; (I-6) N-(2-(tert-butylcarbamoyl)-4-chloro-6-methylphenyl)-1-(3,5-dichloropyridin-2-yl)-3-(thietan-3-yloxy)-1H-pyrazole-5-carboxamide; (I-7) N-(2-(tert-butylcarbamoyl)-4-cyano-6-methylphenyl)-1-(3-chloropyridin-2-yl)-3-((3-methyl-1,1-dioxidothietan-3-yl)oxy)-1H-pyrazole-5-carboxamide; (I-8) 1-(3-chloropyridin-2-yl)-N-(2,4-dichloro-6-(isopropylcarbamoyl)phenyl)-3-((1,1-dioxidothietan-3-yl)oxy)-1H-pyrazole-5-carboxamide; (I-9) N-(2-bromo-4-chloro-6-(isopropylcarbamoyl)phenyl)-1-(3-chloropyridin-2-yl)-3-((1,1-dioxidothietan-3-yl)oxy)-1H-pyrazole-5-carboxamide; (I-10) N-(4-chloro-2-(cyclopropylcarbamoyl)-6-methylphenyl)-1-(3-chloro-5-fluoropyridin-2-yl)-3-(thietan-3-yloxy)-1H-pyrazole-5-carboxamide and (I-11) N-(4-chloro-2-(isopropylcarbamoyl)-6-methylphenyl)-1-(3,5-dichloropyridin-2-yl)-3-((1,1-dioxidothietan-3-yl)oxy)-1H-pyrazole-5-carboxamide.

3. The pesticidal mixture according to claim 1, wherein said component (2) is at least one insecticidally active compound (II) selected from:
(II-1) Acetylcholinesterase (AChE) inhibitors selected from the class of (II-1A) carbamates including alanycarb (Z001), aldicarb (Z002), bendiocarb (Z003), benfuracarb (Z004), butocarboxim (Z005), butoxycarboxim (Z006), carbaryl (Z007), carbofuran (Z008), carbosulfan (Z009), ethiofencarb (Z010), fenobucarb (Z011), formetanate (Z012), furathiocarb (Z013), isoprocarb (Z014), methiocarb (Z015), methomyl (Z016), metolcarb (Z017), oxamyl (Z018), pirimicarb (Z019), propoxur (Z020), thiodicarb (Z021), thiofanox (Z022), triazamate (Z023), trimethacarb (Z024), XMC (Z025), and xylylcarb (Z026); or
(II-1B) organophosphates including acephate (Z027), azamethiphos (Z028), azinphos-ethyl (Z029), azinphosmethyl (Z030), cadusafos (Z031), chlorethoxyfos (Z032), chlorfenvinphos (Z033), chlormephos (Z034), chlorpyrifos (Z035), chlorpyrifos-methyl (Z036), coumaphos (Z037), cyanophos (Z038), demeton-s-methyl (Z039), diazinon (Z040), dichlorvos/ddvp (Z041), dicrotophos (Z042), dimethoate (Z043), dimethylvinphos (Z044), disulfoton (Z045), epn (Z046), ethion (Z047), ethoprophos (Z048), famphur (Z049), fenamiphos (Z050), fenitrothion (Z051), fenthion (Z052), fosthiazate (Z053), heptenophos (Z054), imicyafos (Z055), isofenphos (Z056), isopropyl o-(methoxyaminothio-phosphoryl) salicylate (Z057), isoxathion (Z058), malathion (Z059), mecarbam (Z060), methamidophos (Z061), methidathion (Z062), mevinphos (Z063), monocrotophos (Z064), naled (Z065), omethoate (Z066), oxydemeton-methyl (Z067), parathion (Z068), parathion-methyl (Z069), phenthoate (Z070), phorate (Z071), phosalone (Z072), phosmet (Z073), phosphamidon (Z074), phoxim (Z075), pirimiphos-methyl (Z076), profenofos (Z077), propetamphos (Z078), prothiofos (Z079), pyraclofos (Z080), pyridaphenthion (Z081), quinalphos (Z082), sulfotep (Z083), tebupirimfos (Z084), temephos (Z085), terbufos (Z086), tetrachlorvinphos (Z087), thiometon (Z088), triazophos (Z089), trichlorfon (Z090), and vamidothion (Z091);
(II-2) GABA-gated chloride channel blockers selected from the class of
(II-2A) Cyclodiene Organochlorines including chlordane (Z092) and endosulfan (Z093); or
(II-2B) Phenylpyrazoles (Fiproles) including ethiprole (Z094), fipronil (Z095), flufiprole (Z096), pyrafluprole (Z097) and pyriprole (Z0918;
(II-3) Sodium channel modulators selected from the class of
(II-3A) Pyrethroids/Pyrethrins including acrinathrin (Z099), allethrin (Z100), d-cis-trans allethrin (Z101), d-trans-allethrin (Z102), bifenthrin (Z103), bioallethrin (Z104), bioallethrin s-cyclopentenyl isomer (Z105), bioresmethrin (Z106), cycloprothrin (Z107), cyfluthrin (Z108), beta-cyfluthrin (Z109), cyhalothrin (Z110), lambda-cyhalothrin (Z111), gamma-cyhalothrin (Z112), cypermethrin (Z113), alpha-cypermethrin (Z114), beta-cypermethrin (Z115), theta-cypermethrin (Z116), zeta-cypermethrin (Z117), cyphenothrin [(1r)-trans-isomers (Z118), deltamethrin (Z119), empenthrin [(ez)-(1r)-isomers] (Z120), esfenvalerate (Z121), etofenprox (Z122), fenpropathrin (Z123), fenvalerate (Z124), flucythrinate (Z125), flumethrin (Z126), tau-fluvalinate (Z127), halfenprox (Z128), imiprothrin (Z129), meperfluthrin (Z130), metofluthrin (Z131), momfluorothrin (Z132), kadethrin (Z133), permethrin (Z134), phenothrin [(1r)-trans-isomer] (Z134), prallethrin (Z135), profluthrin (Z136), pyrethrins (pyrethrum) (Z137), resmethrin (Z138), silafluofen (Z139), tefluthrin (Z140), tetramethylfluthrin (Z141), tetramethrin (Z142), tetramethrin [(1r)-isomers] (Z143), tralomethrin (Z144) and transfluthrin (Z145); or
(II-3B) DDT (Z146) or methoxychlor (Z147)
(II-4) Nicotinic acetylcholine receptor (nAChR) competitive modulators selected from the class of
(II-4A) Neonicotinoids including acetamiprid (Z148), clothianidin (Z149), dinotefuran (Z150), imidacloprid (Z151), nitenpyram (Z152), thiacloprid (Z153), thiamethoxam (Z154), 1-[(6-chloro-3-pyridinyl)methyl]-2,3,5,6,7,8-hexahydro-9-nitro-(5S,8R)-5,8-epoxy-H-imidazo[1,2-a]azepine (Z155); 1-[(6-chloro-3-pyridyl)methyl]-2-nitro-1-[(E)-pentylideneamino]guanidine (Z156); and 1-[(6-chloro-3-pyridyl)methyl]-7-methyl-8-nitro-5-propoxy-3,5,6,7-tetrahydro-2H-imidazo[1,2-a]pyridine (Z157); or
(II-4B) Nicotine (Z158); or
(II-4C) Sulfoximines including sulfoxaflor (Z159); or
(II-4D) Butenolides including flupyradifurone (Z160); or
(II-4E) Mesoionics including triflumezopyrim (Z161), and dichloromezotiaze (Z162),
(II-4F) Flupyrimin (Z163),
(II-5) Nicotinic acetylcholine receptor (nAChR) allosteric modulators—Site I selected from the class of spinosyns including spinetoram (Z164) and spinosad (Z165),
(II-6) Glutamate-gated chloride channel (GluCl) allosteric modulators selected from the class avermectins/Milbemycins including abamectin (Z166), emamectin benzoate (Z167), lepimectin (Z168) and milbemectin (Z169),
(II-7) Juvenile hormone mimics selected from the class of
(II-7A) Juvenile hormone analogues including hydroprene (Z170), kinoprene (Z171) and methoprene (Z172); or
(II-7B) Fenoxycarb (Z173); or
(II-7C) Pyriproxyfen (Z174),
(II-8) Miscellaneous non-specific (multi-site) inhibitors selected from the class of
(II-8A) Alkyl halides including methyl bromide (Z175) and other alkyl halides (Z176); or
(II-8B) Chloropicrin (Z177); or
(II-8C) Fluorides including cryolite (sodium aluminium fluoride) (Z178) and sulfuryl fluoride (Z179); or
(II-8D) Borates including borax (Z180), boric acid (Z181), disodium octaborate (Z182), sodium borate (Z183), and sodium metaborate (Z184); or
(II-8E) Tartar emetic (Z185); or
(II-8F) Methyl isothiocyanate generators including dazomet (Z186) and metam (Z187),
(II-9) Chordotonal organ TRPV channel modulators selected from the class of
(II-9A) Pyridine azomethine derivatives including pymetrozine (Z188), and pyrifluquinazon (Z189); or
(II-9B) Pyropenes including afidopyropen (Z190),
(II-10) Mite growth inhibitors affecting CHS1 selected from the class of
(II-10A) Clofentezine (Z191), Hexythiazox (Z192) and Diflovidazin (Z193); or
(II-10B) Etoxazole (Z194),
(II-11) Microbial disruptors of insect midgut membranes selected from the class of
(II-11A) Bacillus thuringiensis (Z195) and the insecticidal proteins they produce, including Bacillus thuringiensis or Bacillus sphaericus (Z196) and the insecticidal proteins they produce such as Bacillus thuringiensis subsp. israelensis, Bacillus thuringiensis subsp. aizawai, Bacillus thuringiensis subsp. kurstaki and Bacillus thuringiensis subsp. Tenebrionis, or the B.t crop proteins: Cry1Ab, Cry1Ac, Cry1Fa, Cry1A.105, Cry2Ab, Vip3A, mCry3A, Cry3Ab, Cry3Bb and Cry34/35Ab1,
(II-12) Inhibitors of mitochondrial ATP synthase selected from the class of
(II-12A) Diafenthiuron (Z197); or
(II-12B) Organotin miticides including azocyclotin (Z198), cyhexatin (Z199) and fenbutatin oxide (Z200), or
(II-12C) Propargite (Z201), or
(II-12D) Tetradifon (Z202),
(II-13) Uncouplers of oxidative phosphorylation via disruption of the proton gradient selected from the class of
(II-13A) Pyrroles including chlorfenapyr (Z203); or
(II-13B) Dinitrophenols including DNOC (Z204); or
(II-13C) Sulfluramid (Z205),
(II-14) Nicotinic acetylcholine receptor (nAChR) channel blockers selected from the class of nereistoxin analogues including bensultap (Z206), cartap hydrochloride (Z207), thiocyclam (Z208) and thiosultap-sodium (Z209),
(II-15) Inhibitors of the chitin biosynthesis affecting CHS1 selected from the class of bzoylureas including bistrifluron (Z210), chlorfluazuron (Z211), diflubenzuron (Z212), flucycloxuron (Z213), flufenoxuron (Z214), hexaflumuron (Z215), lufenuron (Z216), novaluron (Z217), noviflumuron (Z218), teflubenzuron (Z219) and triflumuron (Z220),
(II-16) Inhibitors of the chitin biosynthesis type 1 including buprofezin (Z221),
(II-17) Moulting disruptors, Dipteran, including cyromazine (Z222),
(II-18) Ecdyson receptor agonists selected from the class of diacylhydrazines including methoxyfenozide (Z223), tebufenozide (Z224), halofenozide (Z225), fufenozide (Z226) and chromafenozide (Z227);
(II-19) Octopamin receptor agonists, including amitraz (Z228),
(II-20) Mitochondrial complex III electron transport inhibitors selected from the class of
(II-20A) Hydramethylnon (Z229); or
(II-20B) Acequinocyl (Z230); or
(II-20C) Fluacrypyrim (Z231); or
(II-20D) Bifenazate (Z232),
(II-21) Mitochondrial complex I electron transport inhibitors selected from the class of
(II-21A) METI acaricides and insecticides including fenazaquin (Z233), fenpyroximate (Z234), pyrimidifen (Z235), pyridaben (Z236), tebufenpyrad (Z237) and tolfenpyrad (Z238); or
(II-21B) Rotenone (Z239),
(II-22) Voltage-dependent sodium channel blockers selected from the class of
(II-22A) Oxadiazines including indoxacarb (Z240); or
(II-22B) Semicarbazones including metaflumizone (Z241); or
(II-22C) 1-[(E)-[2-(4-cyanophenyl)-1-[3-(trifluoromethyl)phenyl]ethylidene]amino]-3-[4-(difluoromethoxy)phenyl]urea (Z242),
(II-22D) 2-[3-(ethanesulfonyl)pyridin-2-yl]-5-[trifluoro(methanesulfonyl)]-1,3-benzoxazole (oxazosulfyl) (Z243),
(II-23) Inhibitors of the acetyl CoA carboxylase selected from the class of tetronic and Tetramic acid derivatives including spirodiclofen (Z244), spiromesifen (Z245), spiropidion (Z246), and spirotetramat (Z247),
(II-24) Mitochondrial complex IV electron transport inhibitors selected from the class of
(II-24A) Phosphides including aluminium phosphide (Z248), calcium phosphide (Z249), phosphine (Z250) and zinc phosphide (Z251); or
(II-24B) Cyanides including calcium cyanide (Z252), potassium cyanide (Z253) and sodium cyanide (Z254),
(II-25) Mitochondrial complex II electron transport inhibitors selected from the class of
(II-25A) Beta-ketonitrile derivatives including cyenopyrafen (Z255) and cyflumetofen (Z256), or
(II-25B) Caboxanilides including pyflubumide (Z257),
(II-26) Ryanodine receptor-modulators from the class of diamides including flubendiamide (Z258), chlorantraniliprole (Rynaxypyr®) (Z259), cyantraniliprole (Cyazypyr®) (Z260), cyclaniliprole (Z260), tetraniliprole (Z261), tetra-chlorantraniliprole (Z262), (R)-3-Chlor-N1-{2-methyl-4-[1,2,2,2-tetrafluor-1-(trifluormethyl)ethyl]phenyl}-N2-(1-methyl-2-methylsulfonylethyl)phthalamid (Z263); (S)-3-Chlor-N1-{2-methyl-4-[1,2,2,2-tetrafluor-1-(trifluormethyl)ethyl]phenyl}-N2-(1-methyl-2-methylsulfonylethyl)phthalamid (Z264); methyl-2-[3,5-dibromo-2-({[3-bromo-1-(3-chlorpyridin-2-yl)-1H-pyrazol-5-yl]carbonyl}amino)benzoyl]-1,2-dimethylhydrazinecarboxylate (Z265); N-[2-(5-amino-1,3,4-thiadiazol-2-yl)-4-chloro-6-methyl-phenyl]-5-bromo-2-(3-chloro-2-pyridyl)pyrazole-3-carboxamide (Z266); 5-chloro-2-(3-chloro-2-pyridyl)-N-[2,4-dichloro-6-[(1-cyano-1-methyl-ethyl)carbamoyl]phenyl]pyrazole-3-carboxamide (Z267); 5-bromo-N-[2,4-dichloro-6-(methylcarbamoyl)phenyl]-2-(3,5-dichloro-2-pyridyl)pyrazole-3-carboxamide (Z268); N-[2-(tert-butylcarbamoyl)-4-chloro-6-methyl-phenyl]-2-(3-chloro-2-pyridyl)-5-(fluoromethoxy)pyrazole-3-carboxamide (Z269); N2-(1-cyano-1-methyl-ethyl)-N1-(2,4-dimethylphenyl)-3-iodo-phthalamide (Z270); and 3-chloro-N2-(1-cyano-1-methyl-ethyl)-N1-(2,4-dimethylphenyl)phthalamide (Z271),
(II-27) Chordotonal organ Modulators—undefined target site including flonicamid (Z272),
(II-28) GABA-gated chloride channel allosteric modulators selected from the class of
(II-28A) Meta-diamides including broflanilide (Z273); or
(II-28B) Isoxazolines including fluxametamide (Z274); Isocycloseram (Z275),
(II-29) Baculoviruses selected from the class of
(II-29A) Granuloviruses (GVs) including Cydia pomonella GV (Z276) and Thaumatotibia leucotreta GV (Z277); or
(II-29B) Nucleopolyhedroviruses (NPVs) including Anticarsia gemmatalis MNPV (Z278), and Helicoverpa armigera NPV (Z279),
(II-30) Nicotinic Acetylcholine Receptor (nAChR) Allosteric Modulators—Site II including GS omega/kappa HXTX-Hv1a peptide (Z280),
(II-31) Insecticidal active compounds of unknown or uncertain mode of action including
Afidopyropen (Z281), azadirachtin (Z282), amidoflumet (Z283), benzoximate (Z284), benzpyrimoxan (Z285), bifenazate (Z286), bromopropylate (Z287), chinomethionat (Z288), cryolite (Z289), dicofol (Z290), flufenerim (Z291), flometoquin (Z292), fluhexafon (Z293), fluensulfone (Z294), flupyradifurone (Z295), lime sulphur (Z296), mancozeb (Z297), piperonyl butoxide (Z298), pyridalyl (Z299), pyrifluquinazon (Z300), sulfoxaflor (Z301), sulphur (Z302), 4-[5-(3,5-Dichloro-phenyl)-5-trifluoromethyl-4,5-dihydro-isoxazol-3-yl]-2-methyl-N-[(2,2,2-trifluoro-ethylcarbamoyl)-methyl]-benzamide (Z303); cyclopropaneacetic acid (Z304); 1,1-[(3S,4R,4aR,6S,6aS,12R, 12aS,12bS)-4-[[(2-cyclopropylacetyl)oxy]methyl]-1,3,4,4a,5,6,6a,12,12a,12b-decahydro-12-hydroxy-4,6a,12b-trimethyl-11-oxo-9-(3-pyridinyl)-2H,11H-naphtho[2,1-b]pyrano[3,4-e]pyran-3,6-diyl]ester (Z305); 11-(4-chloro-2,6-dimethylphenyl)-12-hydroxy-1,4-dioxa-9-azadispiro[4.2.4.2]-tetradec-11-en-10-one (Z306); 3-(4′-fluoro-2,4-dimethylbiphenyl-3-yl)-4-hydroxy-8-oxa-1-azaspiro[4.5]dec-3-en-2-one (Z307); 112-fluoro-4-methyl-5-[(2,2,2-trifluoroethyl)sulfinyl]phenyl]-3-(trifluoromethyl)-1H-1,2,4-triazole-5-amine (Z308); or actives on basis of Bacillus firmus (Votivo, II-1582) (Z309); (E/Z)—N-[1-[(6-chloro-3-pyridyl)methyl]-2-pyridylidene]-2,2,2-trifluoro-acetamide (Z310); (E/Z)—N-[1-[(6-chloro-5-fluoro-3-pyridyl)methyl]-2-pyridylidene]-2,2,2-trifluoro-acetamide (Z311); (E/Z)-2,2,2-trifluoro-N-[1-[(6-fluoro-3-pyridyl)methyl]-2-pyridylidene]acetamide (Z312); (E/Z)—N-[1-[(6-bromo-3-pyridyl)methyl]-2-pyridylidene]-2,2,2-trifluoro-acetamide (Z313); (E/Z)—N-[1-[1-(6-chloro-3-pyridyl)ethyl]-2-pyridylidene]-2,2,2-trifluoro-acetamide (Z314); (E/Z)—N-[1-[(6-chloro-3-pyridyl)methyl]-2-pyridylidene]-2,2-difluoro-acetamide (Z315); (E/Z)-2-chloro-N-[1-[(6-chloro-3-pyridyl)methyl]-2-pyridylidene]-2,2-difluoro-acetamide (Z316); (E/Z)—N-[1-[(2-chloropyrimidin-5-yl)methyl]-2-pyridylidene]-2,2,2-trifluoro-acetamide (Z317); (E/Z)—N-[1-[(6-chloro-3-pyridyl)methyl]-2-pyridylidene]-2,2,3,3,3-pentafluoro-propanamide) (Z318); triflumezopyrim (Z319); 4-[5-[3-chloro-5-(trifluoromethyl)phenyl]-5-(trifluoromethyl)-4H-isoxazol-3-yl]-N-[2-oxo-2-(2,2,2-trifluoroethylamino)ethyl]naphthalene-1-carboxamide (Z312); 3-[3-chloro-5-(trifluoromethyl)phenyl]-4-oxo-1-(pyrimidin-5-ylmethyl)pyrido[1,2-a]pyrimidin-1-ium-2-olate (Z313); 8-chloro-N-[2-chloro-5-methoxyphenyl)sulfonyl]-6-trifluoromethyl)-imidazo[1,2-a]pyridine-2-carboxamide (Z314); 4-[5-(3,5-dichlorophenyl)-5-(trifluoromethyl)-4H-isoxazol-3-yl]-2-methyl-N-(1-oxothietan-3-yl)benzamide (Z315); 5-[3-[2,6-dichloro-4-(3,3-dichloroallyloxyl)phenoxy]propoxy]-1H-pyrazole (Z316); Dimpropyridaz (Z317), Tyclopyrazoflor (Z318) and Nicofluprole (Z319),
(II-32) Biopesticides selected from the class of Microbial pesticides with insecticidal, acaricidal, molluscidal and/or nematicidal activity including Bacillus firmus (Z320), B.t. ssp. galleriae, B.t. ssp. kurstaki, Beauveria bassiana (Z321), Burkholderia sp. (Z322), Chromobacterium subtsugae (Z323), Isaria fumosorosea (Z324), Lecanicillium longisporum (Z325), L. muscarium (formerly Verticillium lecanii) (Z326), Metarhizium anisopliae (Z327), M. anisopliae var. acridum (Z328), Paecilomyces fumosoroseus Apopka strain 97 (Z329), P. lilacinus (Z330), Paenibacillus poppiliae (Z331), Pasteuria spp. (Z332), P. nishizawae (Z333), P. reneformis (Z334), P. usagae (Z335), Pseudomonas fluorescens (Z336), Steinernema feltiae (Z337), Streptomyces galbus (Z338), Wolbachia pipientis (Zap) (Z339) Bacillus amyloliquefaciens (Z373), Bacillus subtilis (Z374), Lecanicillium lecanii (Z375), Purpureocillium lilacinum (Z376) and Burkholderia rinojenses (Z377), and
(II-33) Biochemical pesticides with insecticidal, acaricidal, molluscidal, pheromone and/or nematicidal activity including L-carvone (Z340); citral (Z341); (E,Z)-7,9-dodecadien-1-yl acetate (Z342); ethyl formate (Z343); (E,Z)-2,4-ethyl decadienoate (pear ester) (Z344); (Z,Z,E)-7,11,13-hexadecatrienal (Z345); heptyl butyrate (Z346); isopropyl myristate (Z347); lavanulyl senecioate (Z348); 2-methyl 1-butanol (Z349); methyl eugenol (Z350); methyl jasmonate (Z351); (E,Z)-2,13-octadecadien-1-ol (Z352); (E,Z)-2,13-octadecadien-1-ol acetate (Z353); (E,Z)-3,13-octadecadien-1-ol (Z354), R-1-octen-3-ol (Z355); pentatermanone (Z356); potassium silicate (Z357); sorbitol actanoate (Z358); (E,Z,Z)-3,8,11-tetradecatrienyl acetate (Z359); (Z,E)-9,12-tetradecadien-1-yl acetate (Z360); Z-7-tetradecen-2-one (Z361), Z-9-tetradecen-1-yl acetate (Z362); Z-11-tetradecenal (Z363); Z-11-tetradecen-1-ol (Z364); Acacia negra extract (Z365); extract of grapefruit seeds and pulp (Z366); extract of Chenopodium ambrosiodae (Z367); fatty acid monoester with glycerol or propanediol (Z368), Catnip oil (Z369); Neem oil (Z370); Quillay extract (Z371) and Tagetes oil (Z372).

4. The pesticidal mixture according to claim 1, wherein said component (2) is at least one fungicidally active compound (III) selected from the groups A) to P):
(A) Inhibitors of the ergosterol biosynthesis including (A001) cyproconazole; (A002) difenoconazole; (A003) epoxiconazole; (A004) fenhexamid; (A005) fenpropidin; (A006) fenpropimorph; (A007) fenpyrazamine; (A008) fluquinconazole; (A009) flutriafol; (A010) imazalil; (A011) imazalil sulfate; (A012) ipconazole; (A013) metconazole; (A014) myclobutanil; (A015) paclobutrazol; (A016) prochloraz; (A017) propiconazole; (A018) prothioconazole; (A019) pyrisoxazole; (A020) spiroxamine; (A021) tebuconazole; (A022) tetraconazole; (A023) triadimenol; (A024) tridemorph; (A025) triticonazole; (A026) (1R,2S,5S)-5-(4-chlorobenzyl)-2-(chloromethyl)-2-methyl-I-(IH-1,2,4-triazol-1-ylmethyl)cyclopentanol; (A027) (1S,2R,5R)-5-(4-chlorobenzyl)-2-(chloromethyl)-2-methyl-1-(1H-1,2,4-triazol-1-ylmethyl)cyclopentanol, (A028) (2R)-2-(I-chlorocyclopropyl)-4-[(1R)-2,2-dichlorocyclopropyl]-I-(IH-1,2,4-triazol-1-yl)butan-2-ol; (A029) (2R)-2-(I-chlorocyclopropyl)-4-[(IS)-2,2-dichlorocyclopropyl]-1-(IH-1,2,4-triazol-1-yl)butan-2-ol; (A030) (2R)-2-[4-(4-chlorophenoxy)-2-(trifluoromethyl)phenyl]-1-(1H-1,2,4-triazol-1-yl)propan-2-ol; (A031) (2S)-2-(1-chlorocyclopropyl)-4-[(1R)-2,2-dichlorocyclopropyl]-1-(1H-1,2,4-triazol-1-yl)butan-2-ol; (A032) (2S)-2-(1-chlorocyclopropyl)-4-[(1S)-2,2-dichlorocyclopropyl]-1-(1H-1,2,4-triazol-1-yl)butan-2-ol; (A033) (2S)-2-[4-(4-chlorophenoxy)-2-(trifluoromethyl)phenyl]-1-(IH-1,2,4-triazol-1-yl)propan-2-ol; (A034) (R)-[3-(4-chloro-2-fluorophenyl)-5-(2,4-difluorophenyl)-1,2-oxazol-4-yl](pyridin-3-yl)methanol; (A035) (S)-[3-(4-chloro-2-fluorophenyl)-5-(2,4-difluorophenyl)-1,2-oxazol-4-yl](pyridin-3-yl)methanol; (A036) [3-(4-chloro-2-fluorophenyl)-5-(2,4-difluorophenyl)-1,2-oxazol-4-yl](pyridin-3-yl)methanol; (A037) 1-({(2R,4S)-2-[2-chloro-4-(4-chlorophenoxy)phenyl]-4-methyl-1,3-dioxolan-2-yl}methyl)-1H-1,2,4-triazole; (A038) 1-({(2S,4S)-2-[2-chloro-4-(4-chlorophenoxy)phenyl]-4-methyl-I,3-dioxolan-2-yl}methyl)-IH-1,2,4-triazole; (A039) I-{[3-(2-chlorophenyl)-2-(2,4-difluorophenyl)oxiran-2-yl]methyl}-IH-1,2,4-triazol-5-yl thiocyanate; (A040) I-{[rel(2R,3R)-3-(2-chlorophenyl)-2-(2,4-difluorophenyl)oxiran-2-yl]methyl}-1H-1,2,4-triazol-5-yl thiocyanate; (A041) I-{[rel(2R,3S)-3-(2-chlorophenyl)-2-(2,4-difluorophenyl)oxiran-2-yl]methyl}-1H-1,2,4-triazol-5-yl thiocyanate; (A042) 2-[(2R,4R,5R)-1-(2,4-dichlorophenyl)-5-hydroxy-2,6,6-trimethylheptan-4-yl]-2,4-dihydro-3H-1,2,4-triazole-3-thione; (A043) 2-[(2R,4R,5S)-1-(2,4-dichlorophenyl)-5-hydroxy-2,6,6-trimethylheptan-4-yl]-2,4-dihydro-3H-1,2,4-triazole-3-thione; (A044) 2-[(2R,4S,5R)-I-(2,4-dichlorophenyl)-5-hydroxy-2,6,6-trimethylheptan-4-yl]-2,4-dihydro-3H-1,2,4-triazole-3-thione; (A045) 2-[(2R,4S,5S)-1-(2,4-dichlorophenyl)-5-hydroxy-2,6,6-trimethylheptan-4-yl]-2,4-dihydro-3H-1,2,4-triazole-3-thione; (A046) 2-[(2S,4R,5R)-1-(2,4-dichlorophenyl)-5-hydroxy-2,6,6-trimethylheptan-4-yl]-2,4-dihydro-3H-1,2,4-triazole-3-thione; (A047) 2-[(2S,4R,5S)-1-(2,4-dichlorophenyl)-5-hydroxy-2,6,6-trimethylheptan-4-yl]-2,4-dihydro-3H-1,2,4-triazole-3-thione; (A048) 2-[(2S,4S,5R)-1-(2,4-dichlorophenyl)-5-hydroxy-2,6,6-trimethylheptan-4-yl]-2,4-dihydro-3H-1,2,4-triazole-3-thione; (A049) 2-[(2S,4S,5S)-I-(2,4-dichlorophenyl)-5-hydroxy-2,6,6-trimethylheptan-4-yl]-2,4-dihydro-3H-1,2,4-triazole-3-thione; (A050) 2-[1-(2,4-dichlorophenyl)-5-hydroxy-2,6,6-trimethylheptan-4-yl]-2,4-dihydro-3H-1,2,4-triazole-3-thione; (A051) 2-[2-chloro-4-(2,4-dichlorophenoxy)phenyl]-I-(1H-1,2,4-triazol-1-yl)propan-2-ol; (A052) 2-[2-chloro-4-(4-chlorophenoxy)phenyl]-1-(IH-1,2,4-triazol-1-yl)butan-2-ol; (A053) 2-[4-(4-chlorophenoxy)-2-(trifluoromethyl)phenyl]-1-(1H-1,2,4-triazol-1-yl)butan-2-ol; (A054) 2-[4-(4-chlorophenoxy)-2-(trifluoromethyl)phenyl]-1-(1H-1,2,4-triazol-I-yl)pentan-2-ol; (A055) 2-[4-(4-chlorophenoxy)-2-(trifluoromethyl)phenyl]-1-(IH-1,2,4-triazol-1-yl)propan-2-ol; (A056) 2-{[3-(2-chlorophenyl)-2-(2,4-difluorophenyl)oxiran-2-yl]methyl}-2,4-dihydro-3H-1,2,4-triazole-3-thione; (A057) 2-{[rel(2R,3R)-3-(2-chlorophenyl)-2-(2,4-difluorophenyl)oxiran-2-yl]methyl}-2,4-dihydro-3H-1,2,4-triazole-3-thione; (A058) 2-{[rel(2R,3S)-3-(2-chlorophenyl)-2-(2,4-difluorophenyl)oxiran-2-yl]methyl}-2,4-dihydro-3H-1,2,4-triazole-3-thione; (A059) 5-(4-chlorobenzyl)-2-(chloromethyl)-2-methyl-1-(IH-1,2,4-triazol-1-ylmethyl)cyclopentanol; (A060) 5-(allylsulfanyl)-1-{[3-(2-chlorophenyl)-2-(2,4-difluorophenyl)oxiran-2-yl]methyl}-1H-1,2,4-triazole; (A061) 5-(allylsulfanyl)-1-{[rel(2R,3R)-3-2-chlorophenyl)-2-(2,4-difluorophenyl)oxiran-2-yl]methyl}-1H-1,2,4-triazole; (A062) 5-(allylsulfanyl)-1-{[rel(2R,3S)-3-(2-chlorophenyl)-2-(2,4-difluorophenyl)oxiran-2-yl]methyl}-1H-1,2,4-triazole; (A063) N′-(2,5-dimethyl-4-{[3-(1,1,2,2-tetrafluoroethoxy)phenyl]sulfanyl}phenyl)-N-ethyl-N-methylimidoformamide; (A064) N′-(2,5-dimethyl-4-{[3-(2,2,2-trifluoroethoxy)phenyl]sulfanyl}phenyl)-N-ethyl-N-methylimidoformamide; (A065) N′-(2,5-dimethyl-4-{[3-(2,2,3,3-tetrafluoropropoxy)phenyl]sulfanyl}phenyl)-N-ethyl-N-methylimidoformamide; (A066) N′-(2,5-dimethyl-4-{[3-(pentafluoroethoxy)phenyl]sulfanyl}phenyl)-N-ethyl-N-methylimidoformamide; (A067) N′-(2,5-dimethyl-4-{3-[(1,1,2,2-tetrafluoroethyl)sulfanyl]phenoxy}phenyl)-N-ethyl-N-methylimidoformamide; (A068) N′-(2,5-dimethyl-4-{3-[(2,2,2-trifluoroethyl)sulfanyl]phenoxy}phenyl)-N-ethyl-N-methylimidoformamide; (A069) N′-(2,5-dimethyl-4-{3-[(2,2,3,3-tetrafluoropropyl)sulfanyl]phenoxy}phenyl)-N-ethyl-N-methylimidoformamide; (A070) N′-(2,5-dimethyl-4-{3-[(pentafluoroethyl)sulfanyl]phenoxy}phenyl)-N-ethyl-N-methylimidoformamide; (A071) N′-(2,5-dimethyl-4-phenoxyphenyl)-N-ethyl-N-methylimidoformamide; (A072) N′-(4-{[3-(difluoromethoxy)phenyl]sulfanyl}-2,5-dimethylphenyl)-N-ethyl-N-methylimidoformamide; (A073) N′-(4-{3-[(difluoromethyl)sulfanyl]phenoxy}-2,5-dimethylphenyl)-N-ethyl-N-methylimidoformamide; (A074) N′-[5-bromo-6-(2,3-dihydro-1H-inden-2-yloxy)-2-methylpyridin-3-yl]-N-ethyl-N-methylimidoformamide; (A075) N′-{4-[(4,5-dichloro-1,3-thiazol-2-yl)oxy]-2,5-dimethylphenyl}-N-ethyl-N-methylimidoformamide; (A076) N′-{5-bromo-6-[(1R)-1-(3,5-difluorophenyl)ethoxy]-2-methylpyridin-3-yl}-N-ethyl-N-methylimidoformamide; (A077) N′-{5-bromo-6-[(1S)-1-(3,5-difluorophenyl)ethoxy]-2-methylpyridin-3-yl}-N-ethyl-N-methylimidoformamide; (A078) N′-{5-bromo-6-[(cis-4-isopropylcyclohexyl)oxy]-2-methylpyridin-3-yl}-N-ethyl-N-methylimidoformamide; (A079) N′-{5-bromo-6-[(trans-4-isopropylcyclohexyl)oxy]-2-methylpyridin-3-yl}-N-ethyl-N-methylimidoformamide; (A080) N′-{5-bromo-6-[1-(3,5-difluorophenyl)ethoxy]-2-methylpyridin-3-yl}-N-ethyl-N-methylimidoformamide; (A081) mefentrifluconazole; (A082) ipfentrifluconazole; (A083) 1-(2,4-difluorophenyl)-2-(1H-1,2,4-triazol-1-yl)-1-[1-(2,6-difluoro-4-chlorophenoxy)cyclopropyl]ethanol; and (A084) 1-[2-(I-chlorocyclopropyl)-3-(2-fluorophenyl)-2-hydroxypropyl]-1H-imidazole-5-carbonitrile,
(B) Inhibitors of the respiratory chain at complex I or II including (B001) benzovindiflupyr; (B002) bixafen; (B003) boscalid; (B004) carboxin; (B005) fluopyram; (B006) flutolanil; (B007) fluxapyroxad; (B008) furametpyr; (B009) isofetamid; (B010) isopyrazam (anti-epimeric enantiomer 1R,4S,9S); (B011) isopyrazam (anti-epimeric enantiomer 1S,4R,9R); (B012) isopyrazam (anti-epimeric racemate 1RS,4SR,9SR); (B013) isopyrazam (mixture of syn-epimeric racemate 1RS,4SR,9RS and anti-epimeric racemate 1RS,4SR,9SR); (B014) isopyrazam (syn-epimeric enantiomer 1R,4S,9R); (B015) isopyrazam (syn-epimeric enantiomer 1S,4R,9S); (B016) isopyrazam (syn-epimeric racemate 1RS,4SR,9RS); (B017) penflufen; (B018) penthiopyrad; (B019) pydiflumetofen; (B020) pyraziflumid; (B021) sedaxane; (B022) 1,3-dimethyl-N-(1,1,3-trimethyl-2,3-dihydro-IH-inden-4-yl)-IH-pyrazole-4-carboxamide; (B023) 1,3-dimethyl-N-[(3R)-1,I,3-trimethyl-2,3-dihydro-1H-inden-4-yl]-1H-pyrazole-4-carboxamide; (B024) I,3-dimethyl-N-[(3S)-1,1,3-trimethyl-2,3-dihydro-IH-inden-4-yl]-1H-pyrazole-4-carboxamide; (B025) I-methyl-3-(trifluoromethyl)-N-[2′-(trifluoromethyl)biphenyl-2-yl]-1H-pyrazole-4-carboxamide; (B026) 2-fluoro-6-(trifluoromethyl)-N-(1,1,3-trimethyl-2,3-dihydro-IH-inden-4-yl)benzamide; (B027) 3-(difluoromethyl)-1-methyl-N-(1,1,3-trimethyl-2,3-dihydro-1H-inden-4-yl)-IH-pyrazole-4-carboxamide; (B028) 3-(difluoromethyl)-1-methyl-N-[(3R)-1,1,3-trimethyl-2,3-dihydro-IH-inden-4-yl]-IH-pyrazole-4-carboxamide; (B029) 3-(difluoromethyl)-1-methyl-N-[(3S)-1,1,3-trimethyl-2,3-dihydro-IH-inden-4-yl]-IH-pyrazole-4-carboxamide; (B030) 3-(difluoromethyl)-N-(7-fluoro-1,1,3-trimethyl-2,3-dihydro-IH-inden-4-yl)-1-methyl-1H-pyrazole-4-carboxamide (Fluindapyr); (B031) 3-(difluoromethyl)-N-[(3R)-7-fluoro-1,1,3-trimethyl-2,3-dihydro-IH-inden-4-yl]-1-methyl-1H-pyrazole-4-carboxamide; (B032) 3-(difluoromethyl)-N-[(3S)-7-fluoro-1,1,3-trimethyl-2,3-dihydro-1H-inden-4-yl]-1-methyl-IH-pyrazole-4-carboxamide; (B033) 5,8-difluoro-N-[2-(2-fluoro-4-{[4-(trifluoromethyl)pyridin-2-yl]oxy}phenyl)ethyl]quinazolin-4-amine; (B034) N-(2-cyclopentyl-5-fluorobenzyl)-N-cyclopropyl-3-(difluoromethyl)-5-fluoro-1-methyl-1-H-pyrazole-4-carboxamide; (B035) N-(2-tert-butyl-5-methylbenzyl-N-cyclopropyl-3-(difluoromethyl)-5-fluoro-1-methyl-1H-pyrazole-4-carboxamide; (B036) N-(2-tert-butylbenzyl)-N-cyclopropyl-3-(difluoromethyl)-5-fluoro-1-methyl-1H-pyrazole-4-carboxamide; (B037) N-(5-chloro-2-ethylbenzyl)-N-cyclopropyl-3-(difluoromethyl)-5-fluoro-1-methyl-1H-pyrazole-4-carboxamide; (B038) N-(5-chloro-2-isopropylbenzyl)-N-cyclopropyl-3-(difluoromethyl)-5-fluoro-1-methyl-IH-pyrazole-4-carboxamide; (B039) N-[(1R,4S)-9-(dichloromethylene)-1,2,3,4-tetrahydro-1,4-methanonaphthalen-5-yl]-3-(difluoromethyl)-1-methyl-1H-pyrazole-4-carboxamide; (B040) N-[(1S,4R)-9-(dichloromethylene)-1,2,3,4-tetrahydro-1,4-methanonaphthalen-5-yl]-3-(difluoromethyl)-1-methyl-1H-pyrazole-4-carboxamide; (B041) N-[1-(2,4-dichlorophenyl)-1-methoxypropan-2-yl]-3-(difluoromethyl)-1-methyl-1H-pyrazole-4-carboxamide; (B042) N-[2-chloro-6-(trifluoromethyl)benzyl]-N-cyclopropyl-3-(difluoromethyl)-5-fluoro-1-methyl-1H-pyrazole-4-carboxamide; (B043) N-[3-chloro-2-fluoro-6-(trifluoromethyl)benzyl]-N-cyclopropyl-3-(difluoromethyl)-5-fluoro-1-methyl-1H-pyrazole-4-carboxamide; (B044) N-[5-chloro-2-(trifluoromethyl)benzyl]-N-cyclopropyl-3-(difluoromethyl)-5-fluoro-1-methyl-1H-pyrazole-4-carboxamide; (B045) N-cyclopropyl-3-(difluoromethyl)-5-fluoro-1-methyl-N-[5-methyl-2-(trifluoromethyl)benzyl]-1H-pyrazole-4-carboxamide; (B046) N-cyclopropyl-3-(difluoromethyl)-5-fluoro-N-(2-fluoro-6-isopropylbenzyl)-1-methyl-1H-pyrazole-4-carboxamide; (B047) N-cyclopropyl-3-(difluoromethyl)-5-fluoro-N-(2-isopropyl-5-methylbenzyl)-1-methyl-1H-pyrazole-4-carboxamide; (B048) N-cyclopropyl-3-(difluoromethyl)-5-fluoro-N-(2-isopropylbenzyl)-1-methyl-IH-pyrazole-4-carbothioamide; (B049) N-cyclopropyl-3-(difluoromethyl)-5-fluoro-N-(2-isopropylbenzyl)-1-methyl-1H-pyrazole-4-carboxamide; (B050) N-cyclopropyl-3-(difluoromethyl)-5-fluoro-N-(5-fluoro-2-isopropylbenzyl)-1-methyl-IH-pyrazole-4-carboxamide; (B051) N-cyclopropyl-3-(difluoromethyl)-N-(2-ethyl-4,5-dimethylbenzyl)-5-fluoro-1-methyl-1H-pyrazole-4-carboxamide; (B052) N-cyclopropyl-3-(difluoromethyl)-N-(2-ethyl-5-fluorobenzyl)-5-fluoro-1-methyl-1H-pyrazole-4-carboxamide; (B053) N-cyclopropyl-3-(difluoromethyl)-N-(2-ethyl-5-methylbenzyl)-5-fluoro-1-methyl-1H-pyrazole-4-carboxamide; (B054) N-cyclopropyl-N-(2-cyclopropyl-5-fluorobenzyl)-3-(difluoromethyl)-5-fluoro-1-methyl-IH-pyrazole-4-carboxamide; (B055) N-cyclopropyl-N-(2-cyclopropyl-5-methylbenzyl)-3-(difluoromethyl)-5-fluoro-1-methyl-1H-pyrazole-4-carboxamide; (B056) N-cyclopropyl-N-(2-cyclopropylbenzyl)-3-(difluoromethyl)-5-fluoro-1-methyl-1H-pyrazole-4-carboxamide; (B057) 2-(difluoromethyl)-N-(I,1-dimethyl-3-propyl-2,3-dihydro-1H-inden-4-yl)nicotinamide; (B058) pyrapropoyne; (B059) inpyrfluxam; and (B060) isoflucypram,
(C) Inhibitors of the respiratory chain at complex III including (C001) ametoctradin; (C002) amisulbrom; (C003) azoxystrobin; (C004) coumethoxystrobin; (C005) coumoxystrobin; (C006) cyazofamid; (C007) dimoxystrobin; (C008) enoxastrobin; (C009) famoxadone; (C010) fenamidone; (C011) flufenoxystrobin; (C012) fluoxastrobin; (C013) kresoxim-methyl; (C014) metominostrobin; (C015) orysastrobin; (C016) picoxystrobin; (C017) pyraclostrobin; (C018) pyrametostrobin; (C019) pyraoxystrobin; (C020) trifloxystrobin; (C021) (2E)-2-{2-[({[(IE)-1-(3-{[(E)-1-fluoro-2 phenylvinyl]oxy}phenyl)ethylidene]amino}oxy)methyl]phenyl}-2-(methoxyimino)-N-methylacetamide; (C022) (2E,3Z)-5-{[1-(4-chlorophenyl)-IH-pyrazol-3-yl]oxy}-2-(methoxyimino)-N,3-dimethylpent-3-enamide; (C023) (2R)-2-{2-[(2,5-dimethylphenoxy)methyl]phenyl}-2-methoxy-N-methylacetamide; (C024) (2S)-2-{2-[(2,5-dimethylphenoxy)methyl]phenyl}-2-methoxy-N-methylacetamide; (C025) (3S,6S,7R,8R)-8-benzyl-3-[({3-[(isobutyryloxy)methoxy]-4-methoxypyridin-2-yl}carbonyl)amino]-6-methyl-4,9-dioxo-I,5-dioxonan-7-yl-2-methylpropanoate (Fenpicoxamid); (C026) 2-{2-[(2,5-dimethylphenoxy)methyl]phenyl}-2-methoxy-N-methylacetamide (Mandestrobin); (C027) N-(3-ethyl-3,5,5-trimethylcyclohexyl)-3-formamido-2-hydroxybenzamide; (C028) (2E,3Z)-5-{[1-(4-chloro-2-fluorophenyl)-1H-pyrazol-3-yl]oxy}-2-(methoxyimino)-N,3-dimethylpent-3-enamide; (C029) methyl {5-[3-(2,4-dimethylphenyl)-IH-pyrazol-1-yl]-2-methylbenzyl}carbamate; (C030) 1-(2-{[1-(4-chlorophenyl)pyrazol-3-yl]oxymethyl}-3-methylphenyl)-1,4-dihydro-4-methyl-5H-tetrazol-5-one (Metyltetraprole); and (C031) florylpicoxamid,
(D) Inhibitors of the mitosis and cell division including (D001) carbendazim; (D002) diethofencarb; (D003) ethaboxam; (D004) fluopicolide; (D005) pencycuron; (D006) thiabendazole; (D007) thiophanate-methyl; (D008) zoxamide; (D009) 3-chloro-4-(2,6-difluorophenyl)-6-methyl-5-phenylpyridazine; (D010) 3-chloro-5-(4-chlorophenyl)-4-(2,6-difluorophenyl)-6-methylpylidazine; (D011) 3-chloro-5-(6-chloropyridin-3-yl)-6-methyl-4-(2,4,6-trifluorophenyl)pyridazine; (D012) 4-(2-bromo-4-fluorophenyl)-N-(2,6-difluorophenyl)-1,3-dimethyl-1H-pyrazol-5-amine; (D013) 4-(2-bromo-4-fluorophenyl)-N-(2-bromo-6-fluorophenyl)-1,3-dimethyl-1H-pyrazol-5-amine; (D014) 4-(2-bromo-4-fluorophenyl)-N-(2-bromophenyl)-1,3-dimethyl-IH-pyrazol-5-amine; (D015) 4-(2-bromo-4-fluorophenyl)-N-(2-chloro-6-fluorophenyl)-1,3-dimethyl-1H-pyrazol-5-amine; (D016) 4-(2-bromo-4-fluorophenyl)-N-(2-chlorophenyl)-1,3-dimethyl-1H-pyrazol-5-amine; (D017) 4-(2-bromo-4-fluorophenyl)-N-(2-fluorophenyl)-1,3-dimethyl-1H-pyrazol-5-amine; (D018) 4-(2-chloro-4-fluorophenyl)-N-(2,6-difluorophenyl)-1,3-dimethyl-1H-pyrazol-5-amine; (D019) 4-(2-chloro-4-fluorophenyl)-N-(2-chloro-6-fluorophenyl)-1,3-dimethyl-IH-pyrazol-5-amine; (D020) 4-(2-chloro-4-fluorophenyl)-N-(2-chlorophenyl)-1,3-dimethyl-1H-pyrazol-5-amine; (D021) 4-(2-chloro-4-fluorophenyl)-N-(2-fluorophenyl)-1,3-dimethyl-1H-pyrazol-5-amine; (D022) 4-(4-chlorophenyl)-5-(2,6-difluorophenyl)-3,6-dimethylpyridazine; (D023) N-(2-bromo-6-fluorophenyl)-4-(2-chloro-4-fluorophenyl)-1,3-dimethyl-1H-pyrazol-5-amine; (D024) N-(2-bromophenyl)-4-(2-chloro-4-fluorophenyl)-1,3-dimethyl-1H-pyrazol-5-amine; and (D025) N-(4-chloro-2,6-difluorophenyl)-4-(2-chloro-4-fluorophenyl)-1,3-dimethyl-IH-pyrazol-5-amine,
(E) Compounds capable to have a multisite action including (E001) bordeaux mixture; (E002) captafol; (E003) captan; (E004) chlorothalonil; (E005) copper hydroxide; (E006) copper naphthenate; (E007) copper oxide; (E008) copper oxychloride; (E009) copper(II) sulfate; (E010) dithianon; (E011) dodine; (E012) folpet; (E013) mancozeb; (E014) maneb; (E015) metiram; (E016) metiram zinc; (E017) oxine-copper; (E018) propineb; (E019) sulfur and sulfur preparations including calcium polysulfide; (E020) thiram; (E021) zineb; (E022) ziram; and (E023) 6-ethyl-5,7-dioxo-6,7-dihydro-5H-pynolo[3′,4′:5,6][1,4]dithiino[2,3-c][1,2]thiazole-3-carbonitrile,
(F) Compounds capable to induce a host defence including (F001) acibenzolar-S-methyl; (F002) isotianil; (F003) probenazole; and (F004) tiadinil,
(G) Inhibitors of the amino acid and/or protein biosynthesis including (G001) cyprodinil; (G002) kasugamycin; (G003) kasugamycin hydrochloride hydrate; (G004) oxytetracycline; (G005) pyrimethanil; (G006) 3-(5-fluoro-3,3,4,4-tetramethyl-3,4-dihydroisoquinolin-1-yl)quinoline;
(H) Inhibitors of the ATP production including (H001) silthiofam;
(I) Inhibitors of the cell wall synthesis including (I001) benthiavalicarb; (I002) dimethomorph; (I003) flumorph; (I004) iprovalicarb; (I005) mandipropamid; (I006) pyrimorph; (I007) valifenalate; (I008) (2E)-3-(4-tert-butylphenyl)-3-(2-chloropyridin-4-yl)-I-(morpholin-4-yl)prop-2-en-1-one; and (I009) (2Z)-3-(4-tert-butylphenyl)-3-(2-chloropyridin-4-yl)-1-(morpholin-4-yl)prop-2-en-1-one,
(J) Inhibitors of the lipid and membrane synthesis including (J001) propamocarb; (J002) propamocarb hydrochloride; and (J003) tolclofos-methyl,
(K) Inhibitors of the melanin biosynthesis including (K001) tricyclazole; (K002) 2,2,2-trifluoroethyl {3-methyl-1-[(4-methylbenzoyl)amino]butan-2-yl}carbamate;
(L) Inhibitors of the nucleic acid synthesis including (L001) benalaxyl; (L002) benalaxyl-M (kiralaxyl); (L003) metalaxyl; and (L004) metalaxyl-M (mefenoxam),
(M) Inhibitors of the signal transduction including (M001) fludioxonil; (M002) iprodione; (M003) procymidone; (M004) proquinazid; (M005) quinoxyfen; and (M006) vinclozolin,
(N) Compounds capable to act as an uncoupler including (N001) fluazinam; and (N002) meptyldinocap,
(O) Further compounds including (O001) abscisic acid; (O002) benthiazole; (O003) bethoxazin; (O004) capsimycin; (O005) carvone; (O006) chinomethionat; (O007) cufraneb; (O008) cyflufenamid; (O009) cymoxanil; (O010) cyprosulfamide; (O011) flutianil; (O012) fosetyl-aluminium; (O013) fosetyl-calcium; (O014) fosetyl-sodium; (O015) methyl isothiocyanate; (O016) metrafenone; (O017) mildiomycin; (O018) natamycin; (O019) nickel dimethyldithiocarbamate; (O020) nitrothal-isopropyl; (O021) oxamocarb; (O022) oxathiapiprolin; (O023) oxyfenthiin; (O024) pentachlorophenol and salts; (O025) phosphorous acid and its salts; (O026) propamocarb-fosetylate; (O027) pyriofenone (chlazafenone); (O028) tebufloquin; (O029) tecloftalam; (O030) tolnifanide; (O031) 1-(4-{4-[(5R)-5-(2,6-difluorophenyl)-4,5-dihydro-I,2-oxazol-3-yl]-I,3-thiazol-2-yl}piperidin-1-yl)-2-[5-methyl-3-(trifluoromethyl)-1H-pyrazol-1-yl]ethanone; (O032) 1-(4-{4-[(5S)-5-(2,6-difluorophenyl)-4,5-dihydro-I,2-oxazol-3-yl]-I,3-thiazol-2-yl}piperidin-1-yl)-2-[5-methyl-3-(trifluoromethyl)-IH-pyrazol-I-yl]ethanone; (O033) 2-(6-benzylpyridin-2-yl)quinazoline; (O034) 2,6-dimethyl-1H,5H-[1,4]dithiino[2,3-c:5,6-c′]dipyrrole-1,3,5,7(2H,6H)-tetrone; (O035) 2-[3,5-bis(difluoromethyl)-IH-pyrazol-1-yl]-1-[4-(4-{5-[2-(prop-2-yn-1-yloxy)phenyl]-4,5-dihydro-I,2-oxazol-3-yl}-I,3-thiazol-2-yl)piperidin-1-yl]ethanone; (O036) 2-[3,5-bis(difluoromethyl)-1H-pyrazol-1-yl]-1-[4-(4-{5-[2-chloro-6-(prop-2-yn-1-yloxy)phenyl]-4,5-dihydro-1,2-oxazol-3-yl}-1,3-thiazol-2-yl)piperidin-1-yl]ethanone; (O037) 2-[3,5-bis(difluoromethyl)-IH-pyrazol-1-yl]-1-[4-(4-{5-[2-fluoro-6-(prop-2-yn-1-yloxy)phenyl]-4,5-dihydro-I,2-oxazol-3-yl}-I,3-thiazol-2-yl)piperidin-1-yl]ethanone; (O038) 2-[6-(3-fluoro-4-methoxyphenyl)-5-methylpyridin-2-yl]quinazoline; (O039) 2-{(5R)-3-[2-(1-{[3,5-bis(difluoromethyl)-IH-pyrazol-1-yl]acetyl}piperidin-4-yl)-1,3-thiazol-4-yl]-4,5-dihydro-I,2-oxazol-5-yl}-3-chlorophenyl methanesulfonate; (O040) 2-{(5S)-3-[2-(1-{[3,5-bis(difluoromethyl)-1H-pyrazol-1-yl]acetyl}piperidin-4-yl)-1,3-thiazol-4-yl]-4,5-dihydro-I,2-oxazol-5-yl}-3-chlorophenylmethanesulfonate; (O041) 2-{2-[(7,8-difluoro-2-methylquinolin-3-yl)oxy]-6-fluorophenyl}propan-2-ol; (O042) 2-{2-fluoro-6-[(8-fluoro-2-methylquinolin-3-yl)oxy]phenyl}propan-2-ol; (O043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenylmethanesulfonate; (O044) 2-{3-[2-(1-{[3,5-is(difluoromethyl)-IH-pyrazol-1-yl]acetyl}piperidin-4-yl)-1,3-thiazol-4-yl]-4,5-dihydro-1,2-oxazol-5-yl}phenylmethanesulfonate; (O045) 2-phenylphenol and salts; (O046) 3-(4,4,5-trifluoro-3,3-dimethyl-3,4-dihydroisoquinolin-1-yl)quinoline; (O047) 3-(4,4-difluoro-3,3-dimethyl-3,4-dihydroisoquinolin-1-yl)quinoline (Quinofumelin); (O048) 4-amino-5-fluoropyrimidin-2-ol (tautomeric form: 4-amino-5-fluoropyrimidin-2(1H)-one); (O049) 4-oxo-4-[(2-phenylethyl)amino]butanoic acid; (O050) 5-amino-1,3,4-thiadiazole-2-thiol; (O051) 5-chloro-N′-phenyl-N′-(prop-2-yn-1-yl)thiophene-2-sulfonohydrazide; (O052) 5-fluoro-2-[(4-fluorobenzyl)oxy]pyrimidin-4-amine; (O053) 5-fluoro-2-[(4-methylbenzyl)oxy]pyrimidin-4-amine; (O054) 9-fluoro-2,2-dimethyl-5-(quinolin-3-yl)-2,3-dihydro-1,4-benzoxazepine; (O055) but-3-yn-1-yl{6-[({[(Z)-(I-methyl-1H-tetrazol-5-yl)(phenyl)methylene]amino}oxy)methyl]pyridin-2-yl}carbamate; (O056) ethyl (2Z)-3-amino-2-cyano-3-phenylacrylate; (O057) phenazine-1-carboxylic acid; (O058) propyl 3,4,5-trihydroxybenzoate; (O059) quinolin-8-ol; (O060) quinolin-8-ol sulfate (2:1); (O061) tert-butyl {6-[({[(1-methyl-1H-tetrazol-5-yl)(phenyl)methylene]amino}oxy)methyl]pyridin-2-yl}carbamate; (O062) 5-fluoro-4-imino-3-methyl-1-[(4-methylphenyl)sulfonyl]-3,4-dihydropyrimidin-2(1H)-one; (O063) fluoxapiprolin; (O064) pyridachlometyl; (O065) ipflufenoquin; and (O066) aminopyrifen, and
(P) Inhibitors of histone deacetylase including (P001) N-(1-ethylcyclopropyl)-4-[5-(trifluoromethyl)-1,2,4-oxadiazol-3-yl]benzamide; (P002) N-(2-isopropylcyclopropyl)-4-[5-(trifluoromethyl)-1,2,4-oxadiazol-3-yl]benzamide; (P003) N-(2-methylcyclopropyl)-4-[5-(trifluoromethyl)-1,2,4-oxadiazol-3-yl]benzamide; (P004) N-(1-methylcyclopropyl)-4-[5-(trifluoromethyl)-1,2,4-oxadiazol-3-yl]benzamide; (P005) N-(2-ethylcyclopropyl)-4-[5-(trifluoromethyl)-1,2,4-oxadiazol-3-yl]benzamide; (P006) N-(2,4-difluorophenyl)-4-[5-(trifluoromethyl)-1,2,4-oxadiazol-3-yl]benzamide; (P007) 5-(trifluoromethyl)-3-[4-[[3-(trifluoromethyl)-1,2,4triazol-1-yl]methyl]phenyl]-1,2,4-oxadiazole; (P008) 2-[[4-[5-(trifluoromethyl)-1,2,4-oxadiazol-3-yl]phenyl]methyl]-1,2,4-triazole-3-carbonitrile; (P009) ethyl 1-[[4-[5-(trifluoromethyl)-1,2,4-oxadiazol-3-yl]phenyl]methyl]pyrazole-4-carboxylate; (P010) N-cyclopropyl-1-[[4-[5-(trifluoromethyl)-1,2,4-oxadiazol-3-yl]phenyl]methyl]pyrazole-4-carboxamide; (P011) N,N-dimethyl-1-[[4-[5-(trifluoromethyl)-1,2,4-oxadiazol-3-yl]phenyl]methyl]pyrazole-4-carboxamide; (P012) N-methyl-1-[[4-[5-(trifluoromethyl)-1,2,4-oxadiazol-3-yl]phenyl]methyl]pyrazole-4-carboxamide; (P013) N,N,-dimethyl-H[4-[5-(trifluoromethyl)-1,2,4-oxadiazol-3-yl]phenyl]methyl]-1,2,4-triazol-3-amine; (P014) 3-[4-[(5-ethylsulfanyl-1,2,4-triazol-1-yl)methyl]phenyl]-5-(trifluoromethyl)-1,2,4-oxadiazole; (P015) 3-[4-(triazolo[4,5-b]pyridin-1-ylmethyl)phenyl]-5-(trifluoromethyl)-1,2,4-oxadiazole; (P016) 3-[4-(triazolo[4,5-b]pyridin-2-ylmethyl)phenyl]-5-(trifluoromethyl)-1,2,4-oxadiazole; (P017) 3-[4-(triazolo[4,5-b]pyridin-3-ylmethyl)phenyl]-5-(trifluoromethyl)-1,2,4-oxadiazole; (P018) methyl 1-[[4-[5-(trifluoromethyl)-1,2,4-oxadiazol-3-yl]phenyl]methyl]pyrazole-4-carboxylate; (P019) ethyl 1-[[3-fluoro-4-[5-(trifluoromethyl)-1,2,4-oxadiazol-3-yl]phenyl]methyl]pyrazole-4-carboxylate; (P020) N,N-diethyl-1-[[4-[5-(trifluoromethyl)-1,2,4-oxadiazol-3-yl]phenyl]methyl]pyrazole-4-carboxamide; (P021) N-methoxy-N-methyl-1-[[4-[5-(trifluoromethyl)-1,2,4-oxadiazol-3-yl]phenyl]methyl]pyrazole-4-carboxamide; (P022) propyl 1-[[4-[5-(trifluoromethyl)-1,2,4-oxadiazol-3-yl]phenyl]methyl]pyrazole-4-carboxylate; (P023) N-methoxy-1-[[4-[5-(trifluoromethyl)-1,2,4-oxadiazol-3-yl]phenyl]methyl]pyrazole-4-carboxamide; (P024) N-ethyl-1-[[4-[5-(trifluoromethyl)-1,2,4-oxadiazol-3-yl]phenyl]methyl]pyrazole-4-carboxamide; (P025) 1-[[4-[5-(trifluoromethyl)-1,2,4-oxadiazol-3-yl]phenyl]methyl]pyrazole-4-carboxamide; (P026) N-methoxy-1-[1-[[4-[5-(trifluoromethyl)-1,2,4-oxadiazol-3-yl]phenyl]methyl]pyrazol-4-yl]methanimine; (P027) ethyl 1-[1-[4-[5-(trifluoromethyl)-1,2,4-oxadiazol-3-yl]phenyl]ethyl]pyrazole-4-carboxylate; (P028) 1-[[4-[5-(trifluoromethyl)-1,2,4-oxadiazol-3-yl]phenyl]methyl]pyrrolidin-2-one; (P029) 1-[[4-[5-(trifluoromethyl)-1,2,4-oxadiazol-3-yl]phenyl]methyl]piperidin-2-one; (P030) 4-[[4-[5-(trifluoromethyl)-1,2,4-oxadiazol-3-yl]phenyl]methyl]morpholin-3-one; (P031) 4,4-dimethyl-2-[[4-[5-(trifluoromethyl)-1,2,4-oxadiazol-3-yl]phenyl]methyl]isoxazolidin-3-one; (P032) 2-[[4-[5-(trifluoromethyl)-1,2,4-oxadiazol-3-yl]phenyl]methyl]isoxazolidin-3-one; (P033) 5,5-dimethyl-2-[[4-[5-(trifluoromethyl)-1,2,4-oxadiazol-3-yl]phenyl]methyl]isoxazolidin-3-one; (P034) 3,3-dimethyl-1 [4-[5-(trifluoromethyl)-1,2,4-oxadiazol-3-yl]phenyl]methyl]piperidin-2-one; (P035) 1-[[2-fluoro-4-[5-(trifluoromethyl)-1,2,4-oxadiazol-3-yl]phenyl]methyl]pyrrolidin-2-one; (P036) 1-[[2-fluoro-4-[5-(trifluoromethyl)-1,2,4-oxadiazol-3-yl]phenyl]methyl]piperidin-2-one; (P037) 2-[[4-[5-(trifluoromethyl)-1,2,4-oxadiazol-3-yl]phenyl]methyl]oxazinan-3-one; (P038) 1-[[3-fluoro-4-[5-(trifluoromethyl)-1,2,4-oxadiazol-3-yl]phenyl]methyl]piperidin-2-one; (P039) 3-[[4-[5-(trifluoromethyl)-1,2,4-oxadiazol-3-yl]phenyl]methyl]oxazolidin-2-one; (P040) 1-methyl-3-[[4-[5-(trifluoromethyl)-1,2,4-oxadiazol-3-yl]phenyl]methyl]imidazolidin-2-one; (P041) 1-[[3-fluoro-4-[5-(trifluoromethyl)-1,2,4-oxadiazol-3-yl]phenyl]methyl]-3,3-dimethyl-piperidin-2-one; (P042) 1-[[3-fluoro-4-[5-(trifluoromethyl)-1,2,4-oxadiazol-3-yl]phenyl]methyl]pyrrolidin-2-one; (P043) 2-[[3-fluoro-4-[5-(trifluoromethyl)-1,2,4-oxadiazol-3-yl]phenyl]methyl]-4,4-dimethyl-isoxazolidin-3-one; (P044) 2-[[2,3-difluoro-4-[5-(trifluoromethyl)-1,2,4-oxadiazol-3-yl]phenyl]methyl]isoxazolidin-3-one; (P045) 2-[[3-fluoro-4-[5-(trifluoromethyl)-1,2,4-oxadiazol-3-yl]phenyl]methyl]isoxazolidin-3-one; (P046) 1-[[3-fluoro-4-[5-(trifluoromethyl)-1,2,4-oxadiazol-3-yl]phenyl]methyl]azepan-2-one; (P047) N-[[4-[5-(trifluoromethyl)-1,2,4-oxadiazol-3-yl]phenyl]methyl]propanamide; (P048) 2,2-dimethyl-N-[[4-[5-(trifluoromethyl)-1,2,4-oxadiazol-3-yl]phenyl]methyl]but-3-ynamide; (P049) N-[[4-[5-(trifluoromethyl)-1,2,4-oxadiazol-3-yl]phenyl]methyl]butanamide; (P050) 3-methyl-N-[[4-[5-(trifluoromethyl)-1,2,4-oxadiazol-3-yl]phenyl]methyl]butanamide; (P051) 2-methyl-N-[[4-[5-(trifluoromethyl)-1,2,4-oxadiazol-3-yl]phenyl]methyl]prop-2-enamide; (P052) 2-methyl-N-[[4-[5-(trifluoromethyl)-1,2,4-oxadiazol-3-yl]phenyl]methyl]butanamide; (P053) 2-methoxy-N-[[4-[5-(trifluoromethyl)-1,2,4-oxadiazol-3-yl]phenyl]methyl]; (P054) 3,3,3-trifluoro-N-[[3-fluoro-4-[5-(trifluoromethyl)-1,2,4-oxadiazol-3-yl]phenyl]methyl]propanamide; (P055) 3,3,3-trifluoro-N-[[2-fluoro-4-[5-(trifluoromethyl)-1,2,4-oxadiazol-3-yl]phenyl]methyl]propanamide; (P056) N-[[2,3-difluoro-4-[5-(trifluoromethyl)-1,2,4-oxadiazol-3-yl]phenyl]methyl]butanamide; (P057) N-[[2,3-difluoro-4-[5-(trifluoromethyl)-1,2,4-oxadiazol-3-yl]phenyl]methyl]-3,3,3-trifluoro-propanamide; (P058) 2-(difluoromethoxy)-N-[[4-[5-(trifluoromethyl)-1,2,4-oxadiazol-3-yl]phenyl]methyl]acetamide; (P059) 2-methoxy-2-methyl-N-[[4-[5-(trifluoromethyl)-1,2,4-oxadiazol-3-yl]phenyl]methyl]propanamide; (P060) 1-methyl-3-[[4-[5-(trifluoromethyl)-1,2,4-oxadiazol-3-yl]phenyl]methyl]urea; (P061) 1-ethyl-1-methyl-3-[[4-[5-(trifluoromethyl)-1,2,4-oxadiazol-3-yl]phenyl]methyl]urea; (P062) 1-ethoxy-3-[[4-[5-(trifluoromethyl)-1,2,4-oxadiazol-3-yl]phenyl]methyl]urea; (P063) 1-methoxy-1-methyl-3-[[4-[5-(trifluoromethyl)-1,2,4-oxadiazol-3-yl]phenyl]methyl]; (P064) 1,1-diethyl-3-[[4-[5-(trifluoromethyl)-1,2,4-oxadiazol-3-yl]phenyl]methyl]urea; (P065) N-methoxy-N-[[4-[5-(trifluoromethyl)-1,2,4-oxadiazol-3-yl]phenyl]methyl]cyclopropanecarboxamide; (P066) N-methoxy-N-[[4-[5-(trifluoromethyl)-1,2,4-oxadiazol-3-yl]phenyl]methyl]pent-4-ynamide; (P067) N-methoxy-2-methyl-N-[[4-[5-(trifluoromethyl)-1,2,4-oxadiazol-3-yl]phenyl]methyl]prop-2-enamide; (P068) N,2-dimethoxy-N-[[4-[5-(trifluoromethyl)-1,2,4-oxadiazol-3-yl]phenyl]methyl]propanamide; (P069) N-cyclopropyl-3,3,3-trifluoro-N-[[4-[5-(trifluoromethyl)-1,2,4-oxadiazol-3-yl]phenyl]methyl]propanamide; (P070) 2,2-difluoro-N-(2-methoxyethyl)-N-[[4-[5-(trifluoromethyl)-1,2,4-oxadiazol-3-yl]phenyl]methyl]cyclo propanecarboxamide; (P071) N-ethyl-2-methyl-N-[[4-[5-(trifluoromethyl)-1,2,4-oxadiazol-3-yl]phenyl]methyl]propanamide; (P072) N-[[3-fluoro-4-[5-(trifluoromethyl)-1,2,4-oxadiazol-3-yl]phenyl]methyl]-N-methoxy-propanamide; (P073) 2-methoxy-N-(2,2,2-trifluoroethyl)-N-[[4-[5-(trifluoromethyl)-1,2,4-oxadiazol-3-yl]phenyl]methyl] acetamide; (P074) N-[[2,3-difluoro-4-[5-(trifluoromethyl)-1,2,4-oxadiazol-3-yl]phenyl]methyl]-N-methoxy-cyclopropane carboxamide; (P075) 2-(difluoromethoxy)-N-methyl-N-[[4-[5-(trifluoromethyl)-1,2,4-oxadiazol-3-yl]phenyl]methyl]acetamide; (P076) N-ethoxy-2-methoxy-N-1-[[4-[5-(trifluoromethyl)-1,2,4-oxadiazol-3-yl]phenyl]methyl]propanamide; (P077) N-isopropyl-N-[[4-[5-(trifluoromethyl)-1,2,4-oxadiazol-3-yl]phenyl]methyl]tetrahydrofuran-2-carboxamide; (P078) 1-methoxy-3-methyl-1-[[4-[5-(trifluoromethyl)-1,2,4-oxadiazol-3-yl]phenyl]methyl]urea; (P079) 3-cyclopropyl-1-methoxy-1-[[4-[5-(trifluoromethyl)-1,2,4-oxadiazol-3-yl]phenyl]methyl]urea; (P080) 3-ethoxy-1-methoxy-1-[[4-[5-(trifluoromethyl)-1,2,4-oxadiazol-3-yl]phenyl]methyl]urea; (P081) 3-allyl-1-methoxy-1-[[4-[5-(trifluoromethyl)-1,2,4-oxadiazol-3-yl]phenyl]methyl]urea; (P082) 1-cyclopropyl-3-methoxy-3-methyl-1-[[4-[5-(trifluoromethyl)-1,2,4-oxadiazol-3-yl]phenyl]methyl]urea; (P083) 3-isopropyl-1-methoxy-1-[[4-[5-(trifluoromethyl)-1,2,4-oxadiazol-3-yl]phenyl]methyl]urea; (P084) 1-methoxy-3-prop-2-ynyl-1-[[4-[5-(trifluoromethyl)-1,2,4-oxadiazol-3-yl]phenyl]methyl]urea; (P085) 1-[[3-fluoro-4-[5-(trifluoromethyl)-1,2,4-oxadiazol-3-yl]phenyl]methyl]-1-methoxy-3-methyl-urea; (P086) 3-(cyclopropylmethyl)-1-methyl-1-[[4-[5-(trifluoromethyl)-1,2,4-oxadiazol-3-yl]phenyl]methyl]urea; (P087) 1-ethyl-3-(2,2,2-trifluoroethyl)-1-[[4-[5-(trifluoromethyl)-1,2,4-oxadiazol-3-yl]phenyl]methyl]urea; (P088) 1,3-dimethoxy-1-[[4-[5-(trifluoromethyl)-1,2,4-oxadiazol-3-yl]phenyl]methyl]urea; (P089) 3-ethyl-1-methoxy-1-[[4-[5-(trifluoromethyl)-1,2,4-oxadiazol-3-yl]phenyl]methyl]urea; (P090) N-methyl-4-[5-(trifluoromethyl)-1,2,4-oxadiazol-3-yl]benzamide; (P091) N-[(E)-methoxyiminomethyl]-4-[5-(trifluoromethyl)-1,2,4-oxadiazol-3-yl]benzamide; (P092) N—[(Z)-methoxyiminomethyl]-4-[5-(trifluoromethyl)-1,2,4-oxadiazol-3-yl]benzamide; (P093) N-[4-[5-(trifluoromethyl)-1,2,4-oxadiazol-3-yl]phenyl]cyclopropanecarboxamide; (P094) N-(2-fluorophenyl)-4-[5-(trifluoromethyl)-1,2,4-oxadiazol-3-yl]benzamide; (P095) 2,2-difluoro-N-methyl-2-[4-[5-(trifluoromethyl)-1,2,4-oxadiazol-3-yl]phenyl]acetamide; (P096) N-allyl-N-[[4-[5-(trifluoromethyl)-1,2,4-oxadiazol-3-yl]phenyl]methyl]acetamide; (P097) N-[(E)-N-methoxy-C-methyl-carbonimidoyl]-4-[5-(trifluoromethyl)-1,2,4-oxadiazol-3-yl]benzamide; (P098) N—[(Z)—N-methoxy-C-methyl-carbonimidoyl]-4-[5-(trifluoromethyl)-1,2,4-oxadiazol-3-yl]benzamide; (P100) N-allyl-N-[[4-[5-(trifluoromethyl)-1,2,4-oxadiazol-3-yl]phenyl]methyl]propanamide; (P101) 4,4-dimethyl-1-[[4-[5-(trifluoromethyl)-1,2,4-oxadiazol-3-yl]phenyl]methyl]pyrrolidin-2-one; (P102) N-methyl-4-[5-(trifluoromethyl)-1,2,4-oxadiazol-3-yl]benzenecarbothioamide and (P103) 5-methyl-1-[[4-[5-(trifluoromethyl)-1,2,4-oxadiazol-3-yl]phenyl]methyl]pyrrolidin-2-one.

5. The pesticidal mixture according to claim 1, wherein said component (2) is at least one insecticidally active compound (II) selected from
(II-2) GABA-gated chloride channel blockers;
(II-3) Sodium channel modulators (Pyrethroids/Pyrethrins);
(II-4) Nicotinic acetylcholine receptor (nAChR) competitive modulators;
(II-5) Nicotinic acetylcholine receptor (nAChR) allosteric modulators—Site I;
(II-6) Glutamate-gated chloride channel (GluCl) allosteric modulators;
(II-7) Juvenile hormone mimics;
(II-9) Chordotonal organ TRPV channel modulators;
(II-11) Microbial disruptors of insect midgut membranes;
(II-13) Uncouplers of oxidative phosphorylation via disruption of the proton gradient;
(II-22) Voltage-dependent sodium channel blockers;
(II-28) GABA-gated chloride channel allosteric modulators; and
(II-31) Insecticidal active compounds of unknown or uncertain mode of action.

6. The pesticidal mixture according to claim 1, wherein said component (2) is at least one fungicidally active compound (III) selected from
(A) Inhibitors of the ergosterol synthesis;
(B) Inhibitors of the respiratory chain at complex I or II;
(C) Inhibitors of the respiratory chain at complex III;
(D) Inhibitors of the mitosis and cell division;
(E) Compounds capable to have a multisite action;
(L) Inhibitors of the nucleic acid synthesis;
(M) Inhibitors of the signal transduction;
(N) Compounds capable to act as an uncoupler; and
(P) Inhibitors of histone deacetylase.

7. The pesticidal mixture according to claim 1, wherein said component (2) is at least one fungicidally active compound (III) selected from (A001) cyproconazole, (A002) difenoconazole, (A003) epoxiconazole, (A006) fenpropimorph, (A009) flutriafol, (A013) metconazole, (A017) propiconazole, (A018) prothioconazole, (A021) tebuconazole, (A022) tetraconazol, (A081) mefentrifluconazole, (B001) benzovindiflupyr, (B002) bixafen, (B005) fluopyram, (B007) fluxapyroxad, (B019) pydiflumetofen, (B30) fluindapyr, (B059) inpyrfluxam, (C003) azoxystrobin, (C012) fluoxastrobin (C014) metominostrobin, (C017) pyraclostrobin, (C016) picoxystrobin, (C020) trifloxystrobin, (C025) (3S,6S,7R,8R)-8-benzyl-3-[({3-[(isobutyryloxy)methoxy]-4-methoxypyridin-2-yl}carbonyl)amino]-6-methyl-4,9-dioxo-1,5-dioxonan-7-yl-2-methylpropanoate (Fenpicoxamid), (C030) 1-(2-{[1-(4-chlorophenyl)pyrazol-3-yl]oxymethyl}-3-methylphenyl)-1,4-dihydro-4-methyl-5H-tetrazol-5-one (Metyltetraprole), (D001) carbendazim, (D007) thiophanate-methyl, (E004) chlorothalonil, (E010) dithianon, (E013) mancozeb, (E020) thiram, (F002) Isotianil, (F003) Probenazole, (L003) metalaxyl, (M001) fludioxonil, (N001) fluazinam, (O022) Oxathiapiprolin, (O043) 2-{3-[2-(1-{[3,5-bis(difluoromethyl)-1H-pyrazol-1-yl]acetyl}piperidin-4-yl)-1,3-thiazol-4-yl]-4,5-dihydro-1,2-oxazol-5-yl}-3-chlorophenyl methanesulfonate (fluoxapiprolin), (O046) 3-(4,4,5-trifluoro-3,3-dimethyl-3,4-dihydroisoquinolin-1-yl)quinoline, (O047) 3-(4,4-difluoro-3,3-dimethyl-3,4-dihydroisoquinolin-1-yl)quinoline (Quinofumelin), (O065) ipflufenoquin and (P094) N-(2-fluorophenyl)-4-[5-(trifluoromethyl)-1,2,4-oxadiazol-3-yl]benzamide.

8. The pesticidal mixture according to claim 7, wherein said component (2) is at least one fungicidally active compound (III) selected from (C003) Azoxystrobin, (C017) Pyraclostrobin, (L003) Metalaxyl, (D007) Thiophanate-methyl, (B007) Fluxapyroxad, (M001) Fludioxonil, (F003) Probenazole, (F002) Isotianil and (B005) Fluopyram.

9. The pesticidal mixture according to claim 1, wherein said component (2) is at least one insecticidally active compound (II) selected from Abamectin (Z166), Acephate (Z027), acetamiprid (Z148). Afidopyropen (Z190), alpha-cypermethrin (Z114), Bifenthrin (Z103), Broflanilide (Z273), Benzpyrimoxan (Z285), buprofezin (Z221), Chlorfenapyr (Z203), Clothianidin (Z149), cyhalothrin (Z110), Cypermethrin (Z113), Diafenthiuron (Z197), Dimpropyridaz (Z3170, dinotefuran (Z150), Emamectin benzoate (Z167), flonicamid (Z272), Fluxametamide (Z274), Flupyrimin (Z163), Fipronil (Z095), Fluhexafon (Z293), Flometoquin (Z292), Imidacloprid (Z151), Indoxacarb (Z240), Isocycloseram (Z275), Metaflumizone (Z241), Oxazosulfyl (Z243), Pyridalyl (Z299), Pymetrozine (Z188), Pyriproxyfen (Z174), Spirodiclofen (Z244), Spiropidion (Z246), Spinetoram (Z164), Spinosad (Z165), spirotetramat (Z247), Thiamethoxam (Z154), Teflubenzuron (Z219), thiacloprid (Z153), Triflumezopyrim (Z161) and Tyclopyrazoflor (Z318).

10. The pesticidal mixture according to claim 1, wherein said component (2) is at least one insecticidally active biological compound (II) selected from the class of (II-11A) Bacillus thuringiensis (Z195) and the insecticidal proteins they produce including Bacillus thuringiensis or Bacillus sphaericus and the insecticidal proteins they produce such as Bacillus thuringiensis subsp. israelensis, Bacillus sphaericus, Bacillus thuringiensis subsp. aizawai, Bacillus thuringiensis subsp. kurstaki and Bacillus thuringiensis subsp. tenebrionis, or the B.t crop proteins: Cry1Ab, Cry1Ac, Cry1Fa, Cry1A.105, Cry2Ab, Vip3A, mCry3A, Cry3Ab, Cry3Bb and Cry34/35Ab1,

11. The pesticidal mixture according to claim 1, wherein said mixture further comprises an agriculturally acceptable auxiliaries, solvents, carriers, surfactants or extenders.

12. The pesticidal mixture according to claim 1, wherein component (1) and said component (2) is in a weight ratio of from 1000:1 to 1:1000.

13. The pesticidal mixture according to claim 1, wherein component (1) and said component (2) is in a weight ratio of from 100:1 to 1:100.

14. A method for controlling insects, acarids, nematodes, phytopathogenic fungi comprising contacting an insect, acarid, nematode, phytopathogenic fungi or their food supply, habitat, breeding grounds or their locus with a pesticidally effective amount of a mixture according to claim 1.

15. A method of protecting plants from attack or infestation by insects, acarids, nematodes or phytopathogenic fungi comprising contacting the plant, or the soil or water in which the plant is growing, with a pesticidally effective amount of a mixture according to claim 1.

16. A seed, comprising the pesticidal mixture according to claim 1 in an amount from 0.1 g to 10 kg per 100 kg of seeds.

17. A method for the protection of plant propagation material comprising contacting the plant propagation material with a mixture according to claim 1 in a pesticidally effective amounts.

18. A method for protecting crops against pests selected from the group consisting of lepidopterans (Lepidoptera), beetles (Coleoptera), flies and mosquitoes (Diptera), thrips (Thysanoptera), termites (Isoptera), bugs, aphids, leafhoppers, whiteflies, scale insects, cicadas (Hemiptera), ants, bees, wasps, sawflies (Hymenoptera), crickets, grasshoppers, locusts (Orthoptera), and Arachnoidea, the method comprising treating the crops with the pesticidal mixture of claim 1.

19. A method for protecting crops against diseases caused by insects, acarids, nematodes or phytopathogenic fungi, the method comprising treating the crops with the pesticidal mixture of claim 1.

20. A method for treating a seed or transgenic plants, the method comprising contacting the seed or transgenic plant with the pesticidal mixture of claim 1.
